(19) United States
(12) Patent Application Publication
(10) Pub. No.: US 2006/0262055 A1
(43) Pub. Date: Nov. 23, 2006

(54) Plane display device

(75) Inventor: Hiroshi Takahara, Osaka (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology, Minato-ku (JP)

(21) Appl. No.: 11/337,008

(22) Filed: Jan. 23, 2006

(30) Foreign Application Priority Data
Jan. 26, 2005 (JP) 2005-018963
Sep. 12, 2005 (JP) 2005-264325

(51) Int. Cl. G09G 3/30

(52) U.S. Cl. 345/81

(57) ABSTRACT

The invention provides a plane display device having a display area divided into a plurality of processing blocks, the processing blocks each having a plurality of photosensor pixels 27, and the plane display device includes a precharge signal supply unit for supplying precharge signals to the respective photosensor pixels 27, a reading unit for acquiring reading signals outputted from the respective photosensor pixels 27 according to intensities of light beams irradiated on the respective photosensor pixels 27 in a state in which the precharge signals are supplied to the respective photosensor pixels 27, and a storage unit for storing data relating to the precharge signals for the plurality of photosensor pixels 27 in the corresponding processing blocks, and the precharge signal supply unit supplies the precharge signals to the respective photosensor pixels 27 on the basis of the data.

### FIELD OF THE INVENTION

The present invention relates to a plane display device provided with an image capturing function.

### DESCRIPTION OF THE RELATED ART

A liquid crystal display device includes an array substrate having a source signal line, a gate signal line and a pixel transistor formed thereon, a source driver circuit that drives the source signal line and a gate driver circuit that drives the gate signal line. In association with recent advancement and development of technology of integrated circuit, a process technology of forming part of a drive circuit on the array substrate is put into practical use. Accordingly, reduction of weight, thickness and length of the liquid crystal display device as a whole is achieved, and hence it is widely used as a display device for various types of portable equipments such as mobile phones and laptop computers.

A display device provided with an image capturing function in which a close area sensor for capturing images is arranged on an array substrate is proposed (for example, JP-A-2001-292276, JP-A-2001-339640). The display device provided with the image capturing function of this type in the related art captures images by varying an amount of charge capacity of a capacitor connected to a sensor according to an amount of received light beam at the sensor and detecting voltages at both ends of the capacitor.

When connecting a SRAM or a buffer circuit to the capacitor in order to detects the voltages at the both ends of the capacitor in the display device configured as described above, determination between “0” and “1” is performed depending on whether the voltage exceeds a threshold voltage of a transistor which constitutes the SRAM or the buffer circuit.

However, since the threshold voltage of the transistor fluctuates, it is possible that a criterion between “0” and “1” may be shifted.

In view of such circumstances, it is an object of the present invention to provide a plane display device which can capture images without being affected by fluctuations of electrical characteristic of a sensor or a transistor.

### DISCLOSURE OF THE INVENTION

The present invention provides a plane display device having an array substrate formed with display pixels in a matrix manner and a plurality of photosensor pixels thereon, including: a display area of the plane display device divided into a plurality of processing blocks, the processing blocks each being formed with the plurality of photosensor pixels; a precharge signal supply unit for supplying precharge signals that provide energy required in action of the photosensor pixels to the photosensor pixels respectively; a reading unit for acquiring reading signals outputted from the respective photosensor pixels according to intensity of a light beam irradiated on the respective photosensor pixels in a state in which the precharge signals are supplied to the respective photosensor pixels; and a storage unit for storing data relating to the precharge signal or the precharge signals for one or more photosensor pixels in the processing block, wherein the precharge signal supply unit supplies the precharge signals to the respective photosensor pixels on the basis of the data.

According to the present invention, images can be captured without being affected by the fluctuation of the electrical characteristics of the sensor or the transistor.

### BRIEF DESCRIPTION OF THE DRAWINGS

FIG. 1 is a block diagram of a plane display device according to a first embodiment of the present invention.

FIG. 2 is an enlarged explanatory drawing of a pixel according to present invention.

FIG. 3 is a drawing showing an arrangement of the pixels according to the present invention.

FIG. 4 is a drawing showing an arrangement of photosensor pixels according to the present invention.

FIG. 5 is a drawing showing another arrangement of the photosensor pixels according to the present invention.

FIG. 6 is a drawing showing another arrangement of the photosensor pixels according to the present invention.

FIG. 7 is a drawing showing another arrangement of the photosensor pixels according to the present invention.

FIG. 8 is a drawing showing another arrangement of the photosensor pixels according to the present invention.

FIG. 9 is a drawing showing another arrangement of the photosensor pixels according to present invention.

FIG. 10 is a drawing showing an area where the photosensors are formed according to the present invention.

FIG. 11 is a drawing showing the area where the photosensors are formed according to the present invention.

FIG. 12 is a drawing showing the area where the photosensors are formed according to the present invention.

FIG. 13 is a drawing showing the area where the photosensors are formed according to the present invention.

FIG. 14 is an equivalent circuit diagram of the pixel according to the present invention.

FIG. 15 is a block diagram of a plane display device according to the present invention.

FIG. 16 is an equivalent circuit diagram of the pixel according to the present invention.

FIG. 17 is a block diagram of the plane display device according to the present invention.

FIG. 18 is a timing chart diagram of a drive method of the plane display device according to the present invention.

FIG. 19 is a timing chart diagram of the drive method of the plane display device according to the present invention.

FIG. 20 is a block diagram of the plane display device according to the present invention.

FIG. 21 is an explanatory drawing showing the drive method of the plane display device according to the present invention.

FIG. 22 is an explanatory drawing showing the drive method of the plane display device according to the present invention.

FIG. 23 is a block diagram of the plane display device according to the present invention.

FIG. 24 is a block diagram of the plane display device according to the present invention.

FIG. 25 is a block diagram of the plane display device according to the present invention.

FIG. 26 is a timing chart diagram of the drive method of the plane display device according to the present invention.

FIG. 27 is a timing chart diagram of the drive method of the plane display device according to the present invention.

FIG. 28 is a timing chart diagram of the drive method of the plane display device according to the present invention.

FIG. 29 is a timing chart diagram of the drive method of the plane display device according to the present invention.

FIG. 30 is a timing chart diagram of the drive method of the plane display device according to the present invention.

FIG. 31 is an equivalent circuit diagram of the pixel and a peripheral circuit portion according to the present invention.

FIG. 32 is an equivalent circuit diagram of the pixel and the peripheral circuit portion according to the present invention.

FIG. 33 is an equivalent circuit diagram of the pixel and the peripheral circuit portion according to the present invention.

FIG. 34 is an equivalent circuit diagram of the pixel and the peripheral circuit portion according to the present invention.

FIG. 35 is an equivalent circuit diagram of the pixel and the peripheral circuit portion according to the present invention.

FIG. 36 is an explanatory drawing showing the drive method of the plane display device according to the present invention.

FIG. 37 is an explanatory drawing showing the drive method of the plane display device according to the present invention.

FIG. 38 is an equivalent circuit diagram of the pixel according to the present invention.

FIG. 39 is an equivalent circuit diagram of the pixel according to the present invention.

FIG. 40 is an equivalent circuit diagram of the pixel according to the present invention.

FIG. 41 is an equivalent circuit diagram of the pixel and the peripheral circuit portion according to the present invention.

FIG. 42 is an equivalent circuit diagram of the pixel and the peripheral circuit portion.

FIG. 43 is an equivalent circuit diagram of the pixel according to the present invention according to the present invention.

FIG. 44 is a timing chart diagram of the drive method of the plane display device according to the present invention.

FIG. 45 is an equivalent circuit diagram of the pixel according to the present invention.

FIG. 46 is an equivalent circuit diagram of the pixel according to the present invention.

FIG. 47 is an equivalent circuit diagram of the pixel according to the present invention.

FIG. 48 is an equivalent circuit diagram of the pixel according to the present invention.

FIG. 49 is an equivalent circuit diagram of the pixel according to the present invention.

FIG. 50 is an equivalent circuit diagram of the pixel according to the present invention.

FIG. 51 is an equivalent circuit diagram of the pixel according to the present invention.

FIG. 52 is an equivalent circuit diagram of the pixel according to the present invention.

FIG. 53 is an equivalent circuit diagram of the pixel according to the present invention.

FIG. 54 is an equivalent circuit diagram of the pixel according to the present invention.

FIG. 55 is an equivalent circuit diagram of the pixel according to the present invention.

FIG. 56 is an equivalent circuit diagram of the pixel according to the present invention.

FIG. 57 is an equivalent circuit diagram of the pixel according to the present invention.

FIG. 58 is an equivalent circuit diagram of the pixel according to the present invention.

FIG. 59 is an equivalent circuit diagram of the pixel according to the present invention.

FIG. 60 is an explanatory drawing of the drive method of the plane display device according to the present invention.

FIG. 61 is an explanatory drawing showing the drive method of the plane display device according to the present invention.

FIG. 62 is an explanatory drawing showing the drive method of the plane display device according to the present invention.

FIG. 63 is an explanatory drawing showing the plane display device according to the present invention.

FIG. 64 is an explanatory drawing of the plane display device according to the present invention.

FIG. 65 is an explanatory drawing showing the plane display device according to the present invention.

FIG. 66 is an explanatory drawing showing the plane display device according to the present invention.

FIG. 67 is an explanatory drawing showing the plane display device according to the present invention.

FIG. 68 is an explanatory drawing showing the plane display device according to the present invention.

FIG. 69 is an explanatory drawing showing the drive method of the plane display device according to the present invention.

FIG. 70 is an explanatory drawing showing the drive method of the plane display device according to the present invention.

FIG. 71 is an explanatory drawing showing the drive method of the plane display device according to the present invention.

FIG. 72 is an explanatory drawing showing the drive method of the plane display device according to the present invention.

FIG. 73 is an explanatory drawing showing the drive method of the plane display device according to the present invention.

FIG. 74 is an explanatory drawing showing the drive method of the plane display device according to the present invention.

FIG. 75 is an explanatory drawing showing the drive method of the plane display device according to the present invention.

FIG. 76 is an explanatory drawing showing the drive method of the plane display device according to the present invention.

FIG. 77 is an explanatory drawing showing the drive method of the plane display device according to the present invention.

FIG. 78 is an explanatory drawing showing the drive method of the plane display device according to the present invention.

FIG. 79 is an explanatory drawing showing the drive method of the plane display device according to the present invention.

FIG. 80 is an explanatory drawing showing the drive method of the plane display device according to the present invention.

FIG. 81 is an explanatory drawing showing the drive method of the plane display device according to the present invention.

FIG. 82 is an explanatory drawing showing the drive method of the plane display device according to the present invention.

FIG. 83 is an explanatory drawing showing the drive method of the plane display device according to the present invention.

FIG. 84 is an explanatory drawing showing the drive method of the plane display device according to the present invention.

FIG. 85 is an explanatory drawing showing the drive method of the plane display device according to the present invention.

FIG. 86 is an explanatory drawing showing the drive method of the plane display device according to the present invention.

FIG. 87 is an explanatory drawing showing the drive method of the plane display device according to the present invention.

FIG. 88 is an explanatory drawing showing the drive method of the plane display device according to the present invention.

FIG. 89 is an explanatory drawing showing the drive method of the plane display device according to the present invention.

FIG. 90 is an explanatory drawing showing the drive method of the plane display device according to the present invention.

FIG. 91 is an explanatory drawing showing the drive method of the plane display device according to the present invention.

FIG. 92 is an explanatory drawing showing the drive method of the plane display device according to the present invention.

FIG. 93 is an explanatory drawing showing the drive method of the plane display device according to the present invention.

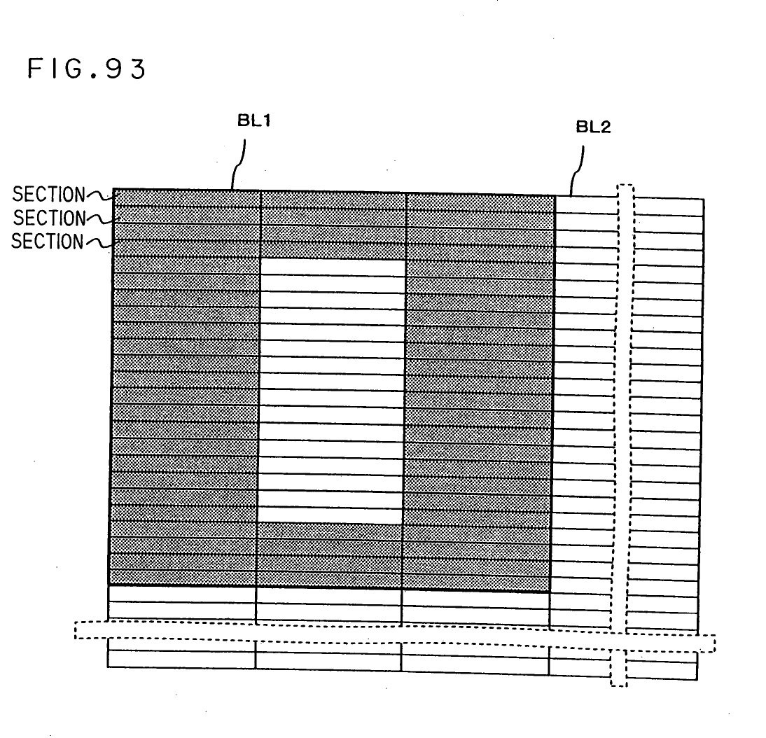

FIG. 94 is an explanatory drawing showing the drive method of the plane display device according to the present invention.

FIG. 95 is an explanatory drawing showing the drive method of the plane display device according to the present invention.

FIG. 96 is an equivalent circuit diagram of the pixel and the peripheral circuit portion according to the present invention.

FIG. 97 is an explanatory drawing showing the plane display device according to the present invention.

FIG. 98 is an explanatory drawing of the plane display device according to the present invention.

FIG. 99 is an explanatory drawing showing the plane display device according to the present invention.

FIG. 100 is an explanatory drawing showing the plane display device according to the present invention.

FIG. 101 is an explanatory drawing showing the drive method of the plane display device according to the present invention.

FIG. 102 is an explanatory drawing showing the drive method of the plane display device according to the present invention.

FIG. 103 is an explanatory drawing showing the drive method of the plane display device according to the present invention.

FIG. 104 is an explanatory drawing showing the drive method of the plane display device according to the present invention.

FIG. 105 is an explanatory drawing showing the drive method of the plane display device according to the present invention.

FIG. 106 is an explanatory drawing showing the drive method of the plane display device according to the present invention.

FIG. 107 is an explanatory drawing showing the plane display device according to the present invention.

FIG. 108 is an explanatory drawing showing the plane display device according to the present invention.

FIG. 109 is an explanatory drawing showing the plane display device according to the present invention.

FIG. 110 is an explanatory drawing showing the plane display device according to the present invention.

FIG. 111 is an explanatory drawing showing the drive method of the plane display device according to the present invention.

FIG. 112 is an explanatory drawing showing the drive method of the plane display device according to the present invention.

FIG. 113 is an explanatory drawing showing the drive method of the plane display device according to the present invention.

FIG. 114 is an explanatory drawing showing the drive method of the plane display device according to the present invention.

FIG. 115 is an explanatory drawing showing the drive method of the plane display device according to the present invention.

FIG. 116 is an explanatory drawing showing the drive method of the plane display device according to the present invention.

FIG. 117 is an explanatory drawing showing the drive method of the plane display device according to the present invention.

FIG. 118 is an explanatory drawing showing the drive method of the plane display device according to the present invention.

FIG. 119 is an explanatory drawing showing the drive method of the plane display device according to the present invention.

FIG. 120 is an explanatory drawing showing the drive method of the plane display device according to the present invention.

FIG. 121 is an explanatory drawing showing the drive method of the plane display device according to the present invention.

FIG. 122 is an explanatory drawing showing the drive method of the plane display device according to the present invention.

FIG. 123 is an explanatory drawing showing the drive method of the plane display device according to the present invention.

FIG. 124 is an explanatory drawing showing the drive method of the plane display device according to the present invention.

FIG. 125 is an explanatory drawing showing the drive method of the plane display device according to the present invention.

FIG. 126 is an explanatory drawing showing the drive method of the plane display device according to the present invention.

FIG. 127 is an explanatory drawing showing the drive method of the plane display device according to the present invention.

FIG. 128 is an explanatory drawing showing the drive method of the plane display device according to the present invention.

FIG. 129 is an explanatory drawing showing the drive method of the plane display device according to the present invention.

FIG. 130 is an explanatory drawing showing the drive method of the plane display device according to the present invention.

FIG. 131 is an explanatory drawing showing the drive method of the plane display device according to the present invention.

FIG. 132 is an explanatory drawing showing the drive method of the plane display device according to the present invention.

FIG. 133 is an explanatory drawing showing the drive method of the plane display device according to the present invention.

FIG. 134 is an explanatory drawing showing the drive method of the plane display device according to the present invention.

FIG. 135 is an explanatory drawing showing the drive method of the plane display device according to the present invention.

FIG. 136 is an explanatory drawing showing the drive method of the plane display device according to the present invention.

FIG. 137 is an explanatory drawing showing the drive method of the plane display device according to the present invention.

FIG. 138 is an explanatory drawing showing the drive method of the plane display device according to the present invention.

FIG. 139 is an explanatory drawing showing the drive method of the plane display device according to the present invention.

FIG. 140 is an explanatory drawing showing a circuit configuration of the plane display device according to the present invention.

FIG. 141 is an explanatory drawing showing the plane display device applied to a cellular phone.

FIG. 142 is an explanatory drawing showing the plane display device applied to a video camera.

FIG. 143 is an explanatory drawing of an electronic camera.

### DESCRIPTION OF THE PREFERRED EMBODIMENTS

Referring now to the drawings, a plane display device according to an embodiment of the present invention will be described.

Since there are a number of contents included in the embodiment, a table of contents will be shown first so as to facilitate understanding the contents.

[A. Plane Display Device]

A-1. First Embodiment

(1) Configuration of Plane Display Device

(1-1) Configuration of Array Substrate 11

(1-2) Configuration of Respective Circuits

(2) Configuration of Pixel 16

(2-1) Configuration of Display Pixel 26

(2-2) Configuration of Photosensor Pixel 27

(2-3) Arrangement of Photosensor Pixels 27

(2-4) Area for Forming Photosensor Pixel 27 and Display Area

(3) Configuration and Operation of Equivalent Circuit of Photosensor Pixel 27

(3-1) Description of Equivalent Circuit

(3-2) Timing of Operation

(3-3) First Modification

(3-4) Second Modification

(3-5) Third Modification

(4) Configuration of Peripheral Parts

(4-1) Function of Comparator Circuit 155

(5) Display and Reading Method

(6) Exposure time Tc

(7) Terminal Voltage of Photosensor 35

(8) Image Capturing Operation by a Plurality of Times

(9) Division of Selection Circuit

(9-1) When Divided into Two Selection Circuits

(9-2) When Divided into More than Two Selection Circuits

(10) Selection Function in Source Driver Circuit 14

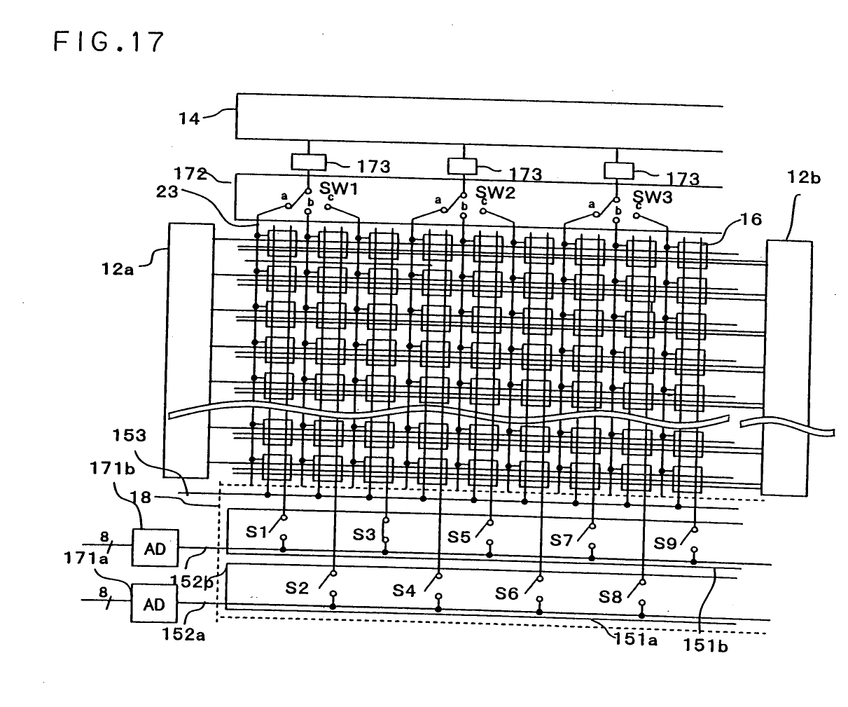

(11) Timing of Operation in FIG. 17

(12) Method of shortening Exposure time Tc

(13) Method of elongating Exposure time Tc

(14) First Modification

(14-1) Operation of First Modification

(14-2) Modification of First Modification

(15) Second Modification

(16) Third Modification

A-2. Second Embodiment

(1) Configuration of Pixel

(2) Modification of Comparator Circuit 155

A-3. Third Embodiment

(1) Relation between Exposure Time Tc and Precharge Signal Vp

(2) Matrix Processing

A-4. Fourth Embodiment

A-5. Fifth Embodiment

A-6. Sixth Embodiment

A-7. Seventh Embodiment

A-8. Modification

(1) First Modification

(2) Second Modification

(3) Third Modification

(4) Fourth Modification

(5) Fifth Modification

(6) Sixth Modification

(7) Seventh Modification

(8) Eighth Modification

(9) Ninth Modification

A-9. Eighth Embodiment

(1) First Modification

(2) Second Modification

(3) Third Modification

A-10. Ninth Embodiment

(1) Configuration of Inverting Circuit 501

(2) Contents of Operation

(3) First Modification

(4) Second Modification

(5) Third Modification

A-11. Tenth Embodiment

(1) First Modification

(2) Second Modification

(3) Third Modification

A-12. Eleventh Embodiment

(1) First Modification

(2) Second Modification

(3) Third Modification

(4) Fourth Modification

(5) Fifth Modification

(6) Sixth Modification

(7) Seventh Modification

(8) Eighth Modification

A-13. Twelfth Embodiment

B. Operative Example of Plane Display Device]

(1) Configuration of Array Substrate 11

(2) Color Filter, Deflection Plate, Phase film

(3) Other configurations

(4) Reading Operation

(5) Light Shielding Operation

(6) Operation by Light Pen

(7) Modification

C. Drive Method of Plane Display Device]

C-1. First Embodiment

(1) ON Output Area and Shadow

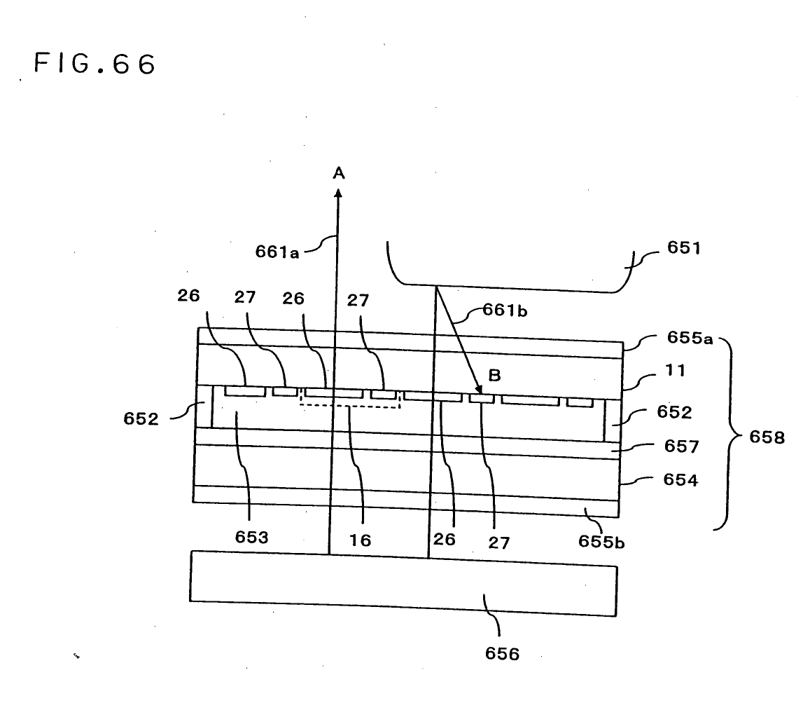

(1-1) ON Output Area and OFF Output Area in FIG. 66

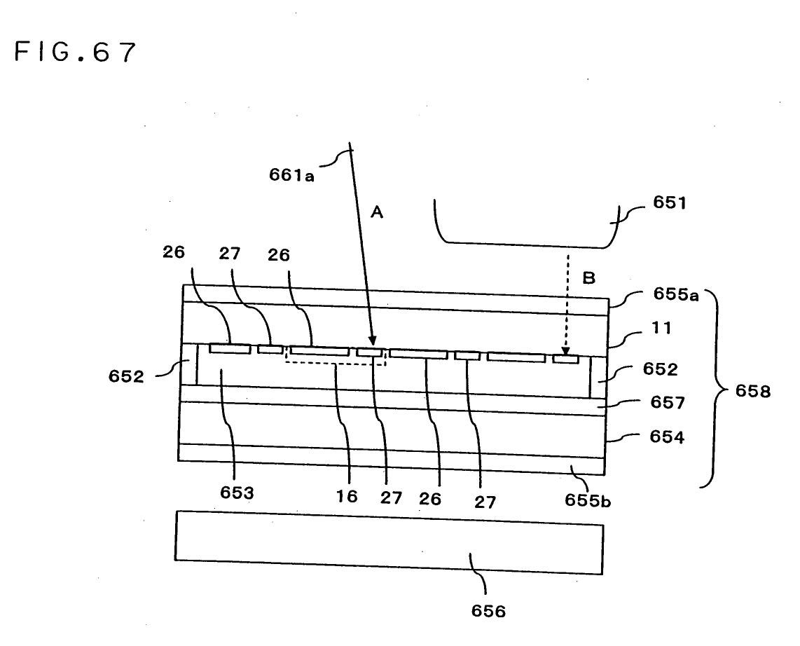

(1-2) ON Output Area and OFF Output Area in FIG. 67

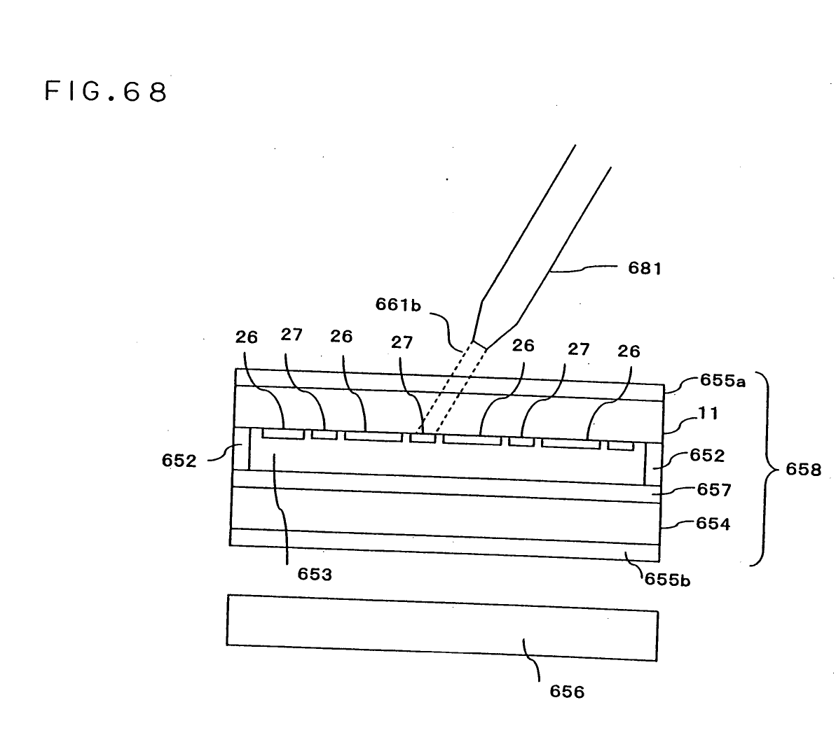

(1-3) ON Output Area and OFF Output Area in FIG. 68

(1-4) ON Output and OFF Output Areas

(1-5) Rate of Number of ON Pixels

(2) Calibration

(3) Data Formation by Comparator Circuit 155

(4) Operation and Processing by Precharge Signal Vp

(4-1) Preservation of Precharge Signal Vp

(4-2) Setting and Optimization of Precharge Signal Vp

(5) Photosensor Processing Circuit

(6) Exposure time Tc

(7) Calibration and Exposure Time Tc

(8) Other Adjustments

C-2. Second Embodiment

(1) Calibration and Precharge Signal Vp

(2) Surface Area of On Output Area

(3) Center Coordinate

(4) Modification

C-3. Third Embodiment

(1) Detection of Position Touched by Finger or the like

(2) Direction of Arrangement of Display Panel

(3) Method using Pressure

D. Method of Detecting Input Coordinate

D-1. First Embodiment

(1) Reference Voltage Position

(2) Rate of Number of ON Pixels

(4) Correction Coefficient

(4) Relation with Exposure Time Tc

(5) Values of m and n

(6) Temperature Correction

(7) Method of Processing Precharge Signal Vp

(8) Configuration of Photosensor

D-2. Second Embodiment

D-3. Third Embodiment

D-4. Fourth Embodiment

D-5. Fifth Embodiment

E. Method of Acquisition of Illuminance of Outside Light

E-1. First Embodiment

(1) Adjustment of Illuminance Correction Coefficient H

(2) Control of Brightness of Backlight

(3) Adjustment of Precharge Signal (Calibration Voltage)

E-2. Second Embodiment

E-3. Third Embodiment

E-4. Fourth Embodiment

(1) Calibration

(2) Hysteresis Operation

(3) Setting of Exposure Time Tc

F. Characteristic Compensation of Photosensor

(1) Characteristic Distribution

(2) Processing Block (BL)

(3) Processing Block (BL) and Section

(4) Application of Precharge Signal Vp

(4-1) Magnitude of Precharge Signal Vp

(4-2) Difference between Precharge Signals Vp

(4-3) Position of Application of Precharge Signal Vp

(5) Drive Method of Liquid Crystal Panel

(6) Variation of Precharge Signal Vp

(7) Basic Precharge Signal Vp

(8) Method of Adjustment

(8-1) Operating State

(8-2) Modification of Adjustment Method

(9) Types of Precharge Signals Vp to be applied to Processing Block

(10) Variations in Precharge Signals Vp

G. Setting of Non-enterable Area

(1) Setting of Precharge Signal Vp

(2) Input Operation

(3) Interlock with Image Display

(4-1) First Modification

(4-2) Second Modification

(4-3) Third E Modification

(4-4) Fourth Modification

(4-5) Fifth Modification

(4-6) Sixth Modification

(4-7) Seventh Modification

(4-8) Eighth Modification

(4-9) Ninth Modification

(5) Approach, Contact and Separation

(6) Variations in Precharge Signal Vp and Exposure Time Tc

(7) Effect of Disturbance

H. Acquisition of Voltage V0

(1) First Modification

(2) Second Modification

(3) Third Modification

I. Contact Detection

(1) Size of Processing Block (BL)

(2) Detection of Shadow Position

(3) Cursor Display

(3-1) Second Modification

(3-2) Third Modification

(4) ON Output Area and Input Detection Photosensor

(5) Specification of Coordinate Position

(5-1) Processing of a Plurality of Coordinate Positions

(5-2) Input direction of the object

(5-3) Direction of Arrangement of Display Screen

(5-4) Input Confirmation

(5-5) Start of Calibration

(6) Variation in Rate of the Number of ON Pixels (%) at Time of Approach, Contact and Separation

(7) Input Determination System

(8) Processing of Approach and Separation Signal

(8-1) First Modification

(8-2) Second Modification

(8-3) Third Modification

(8-4) Fourth Modification

J. Circuit Configuration and Operation

(1) First Embodiment

(2) Second Embodiment

K. Application Example

(1) Cellular Phone

(2) Video Camera

Referring now to the drawings, description will be made in sequence.

### A. Plane Display Device

### A-1. First Embodiment

A plane display device according to a first embodiment will be described.

(1) Configuration of Plane Display Device

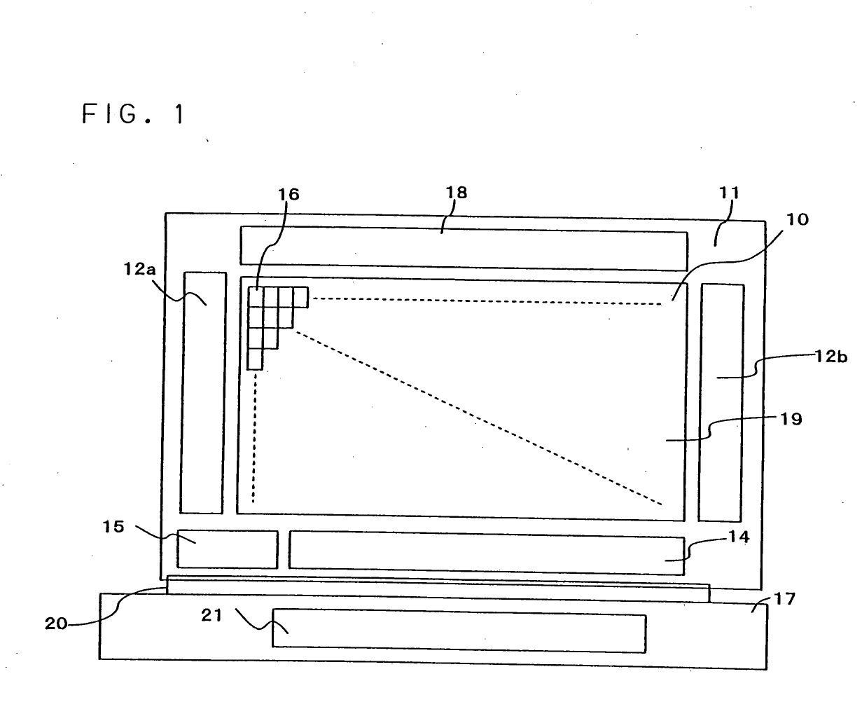

FIG. 1 is a schematic drawing of a plane display device according to the present invention. The present invention is characterized by an image capturing function by photosensor pixels 27 arranged at least in an image display area 10.

The plane display device in FIG. 1 mainly includes a panel unit formed of an array substrate 11 and a circuit board 17.

The plane display device having a coordinate input function is referred to as “input display”.

(1-1) Configuration of Array Substrate 11

Pixels 16 (display pixels 26+photosensor pixels 27) of the present invention have a display resolution of 320 pixels in a horizontal direction×240 pixels in a vertical direction. The pixel is divided into portions of red (R), blue (B) and green (G) in the horizontal direction, and source signal lines 21 are provided respectively. The total number of the source signal lines 21 is 320×3=960, and the total number of gate signal lines 22 for driving the display pixels 26 is 240.

Provided on the array substrate 11 are the source signal lines 23, the gate signal lines 22, the pixels 16 controlled by the signal lines (display pixels 26+photosensor pixels 27), a source driver circuit 14 formed of an IC for driving the source signal lines 23, a gate driver circuit 12 formed of the IC for driving the gate signal lines 22, and a photosensor processing circuit 18 for capturing and outputting images. These circuits are composed of transistors formed, for example, by low-temperature polysilicon technology.

Formation of the transistor is not limited to the low-temperature polysilicon technology, and may be formed by high-temperature polysilicon technology in which a process temperature is 450° C. or higher. It is also possible to form the transistor using a semiconductor film obtained by solid phase (CGS) epitaxy. The transistor may be formed by amorphous silicon technology. The pixels 16 are formed in a matrix manner.

The display pixels 26 of the pixels 16 are not limited to a liquid crystal device, and may be composes of a self-luminous device composed of an EL device or the like.

(1-2) Configuration of the Respective Circuits

The source driver circuit 14 includes a D/A converting circuit that converts input digital pixel data to an analogue voltage that is suitable for driving the display device. The source driver circuit 14 may be the one which performs digital output that executes a PWM modulation. In this case, since it is configured to apply the digital data pulses on the source signal lines 23, the D/A converting circuit is not necessary.

When the display unit 10 is composed of the EL device, the source driver circuit 14 may be the one which outputs picture signal which is a current output. In the case of the EL device, preferably, a configuration in which the source driver circuit 14 formed by a chip such as silicon mounted on the array substrate 11 through a COG (Glass On Chip) technology is employed. It is because, that a memory function or the like can be integrated in the IC, and hence miniaturization is achieved.

On the circuit substrate 17, a control IC (not shown) for controlling the respective circuits on the array substrate 11, a memory (not shown) for storing image data or the like, and a power circuit (not shown) for outputting various types of direct-current voltages used by the array substrate 11 and the circuit board 17 may be provided. It is also possible to provide a CPU, an MPU separately from the control IC (not shown), to integrate the memory or the power circuit with a picture signal processing circuit formed of the IC, or to mount discrete parts on the circuit board 17 and the array substrate 11.

The device or the IC to be mounted on the circuit board 17 may be manufactured, for example, by the polysilicon technology. It may be formed directly on the array substrate 11. Matters described above may be applied to the source driver circuit 14 and the signal processing circuit 18, as a matter of course.

A gate driver circuit 12a is preferably formed on the array substrate 11 by the low-temperature polysilicon technology, because narrowing of a frame can be achieved. Cost reduction is also achieved. The gate driver circuit 12a selects a gate signal line 22a in sequence, and writes picture data on the display pixel 26 synchronously with the source driver circuit 14.

The gate driver circuit 12a selects a gate signal line 22b and a gate signal line 22c in sequence, and applies a writing signal (precharge signal Vp or a precharge current) to the photosensor pixel 27 synchronously with the source driver circuit 14. It also takes out an output voltage (sensor voltage) from the photosensor pixel 27.

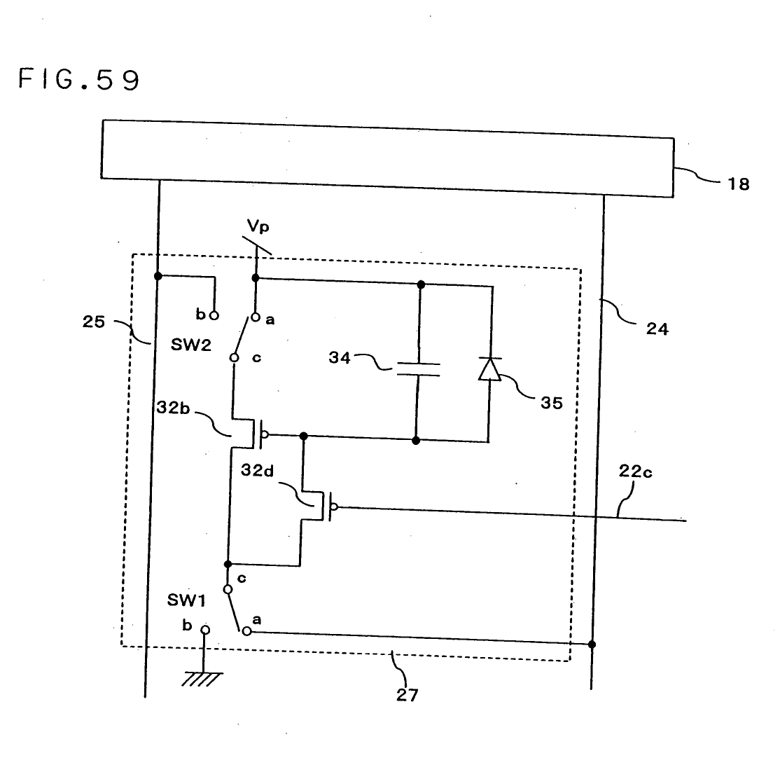

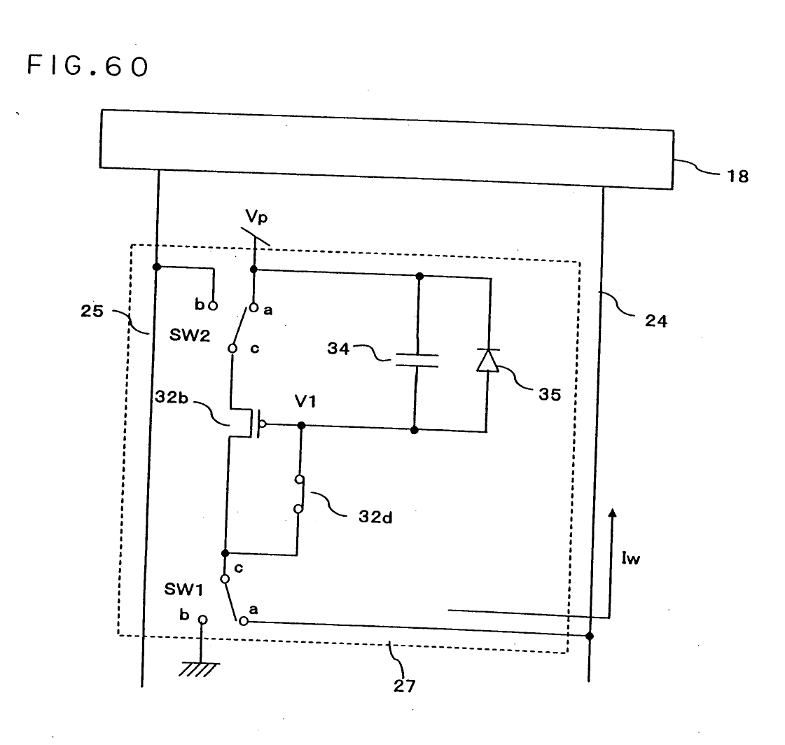

There are two types of the precharge signals Vp; voltage and current. In this specification, the precharge signal Vp is described as a voltage. However, as shown in FIG. 59 and FIG. 60, the precharge signal Vp is described as a current.

Although description will be given as “read an operating state of a transistor 32b” in the present invention, the present invention is not limited thereto. For example, in a configuration in which one terminal of a photosensor 35 is connected to a drain terminal of a transistor 32c, even when the transistor 32b does not exist, a terminal voltage of the photosensor 35 can be read by closing the transistor 32c. In other words, any configuration may be employed in the present invention as long as it can detect a state of variation in a terminal voltage or an electric charge of the device which is varied by a light beam. There is a case in which the plurality of photosensors 35 are formed on the single photosensor pixel 27.

When a light beam is irradiated on the photosensor pixel 27, the photosensor 35 leaks and hence the output state varies. Alternatively, when the photosensor pixel 27 is brought in a shadow, it remains a predetermined state without leak.

The precharge signal is applied to the photosensor pixel 27 synchronously with a rewriting cycle of the image display. The operating state of the photosensor pixel 27 is read out synchronously with the rewriting cycle of the image display. However, the rewriting of the image display is performed for each frame, and a cycle of applying the precharge signal to the photosensor pixel 27, or a cycle of reading the operating state of the photosensor pixel 27 may be performed by a cycle of two frames. It may not be executed by the cycle of frames, but may be executed by a unit of horizontal scanning period. Even when it is executed by the unit of horizontal scanning period, it is executed synchronously with the rewriting of the image display. However, timing of selecting a pixel row and rewriting the display of the respective pixel rows and timing of applying the precharge signal to the photosensor pixel 27 are not limited to be simultaneous. It may be executed by setting a predetermined delay time.

The precharge signal is applied to the photosensor pixel 27, and maintains the photosensor 35 at a predetermined state. An impedance of the photosensor 35 varies by being irradiated by a light beam, and a varied state is maintained. The photosensor 35 leaks a current or an electric charge mainly by being irradiated by a light beam, and the terminal voltage of the photosensor 35 varies.

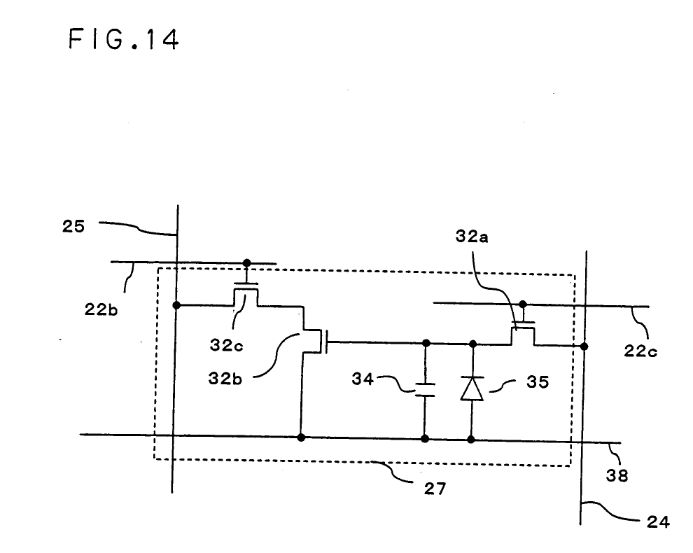

The photosensor pixel 27 preserves the precharge signal by being shielded from a light beam or a speed of leaking the current or the electric charge is lowered. Alternatively, lowering of the potential of the voltage applied to the photosensor 35 is lowered. When the photosensor pixel 27 is not shielded from a light beam and the light beam is irradiated on the photosensor 35, the leak speed of the current or the electric charge is increased. When the current or the electric charge leaks and hence the terminal voltage of the photosensor 35 is lowered more than a predetermined extent, the transistor 32b of the photosensor pixel 27 in FIG. 14 is turned off.

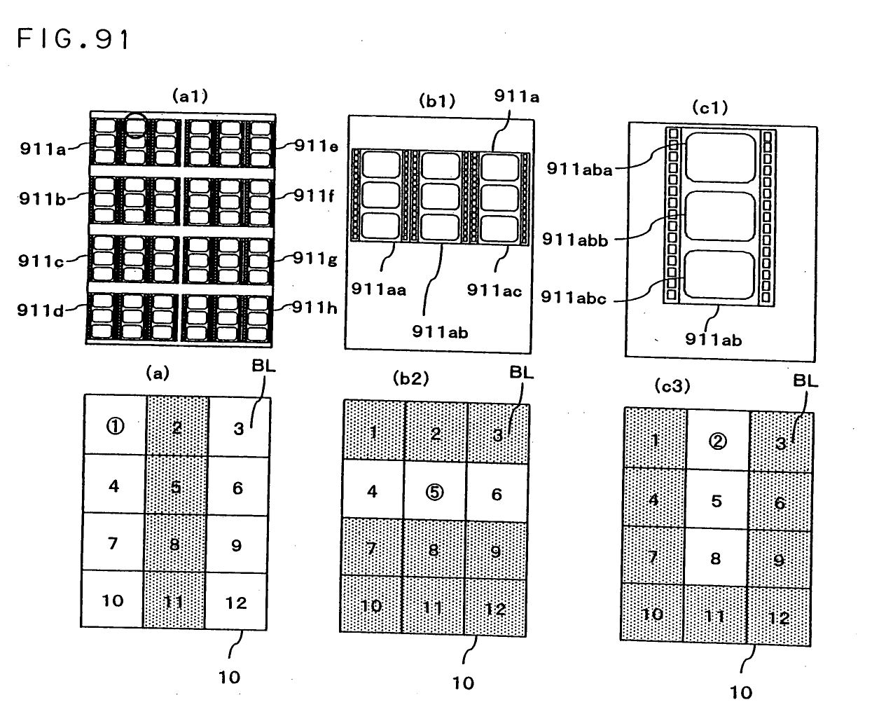

Every time when the precharge signal is applied, the photosensor pixel 27 is set to an initial state or to a predetermined state, and when a light beam is irradiated on the photosensor pixel 27, the operating state of the photosensor pixel 27 varies. When the light beam is not irradiated on the photosensor pixel 27, the initial state or the state close to the predetermined state is maintained. In other words, the precharge signal is a signal that provides energy required for the operation of the photosensor pixel 27, and a signal that sets the photosensor pixel 27 to a predetermined threshold. The predetermined threshold is a value at which the operation of the photosensor pixel 27 can be varied by being irradiated by a light beam. For example, if the value of the precharge signal is a voltage at which the transistor 32b in FIG. 14 is brought into an OFF-state, the transistor 32b is in the OFF-state from the beginning. Even though a light beam is applied to the photosensor 35, the transistor 32b stays in the OFF-state and does not change. In this state, the precharge signal does not exceed the predetermined threshold, and is not adequate as the precharge signal other than a case of being applied to an embodiment shown, for example, in FIG. 91. In other words, the precharge signal applied to the photosensor pixel 27 is of a value at which the operating state of the photosensor pixel 27 changes when a light beam of a predetermined intensity is irradiated on the photosensor pixel 27 during a predetermined period.

When the precharge signal is applied to the photosensor pixel 27 and a light beam is irradiated, the precharge signal preserved in the photosensor 35 varies. The precharge signal is applied to the photosensor 35 in the present invention at a predetermined cycle. The light beam is constantly irradiated on the photosensor pixel 27. The precharge signal sets the photosensor pixel 27 to the predetermined state at the predetermined cycle. It may also be considered to be a signal for resetting the photosensor pixel 27 to the predetermined state. For example, in the embodiment shown in FIG. 14, even when a light beam is irradiated on the photosensor 35 and hence the transistor 32b is turned into the OFF-state, the transistor 32b is set to the ON-state when the precharge signal is applied.

In this specification, the term “precharge signal” may represent either the precharge voltage Vp or the precharge current. In order to simplify the description, it is mainly described as the voltage in examples, that is, as the precharge signal Vp. It may be considered that the precharge voltage Vp is retained by the photosensor 35 by the precharge current. The precharge current being retained by the photosensor pixel 27 is also within the technical scope of the present invention as a matter of course.

The precharge signal may be understood as a signal for turning the photosensor pixel 27 into the ON-state or to the OFF-state. Alternatively, the precharge signal may be understood as a signal that varies the operating state of the photosensor pixel 27.

The state in which the photosensor pixel 27 is in the ON-state represents a state in which the precharge signal is preserved at a higher level than the predetermined threshold, and the OFF-state represents a state in which the precharge signal is lower than the predetermined threshold. However, this example shows a case in which the transistor 32b is an N-channel transistor as shown in FIG. 14. When the transistor 32b is a P-channel transistor, or when it has a different configuration, the relation between ON and OFF states is inverted, or the operation may be adapted to be the inverted relation. This case is also included in the technical scope of this invention.

The precharge signal Vp to be applied to the photosensor pixel 27 is outputted from the photosensor processing circuit 18 composed of the IC. The precharge signal Vp is applied to a precharge signal line 24. The output voltage from the photosensor pixel 27 is outputted to a photosensor output signal line 25 and taken into the photosensor processing circuit 18.

In the description, the voltage is outputted to the photosensor output signal line 25. However, the invention is not limited thereto, and a mode in which a current or an electric charge is outputted or supplied to the photosensor output signal line 25 may also be applicable as a matter of course.

The invention is not limited to the mode in which the operating state of the photosensor 35 is detected by input or output of the current or the voltage into/from the photosensor output signal line 25, and a mode in which the operating state of the photosensor 35 is detected by detecting a direction of flow of the current or the voltage into/from the photosensor output signal line 25 is also applicable.

In the description in this specification, the operating state of the photosensor pixel 27 is detected. However, the fact that the operating state of the photosensor 35 or the photosensor pixel 27 is changed, or is maintained in the predetermined state must simply be determined in the present invention. Therefore, the term “detect” includes a wide range of signification such as “recognize” the operating state of the photosensor pixel 27. Alternatively, it means to store the operating state of the photosensor pixel 27 and compare with the operating state of the previous time. In addition to the detection of the ON-state and the OFF-state of the photosensor pixel 27, it is also possible to detect variations in the ON-state or variations in the OFF-state. For example, when the threshold at the time when the photosensor pixel 27 is in the ON-state is 2.0 V, processing, detection, or measurement in distinction may be made among an ON-state in which a voltage or a voltage level obtained when reading from the photosensor pixel 27 is 2.5 V, an ON-state in which the voltage or the voltage level is 2.8 V, and an OFF-state in which the voltage or the voltage level is 1.8 V.

A photosensor signal processing circuit 15 controls a gate driver circuit 12b and the photosensor processing circuit 18, and executes calculation or comparative processing of output data from the photosensor processing circuit 18. The photosensor signal processing circuit 15 determines the position of the photosensor 35 on which a light beam is irradiated or which is shielded from the light beam and outputs coordinate positions thereof. The photosensor signal processing circuit also controls an external microcomputer (not shown) and output and input of control data.

The photosensor signal processing circuit 15 preferably employs a configuration of a chip formed of silicon or the like mounted on the array substrate 11 by the COG (Chip On Glass) technology. It is because a memory function can be integrated in the IC 15 to realize compact configuration of an information display device in the present invention.

A picture signal processing circuit (IC) 21 that controls display and image capturing is mounted on the circuit board 17. The array substrate 11 and the circuit board 17 transmit various signals, for example, via a flexible printed circuit (FPC) 20. An output picture signal from the picture signal processing circuit 21 is applied to the source driver circuit 14.

The photosensor signal processing circuit 15 may include a counter for taking picked up data from the photosensor 35 and detecting an average gradation integrated therein as a component of the circuit. The term “average gradation” represents a gradation obtained 0 by averaging the gradations in the output data over the plurality of pixels 16. When an image of 256 gradation is targeted, in a case of data in which 5 pixels out of 10 pixels are white and the remaining 5 pixels are black, the average gradation is 256 (gradations)×5 (pixels)/10 (pixels)=128 (gradations).

(2) Configuration of Pixel 16

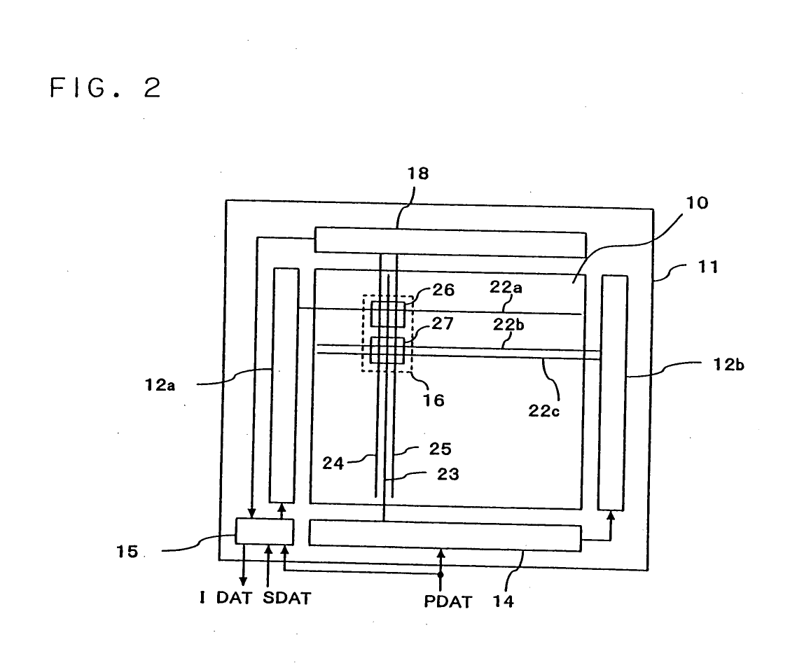

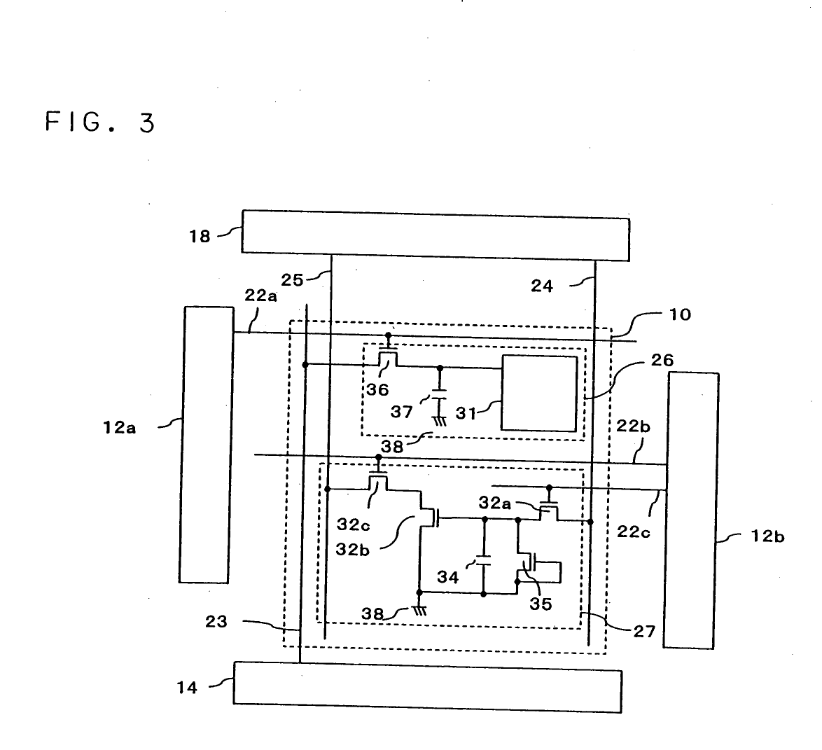

FIG. 2 and FIG. 3 are block diagrams of the plane display device according to the embodiment showing mainly the pixel 16 (display pixel 26+photosensor pixel 27) in detail. Although there is only the single pixel 16 shown in the drawing, the plurality of pixels are formed in a matrix manner as shown in FIG. 1. For facilitating description, other components are also omitted. The pixel 16 in FIG. 2 is composed of the display pixel 26 and the photosensor pixel 27.

(2-1) Configuration of Display Pixel 26

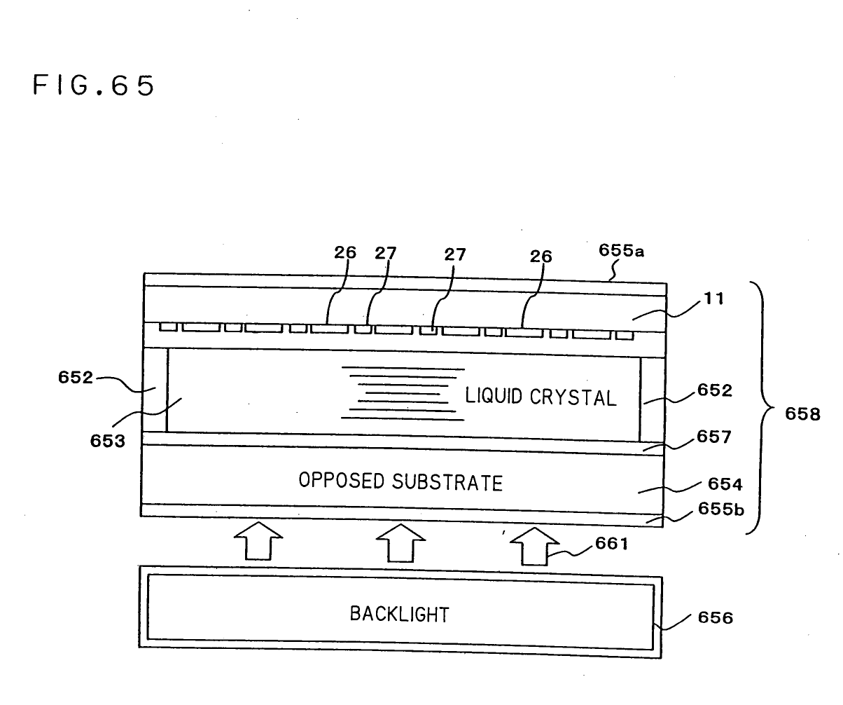

The display Pixels 26 are formed at, or in the vicinities of, respective intersections between the source signal lines 23 and the gate signal lines 22a which are laid vertically and horizontally. The display pixel 26 includes a thin film transistor, an FET or a bipolar transistor (hereinafter referred to as “transistor”) 36, a liquid crystal layer 653 formed between a pixel electrode 31 formed at an end of the transistor 36 and an opposed electrode 654, and an auxiliary capacitance 37 formed between and a common signal line 38 (FIG. 3, FIG. 65).

(2-2) Configuration of Photosensor Pixel 27

The photosensor pixel 27 includes, as shown in FIG. 3, the transistor 35 that is operated as a photodiode, an auxiliary capacitance (capacitor) 34 for preserving the precharge signal Vp, the transistor 32b that is operated as a source follower, a transistor 32a that is operated as a switching element that applies the precharge signal Vp to the auxiliary capacitance 34, and the transistor 32c that selects an output from the source follower as the transistor 32b and outputs the same to the photosensor output signal line 25.

The one terminal of the photosensor device 35 is connected to the common signal line 38. A potential of the common signal line 38 is preferably maintained at a fixed value such as a ground potential. The common signal line 38 that constitutes the one terminal of the auxiliary capacitance 37 and the common signal line 38 that constitutes the one terminal of the photosensor device (photodiode) 35 may be separated, so that either the same potential or the different potential can be applied.

(2-3) Arrangement of Photosensor Pixels 27

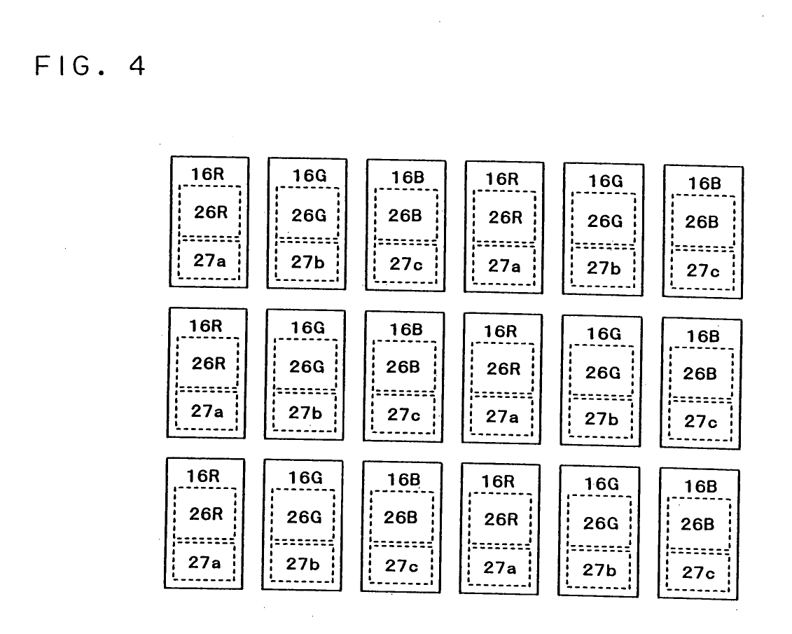

As an example, in FIG. 4, the photosensors 27 are formed in the respective pixels 16. In other words, the number of display pixels 26 and the number of the photosensor pixels 27 are the same.

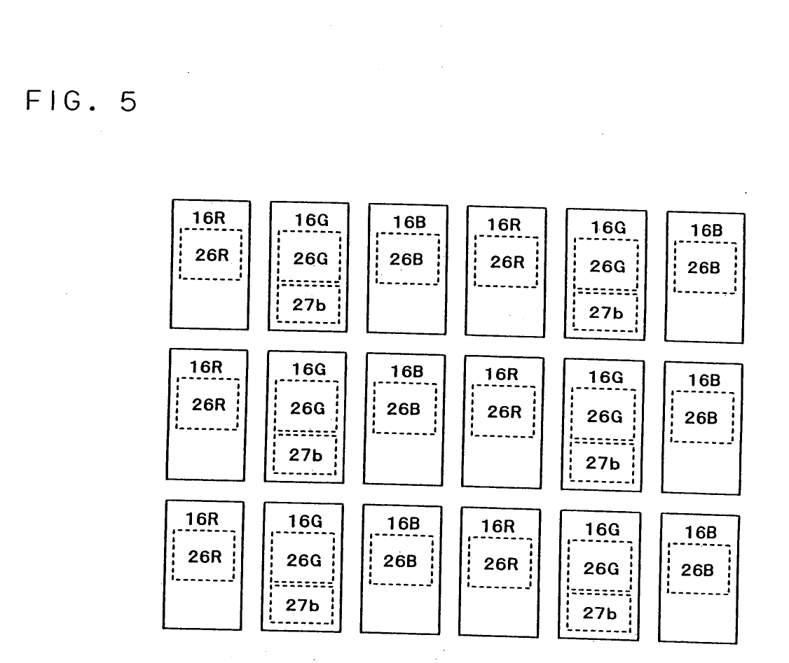

The photosensor pixels 27b may be disposed on one of the RGB pixels 16 (26R, 26G, 26B) as shown in FIG. 5.

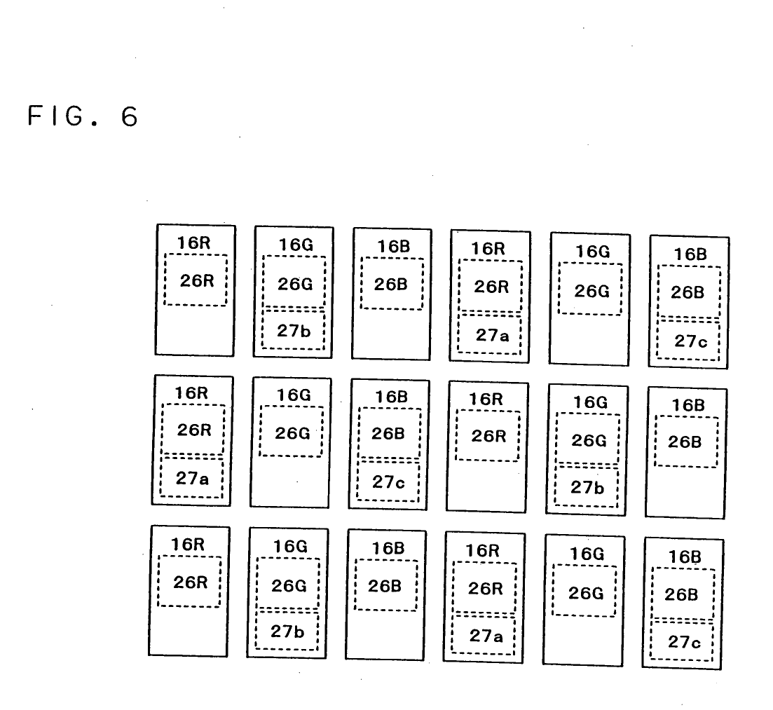

As shown in FIG. 6, one photosensor pixel (27a, 27b, 27c) is arranged or formed in every two pixels. Preferably, as shown in FIG. 6, the photosensor pixels 27 are arranged in pixel rows of even numbers and pixel columns of odd numbers, and the photosensor pixels 27 are arranged in pixel rows of odd numbers and pixels columns of even numbers.

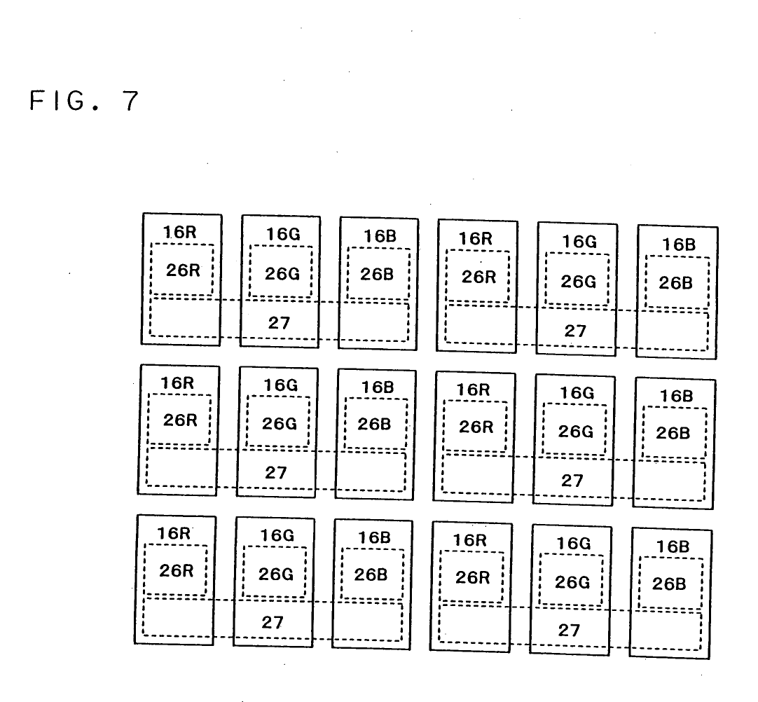

As shown in FIG. 7, one photosensor pixel 27 is arranged or formed for each set of the RGB pixels. An area surface of the photosensor pixel 27 can be increased and the sensitivity is increased. Therefore, even though the illuminance is low, an input object can be detected.

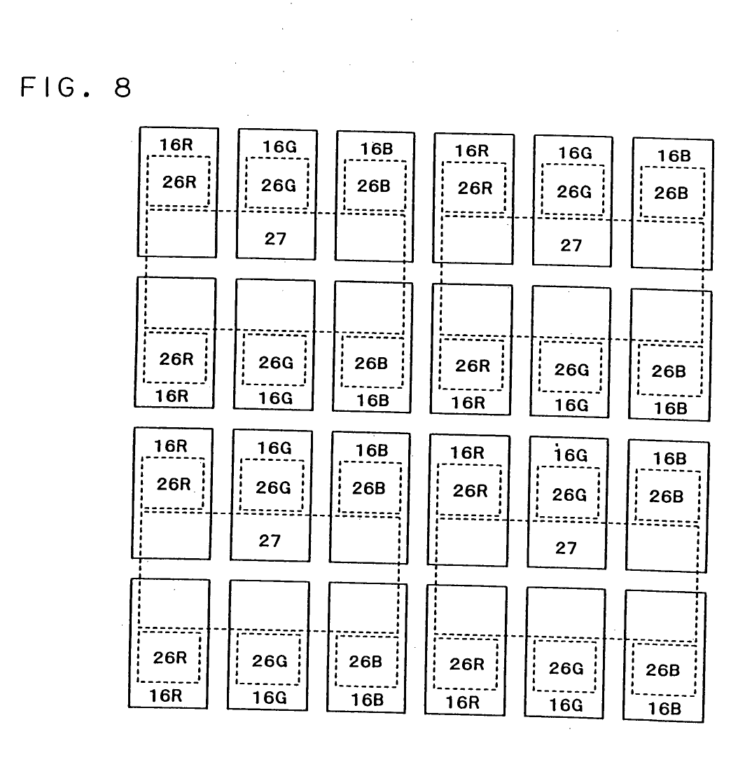

As shown in FIG. 8, a configuration in which the one photosensor pixel 27 is arranged or formed of six pixels (26R×2, 26G×2, 26B×2). In FIG. 8, the photosensor pixels 27 are formed every two pixel rows. By configuring as shown in FIG. 8, a larger surface area of the photosensor pixel 27 than those in FIG. 7 can be secured, and the sensitivity is increased.

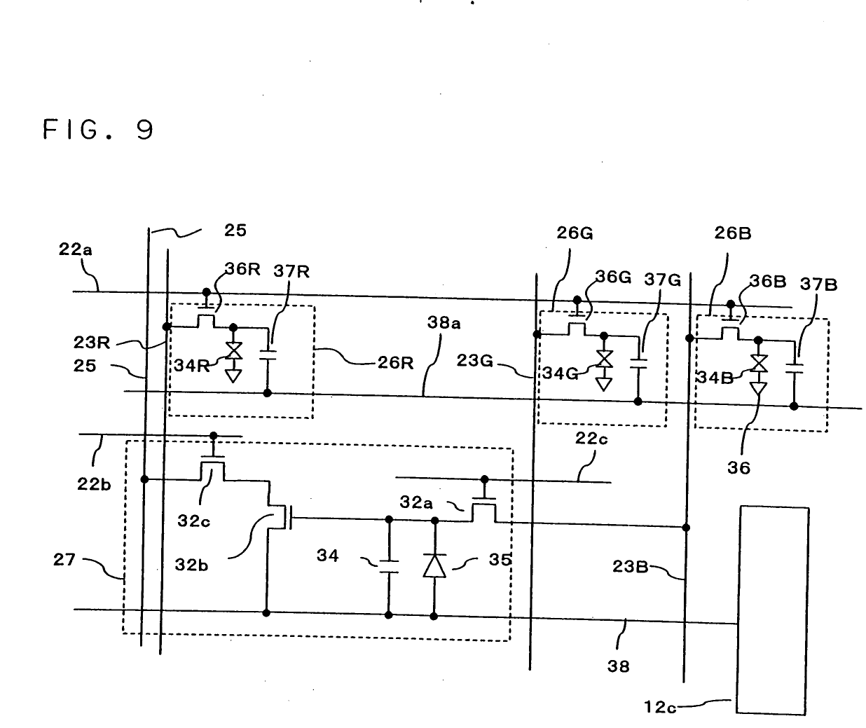

As described above, the photosensor pixel 27 is not limited to a mode of being formed for every display pixels 26. As shown in FIG. 9, one pixel 16 is composed of three RGB subpixels 26R, 26G and 26B. Each subpixel 27 includes the transistor 36, the transistor 32a that controls whether or not the electric charge is accumulated to the capacitor 34, the image capturing photosensor (light detection photosensor) 35, the capacitor 34 for preserving the precharge signal Vp, the transistor 32b for outputting binary data according to the accumulated electric charge in the capacitor 34, and the transistor 32c that outputs the data held in the transistor 32b.

Although the photosensor 35 shown as an example has a configuration in which the transistor is connected to the diode, the invention is not limited thereto, and any photosensor may be used as long as a value of resistance is varies by being irradiated by a light beam. For example, a photodiode is exemplified. Most of other semiconductor substances have a property such that physical characteristics or the behaviors as an optical sensor vary, and hence may be used for the plane display device in the present invention.

The pixel 16 may be formed with a SRAM (Rewritable Memory). The brightness or the light transmittance of each pixel 16 is controlled by a difference between a pixel electrode potential determined by the electric charge accumulated in the auxiliary capacitance 34 and the potential of the common electrode formed on the opposed substrate 36.

A configuration in which the pixels 16 are formed with the photosensor pixels 27 on pixel rows in odd numbers or pixel columns in odd numbers and not on pixel rows in even numbers or pixel columns in even numbers may be applicable. Alternatively, a configuration in which the pixels 16 are formed with the photosensor pixels 27 on pixel rows in even numbers or pixel columns in even numbers and not on pixel rows in odd numbers or pixel columns in odd numbers may be applicable.

The photosensor pixels 27 may be formed every three pixel rows or three pixel columns, or every four or more pixels. The photosensor pixels 27 may be formed at random in the display area 10. The photosensor pixels 27 may be formed at regular intervals. The photosensor pixel 27 may be formed in a matrix manner such as 3×3 pixels.

The position of the photosensor pixel 27 is not limited to within the display area 10, and may be formed on outside of the display area 10. A configuration in which the photosensor pixels 27 are formed in the periphery of the display area 10 is exemplified. The number of photosensor pixels 27 formed in the pixel 16 is not limited to one, and the plurality of photosensor pixels 26 are formed in the single pixel 16.

Preferably, a light-shielding film is formed on the photosensor 35 of the photosensor pixel 27. When configuring in such a manner that the photosensor 35 senses the outside light and does not sense a light beam from the backlight, the light-shielding film is formed or arranged between the photosensor 35 and the backlight.

(2-4) Area for Forming Photosensor Pixel 27 and Display Area

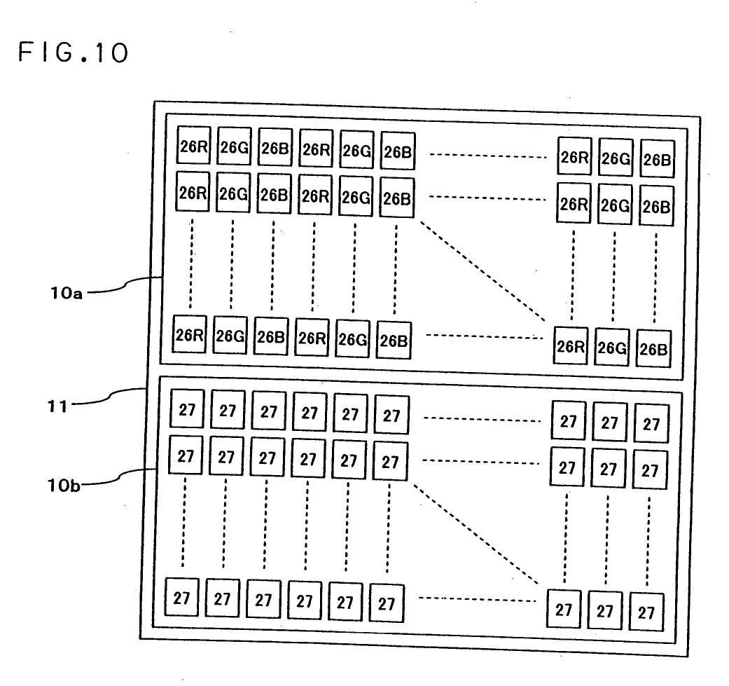

In the above described embodiment, the photosensor pixels 27 and the display pixels 26 are formed on the display area 10. However, the present invention is not limited thereto. For example, as shown in FIG. 10, a configuration in which the display pixels 26 are formed on a half or a predetermined area 10a of the array substrate 11 in a matrix manner, and the photosensor pixels 27 are formed in a matrix manner in other area as information input area is also applicable.

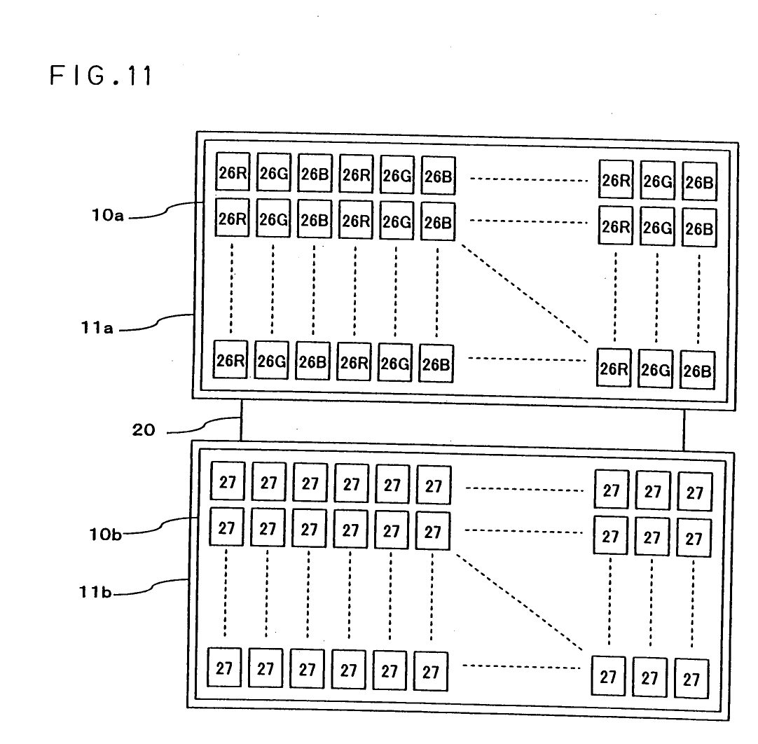

As shown in FIG. 11, a configuration in which the display pixels 26 are formed on an array substrate 11a in a matrix manner, and the photosensor pixels 27 are formed on an array substrate 11b in a matrix manner. The array substrate 11a and the array substrate 11b are connected by the flexible substrate 20, and signals are transmitted between the array substrate 11a and the array substrate 11b via the flexible substrate 20.

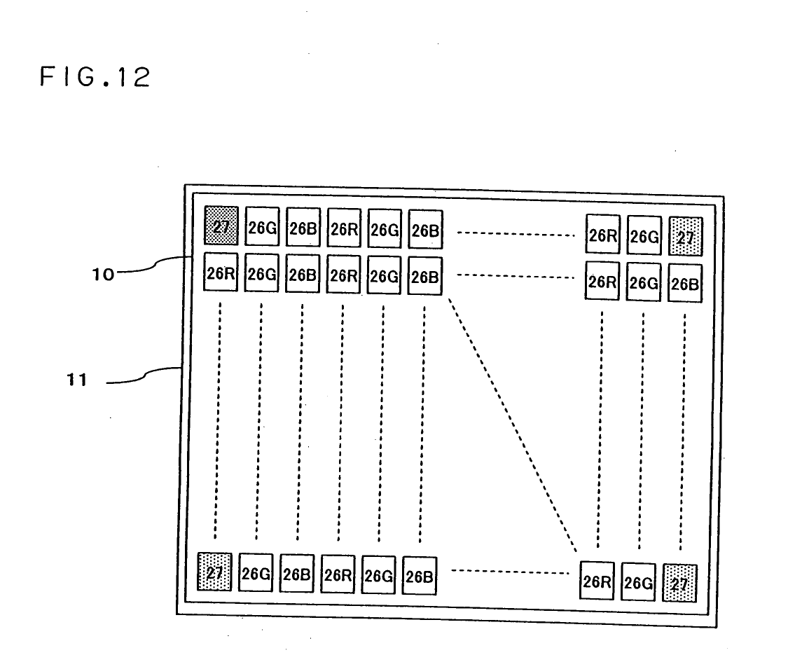

As shown in FIG. 12, the display pixels 26 are formed on the array substrate 11 in a matrix manner and the photosensor pixels 27 are formed in the periphery of the display area 10 or at four corners thereof.

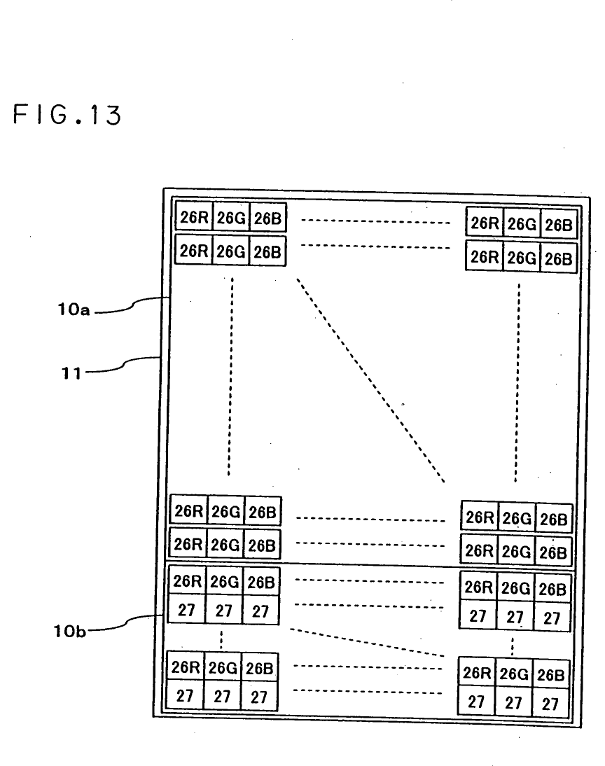

As shown in FIG. 13, it is also possible to form the display pixels 26 on the display area 10a in a matrix manner and form the photosensor pixels 27 and the display pixels 26 on the display area 10b in a matrix manner in the single array substrate 11.

(3) Configuration and Operation of Equivalent Circuit of Photosensor Pixel 27

The pixel 16 is composed of the display pixel 26 and the photosensor pixel 27 as shown in FIG. 3. A picture signal is applied to the display pixel 26 by the source driver circuit 14. The timing of application of the picture signal is controlled by the gate driver circuit 12a.

(3-1) Description of Equivalent Circuit

An equivalent circuit drawing of the photosensor pixel 27 is shown in FIG. 14. As shown in FIG. 3, the photosensor pixel 27 includes the transistor (photosensor) 35 that operates as the photodiode. In the present invention, the photosensor 35 is formed by connecting the N-channel transistor with the diode. By connecting the N-channel transistor with the diode, the configuration is simplified and the electric charge retaining characteristics is also improved.

The present invention is not limited to the configuration described above. For example, the photosensor 35 may be composed of the P-channel transistor. It may also be formed of a thin film diode (TFD).

Although the transistor that constitutes the photosensor pixel 27 is also composed of the N-channel transistor, the invention is not limited thereto. It may be composed of the P-channel transistor. The transistors 32 are directly formed on the array substrate 11. However, the configuration of the transistor 32 is not limited thereto, and the transistor 32 may be formed on the array substrate 11 by transferring the display pixel 26 or the photosensor pixel 27 by a transfer technology or the like, as a matter of course.

When a light beam is irradiated on the photosensor 35, leak from the photosensor 35 occurs according to the intensity of the light beam and the duration of irradiation of the light beam. The leak causes the potential between the both terminals of the photosensor 35 to be lowered (the electric charge held by the capacitor 34 is discharged). Therefore, by measuring and detecting the potential between both terminals of the photosensor 35, the fact that the light beam is irradiated on the photosensor or the relative intensity of the light beam irradiated on the photosensor can be figured out.

The auxiliary capacitance (capacitor) 34 that preserves the precharge signal Vp is composed of a gate insulating film. By utilizing the gate insulating film, the auxiliary capacitance having a small surface area and a large capacity can be achieved.

The one terminal of the photosensor 35 is connected to a gate terminal of the transistor 32b that operates as the source follower, and one terminal of the auxiliary capacitance 34 is also connected thereto. When the voltage of the gate terminal of the transistor 32b is reduced to a certain value or below (Vt voltage), the transistor 32b is turned to the OFF-state. When it is higher than the Vt voltage, the transistor 32c is turned to the ON-state. Although the Vt voltage corresponds to the predetermined threshold, the predetermined threshold is different depending on the characteristic of the transistor 32b or the photosensor 35. Therefore, the threshold is different from the photosensor pixel 27 to the photosensor pixel 27. In order to facilitate the processing, the common predetermined threshold can be used for a plurality of divisions and the plurality of photosensor pixels 27.

In this specification, description is made such that the photosensor pixel 27 is turned to the ON-state at a voltage higher than the Vt voltage and the photosensor pixel 27 is turned to the OFF-state at a voltage lower than the Vt voltage. This is for facilitating understanding. In fact, the Vt voltage varies due to disturbance of light such as the backlight, the timing of measurement, or parasitic capacitance such as the transistor which constitutes the pixel. Therefore, the Vt voltage is increased or decreased by a predetermined margin. Alternatively, a voltage obtained by processing the Vt voltage is used as the predetermined threshold.

The transistor 32a applies the precharge signal Vp applied to the precharge signal line 24 to the one terminal of the photosensor 35. When the On-voltage is applied to the gate signal line 22c, the transistor 32a is turned ON. The precharge signal Vp is a voltage (higher than the Vt voltage) that turns the transistor 32b ON a predetermined margin. When a light beam is irradiated on the photosensor 35, the electric charge retained by the capacitor 34 is discharged through between channels of the photosensor 35. Preferably, the precharge signal Vp is applied for each field or each frame (the rewriting cycle for one screen). It is also applicable to apply once to a plurality of fields or frame (the rewriting cycle for a plurality of screens).

The precharge signal Vp is applied to the gate terminal of the transistor 32b of the photosensor pixel 27 by the transistor 32a. The transistor 32c is controlled by the gate driver circuit 12b. The gate terminal of the transistor 32c is connected to the gate signal line 22b. When the ON-voltage is applied to the gate signal line 22b, the transistor 32c is turned ON. When the transistor 32b is in the ON-state, the electric charge of the photosensor output signal line 25 is discharged to the common signal line 38 via the transistors 32c, 32b (it may be charged depending on the potential of the common signal line 38).

The potential of the photosensor output signal line 25 varies according to the variations in electric discharge of the photosensor output signal line 25. Even when the transistor 32c is turned ON, if the transistor 32b is turned OFF, the electric charge of the photosensor output signal line 25 does not vary.

As described above, by detecting variation in electric charge of the photosensor output signal line 25, whether the transistor 32b is in the ON-state, an intermediate ON-state or the OFF-state can be detected. In other words, this detection detects the potential of the gate terminal of the transistor 32b. The gate terminal voltage of the transistor 32b varies with the magnitude of the precharge signal Vp and the intensity and the duration of irradiation (exposure time Tc) of a light beam irradiated on the photosensor 35.

(3-2) Timing of Operation

The cycle or the timing to turn the transistor 32c ON is executed for each field or for each frame (rewriting cycle of one screen). Alternatively, it is executed for each frame period or by a unit of horizontal scanning period. For example, the transistor 32c is turned ON for two frame periods by a cycle of 10 horizontal scanning periods to read the operating state of the photosensor 35 and the transistor 32a is turned ON to apply the precharge signal Vp to the photosensor 35.

The image display is executed synchronously with the cycle and the timing of application of the precharge signal Vp. The timing to turn the transistor 32c ON (selection timing) may be a cycle of a plurality of fields or of a plurality of frames (rewriting cycle for a plurality of screens).

A dynamic intensity of the light beam irradiated on the photosensor 35 can be detected from the magnitude of the precharge signal Vp and the exposure time Tc (a time period from the moment when the transistor 32a is turned in the ON-state and the precharge signal Vp is applied to the gate terminal of the transistor 32b to the moment when the transistor 32c is turned in the ON-state and the operating state of the transistor 32b or the operating state of the photosensor 35 is taken out to the photosensor output signal line 25), and the amount of light leak (sensitivity) of the photosensor 35.

The dynamic intensity of a light beam is none other than an operation to read the image like an image scanner. In the present invention, the photosensor pixels 27 are formed in a matrix manner. Therefore, by detecting (measuring) the ON and OFF states of the transistors 32b of the respective photosensor pixels 27, the image formed or illuminated on the display area 10 can be captured. The shadow of the substance and the light beam and reflected by the substance can be taken into the panel.

Hereinafter, the transistor 32b whose operation varies with the terminal voltage of the photosensor 35 is referred to as “detection transistor 32b”. The transistor 32c and the transistor 32a that perform a switching operation are referred to as “switch transistors 32a, 32c.

(3-3) First Modification

The common signal line 38 which constitutes a terminal of the auxiliary capacitance 34 and the common signal line 38 that constitutes the one terminal of the photosensor device (photodiode) 35 in FIG. 14 are separated so that either the same potential or the different potential can be applied.

(3-4) Second Modification

It is preferably to configure so that the voltage to be applied to the common signal line 38 can be varied. It is because the timing at which the voltage retained by the photosensor 35 reaches a voltage lower than the Vt voltage of the transistor 32b can be adjusted or varied by the voltage applied to the common signal line 38. It is also because the timing at which the voltage retained by the photosensor 35 reaches a voltage lower than the Vt voltage of the transistor 32b can be adjusted or varied by adjusting or setting the same within a certain voltage range in the vicinity of the Vt voltage.

The term “Vt voltage” represents a voltage that switches the transistor 32b to the ON-state or a state similar to the ON-state by applying a voltage of a value higher than this voltage to the gate terminal of the transistor 32b, thereby changing the same to a state in which the impedance between channels of the transistor 32b is lowered or a current is flowed or is apt to flow to the transistor 32b.

By applying a voltage of a value lower than the Vt voltage to the gate terminal of the transistor 32b, the transistor 32b is changed to the OFF-state or a state similar to the OFF-state, whereby the impedance between the channels of the transistor 32b is increased. Alternatively, the state is changed to a state in which a current does not flow to or can hardly flow to the transistor 32b. The description given above is applied to a case in which the transistor 32b is of the N-channel. When the transistor 32b is of the P-channel, the operation is inverted.

The transistor 32 may be of any of the N-channel and the P-channel. The transistor 32b may be adapted either to convert the applied Vt voltage into a current or to amplify the applied Vt voltage or convert the same to a certain voltage. For example, it is adapted to perform a current mirror operation or an offset cancelling operation. These modifications are included in the scope of the present invention.

(3-5) Third Modification

The transistor 32c, the transistor 32b, and the transistor 32a are not limited to the transistor, and may be formed of a TFD. The Vt voltage in the case of the TFD designates a voltage that changes the state into the operating state of the TFD by a voltage applied to one terminal of the TFD (the ON-state or the state similar to the ON-state, the OFF-state or the state similar to the OFF-state).

The transistor 32 is not limited to the thin film transistor, but may be an FET, the bipolar transistor or the CMOS transistor. It is also applicable to form the pixel 16 by mixing the bipolar transistor and the CMOS transistor. It is also applicable to form the pixel 16 by mixing the P-channel and the N-channel transistors.

(4) Configuration of Peripheral Parts

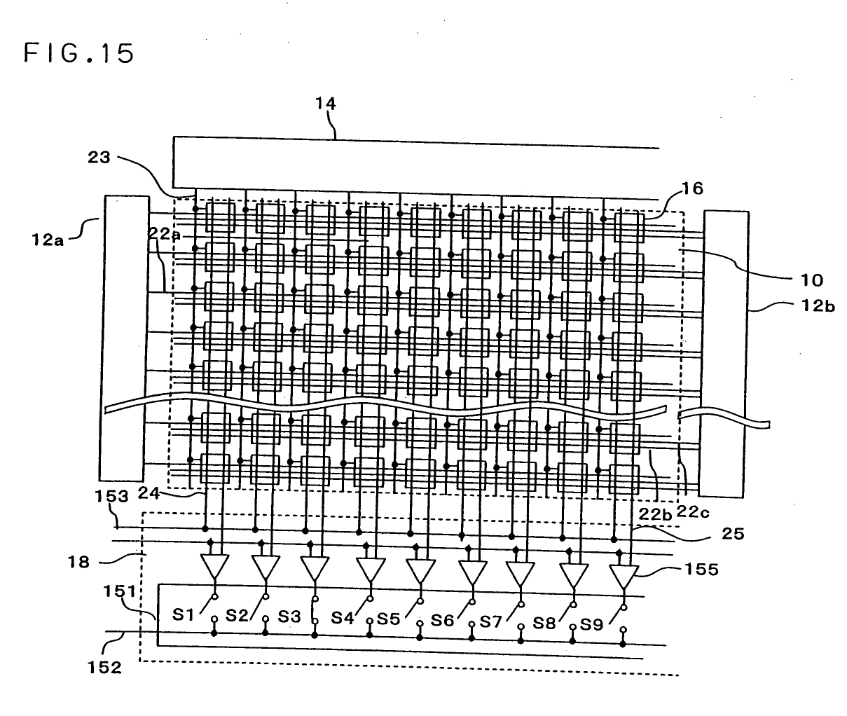

FIG. 15 shows a structural diagram showing peripheral parts of the pixel 16. The photosensor output signal line 25 is connected to the photosensor processing circuit 18. The photosensor processing circuit 18 is mainly composed of a comparator circuit 155 and a selection circuit 151. The selection circuit 31 is exemplified by an analogue switch. It may be of other mechanical relay circuit or the MOS relay. The selection circuit 151 includes a shift register circuit in addition to a switching or selection circuit.

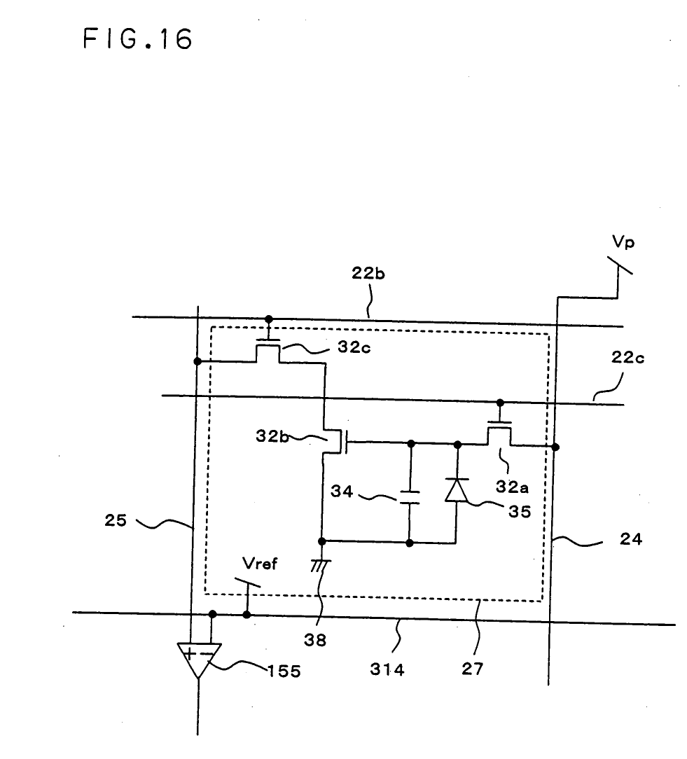

The connecting state between the photosensor pixel 27 and the comparator circuit 155 is shown in FIG. 16. The comparator circuit 155 may be of an OP amplifier circuit, a differential amplifier, and the like. In other words, any member that changes the output of the comparator circuit 155 with respect to a comparative voltage or a comparative object at one terminal is applicable.

Although the comparator circuit 155 detects variation or the like of the voltage applied to the photosensor output signal line 25 in the description in conjunction with FIG. 15, the invention is not limited thereto.

It is also applicable to perform processing by converting the voltage (current) output to digital data by an analogue-digital conversion circuit (AD circuit) 171 without forming the comparator circuit 155 as shown in FIG. 17. It is also applicable to perform direct processing of the output analogue data.

The comparator circuit 155 is not limited to be arranged or formed at the outputs of all the photosensor output signal lines 25. A configuration in which the comparator circuits 155 or the like are formed only on the pixel rows of even numbers may also be employed. It is also possible to arrange the selection circuit 151 on the upstream side of the comparator circuit 155 (between the photosensor output signal line and the comparator circuit 155) for reduce the number of comparator circuits 155 to be formed.

The comparator circuit 155 is characterized in that whether or not the voltage is larger than or smaller than a comparative voltage Vref is determined, and H or L is logically outputted (binarized). Therefore, since the output is converted into a logical signal, a logical processing thereafter is facilitated. In other words, the comparative voltage Vref applied to the comparator circuit 155 and the signal read from the photosensor pixel 27 are compared, and converted into a binary signal whether it is higher or lower than the comparative voltage Vref. By converting into the binary signal, the process of detecting the entered coordinate position is facilitated.

The present invention is not limited thereto, and may be the one outputting in an analogue manner (using the OP amplifier circuit or the like). A configuration in which the output of the comparator circuit 155 outputs binary values (large, small, same) is also applicable. Preferably, the comparator circuit and the OP amplifier circuit are preferably configured or formed to have a hysteresis characteristic so that the output does not vary at a voltage value within a certain range or within the voltage range. The comparator circuit 155 may have a circuit configuration in which a current is converted into a voltage (for example, a current-voltage converting circuit using an OP amplifier device).

Although the gate driver circuit 12 is described to be formed directly on the array substrate 11 by the polysilicon technology, the invention is not limited thereto, and it may be formed of silicon chip or the like and mounted or loaded on the array substrate 11 by a COG technology. It is the same for the source driver circuit 14, the photosensor processing circuit 18, and the signal processing circuit 15.

The gate driver circuit 12a controls the gate signal line 22a of the display pixel 26. The gate driver circuit 12b controls the gate signal line 22b and the gate signal line 22c of the photosensor pixel 26. The gate driver circuit 12a and the gate driver circuit 12b operate synchronously. Therefore, the selection clocks of the gate signal line 22a and the gate signal lines 22b, 22c are the identical clock, or are generated in reference to the clock signal.

(4-1) Function of Comparator Circuit 155

The circuit 155 will be described as the comparator circuit for simplifying the description below. As shown in FIG. 15 and so on, the precharge signal Vp is applied to the precharge signal line 24 from a precharge signal terminal 153. The precharge signal Vp is applied synchronously with the picture signal outputted from the source driver circuit 14. Although the precharge signal Vp is described such that the same precharge signal Vp is applied to all the precharge signal lines 24, the invention is not limited thereto, and may be varied or adjusted. It may be varied or adjusted corresponding to the characteristics of the photosensor 35.

The comparative voltage Vref is applied to one terminal of input terminals of all the comparator circuits 155 from a comparator voltage terminal 154 in FIG. 15. Although it is described such that the same voltage as the comparative voltage Vref is applied to all the comparator circuits 155, the invention is not limited thereto, and may be a different voltage. For example, the Vref voltage to be applied may be differentiated between the pixel columns of even numbers and the pixel columns of odd numbers. The Vref voltage may be differentiated corresponding to the characteristics of the photosensor 35.

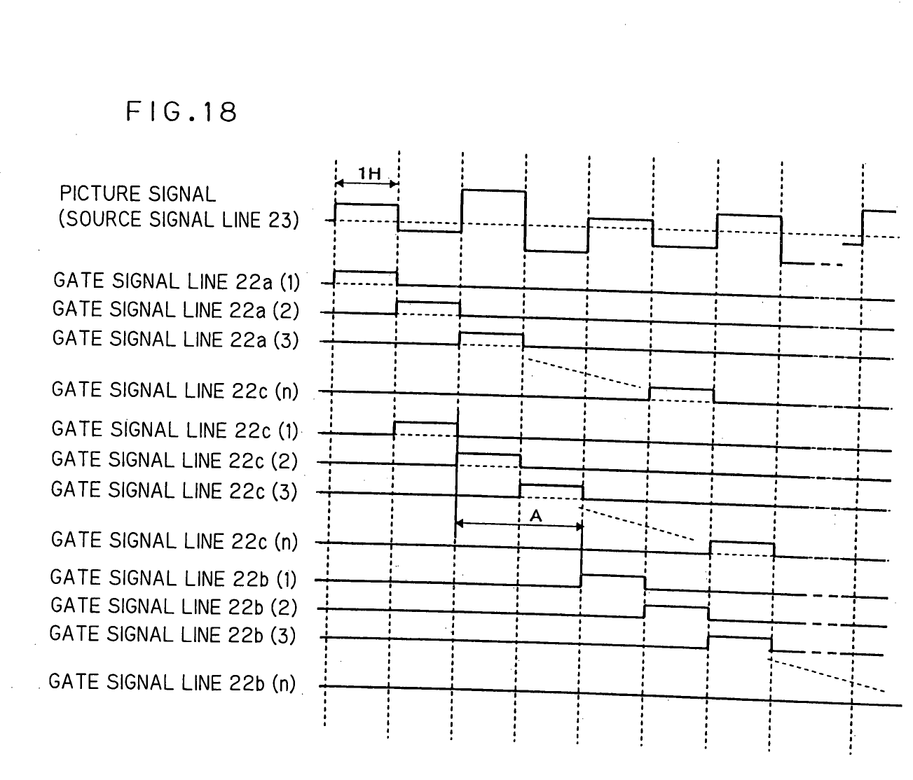

As shown in FIG. 15, an end of the photosensor output signal line 25 is connected to the input terminal of the comparator circuit 155. The selection circuit 151 is connected to the output terminal of the comparator circuit 155. A switch Sk (k=1−n, n designates the number of pixel columns) of the selection circuit 151 is formed and one switch Sk is selected. The output of the selected comparator circuit 155 is connected to a voltage output terminal 152. Therefore, the output voltage is outputted to the voltage output terminal 152. The switch Sk (k=1−n) is configured to be selected at least once in a horizontal scanning period. The gate driver circuit 12b selects the gate signal line 22b synchronously with the one horizontal scanning period (1H) clock, and outputs the output voltage of the transistor 32c to the photosensor output signal line 25 (see FIG. 18).

(5) Display and Reading Method

As shown in FIG. 18, the picture signal is applied to the source signal line 23 by a unit of horizontal scanning period (1H) corresponding to the display image. The polarity of the picture signal is inverted at every 1H or frame. The polarity applied to every pixel row is inverted at every one frame (or one field, that is, a cycle of rewiring the screen). On the other hand, the gate signal line 22a selects the pixel row in sequence synchronously with the clock of 1H, and the transistor 32 of the selected pixel 16 writes the picture signal applied to the source signal line 23 to the pixel electrode 31.

As shown in FIG. 18, the gate driver circuit 12b selects the gate signal line 22a in 1H cycles, and shifts the position of the gate signal lines 22c selected in sequence. The shifting direction is the same as the shifting direction of the gate signal line 22a. When the ON-voltage is applied to the gate signal line 22c, the switching transistor 32a corresponding to the pixel row connected to the gate signal line 22c is turned ON. Therefore, it is applied to the precharge signal line 24. The precharge signal Vp is applied to the photosensor 35. The precharge signal Vp may be varied at every 1H, but is preferably a constant voltage.

When a light beam is irradiated on the photosensor 35, an electric charge is discharged via the photosensor 35, and the terminal voltage of the photosensor 35 is lowered with respect to the precharge signal Vp. Lowering of the terminal voltage is determined by intensity of the light beam irradiated on the photosensor 35 and duration of irradiation (exposure time Tc) of the light beam. When the applied precharge signal Vp is lowered to a level lower than the Vt voltage of the detection transistor 32, the transistor 32b is turned OFF, and when it is higher than the Vt voltage, it is turned ON.

In the same manner, the gate driver circuit 12b synchronizes the gate signal line 22b with the clock of 1H and selects the pixel row in sequence, and the switching transistor 32c of the selected photosensor pixel 27 outputs the output of the detected transistor 32b to the voltage output signal line 25. When a light beam is irradiated on the photosensor 35, the electric charge is discharged via the photosensor 35, and the terminal voltage of the photosensor 35 is lowered to a level lower than the precharge signal Vp.

As described above, the lowering of the voltage (discharge of the electric charge) is determined by the intensity of a light beam irradiated on the photosensor 35 and the exposure time Tc. It is also determined by the capacity of the capacitor 34. The applied precharge signal Vp is lowered by being irradiated by a light beam to the photosensor 35. When the voltage applied to the gate terminal of the transistor 32b is lower than the Vt voltage, the transistor 32b is turned OFF, and when it is higher than the Vt voltage, it is turned ON. Therefore, by turning the switching transistor 32c into the ON-state, the operating state of the transistor 32b can be outputted to the photosensor output signal line 25.

(6) Exposure Time Tc

Subsequently, the exposure time Tc will be described. As shown in FIG. 18, the gate signal line 22b is selected after a period A is elapsed after the gate signal line 22c is selected. The period A is referred to as “exposure time Tc”. In other words, the exposure time Tc is from a moment when the precharge signal Vp is applied to the arbitrary photosensor pixel 27 to a moment when it is read out. More accurately, it corresponds to a period from a moment when the precharge signal Vp applied to the photosensor 35 is settled and the voltage is outputted to the photosensor output signal line 25 to a moment when the outputted state is settled and hence it can be read out from the voltage output terminal 152.

In this specification, the exposure time Tc is defined to be a period from a moment when the precharge signal Vp is applied to the photosensor pixel 27 to a moment when the holding voltage of the photosensor 35 of the applied photosensor pixel 27 is read out. Since the timing of selecting the gate signal line 22b and the timing of selecting the gate signal line 22c are synchronized, the timing of detecting the terminal voltage of the photosensor 35 is relatively proportional even when the exposure time Tc is varied or adjusted. Therefore, intensity of outside light can be figured out accurately. Even when the photosensors 35 varies from lot to lot of the array substrates 11, there is no problem.

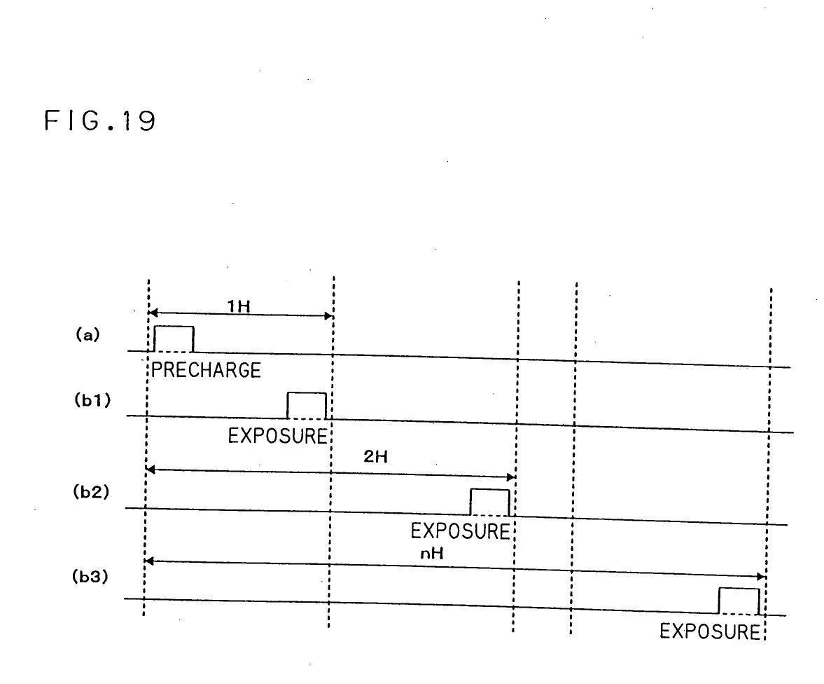

The exposure time Tc can be changed as shown in FIG. 19. Reference sign (a) in FIG. 19 shows a selection signal of the gate signal line 22c. An ON voltage is applied to the gate signal line 22c and the precharge signal Vp is applied to the photosensor pixel 27 for a certain period of one horizontal scanning period (1H). Reference sign (b) in FIG. 19 shows a selection signal of the gate signal line 22b. During a certain period of one horizontal scanning period (1H), an ON-voltage is applied to the gate signal line 22b, and the voltage or the like is taken out from the photosensor pixel 27 to the photosensor output signal line 25.

Reference numeral (b1) in FIG. 19 shows a case in which the exposure time Tc is within the one horizontal scanning period (1H). Reference numeral (b2) in FIG. 19 shows an embodiment in which the exposure time Tc is longer than 1H (in the proximity of 2H in the drawing). Reference numeral (b3) in FIG. 19 shows an embodiment in which the exposure time Tc is nH (n represents integers).

Although FIG. 19 shows a case of the unit of 1H, the unit may be smaller than 1H. For example, 0.5H period (½ of one horizontal scanning period) or 0.25H (¼ of one horizontal scanning period) may be applied. It is also possible to vary or adjust the exposure time Tc by a unit of one field or one frame period. It is possible to vary or adjust the exposure time Tc by a period within one field or one frame. The precharge signal Vp and the exposure time Tc are adjusted to be outputted from the voltage output terminal 152 adequately.

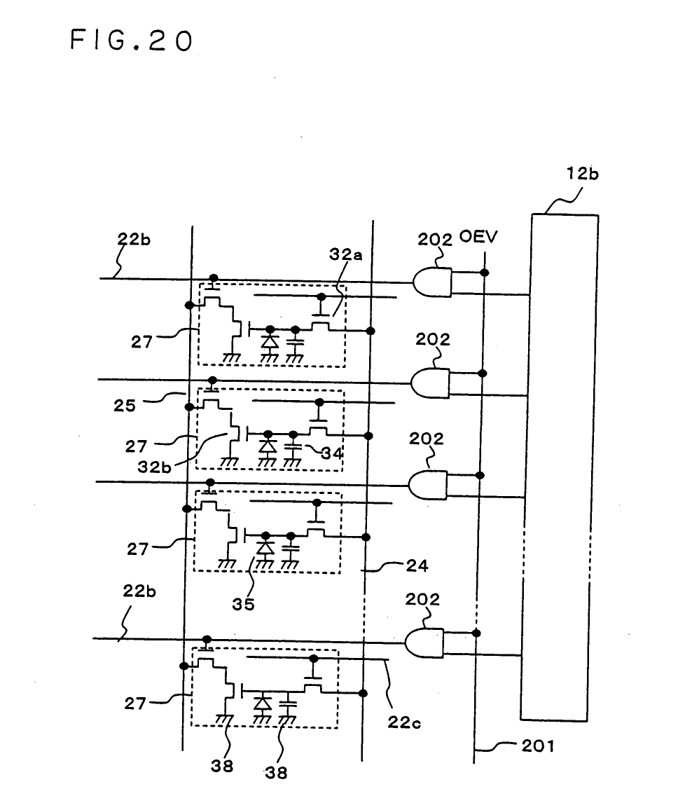

In order to realize a time setting of the exposure time Tc within 1H, it is preferable to add an enable (OEV) circuit to the gate driver circuit 12b as shown in FIG. 20. The ON-voltage is applied to the gate signal line 22b only during the period in which a period in which an H-logical voltage is applied to the enable terminal (OEV) terminal 201 and the period in which the gate driver circuit 12b outputs the H-logical voltage for selecting the gate signal line 22b are logically multiplied (AND).

In the configuration of the gate driver circuit 12b like the one shown in FIG. 15, there is no enable terminal (OEV) 201. Therefore, the ON-voltage (selected voltage) is applied to the gate signal line 22c during the period in which the gate driver circuit 12b outputs the H-logical voltage for selecting the gate signal line 22b.

In the configuration shown in FIG. 20, the period of applying the ON-voltage to the gate signal line 22b can be set to a period shorter than 1H by the control of the logical voltage of the enable terminal (OEV) 201.

Therefore, the gate signal lines 22b, 22c formed on the identical photosensor pixel 27 during 1H period are selected by the gate driver circuit 22b and, when applying the precharge signal Vp, the gate signal line 22b is disabled under the control of the OEV terminal. In other words, although the gate signal line 22b is selected by the shift register circuit, an OFF-voltage is applied to the gate signal line 22b by the OEV terminal 201. The gate signal line 22b is brought into a selected state under the control of the OEV terminal 201 connected to the gate signal line 22b after having elapsed the exposure time Tc within 1H after the precharge signal Vp is applied to the photosensor 35. In other words, the ON-voltage is applied to the gate signal line 22b by the OEV terminal 201. The gate signal line 22b is controlled by logically multiplying a logic of the OEV terminal and the output from the shift register circuit 12b by an AND circuit 202. Therefore, the transistor 32c is turned ON and the output of the transistor 32b is outputted to the photosensor output signal line 25.

The configuration or the operation relating to the OEV described above can be applied also to the gate driver circuit 12a. The operation of the gate driver circuit 12b to control the gate signal line 22b is preferably applied to the gate signal line 22a and the gate signal line 22c. It can also be applied to other embodiments in the present invention.

(7) Terminal Voltage of Photosensor 35

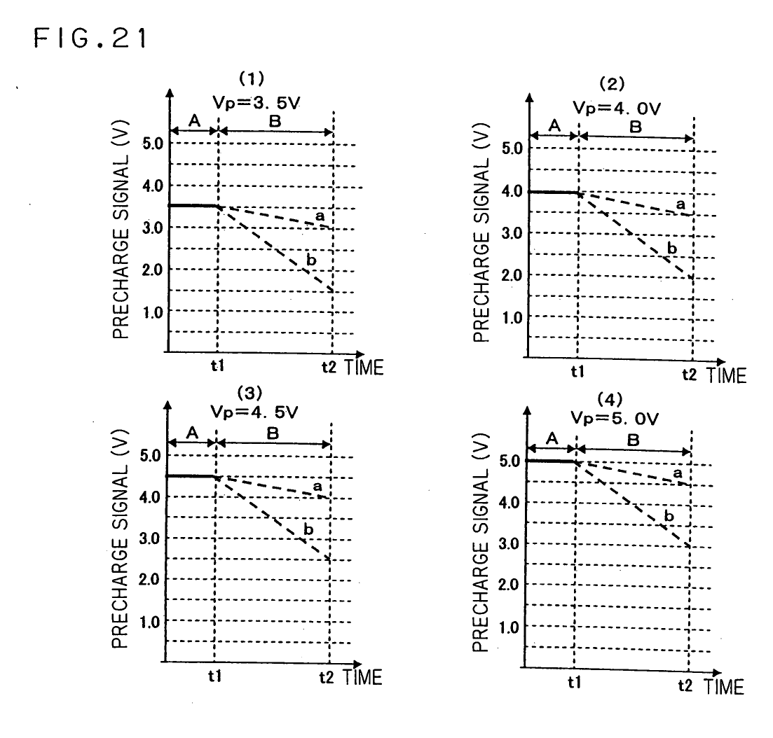

The terminal voltage of the photosensor 35 varies with the magnitude of the precharge signal Vp applied to the photosensor 35 and the intensity of outside light irradiated on the photosensor 35. Variations are shown in FIG. 21. The precharge signal Vp is applied during a period A in FIG. 21.

FIG. 21(1) shows a case in which the precharge signal Vp=3.5 V. When outside light irradiated on the photosensor 35 is weak even after the precharge signal Vp of 3.5 V is applied, the terminal voltage of the photosensor 35 varies as indicated by a straight line a. When outside light irradiated on the photosensor 35 is strong, the terminal voltage of the photosensor 35 varies as indicated by a straight line b. After having elapsed a period B, the switching transistor 32c is turned ON, and the voltage or the like is taken out to the photosensor output signal line 25. When the precharge signal Vp is applied at t1 and read at t2, the period B corresponds to the exposure time Tc.

It is assumed that the Vt of the transistor 32b is 2.5 V, the transistor 32b is turned ON when the gate terminal voltage of the transistor 32b is higher than Vt, and the transistor 32b is turned OFF at a voltage below 2.5 V.

In the case of the straight line b in FIG. 21(1), the voltage is 1.5 V at t2. Therefore, the OFF-state of the transistor 32b is taken out to the photosensor output signal line 25. When the period B is short, the voltage of the photosensor output signal line 25 is higher than 1.5 V. When the period B is long, the voltage of the photosensor output signal line 25 is below 1.5 V. In the case of the straight line a in FIG. 21(1), the voltage is 3.0 V at t2. Therefore, the ON-state of the transistor 32b is taken out to the photosensor output signal line 25.

FIG. 21(2) shows a case in which the precharge signal Vp=4.0 V. When outside light irradiated on the photosensor 35 is weak even after the precharge signal Vp of 4.0 V is applied, the terminal voltage of the photosensor 35 varies as indicated by the straight line a. When outside light irradiated on the photosensor 35 is strong, the terminal voltage of the photosensor 35 varies as indicated by the straight line b. After having elapsed the period B, the switching transistor 32c is turned ON and the voltage or the like is taken out to the photosensor output signal line 25.

When the impedance variation in the photosensor 35 is proportional to the light irradiation intensity, an inclination of the straight line b in FIG. 21(1) and an inclination of the straight line b in FIG. 21(2) are the same. An inclination of the straight line a in FIG. 21(1) and an inclination of the straight line a in FIG. 21(2) are the same. Referring to the straight line a in FIG. 21 (2), the transistor 32b is in the ON-state at t2, and referring to the straight line b, the transistor 32b is in the OFF-state. FIG. 21(3) shows a case in which the precharge signal Vp=4.5 V, and FIG. 21(4) shows a case in which the precharge signal Vp=5.0 V.

In FIG. 21, assuming that the transistor 32c is in the ON-state when the gate terminal voltage of the transistor 32c is higher than Vt=2.5 (V), and is in the OFF-state when it is under 2.5 (V), the transistor 32b is in the ON-state in the case of the straight line a and in the OFF-state in the case of the straight line b at the time t2 in FIG. 21(1). In FIG. 21(2), it is in the ON-state in the case of the straight line a, and in the OFF-state in the case of the straight line b. In FIG. 21(3), it is in the ON-state in the case of the straight line a and in the ON-state in the case of the straight lien b. In FIG. 21(4), it is in the ON-state in the case of the straight line a and in the ON-state in the case of the straight line b.

It is also possible to configure the gate driver circuit 22b that drives the gate signal line 22c separately from the gate driver circuit 22b that drives the gate signal line 22b.

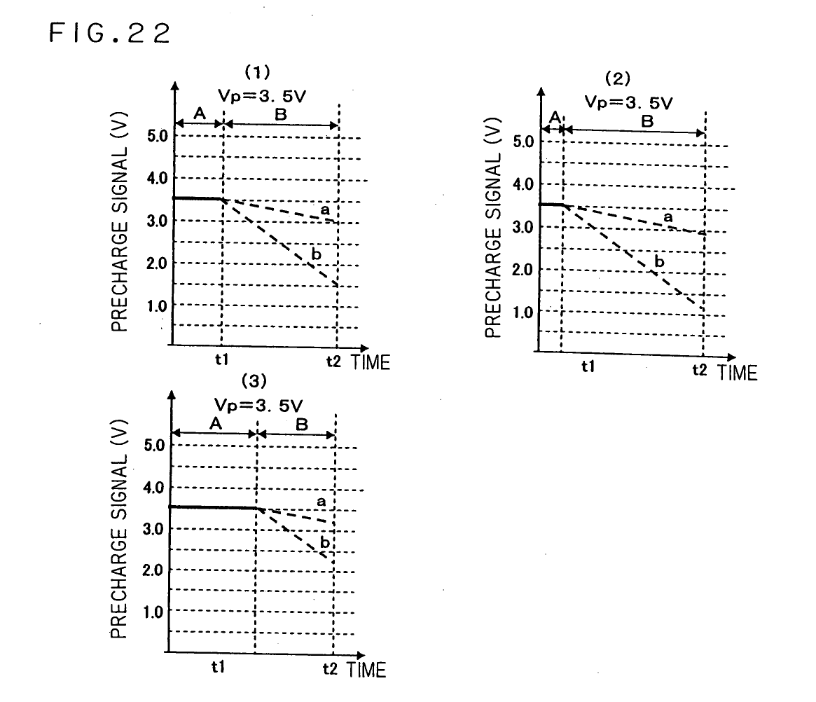

In the embodiment shown above, the period A in which the precharge signal Vp is applied is the same (FIGS. 21(1), (2), (3) and (4)). However, in the present invention, the invention is not limited thereto. For example, it may be driven as shown in FIG. 22. In the embodiment shown in FIG. 22, the period A in which the precharge signal Vp is applied is short and the exposure time Tc=B is the longest in FIG. 22(2). In FIG. 22(3), the period A in which the precharge signal Vp is applied is long, and the exposure time Tc=B is the shortest. In FIGS. 22 (1), (2) and (3), it is assumed that the period A+the period B=a constant value.

In FIG. 22, assuming that it is in the ON-state when the gate terminal voltage of the transistor 32c is higher than Vt=1.5 (V) and is in the OFF-state when the voltage is lower than that, the transistor 32c is in the ON-state in the case of the straight line a, and is in the OFF-state in the case of the straight line b at the time t2 in FIG. 22(1). In FIG. 22(2), it is in the ON-state in the case of the straight line a, and in the OFF-state in the case of the straight line b. In FIG. 22(3), it is in the ON-state in the case of the straight line a, and in the ON-state in the case of the straight line b.

As described above, the ON and OFF states of the transistor 32b and the state of the photosensor 35 can be varied by varying or adjusting not only the exposure time Tc, but also the time of application of the precharge signal Vp, the exposure time Tc in a predetermined period, or the time of application of the precharge signal Vp.

(8) Image Capturing Operation by a Plurality of Times

The operating state of the photosensor pixel 27 is preferably detected (image capturing) by a plurality of times with different image-pickup conditions (precharge signal Vp, exposure time Tc). It is also applicable to generate a distribution of the operating state and captured image data of the photosensor 35 on the basis of the result of the image capturing by the plurality of times.

More specifically, as shown in FIG. 21, the image is captured in a state in which the respective voltages Vp are applied to the capacitor 34 while varying the precharge signal Vp to the capacitor 34 by a plurality of times (four combinations in FIG. 21). A control signal therefor is supplied to the gate driver circuit 12b of the array substrate 11. Also digital data or analog data from the comparator circuit 155 as a result of capturing the image outputted from the array substrate 11 is calculated.

(9) Division of Selection Circuit

In the configuration shown in FIG. 15, it is necessary that the selection switch Sk is selected once per every 1H period. Therefore, relatively high-speed operation is necessary. In order to cope with this problem, the selection circuit is divided.

(9-1) When Divided into Two Selection Circuits

In FIG. 17, the pixel columns of odd numbers are connected to the selection circuit 151b and the pixel rows of even numbers are connected to the selection circuit 151a. The voltage from the selection circuit 151b or the like is outputted form the voltage output terminal 152b. The voltage or the like from the selection circuit 151a is outputted from the voltage output terminal 152a. Therefore, in comparison with the case in FIG. 15, the time for selecting the switch Sk can be duplicated.

In FIG. 17, the precharge signal Vp is applied to all the precharge signal lines 24 from one precharge signal terminal 153. However, the invention is not limited thereto.

For example, it is also possible to form or arrange a plurality of the precharge signal terminals 153 and cause the precharge signal Vp to be applied to the respective precharge signal lines 24 to vary.

For example, by applying the different precharge signals Vp to the photosensors 35 in the pixel columns of odd numbers and the pixel columns of even numbers, the pixel columns to which the precharge signal Vp having higher sensitivity with respect to the outside light intensity is applied are selected to execute a coordinate detection process. It is also possible to apply the different precharge signals Vp in the cycle of three pixel columns or more or in the cycle of two pixel rows or more.

(9-2) When Divided into More than Two Selection Circuits

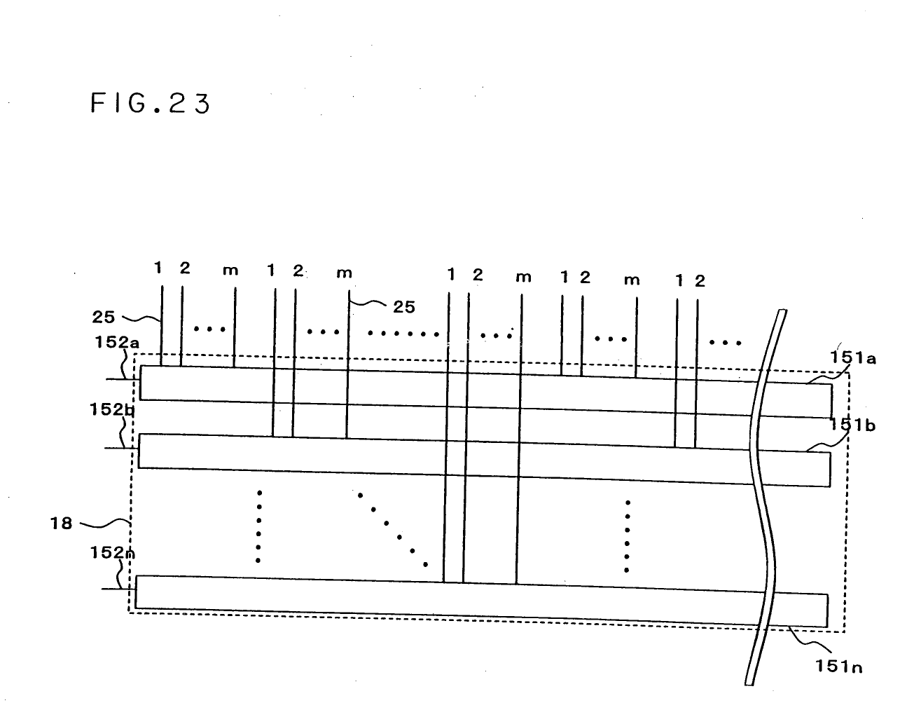

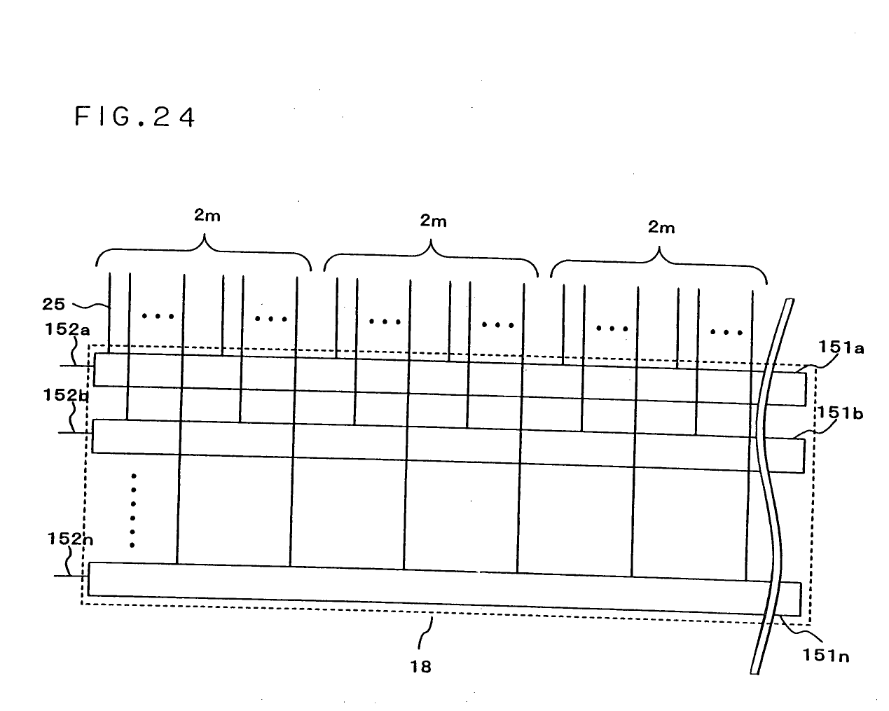

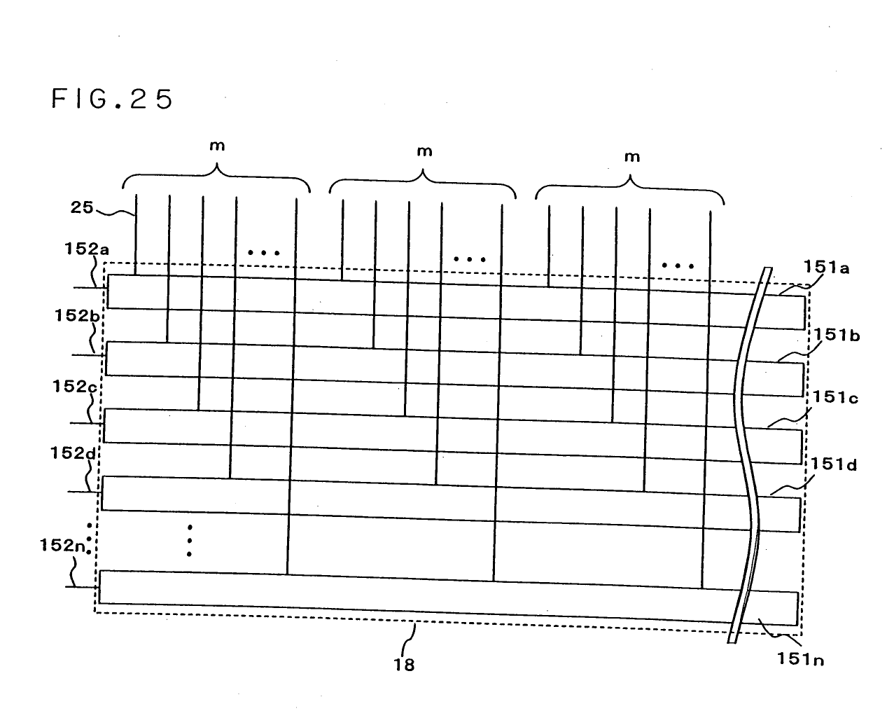

FIG. 17 has a configuration in which the two selection circuits 151 are formed. However, the invention is not limited thereto. For example, it is also possible to configure n selection circuits 151 as shown in FIG. 23, FIG. 24 and FIG. 25. The more the number of n increases, the longer the time required for processing signals applied to one photosensor output signal line 25 in the 1H period becomes. Therefore, stable output signal processing is achieved. However, re-composition (re-arrangement) of the output data becomes complex with increase in number of divisions.

FIG. 23 shows a configuration in which m photosensor output signal lines 25 from the left end of the screen are connected to the selection circuit 151a, then, the next m photosensor output signal lines 25 are connected to the selection circuit 151b, then, the next m photosensor output signal lines 25 are connected to the selection circuit 151c . . . and so forth.

FIG. 24 shows a configuration in which 2n photosensor output signal lines 25 from the left end of the screen are connected to the selection circuits, 151a, 151b, 151c, 151d, . . . 151n, 151a, 151b, 151c, . . . 151n, and the next 2n photosensor output signal lines 25 are connected to the selection circuits 151a, 151b, 151c, 151d, . . . 151n, 151a, 151b, 151c, . . . 151n, and then the next 2n photosensor output signal lines 25 are connected to the selection circuits 151a, 151b, 151c, 151d, . . . 151n, 151a, 151b, 151c, . . . 151n.

FIG. 25 shows a configuration in which m photosensor signal lines 25 from the left end of the screen are connected to the selection circuits 151a, 151b, 151c, 151d, . . . 151n, 151a, 151b, 151c, . . . 151n, and the next m photosensor output signal lines 25 are connected to the selection circuits 151a, 151b, 151c, 151d, . . . 151n, 151a, 151b, 151c, . . . 151n, and the next m photosensor output signal lines 25 are connected to the selection circuits 151a, 151b, 151c, 151d, . . . 151n, 151a, 151b, 151c, . . . 151n.

(10) Selection Function in Source Driver Circuit 14

FIG. 15 shows an embodiment in which the all the source signal lines 23 are connected to the source driver circuits 14. However, as shown in FIG. 17, a configuration in which the source driver circuit 14 outputs a red (R) picture signal, a green (G) picture signal and a blue (B) picture signal in sequence during one horizontal scanning period, and a switch SW of a switching circuit 172 directly formed on the array substrate 11 distributes the R picture signal to the R source signal line 23, the G picture signal to the G source signal line 23, and the B picture signal to the B source signal line 23 may also be employed. In other words, the source driver circuit 14 has a function of three selection circuits.

In the configuration shown in FIG. 17, the number of the output terminals of the source driver circuit 14 may be ⅓ of the case of the embodiment shown in FIG. 15. Therefore, the number of connection between the array substrate 11 and the source driver circuit 14 may also be ⅓, and hence the possibility of occurrence of the mounting defect may be reduced.

In the embodiment shown in FIG. 17, the switching circuit 172 is formed on the array substrate 11 by the polysilicon technology. However, the invention is not limited thereto, and may be formed of silicon chip and mounted on the array substrate 11.

(11) Timing of Operation in FIG. 17

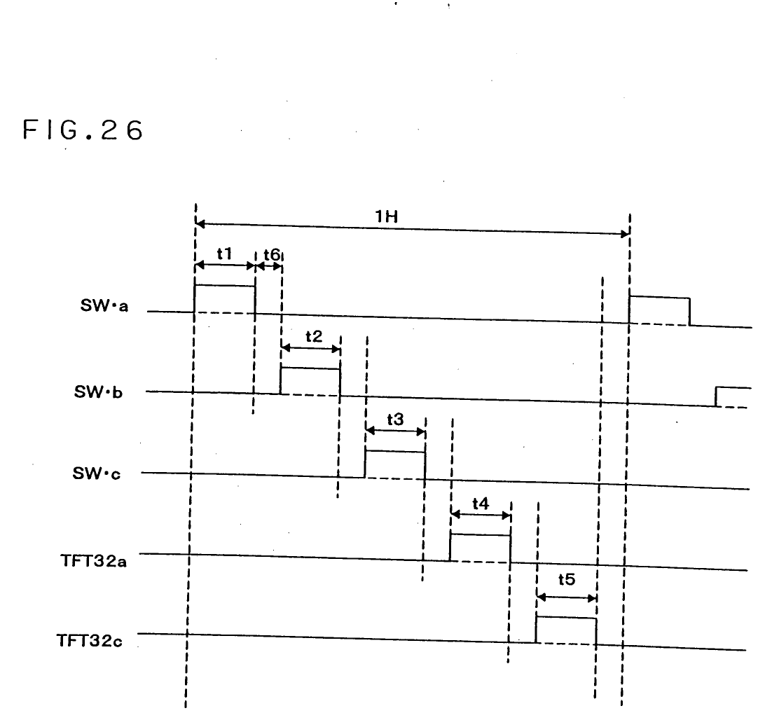

The timing of operation in FIG. 17 is shown in FIG. 26. The SW of the switching circuit 172 switches terminals a, b, c in the period of one horizontal scanning period (1H). The transistor 32a and the transistor 32c of the photosensor pixel 27 are operated.

The SW selects the terminal a at the beginning of the 1H period, and the R picture signal is outputted from the source driver circuit 14. Therefore, the R picture signal is applied to the R source signal line 23. Subsequently, the SW of the switching circuit 172 selects the terminal b, and the G picture signal is outputted from the source driver circuit 14. Therefore, the G picture signal is applied to the G source signal line 23. Subsequently, the SW of the switching circuit 172 selects the c terminal, and the B picture signal is outputted from the source driver circuit 14. Therefore, the B picture signal is applied to the B source signal line 23. At the next timing, an ON-voltage is applied to the gate signal line 22c to turn the transistor 32a ON, and the precharge signal Vp applied to the precharge signal line 24 is applied to the photosensor pixel 27. At the end of 1H, an ON-voltage is applied to the gate signal line 22b to turn the transistor 32c of the photosensor pixel 270N and the output of the transistor 32b is outputted to the photosensor output signal line 25.

In FIG. 26, the period of t1 is a period in which the SW selects the terminal a and the R picture signal is outputted from the source driver circuit 14. The period of t2 is a period in which the SW of the switching circuit 172 selects the terminal b and the G picture signal is outputted from the source driver circuit 14. The period of t3 is a period in which the SW of the switching circuit 172 selects the c terminal and the B picture signal is outputted from the source driver circuit 14. Therefore, the B picture signal is applied to the B source signal line 23. At the next timing, an ON-voltage is applied to the gate signal line 22c to turn the transistor 32a ON, and the precharge signal Vp applied to the precharge signal line 24 is applied to the photosensor pixel 27. An On-voltage is applied to the gate signal line 22b at the end of 1H to turn the transistor 32c of the photosensor pixel 270N, and the output of the transistor 32b is outputted to the photosensor output signal line 25.

When the periods of t1, t2, t3, t4, t5 are set to be the same length, the circuit configuration of the photosensor processing circuit 18 or the like is simplified. However, the invention is not limited thereto. For example, it is preferable to make the period of t4 in which the precharge signal Vp is applied longer than the periods t1, t2, t3 in which the picture signal is applied.

In particular, the period of t5 that turns the transistor 32c ON is preferably set to the longest period. It is because a stable output can be supplied to the comparator circuit 155. It is preferable to secure a period of t6 among the periods of t1, t2, t3, t4, t5. It is because the periods in which the respective switches SW, or the transistor 32 are changed from the ON-state to the OFF-state, that is, the switching periods are unstable.

As described in FIG. 18, the photosensor pixel 27 to which the precharge signal Vp is applied and the photosensor pixel 27 from which the transistor 32c outputs to the photosensor output signal line do not necessarily have to be the same.

(12) Method of shortening Exposure time Tc

In FIG. 26, the period from the period of t4 in which the precharge signal Vp is applied to the period of t5, which is the output period of the photosensor 35 (the exposure time Tc), can be extremely shortened.

In FIG. 26, the period of t1 is the period in which the SW selects the terminal a and the R picture signal is outputted from the source driver circuit 14. The period of t2 is the period in which the SW of the switching circuit 172 selects the terminal b and the G picture signal is outputted from the source driver circuit 14. The period of t3 is the period in which the SW of the switching circuit 172 selects the c terminal, and the B picture signal is outputted from the source driver circuit 14. Therefore, the B picture signal is applied to the B source signal line 23. At the next timing, the ON-voltage is applied to the gate signal line 22c to turn the transistor 32a ON and the precharge signal Vp applied to the precharge signal line 24 is applied to the photosensor pixel 27.

The ON-voltage is applied to the gate signal line 22b at the end of 1H, and the transistor 32c of the photosensor pixel 27 is turned ON to output the output of the transistor 32b to the photosensor output signal line 25.

(13) Method of Elongating Exposure Time Tc

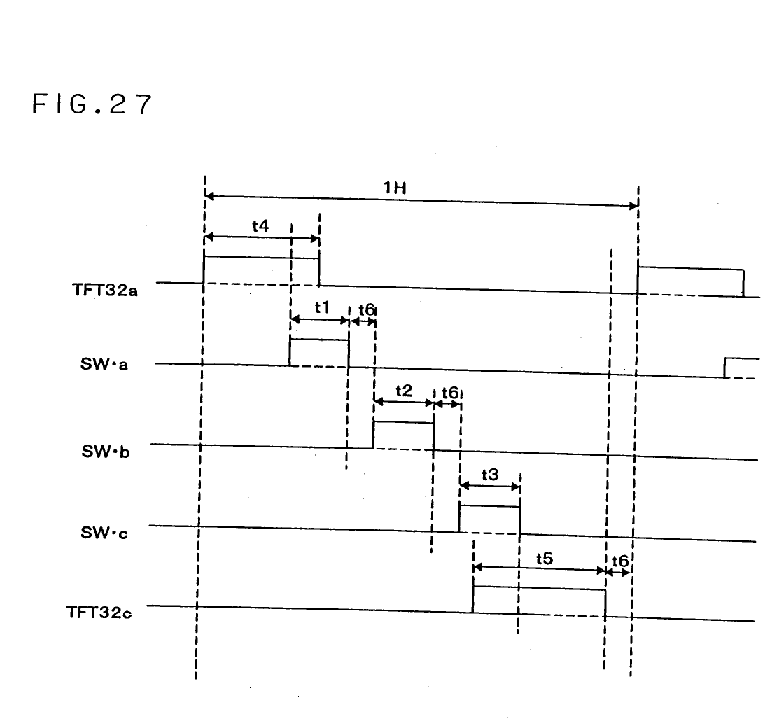

In order to relatively elongate the exposure time Tc, a configuration shown in FIG. 27 is recommended. In FIG. 27, a first precharge signal Vp of 1H is applied to the photosensor 35. At the end of 1H, the output of the photosensor 35 is taken out to the photosensor output signal line 25. In the first period of t4 in 1H, the gate signal line 22c is selected, and the transistor 32a is turned into the ON-state, and the precharge signal Vp is applied to the photosensor 35. The next period of t1 is a period in which the SW selects the terminal a and the R picture signal is outputted from the source driver circuit 14. The next period of t2 is a period in which the SW of the switching circuit 172 selects the terminal b, and the G picture signal is outputted from the source driver circuit 14. In the next period of t3, the SW of the switching circuit 172 selects the c terminal, and the B picture signal is outputted from the source driver circuit 14. Therefore, the B picture signal is applied to the B source signal line 23.

At the last timing in 1H, an ON-voltage is applied to the gate signal line 22b to turn the transistor 32c into the ON-state and hence the transistor 32c of the photosensor pixel 27 is turned ON, whereby the output of the transistor 32b is outputted to the photosensor output signal line 25.

(14) First Modification

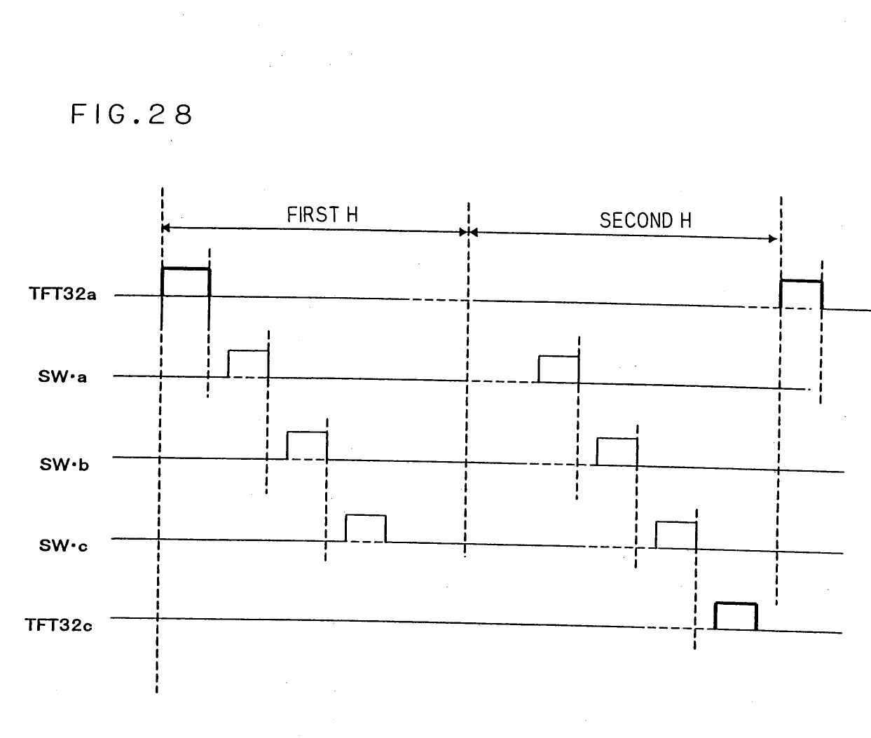

In the above-described embodiment, application of the precharge signal Vp and taking-out of the output of the photosensor are executed with respect to the each photosensor pixel 27 during the 1H period. However, the invention is not limited thereto. A first modification of the embodiment in FIG. 28 will be shown.

(14-1) Operation of First Modification

In FIG. 28, the operations of the transistor 32a and the transistor 32c are different between a first horizontal scanning period (first H, for example, during a period in which a first pixel raw is selected) and in the next second horizontal scanning period (second H, for example, a period in which a second pixel row is selected). The operations of the picture signals R, G and B that the source driver circuit 14 outputs are the same (picture signals are outputted every 1H).

In FIG. 28, the transistor 32a is turned ON in the pixel row of the first H, and the precharge signal Vp is applied to the photosensor pixel 27 in the first pixel row. As is clear from FIG. 28, since the transistor 32c of the photosensor pixel 27 in the fist pixel row is not selected, the output of the photosensor 35 in the fist pixel raw is not read out. Since the gate signal line 22c is not selected in the pixel row of the second H, the transistor 32a is maintained in the OFF-state. Therefore, the precharge signal Vp is not applied to the pixel 27 in the second pixel row. As is clear from FIG. 28, since the gate signal line 22b in the second pixel row is selected, the transistor 32c of the photosensor pixel 27 is selected. Therefore, the output of the photosensor 35 in the second pixel raw is read by the photosensor output signal line 25.

From the operation described above, in a first frame, the precharge signal Vp is applied to the pixel rows of odd numbers. In the pixel raws of even numbers, the output of the photosensor 35 is read. In a second frame next to the first frame, the precharge signal Vp is applied to the pixel rows of even numbers. In the pixel rows of odd numbers, the output of the photosensor 35 is read. Therefore, the exposure time Tc can be set to a time over one frame.

(14-2) Modification of First Modification

The first modification is not limited to the mode of applying the precharge signal Vp to the respective pixel rows in sequence and reading outputs of the photosensor 35 from the respective pixel rows. For example, it is also possible to execute every other pixel row, or every several pixel rows. Alternatively, application of the precharge signal Vp and reading of the output of the photosensor 35 may be executed at every random pixel rows. The operation described above may also be performed by a unit of pixel column.

(15) Second Modification

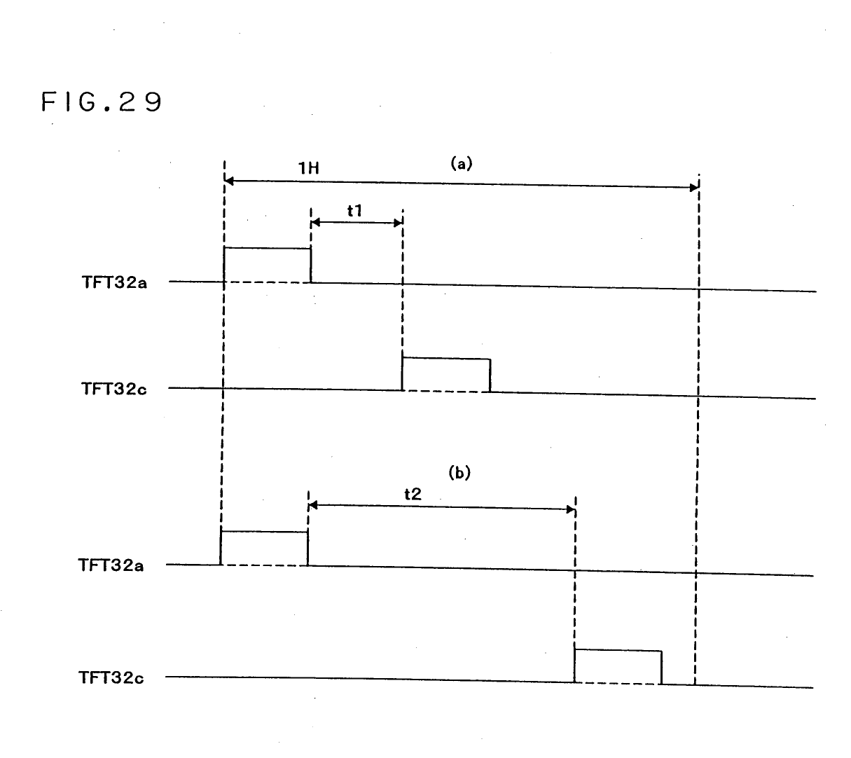

A second modification is shown in FIG. 29. As shown in FIG. 29, the application of the precharge signal Vp (the transistor 32a is operated) at every 1H (one horizontal scanning period), that is, at every pixel row and the reading of the photosensor 35 (the transistor 32c is operated) are included within the technical scope of the present invention.

FIG. 29(a) shows an embodiment in which the time t1 (exposure time Tc) between the application of the precharge signal Vp by the transistor 32a and the output of the state of the photosensor 35 by the transistor 32c within the 1H period is relatively short.

FIG. 29(b) shows an embodiment in which the time t2 (exposure time Tc) between the application of the precharge signal Vp by the transistor 32a and the output of the state of the photosensor 35 by the transistor 32c within the 1H period is relatively long. As described above, in the present invention, the exposure time Tc can be set or adjusted freely by controlling (including an OEV terminal control) the gate driver circuit 12b.

(16) Third Modification

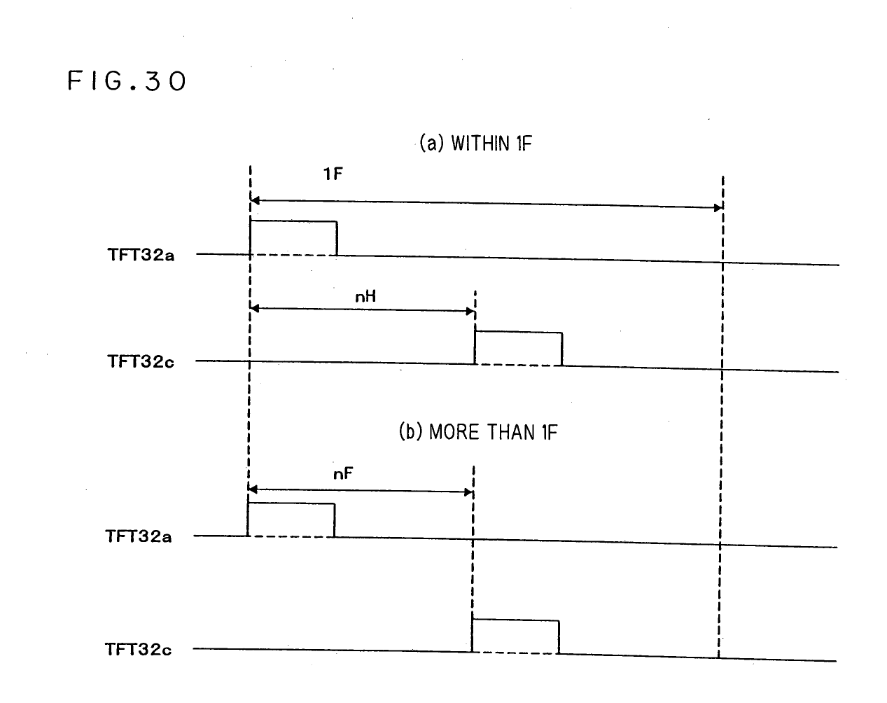

FIG. 30 shows a third modification. As shown in FIG. 30, application of the precharge signal Vp (the transistor 32a is operated) and reading of the photosensor 35 (the transistor 32c is operated) by a unit of 1F (one field or one frame) are included within the technical scope of the present invention.

FIG. 30(a) is an embodiment in which a time nH between the application of the precharge signal Vp by the transistor 32a and the output of the state of the photosensor 35 by the transistor 32c in the 1F period is varied by nH (n is one or larger integers, n<=the number of horizontal scanning lines in 1F).

FIG. 30(b) is an embodiment in which a time mF (m represents one or larger integers) between the application of the precharge signal Vp by the transistor 32a and the output of the state of the photosensor 35 by the transistor 32c is varied.

### [A-2] Second Embodiment

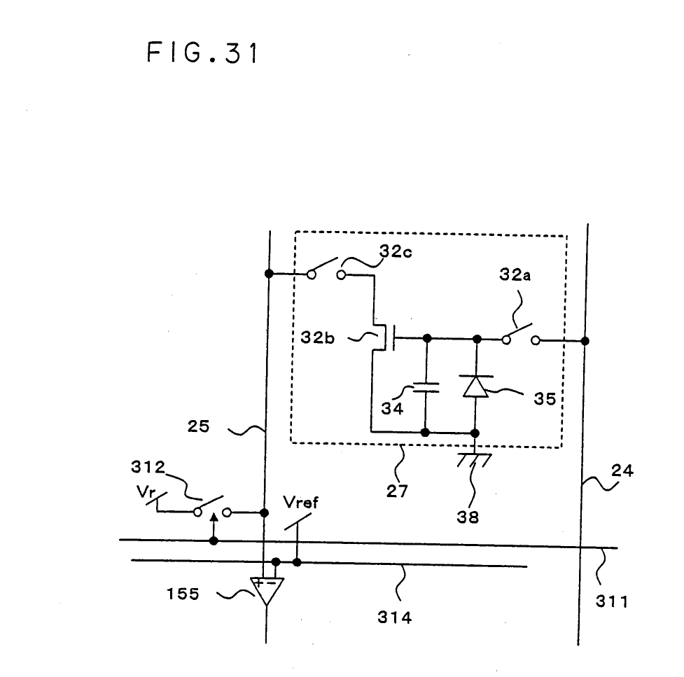

FIG. 31 is a pixel configuration in a second embodiment. The transistor 32a, the transistor 32c and a transistor 312 are shown as switches in order to clarification of description. The common signal lines 38 are indicated by a ground (GND) signal.

(1) Configuration of Pixel

In FIG. 31, the gate signal line 22d is a signal line controlled by the gate driver circuit 12b. When the ON-voltage of the gate signal line 22d is applied, the transistor 312 is turned ON. When the transistor 312 is turned ON, a Vr potential is applied to the photosensor output signal line 25.

The Vr voltage is preferably homologized with the precharge signal Vp. At the same time as the precharge signal Vp is applied to the precharge signal line 24, the precharge signal Vp is also applied to the photosensor output signal line 25. In order to apply the precharge signal Vp to the photosensor output signal line 25, the transistor 312 is closed. It is also possible to close the transistor 32c, and close the transistor 312 before taking out the operating state of the transistor 32b, and then apply the precharge signal Vp to the photosensor output signal line 25.

The application of the precharge signal Vp to the photosensor output signal line 25 may be performed by causing the photosensor processing circuit 18 to generate the precharge signal Vp and applying the precharge signal Vp to the photosensor output signal line 25. As another embodiment, the Vr potential may be, for example, a GND potential. Alternatively, the Vr potential may be, for example, the precharge signal. Vp or a voltage in the proximity thereto. The Vt voltage is supplied to a reset signal line 311.

In the above described embodiment, the GND potential and the precharge signal Vp are applied to the photosensor output signal line 25 by closing the transistor 312. However, it is not limited to the GND potential and the precharge signal Vp, and may be other potentials. For example, it may be a voltage in the proximity of the Vt voltage of the transistor 32b. It also may be the comparative voltage Vref voltage of the comparator circuit 155. It is preferable to adapt the Vr potential to be applied by the transistor 312 to be variable or adjustable. To make it variable, an electronic volume is added to enable digital control.

By applying the Vr voltage, the potential of the photosensor output signal line 25 becomes equivalent to the Vr potential. After having applied the Vr potential, the transistor 32c of the photosensor pixel 27 is turned ON to read the voltage of the photosensor 35. Therefore, variation in output that turns the transistor 32c ON appear on the photosensor output signal line 25 and variation starts absolutely from the Vt potential. Therefore, the stable output is applied to the comparator circuit 155.

The application of the Vt voltage is preferably performed at the time of starting usage of the plane display device. It is also preferably performed at the beginning of one frame. It may also be performed at the beginning of 1H. In other words, it is preferable to perform the application of the Vt voltage at the beginning of every break points.

A comparator signal line 314 for applying the Vref voltage applies the same commonly to all the comparator circuits 155. However, the present invention is not limited thereto. For example, when the plurality of voltage output terminals 152 are included as shown in FIG. 17, a plurality of the comparator signal lines 314 may be formed or arranged. It is also applied to the reset signal line 311.

(2) Modification of Comparator Circuit 155

It is also possible to form a plurality of the comparator circuits 155 for one photosensor output signal line 25. The characteristics of the plurality of the comparator circuit 155 are differentiated.

For example, two types of the photosensor pixels 27 are formed and the characteristics of the photosensors 35 of the photosensor pixels 27 are differentiated. The photosensors are composed to have different sensitivities according to the light intensity. The plurality of comparator circuits 155 are allocated respectively according to the sensitivities of the photosensors.

The characteristics of the transistors 32b of the photosensor pixels 27 are differentiated. The plurality of comparator circuits 155 are allocated respectively corresponding to the different transistors 32b.

For example, the transistors 32b of the different photosensor pixels 27 and the different photosensors 35 are arranged on the display area 10 so as to be different by every pixel row. Then, output signal levels different for each 1H are outputted to the photosensor output signal line 25. An adequate level determination is achieved by selection with comparator circuits 155 having the different output signal levels.

A configuration in which the transistors 32b of the different photosensor pixels 27 and the different photosensors 35 are formed by distributing on an upper side and a lower side of the display area 10 is also exemplified. In this case, the output signals at different levels are outputted to the photosensor output signal lines 25 for the upper side and the lower side (the upper half of the display area and the lower half of the display area) of the screen. An adequate level determination is achieved by selection with the comparator circuits 155 having the different output signal levels.

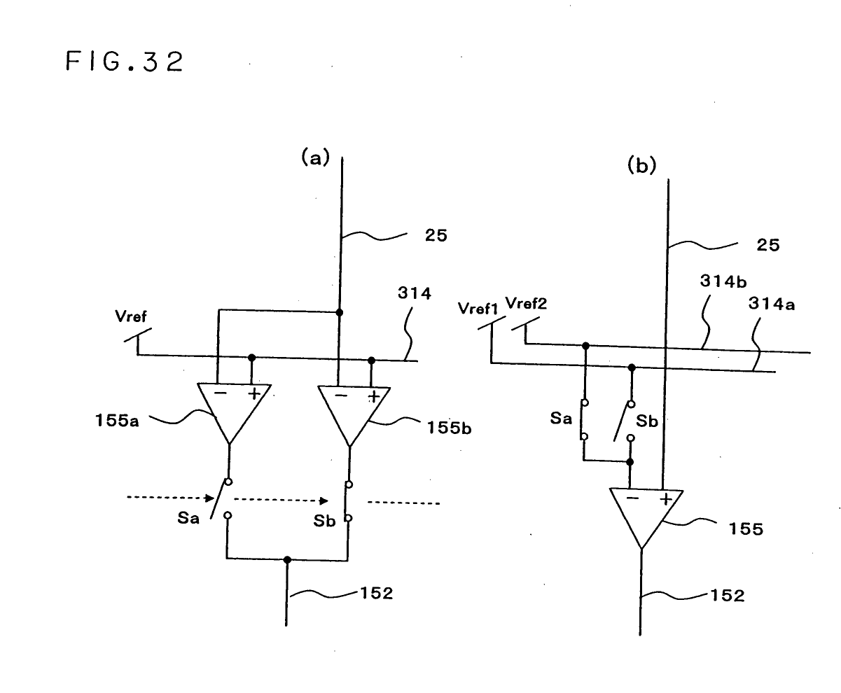

FIG. 32(a) shows a state in which two comparator circuits 155a, 155b are formed for one photosensor output signal line 25. Although the common comparator voltage Vref is applied to the two comparator circuits 155a, 155b, the invention is not limited thereto, and the comparator voltage Vref may be differentiated.

Which one of the two comparator circuits 155a and 155b is to be selected and outputted to the voltage output terminal 152 is selected by switches Sa, Sb. Control of the switches Sa and Sb are performed by the signal processing circuit 15. When the switch Sa is closed, an output of the comparator circuit 155a is outputted to the output terminal 152. When the switch Sb is closed, the output of the comparator circuit 155b is outputted to the output terminal 152.

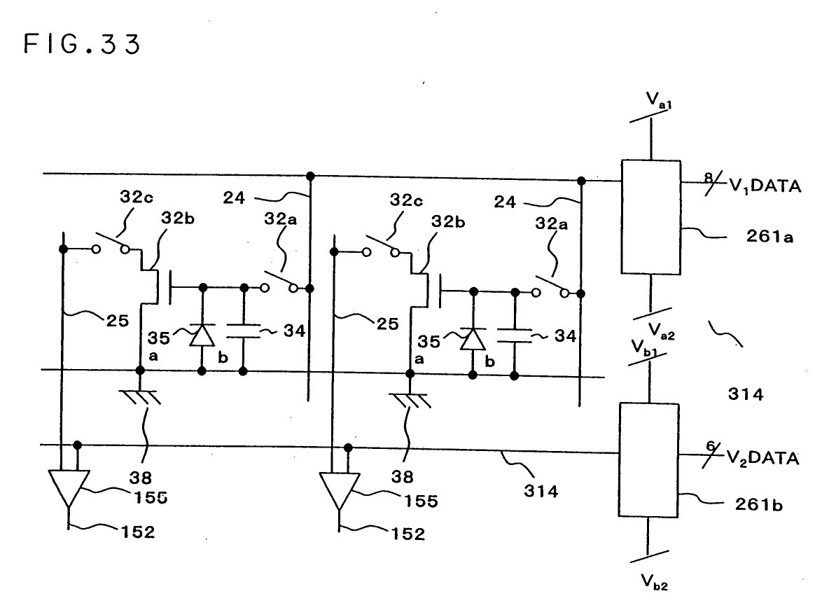

FIG. 32(b) shows a state in which one comparator circuit 155 is formed for each photosensor output signal line 25. The different point from FIG. 16 is that the two comparator voltages Vref can be selected. Comparator voltages Vref1, Vref2 are applied to the comparator signal lines 314a, 314b. The Vref voltage can be varied by an electronic volume 261b of 6 bits in 64 levels (see FIG. 33).

In FIG. 33, the Vref voltage to be applied to the comparator signal line 314 can be varied in 6 bits (64 levels) by the electronic volume 261b. The Vref voltage can be adjusted to obtain an adequate value corresponding to the characteristics of the photosensor 35, the transistor 32b and so on. The optimal Vref voltage can be applied to the comparator circuit 155 in a blink by the selection with the switches Sa, Sb.

The Vref voltage applied to the comparator circuit 155 and the voltage of the photosensor output signal line 25 are compared and the output voltage is outputted to the output terminal 152. Which one of the two Vref voltages is selected is selected by the sensor processing circuit 15. When the switch Sa is closed, the Vref1 voltage is applied to the comparator circuit 155. When the switch Sb is closed, the Vref2 voltage is applied to the comparator circuit 155.

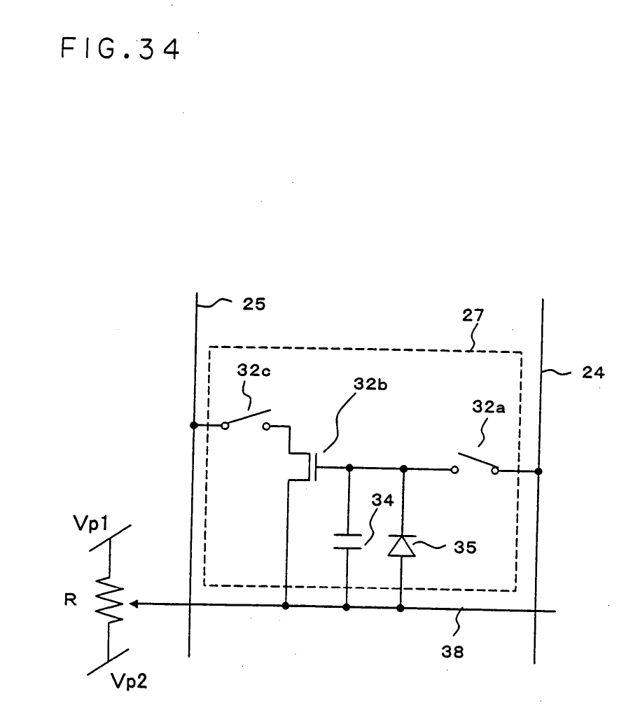

FIG. 34 is an embodiment showing a configuration in which the potential of the common signal line 38 can be varied. Although it is configured to adjust the potential by a volume circuit of R in FIG. 34, the invention is not limited thereto, and a configuration to adjust or vary the same by the electronic volume 261.

In the embodiment shown above, the Vref voltage is varied by the electronic volume 261. However, the precharge signal Vp may also be varied by the electronic volume. For example, as shown in FIG. 33, it is configured in such a manner that the precharge signal Vp of 8 bits (256 levels) can be applied to the precharge signal line 24 by the electronic volume 261a.

The precharge signal Vp gives finer adjustment (better accuracy) than the comparator voltage. In the present invention, the precharge signal Vp is 8 bits, and the comparator voltage is 6 bits. The comparator voltage Vref is a comparative voltage, and hence accuracy is not required. However, the precharge signal Vp requires fine adjustment or setting according to the sensitivity of the photosensor 35 and the exposure time Tc.

### [A-3] Third Embodiment

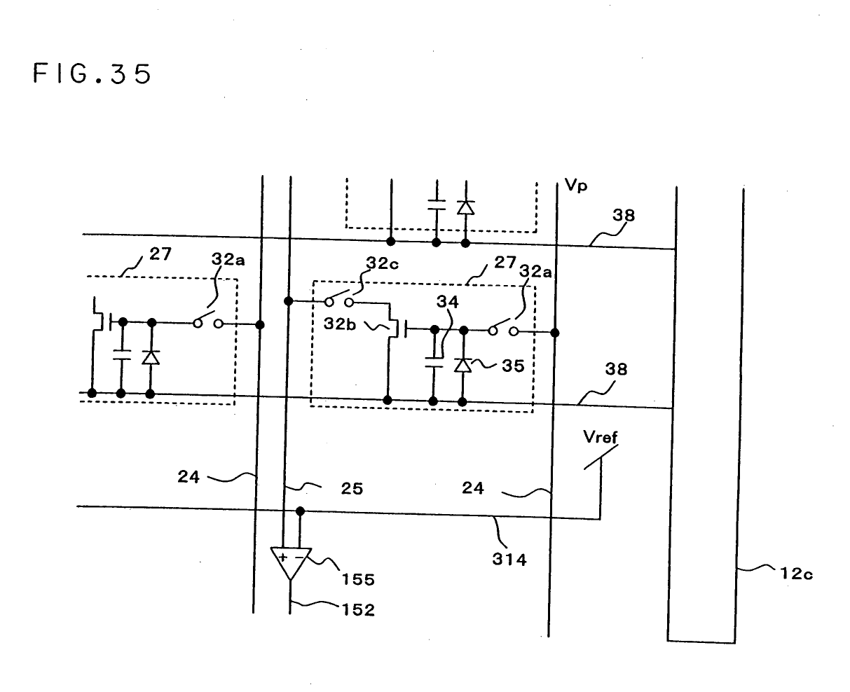

In the embodiment shown above, the potential of one of the photosensor 35 is the GND (ground potential or a predetermined fixed potential). However, the present invention is not limited thereto. For example, as shown in FIG. 35, the common signal line 38 may be connected to the gate drive circuit 12c and varied or modified. For example, the potential of the common signal line 38 may be varied according to the polarity (see FIG. 18) of the picture signal outputted from the source driver circuit 14. It is because the picture signal applied to the source signal line 23 is coupled to the photosensor output signal line 25 and varies the output. By varying the potential of the common signal line 38 synchronously with or homologizing with the polarity of the picture signal, the effect of the coupling can be alleviated or eliminated.

As an example, it is assumed that the potential of the common signal line 38 is Vc1 when the polarity of the picture signal is positive, and the potential of the common signal line 38 is Vc2 when the polarity of the picture signal is negative. When the potential is set to the common signal line 38 as described above, Vc1 and Vc2 of the potential of the common signal line 38 are set (applied) repeatedly at every pixel rows. Even when the characteristics of the photosensor 35 are the same as the characteristics of the transistor 32b, the Vt voltage of the transistor 32b can be valued relatively by varying the potential of the common signal line 38. It is because the GND potential of the photosensor 35 or the like varies. Therefore, by applying a plurality of the potentials of the common signal line 38 of the formed photosensor 35 or the like, the same state as providing a photosensor having a plurality of sensitivities against outside light is achieved.

In the description in conjunction with FIG. 33, the transistor 32b and the photosensor 35 have the same potential (Vr). However, the present invention is not limited thereto. For example, it is also possible to set the terminal a of the transistor 32b to the potential Vr1 and the terminal b of the photosensor 35 to Vr2 differently. When the potential of Vr2 is higher than Vr1, the same effect as the case in which Vt of the transistor 32b is relatively higher is achieved. Therefore, even when the formed photosensors 35 or the like have the same characteristics, the same effect as forming the photosensors having different sensitivities against outside light is achieved. A configuration such that the potential Vr1 is fixed, and the Vr2 is supplied from the common signal line 38, and the common signal line 38 is driven by the gate driver 12c is also applicable.

The number of the potential to be outputted by the gate driver circuit 12c is not limited to the plural number. For example, a configuration in which a voltage to be applied to the common signal line 38 is a single voltage, and the single voltage is varied with the characteristics of the photosensor 35, the exposure time Tc and the characteristics of the transistor 32b is also applicable. Other configurations are the same as or similar to FIG. 3, the description will be omitted.

(1) Relation Between Exposure Time Tc and Precharge Signal Vp

In the respective embodiments described above, the sensitivity against outside light is mainly adjusted by varying the precharge signal Vp. The sensitivity against the exposure time Tc is also adjusted by varying the precharge signal Vp.

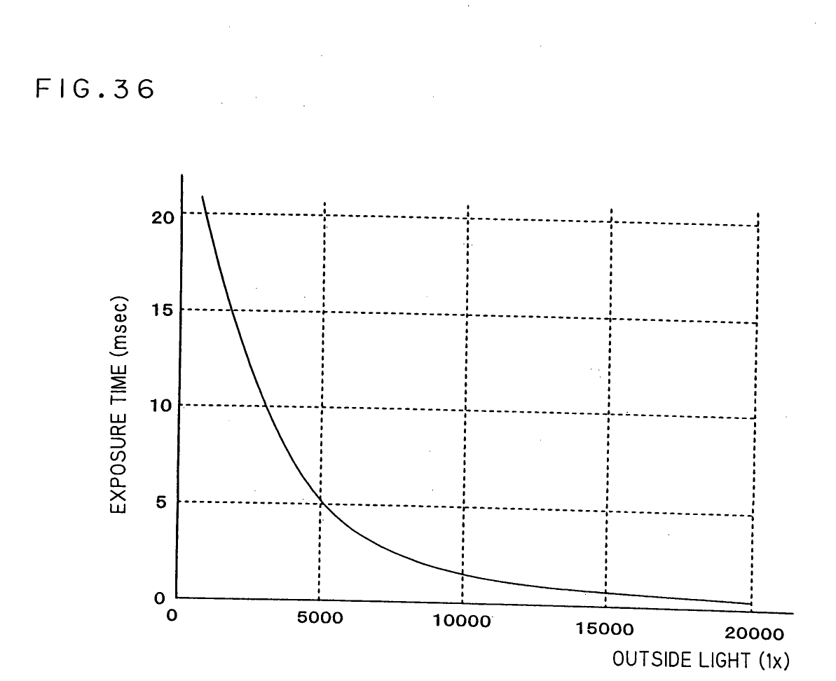

FIG. 36 is an explanatory drawing. The amount of leak of the photosensor 35 increases with increase of intensity of outside light. The electric charge is discharged substantially in proportional to the exposure time Tc. Assuming that the precharge signal Vp at a constant voltage is applied, in order to adjust the gate terminal voltage of the transistor 32b to be approximately Vt, the exposure time Tc is shortened when the outside light to the photosensor 35 is strong and the exposure time Tc is elongated when the outside light to the photosensor 35 is weak. This relation is shown in FIG. 36. Therefore, when the outside light is very strong, the exposure time Tc is extremely shortened. When the sensitivity of the photosensor 35 is very good against the outside light, the exposure time Tc is shortened.

There is a case in which the gate terminal voltage of the transistor 32b soon reaches a value lower than the Vt voltage even though the exposure time Tc is shortened, and hence a change signal to the photosensor output signal line 25 cannot be determined, for example, in a cate in which an outputs from the transistors 32b over the entire screen are outputted as the OFF-state. In other words, it is a state in which the output from the display panel of the present invention cannot acquire the identical picked up data.

In this case, the precharge signal Vp is set to a high value by the electronic volume 261a. By setting the precharge signal Vp voltage at the high level, the time required for reaching the Vt voltage of the transistor 32b is increased, and hence the picked up data (picked up image data, a shadow of a substance, etc.) can be acquired.

There is a case in which the gate terminal voltage of the transistor 32b is far from a value lower than the Vt voltage even when the exposure time Tc is elongated, and hence the change signal to the photosensor output signal line 25 cannot be determined, for example, in a case in which the outputs of the transistors 32b over the entire screen are outputted as the ON-state. In other words, it is a state in which the output from the display panel of the present invention cannot acquire the identical picked up data. In this case, the precharge signal Vp is set to a low value by the electric volume 261a.

By setting the precharge signal Vp voltage to a low value, the time required for reaching Vt voltage of the transistor 32b is shortened, and hence the picked up data (picked up image data, the shadow of the substance, etc.) can be acquired. The exposure time Tc is set to a value within one field (one frame) to obtain a preferable result. It seems to be because it is hardly be affected by the coupling from the source signal line 23 to which the picture signal is applied. It is because the polarity of the picture data is inverted for each one field (one frame) and the potential of the photosensor 35 is fluctuated by the effect of the inversion.

As described above, the present invention is characterized in that the picked up data is acquired by adjusting or setting the exposure time Tc (control of the gate driver circuit 12b) and the precharge signal Vp. It is also characterized in that the comparator voltage Vref is basically set to a fixed value.

(2) Matrix Processing

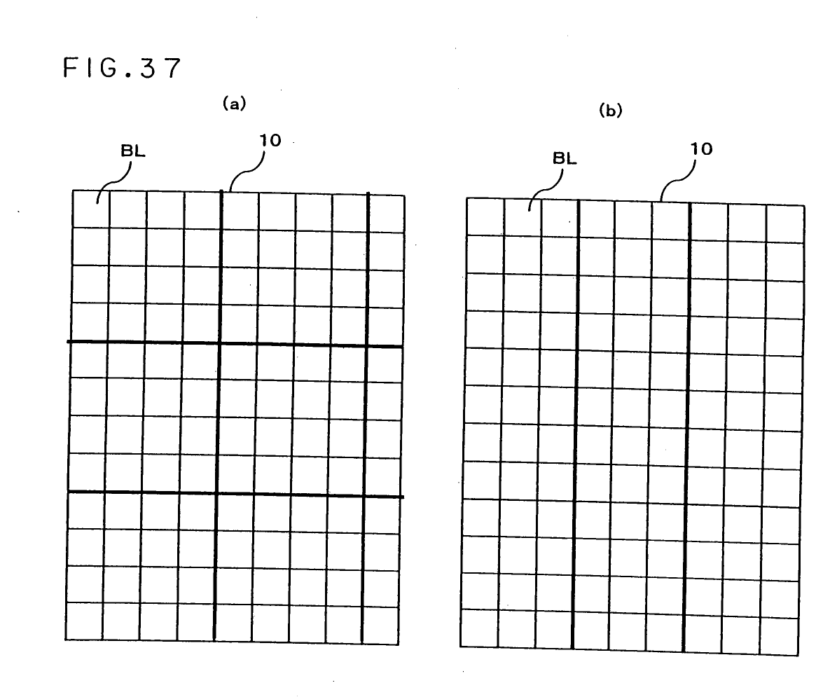

The photosensor 35 is formed in the same process as the pixel 26. A process used for forming the photosensor 35 is the polysilicon technology. In the polysilicon technology, the semiconductor film is formed by a laser anneal technology. Therefore, the characteristics thereof vary significantly due to a temperature distribution of a laser beam. In the present invention, in order to cope with this problem, a matrix processing is performed as shown in FIG. 37.

In the matrix processing, the outputs of the photosensor pixels 27 in a matrix are counted, and a signal processing is performed according to a counted value. As shown in FIG. 33, the invention is binarized by the comparator circuit 155 or the like.

In the laser anneal method, the characteristics of the transistors 32b and the photosensors 35 assume a characteristic distribution inclined from one direction of the display area to the other direction. In order to compensate this characteristic distribution, uniform outside light is irradiated on the area in which the photosensors 35 are formed, the exposure time Tc and the precharge signal Vp are set to constant values respectively, and the outputs of the transistors 32b are counted and added for each matrix.

The output from the voltage output terminal 152 is assumed to be converted to the binary data (ON (1), OFF (0)) by the comparator circuit 155. For example, in the matrix of 10×10, the counted values fall within a range from 0 to 100. The counted values (the counted values after calibration) are compiled and stored for each photosensor 35 in the matrix.

The data picked up by the display device in the present invention is processed by the same matrix segmentation, and the above-described counted value after calibration is subtracted from the counted value after processing at a constant rate. Since the characteristic distribution of the photosensors 35 or the like is already subtracted in the obtained data, a preferable picked up data can be obtained.

As described above, the data after having performed subtraction, the effects of the distribution of the photosensors 35 and the transistors 32b are eliminated or alleviated. Variations in the small area due to the characteristic distribution are averaged as a consequence of the matrix processing and handling of the output data of the matrix as one datum. Therefore, it is not affected by variations in characteristics of the photosensors 35 and the transistors 32b. For example, even when a small number of transistors 32b which are low in laser shot and high in Vt voltage are distributed in the matrix, there is no influence as a whole as long as the transistors 32b of other photosensor pixels 27 are favorable.

The segmentation in the matrix processing may be, for example, a matrix in a checkered pattern as shown in FIG. 37(a). FIG. 37(a) shows an implementation of a matrix processing of 4×4. In particular, the number of the photosensors 35 included in a block BL is preferably 25 or higher, such as 5×5. More preferably, it is 50 or higher, such as 8×8. Further preferably, it is 100 or higher, such as 10×10. However, the number of photosensors included in the matrix does not exceed 1000 such as 35×35.

In the above described embodiment, the matrix is segmented to n×n for processing. However, the concept of the matrix is not limited thereto. For example, as shown in FIG. 37(b), the BL is segmented in the vertical direction. This segmentation is also included in the technical scope of the matrix in the invention. In FIG. 37(b), segmentation is made by three pixel columns in a matrix manner. It is also possible to segment in the lateral direction (the direction of the pixel row) in a matrix manner.

When the signal processing is performed directly on the analogue data, or after converting the analogue data into multi-bit digital data as shown in FIG. 17 without using the comparator circuit 155, the analogue data is averaged (converted into DC) via a low-pass filter. It is also possible to process the digital data as data within the matrix range by means of addition.

### [A-4] Fourth Embodiment

Another pixel configuration will be described as a fourth embodiment below. Although the description will be made for the pixel configuration, the configuration, the system and the operation described in the embodiments above are applied to other configurations thereof.

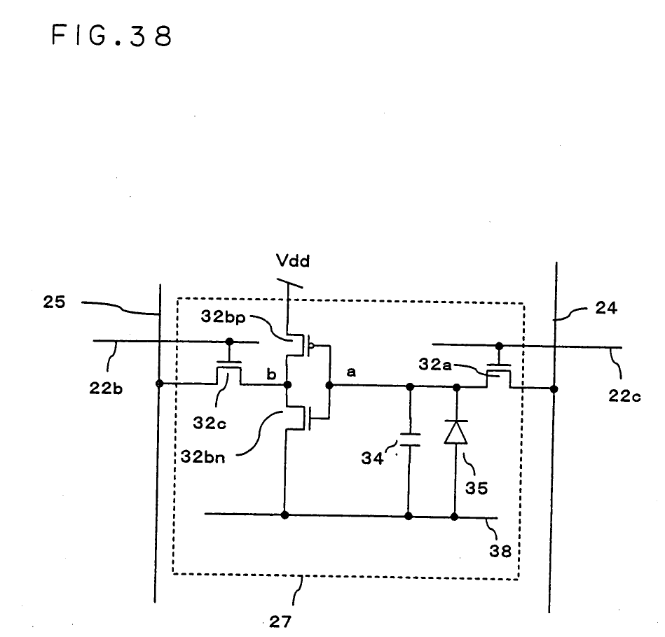

FIG. 38 is an equivalent circuit diagram of a pixel according to the fourth embodiment. The transistor 32b operated by the Vt voltage is composed of an N-channel transistor 32bn and a P-channel transistor 32bp. In other words, the transistor 32b is composed of a CMOS configuration of the P-channel and the N-channel. The P-channel transistor 32bp or the transistor 32bn are operated by the potential at a point a. When the transistor 32c is turned ON, the potential at a point b which is varied by the operation of the P-channel transistor 32bp or the N-channel transistor 32bn is outputted to the photosensor output signal line 25.

### [A-5] Fifth Embodiment

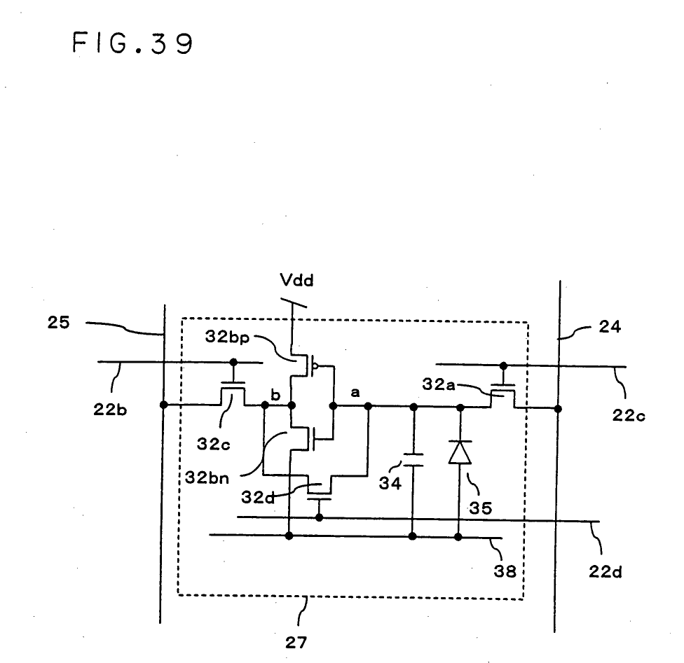

FIG. 39 shows an embodiment in which the transistor 32d that short-circuits an input a and an input b in an inverter circuit composed of the transistor 32bp and the transistor 32bn are formed. The gate terminal of the transistor 32d is connected to the gate signal line 22d. When an ON-voltage is applied to the gate signal line 22d, the transistor 32d is closed, and the input a and the output b of the inverter circuit are short-circuited.

An input terminal and an output terminal of the inverter circuit have an intermediate potential by the short-circuit. By causing the same to have the intermediate potential, an inverter offset state is achieved. Therefore, the possibility of being affected by variations in characteristics of the transistor 32bp and the transistor 32bn may be reduced.

Depending on the characteristics of the P-channel transistor 32bp and the transistor 32bn, a case in which both of the P-channel transistor 32bp and the N-channel transistor 32bn are operated is also included in the technical scope of the present invention. It is because there is no problem in a point in which the potential variation of b is outputted to the photosensor output signal line 25. Other configurations are the same as or similar to the above-described embodiment, description will be omitted.

### [A-6] Sixth Embodiment

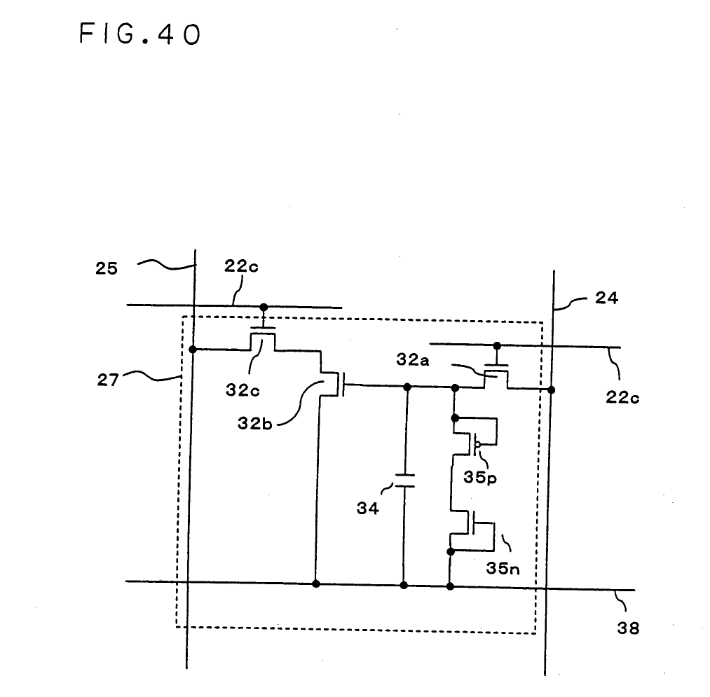

FIG. 40 shows a fifth embodiment in which the photosensor 35 is composed of the N-channel transistor 32bn and the P-channel transistor 32bp.

In other words, the photosensor 35 is composed of the diode-connected P-channel and N-channels transistors connected in series. Variations in characteristics of the P-channel transistor 35p and the transistor 35n are compensated, and the variations in characteristics are controlled as a whole.

In the configuration shown in FIG. 40, each one of the P-channel transistor 324p and the N-channel transistor 35n are provided. However, the present invention is not limited thereto, and a plurality of the N-channel transistors 35n and the P-channel transistors 35p may be formed or arranged.

It is also possible to configure the photosensor 35 of a plurality of the N-channel transistors 35n. Alternatively, it is possible to configure the photosensor 35 of a plurality of the P-channel transistors 35p. Other configurations are the same as or similar to the embodiments shown above, and hence description will be omitted.

### [A-7] Seventh Embodiment

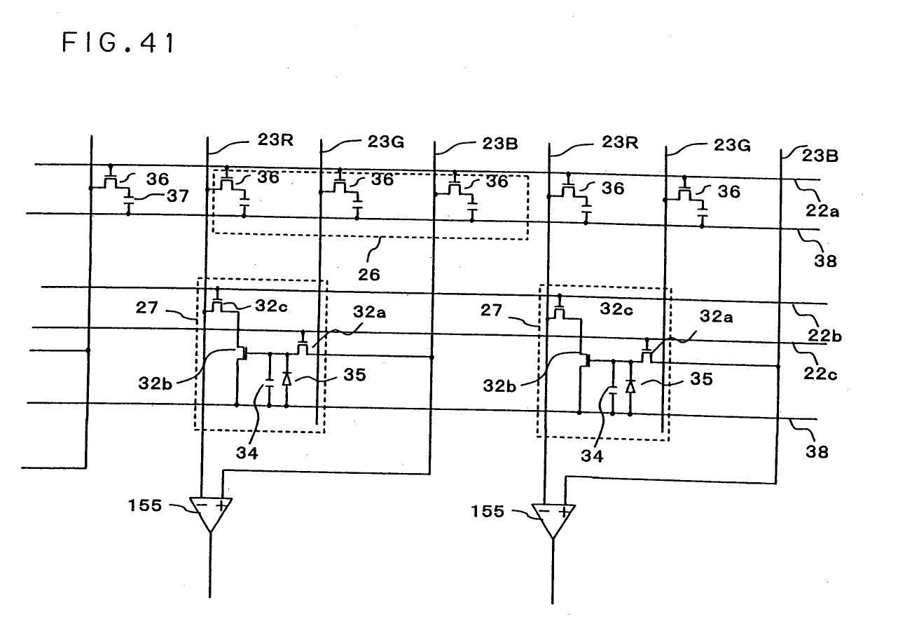

FIG. 41 shows a sixth embodiment in which the photosensor output signal line 25 is shared with the source signal line 23R for applying the R picture signal.

The R pictures signal and the output of the transistor 32c (output of the photosensor) are multiplied on the source signal line 23R. Selection of the gate signal line 22b is performed at timing when no picture signal is applied to the source signal line 23.

FIG. 41 shows a configuration in which the precharge signal line 24 is shared with the source signal line 23B for applying the B picture. The precharge signal Vp and the B picture signal are multiplied on the source signal line 23B. Selection of the gate signal line 22c is performed at timing when no picture signal is applied to the source signal line 23. Other configurations are the same as or similar to the embodiments describe above, and hence description will be omitted.

### [A-8] Modification

(1) First Modification

In the description of the above-described embodiment, the photosensor output signal line 25 is shared with the source signal line 23R for applying the R picture. However, the present invention is not limited thereto.

For example, the photosensor output signal line 25 may be shared with the source signal line 23G for applying the G picture. Alternatively, the photosensor output signal line 25 may be shared with the source signal line 23B for applying the B picture. In other words, the present invention is characterized in that the photosensor output signal line 25 is shared with other signal lines such as the picture signal lines, and the picture signal or the like and the output of the photosensor are multiplied to the shared signal line.

(2) Second Modification

In the description of above-described embodiment, the photosensor output signal line 25 and the source signal line 23 for applying the picture are shared. However, the present invention is not limited thereto, and for example, the photosensor output signal line 25 may be shared with the common signal line 38 or the like.

(3) Third Modification

FIG. 9 shows the embodiment in which the fifth embodiment and an embodiment shown in FIG. 35 are combined.

(4) Fourth Modification

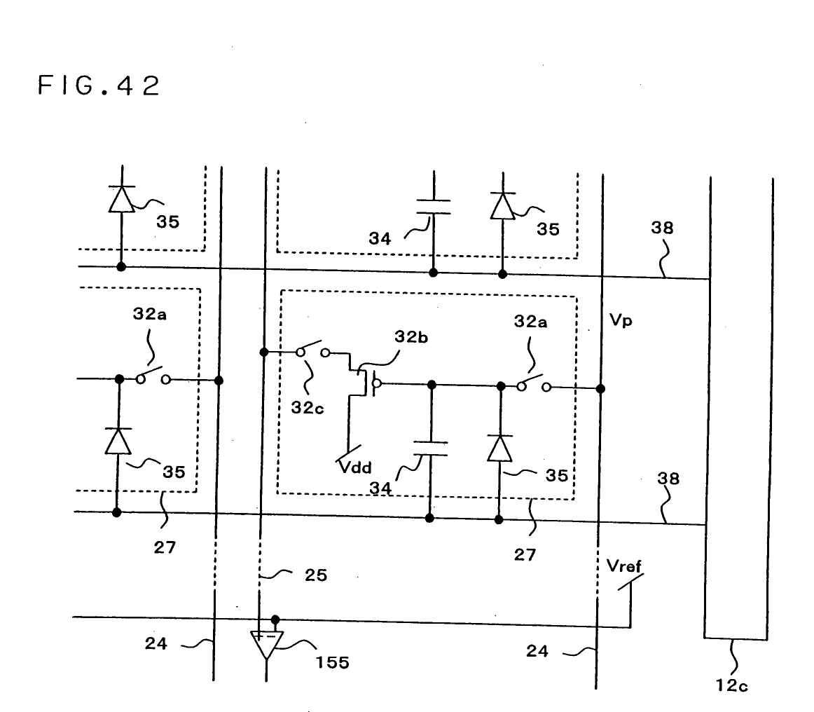

FIG. 42 is an embodiment in which the transistor 32b is composed of the P-channel transistor. One terminal of the transistor 32b is connected to a plus side power source Vdd, and the other end is connected to the transistor 32c. Other configuration is the same as the embodiments shown in FIG. 35 and in FIG. 9, description will be omitted.

(5) Fifth Modification

In the description of the above-described embodiment, the precharge signal line 24 is shared with the source signal line 23B for applying the B picture. However, the present invention is not limited thereto.

For example, the precharge signal line 24 may be shared with the source signal line 23G for applying the G picture. Alternatively, the precharge signal line 24 may be shared with the source signal line 23B for applying the B picture. In other words, the present invention is characterized in that the precharge signal line 24 is shared with other signal lines such as the picture signal lines, and the picture signal or the like and the precharge signal Vp are multiplied on the shared signal line.

(6) Sixth Modification

In the description of the above-described embodiment, the precharge signal line 24 is shared with the source signal line 23 for applying the picture. However, the present invention is not limited thereto, and for example, the precharge signal line 24 may be shared with the common signal line 38 or the like.

(7) Seventh Modification

The precharge signal line 24, the source signal line 23 for applying the picture signal and the photosensor output signal line 25 may be shared to multiply the picture signal, the precharge signal Vp and the output of the photosensor.

(8) Eighth Modification

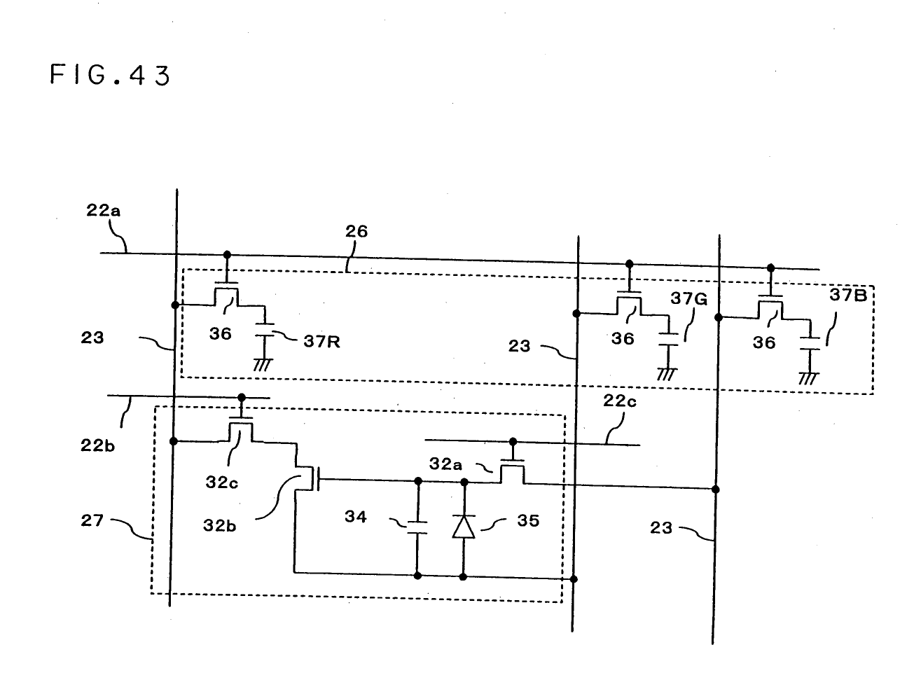

FIG. 43 shows a configuration in which the photosensor output signal line 25 is shard with the source signal line 23R for applying the R picture, the precharge signal line 24 is shared with the source signal line 23 for applying the picture, and the common signal line 38 of GND potential of the photosensor 35 is shared with the source signal line 23G for applying the G picture.

Since positive polarity and negative polarity of the picture signal to be applied to the source signal line 23 are applied alternately by 1H, even though the GND potential of the photosensor 35 is fluctuated, it is maintained at a fixed potential like the direct current (DC) potential in average.

The R picture signal and the output of the transistor 32c (output of the photosensor) are multiplied on the source signal line 23R. Selection of the gate signal line 22b is performed at timing where no picture signal is applied to the source signal line 23. It is a configuration in which the precharge signal line 24 is shared with the source signal line 23B for applying the B picture. The precharge signal Vp and the B picture signal are multiplied on the source signal line 23B. Selection of the gate signal line 22c is performed at timing where no picture signal is applied to the source signal line 23. Other configurations are the same as or similar to the embodiment described in FIG. 41, and hence description will be omitted.

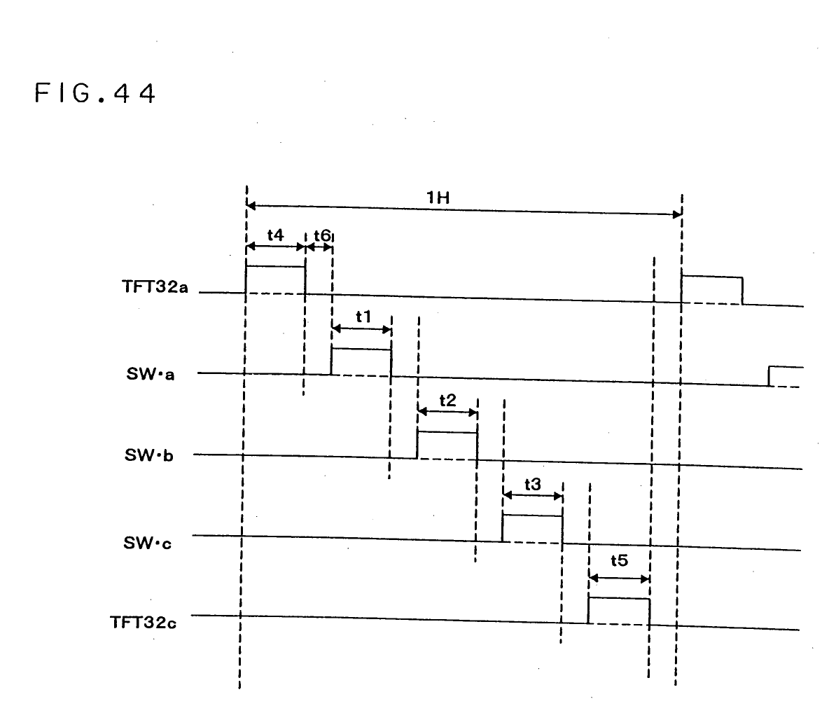

FIG. 44 is a timing chart in the pixel configuration shown in FIG. 43. In a first t4 period at the beginning of 1H, the gate signal line 22c is selected, the transistor 32a is tuned into the ON-state, and the precharge signal Vp is applied to the photosensor 35.

The next t1 period is a period in which the SW selects the terminal a and the R picture signal is outputted from the source driver circuit 14. The next t2 period is a period in which the SW of the switching circuit 172 selects the terminal b and the G picture signal is outputted from the source driver circuit 14. In the next t3 period, the SW of the switching circuit 172 selects the c terminal, and the B picture signal is outputted from the source driver circuit 14. Therefore, the B picture signal is applied to the B source signal line 23.

In the last timing in 1H, an ON-voltage is applied to the gate signal line 22b, the transistor 32c is turned ON, the transistor 32c of the photosensor pixel 27 is turned ON and the output of the transistor 32b is outputted to the photosensor output signal line 25.

By equalizing the periods of t1, t2, t3, t4 and t5, the circuit configuration of, for example, the photosensor processing circuit 18 can be facilitated. It is preferable to secure a period of t6 among the periods of t1, t2, t3, t4, t5. It is because the periods in which the respective switches SW, or the transistor 32 are changed from the ON-state to the OFF-state, that is, the switching periods are unstable.

(9) Ninth Modification

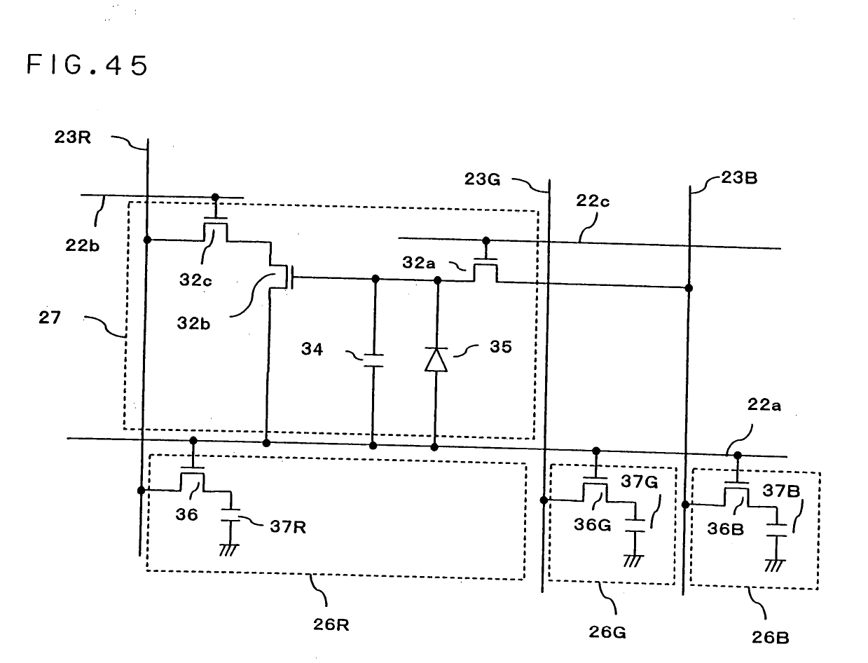

FIG. 45 shows a configuration in which the common signal line 38 is shared with the gate signal line 22a. An On-voltage is applied to the gate signal line 22a during a period of 1H per one field (one frame). During other periods, an OFF-voltage is applied. Therefore, the potential of the gate signal line 22a may be considered to be retained at a fixed potential.

As shown in FIG. 45, even though the common signal line 38 is shared with the gate signal line 22a, the photosensor 35 and the one terminal of the transistor 32b are in the GND grounded state. Therefore, it hardly affects the output of the photosensor due to the fluctuations in potential. However, it is necessary to perform a timing processing so that the gate signal line 22a, the gate signal line 22b and the gate signal line 22c are not selected simultaneously in the display pixel 26 and the pixel 16 having the photosensor pixel 27 or the pixels 16 located in the pixel rows adjacent to the pixel 16. Preferably, in the horizontal scanning period for more than 2H before and after the gate signal line 22a is selected in the pixel 16, the timing processing is performed so that the gate signal line 22b and the gate signal line 22c of the pixel 16 are not selected. Other configurations are the same as or similar to the embodiment described in FIG. 41, description will not be made.

The first to ninth embodiments described above are applied to other embodiments of the present invention. It can also be combined with other embodiments as a matter of course.

### [A-9] Eighth Embodiment

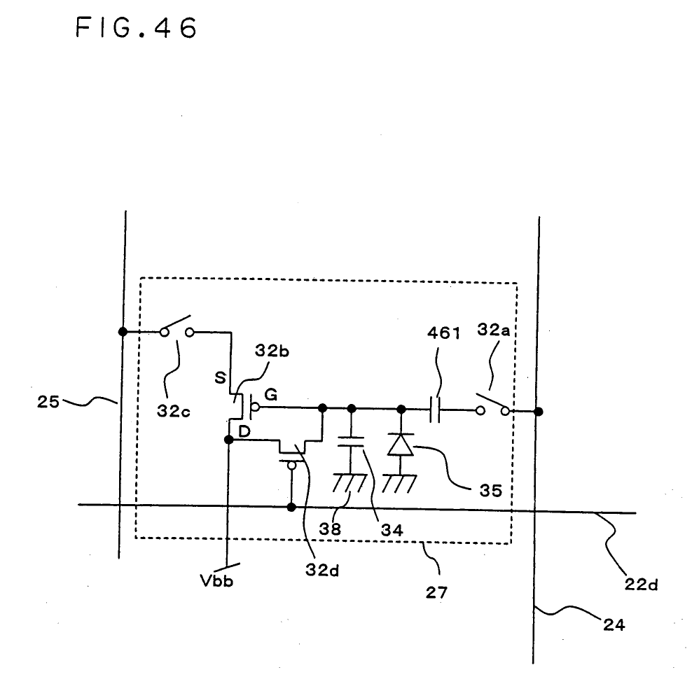

FIG. 46 is a pixel configuration for canceling an offset for compensating variations in characteristics of the transistor 32b.

By canceling the offset, the transistor 32b can be operated with reference to a cutoff voltage. Therefore, the variation in Vt of the transistor 32b can be compensated, and hence a stable output of the photosensor can be obtained. A drain terminal D of the transistor 32b is a Vbb voltage, and is separated from the common signal line 38 connected to the photosensor 35. The potential of Vbb voltage of the transistor 32b can be set or adjusted freely by separation, whereby resetting operation of the transistor 32b can be facilitated.

In FIG. 46, an ON-voltage is applied to the gate signal line 22d before applying the precharge signal Vp, and the transistor 32d is turned ON. When the transistor 32d is turned ON, between the drain terminal D and a gate terminal G of the transistor 32b is short-circuited. The transistor 32b is reset to the Vt voltage due to the short circuit between the gate terminal G and the drain terminal D. In other words, the voltage of the gate terminal G of the transistor 32b is set to a voltage at which a current starts to flow (basically to the Vt voltage). This voltage is referred to as V0. At this time, a predetermined potential V1 is applied to the precharge signal line.

The potential of the gate terminal G corresponds to the potential of the photosensor 35. Subsequently, an ON-voltage is applied to the gate signal line 22c, and the precharge signal Vp is applied to the precharge signal line 24. The transistor 32a is turned ON and the precharge signal Vp is applied to the photosensor 35 via a coupling capacitor 461. In other words, a voltage V2 added to the V0 voltage is applied to the gate terminal of the transistor 32b. The V2 voltage is basically relative to or proportional to the V1 voltage. The V1 becomes V2 voltage by being divided by the capacitor 461 and the capacitor 34.

From the above-described operation, the V2 voltage is applied to the gate terminal of the transistor 32b. The OFF voltage is applied to the gate signal line 22c. Therefore, the transistor 32a is turned OFF and the V2 voltage is retained at one terminal of the photosensor 35.

The following operation is the same as other embodiments. That is, leak occurs in the photosensor 35 due to outside light, and the V2 voltage is lowered. When the V2 voltage is lowered to a value lower than the Vt voltage of the transistor 32b, the transistor 32b is brought into the OFF-state. By turning the transistor 32c ON, the state of the transistor 32b is outputted to the photosensor output signal line 25.

(1) First Modification

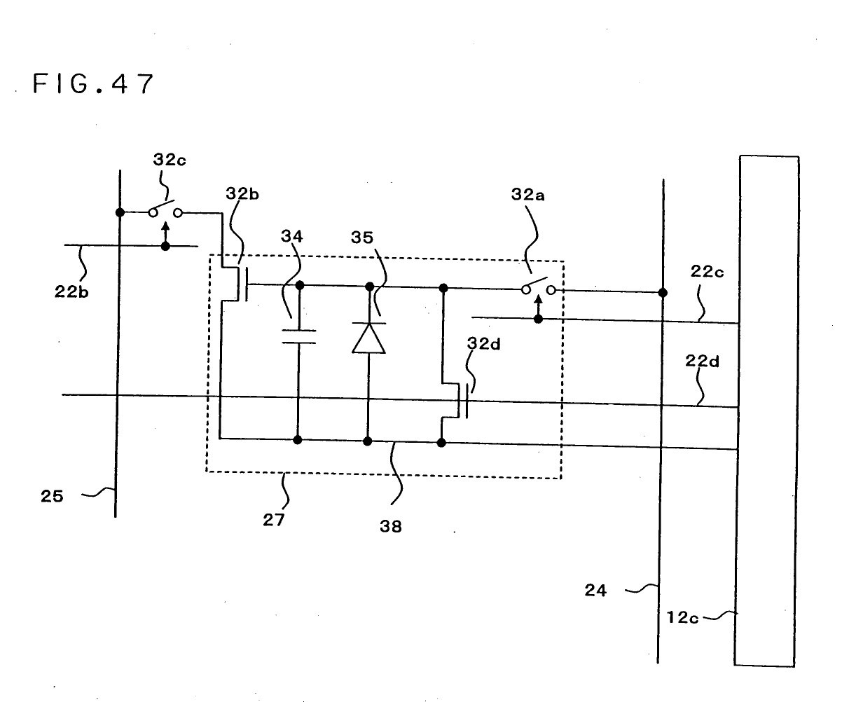

FIG. 47 shows a modification of FIG. 46. The drain terminal D of the transistor 32b is connected to the common signal line 38. The common signal line 38 is connected to the gate driver circuit 12c. Other configurations are the same as or similar to the embodiment described in FIG. 46, and hence description will be omitted.

(2) Second Modification

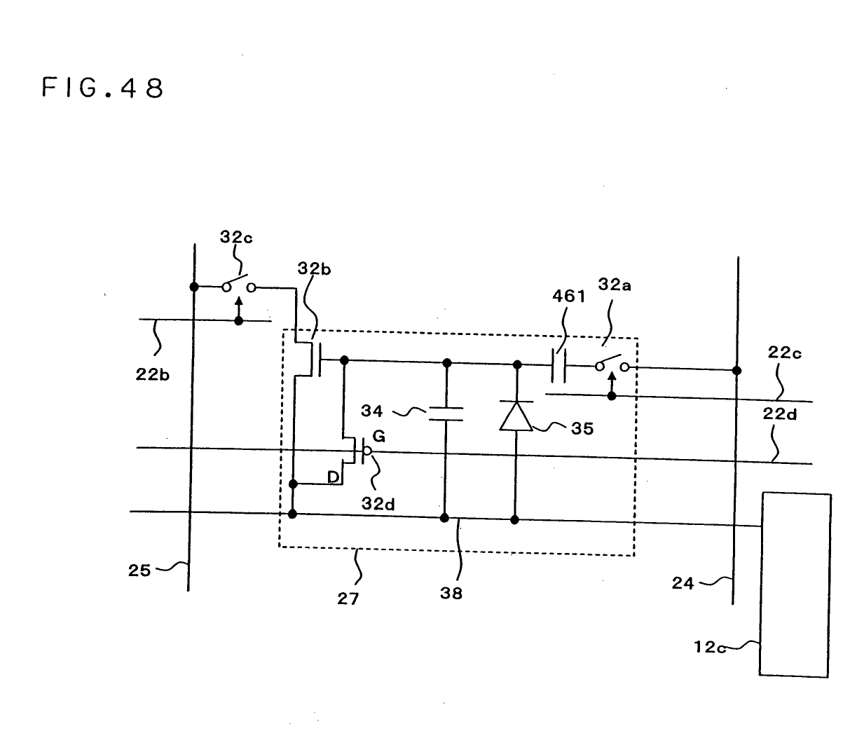

FIG. 48 shows a modification of FIG. 46. The transistor 32d is composed of the P-channel transistor. Other configurations are the same as or similar to the embodiment described in FIG. 46, description will be omitted.

(3) Third Modification

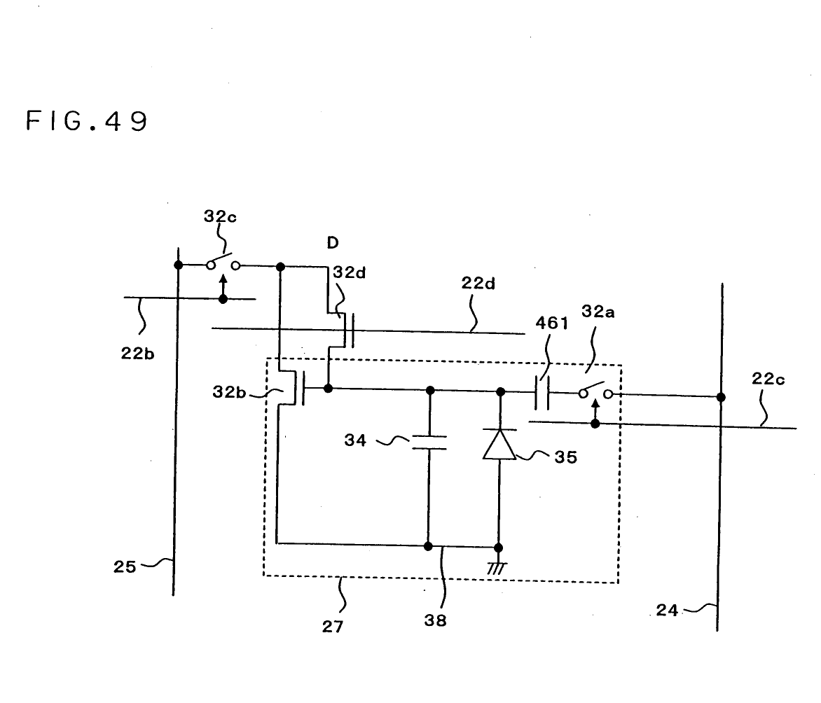

FIG. 49 shows a modification of FIG. 48. In FIG. 49, the transistor 32d for short-circuiting the gate terminal and the source terminal of the transistor 32b is arranged. The one terminal of the photosensor 35 is fixed to the predetermined potential (ground potential).

The first, second, and third modifications described above are applied to other embodiments of the present invention. It can also be combined with other embodiments, as a matter of course.

### [A-10] Ninth Embodiment

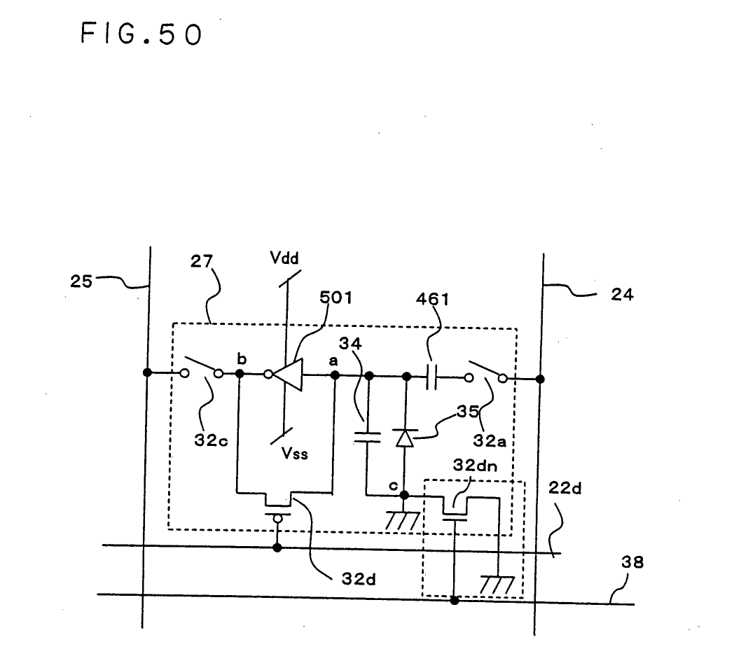

Subsequently, a ninth embodiment will be described. FIG. 50 shows the ninth embodiment in which the transistor 32b in FIG. 46 is replaced by an inverting circuit (inverter) 501.

FIG. 50 shows the embodiment in which an inverter offset cancelling circuit for compensating variations in characteristics of the transistor 32b of the photosensor pixel 27. By cancelling the offset, setting is achieved with reference to the cutoff voltage.

(1) Configuration of Inverting Circuit 501

The inverting circuit 501 is composed of the P-channel transistor and an N-channel transistor as shown in FIG. 38. Although the inverting circuit 501 is described to be operated by Vdd and Vss power sources, the invention is not limited thereto, and may be operated by the Vdd power source and the common signal line 38. It may also be operated at other potentials.

The P-channel transistor or the N-channel transistor of the inverting circuit 501 is operated by a potential of a point a of the inverting circuit 501 and is outputted to a point b. In other words, the voltage to be outputted to the point b varies with the potential at the point a. The voltage of the point b is outputted to the photosensor output signal line 25 by turning the transistor 32c ON.

(2) Contents of Operation

The gate signal line 22c is controlled by the gate driver circuit 12. The gate terminal of the P-channel transistor 32dp is connected to the gate signal line 22d. When an ON-voltage is applied to the gate signal line 22d, the P-channel transistor 32dp is turned ON (between the channels of the transistor 32dp is closed). When an OFF-voltage is applied to the gate signal line 22d, the P-channel transistor 32dp is turned OFF (between the channels of the transistor 32dp is opened).

When causing the inverting circuit 501 to perform the offset operation, an ON-voltage is applied to the gate signal line 22d, and the P-channel transistor 32dp is turned ON (between the channels of the transistor 32dp is closed). In other operating states, an OFF-voltage is applied to the gate signal line 22d, and the P-channel transistor 32dp is turned OFF (between the channels of the transistor 32dp is opened).

As described above, the transistor 32dp is operated by the ON-voltage applied to the gate signal line 22d. When the ON-voltage is applied to the transistor 32dp, the impedance between the channels is lowered, and hence between a terminal a and a terminal b of the inverting circuit 501 is brought into the short-circuited state. Therefore, the inverting circuit 501 is reset.

After the reset operation described above, an OFF-voltage of the gate signal line 22dp is applied. Then, between the channels of the transistor 32dp is opened by the application of the OFF-voltage, and hence the terminal a is separated from the terminal b.

In FIG. 50, an ON-voltage is applied to the gate signal line 22dp before applying the precharge signal Vp, and a transistor 63dp is turned ON. When the transistor 32dp is turned ON, between the drain terminal D and the gate terminal G of the transistor 32bp is short-circuited. The inverting circuit 501 is reset to the Vt voltage due to the short circuit between the gate terminal G and the drain terminal D. In other words, the inverting circuit 501 is set to a voltage at which a current starts to flow (basically to the Vt voltage). This voltage is referred to as the V0 voltage. At this time, the predetermined potential V1 is applied to the precharge signal line.

The potential of the gate terminal G corresponds to the potential of the photosensor 35. Subsequently, An ON-voltage can be applied to the gate signal line 22c, and the precharge signal Vp is applied to the precharge signal line 24. The transistor 32a is turned ON and the precharge signal Vp is applied to the photosensor 35 via the coupling capacitor 461. In other words, the voltage V2 added to the V0 voltage is applied to the gate terminal of the transistor 32b. The V2 voltage is basically relative to or proportional to the V1 voltage. The V1 is divided by the capacitor 461, the capacitor 34, and so on and becomes the V2 voltage.

From the operation described above, the V2 voltage is applied to the gate terminal of the transistor 32b. An OFF-voltage is applied to the gate signal line 22c. Therefore, the transistor 32a is turned OFF and the V2 voltage is retained at one terminal of the photosensor 35.

The operation from this on is the same as other embodiments. In other words, leak occurs in the photosensor 35 due to outside light and the V2 voltage is lowered. The V2 voltage reaches a voltage larger or smaller than the Vt voltage of the inverting circuit 501, the potential at the point b is varied accordingly. By turning the transistor 32c ON, the state of the transistor 32b is outputted to the photosensor output signal line 25. Other configurations are the same as or similar to the embodiments described above, and hence description will be omitted.

(3) First Modification

As a modification, a configuration in which the transistor 32dn shown in the drawing is added in a dotted line in FIG. 50 will be described. In this configuration, the GND terminal of the photosensor 35 is not necessary, because it is grounded to the GND by the transistor 32dn. The gate signal line 22c is controlled by the gate driver circuit 12.

The gate terminals of the P-channel transistor 32dp and the transistor 32dn are connected to the gate signal line 22d. When an ON-voltage is applied to the gate signal line 22d, the P-channel transistor 32dp is turned ON (between the channels of the transistor 32dp is closed), and the N-channel transistor 32dn is turned OFF (between the channels of the transistor 32dn is opened). When an OFF-voltage is applied to the gate signal line 22d, the N-channel transistor 32dn is turned ON (between the channels of the transistor 32dn is closed), and the P-channel transistor 32dp is turned OFF (between the channels of the transistor 32dp is opened). In other words, the P-channel transistor 32dp and the N-channel transistor 32dn are operated in the opposite ways.

When causing the inverting circuit 501 to perform offset operation, the ON-voltage is applied to the gate signal line 22d, and the P-channel transistor 32dp is turned ON (between the channels of the transistor 32dp is closed). At this time, the N-channel transistor 32dn is turned OFF (between the channels of the transistor 32dn is opened). In other operating states, the OFF-voltage is applied to the gate signal line 22d, and the N-channel transistor 32dn is turned ON (between the channels of the transistor 32dn is closed), and the P-channel transistor 32dp is turned OFF (between the channels of the transistor 32dp is opened).

As described above, the transistor 32dp, and the transistor 32dn are operated by the ON-voltage applied to the gate signal line 22d. The impedance between the channels of the transistor 32dp is lowered by the application of the ON-voltage, and between the terminal a and the terminal b of the inverting circuit 501 is brought into the short-circuited state. Therefore, the inverted circuit 501 is reset and between the both terminals of the photosensor 35 is also short-circuited, and the electric charge of the capacitor 34 is discharged.

After the resetting operation as described above, the OFF-voltage is applied to the gate signal line 22dp. Then, between the channels of the transistor 32dp is opened by the application of the OFF-voltage, and between the terminal a and the terminal b is disconnected. On the other hand, the transistor 32dn is brought into the ON-state, and the terminal c of the photosensor 35 is connected to the common signal line 38, and the potential of the common signal line 38 is applied. The impedance is lowered, and between the terminal a and the terminal b of the inverting circuit 501 is brought into the short-circuited state. Therefore, the inverting circuit 501 is reset, and between the both terminals of the photosensor 35 is short-circuited, and the electric charge of the capacitor 34 is discharged.

Other configurations are the same as or similar to the embodiment described above, description will be omitted.

(4) Second Modification

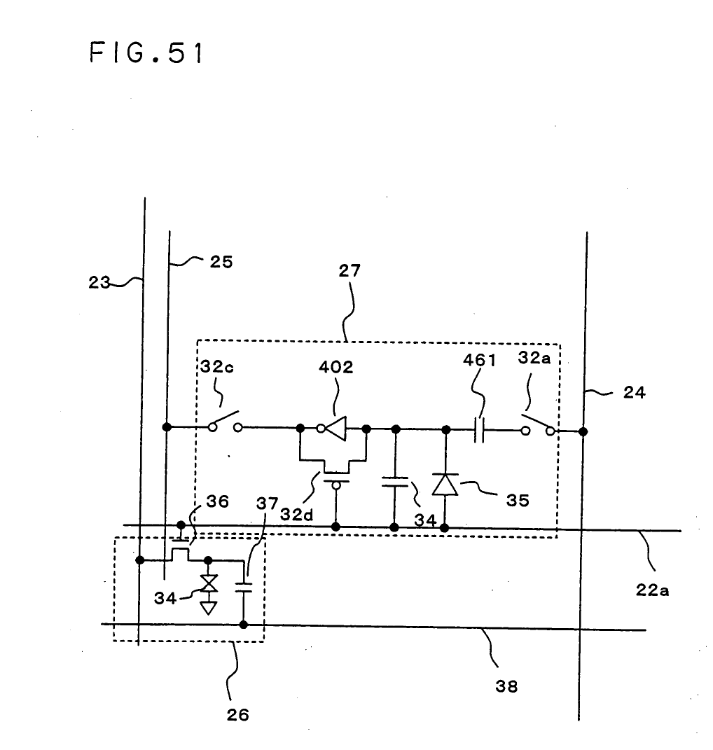

As in FIG. 45, FIG. 51 shows a modification in which the common signal line 38 is shared with the gate signal line 22a in the inverter offset circuit in FIG. 50.

Other configurations are the same as or similar to the embodiment described above, description will be omitted.

(5) Third Modification

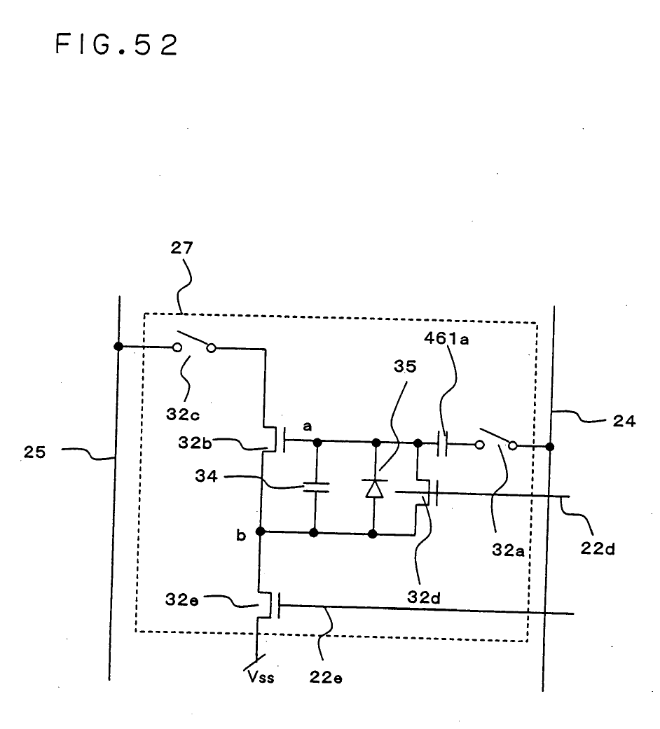

FIG. 52 shows a third modification of the offset canceling circuit. In FIG. 52, an ON-voltage is applied to the gate signal line 22e before applying the precharge signal Vp to turn the transistor 32e ON. The transistor 32e discharge electric charge at the point b.

Subsequently the ON-voltage is applied to the gate signal line 22d. When the transistor 32d is turned ON, between the drain terminal D and the gate terminal G of the transistor 32b is short-circuited. By short-circuit of the gate terminal G and the drain terminal D, the transistor 32b is reset to the Vt voltage. In other words, the voltage of the gate terminal G of the transistor 32b is set to a voltage at which a current starts to flow (basically to the Vt voltage). This voltage is referred to as V0. At this time, the predetermined potential V1 is applied to the precharge signal line.

The potential of the gate terminal G is the potential of the photosensor 35. Subsequently, an ON-voltage is applied to the gate signal line 22c and the precharge signal Vp is applied to the precharge signal line 24. The transistor 32a is turned ON and the precharge signal Vp is applied to the photosensor 35 via the coupling capacitor 461. In other words, the voltage V2 added to the V0 voltage is applied to the gate terminal of the transistor 32b. The V2 voltage is basically relative to or proportional to the V1 voltage. The V1 becomes the V2 voltage by being divided by the capacitor 461 and the capacitor 34.

From the above-described operation, the V2 voltage is applied to the gate terminal of the transistor 32b. The OFF-voltage is applied to the gate signal lien 22c. Therefore, the transistor 32a is turned OFF and the V2 voltage is retained at one terminal of the photosensor 35. The following operation is the same as other embodiments. That is, leak occurs in the photosensor 35 due to outside light, and the V2 voltage is lowered. When the V2 voltage is lowered to a value lower than the Vt voltage of the transistor 32b, the transistor 32b is brought into the OFF-state. By turning the transistor 32c ON, the state of the transistor 32b is outputted to the photosensor output signal line 25. Other configurations are the same as or similar to the embodiment described above, and hence description will be omitted.

The first, second and third modifications are applied to embodiments in the present invention. It can also be combined with other embodiments as a matter of course.

### [A-11] Tenth Embodiment

Intensity of outside light is a wide range from 1 lux to 100000 lux. The photosensor 35 is formed on the array substrate 11. The sensitivity of the photosensor 35 is determined by the size of the photosensor and the characteristics of the semiconductor film. Therefore, in order to accommodate the outside light in a wide range, the exposure time Tc and the precharge signal Vp are adjusted. In the present invention, a pixel configuration for accommodating a wider range of outside light will be described.

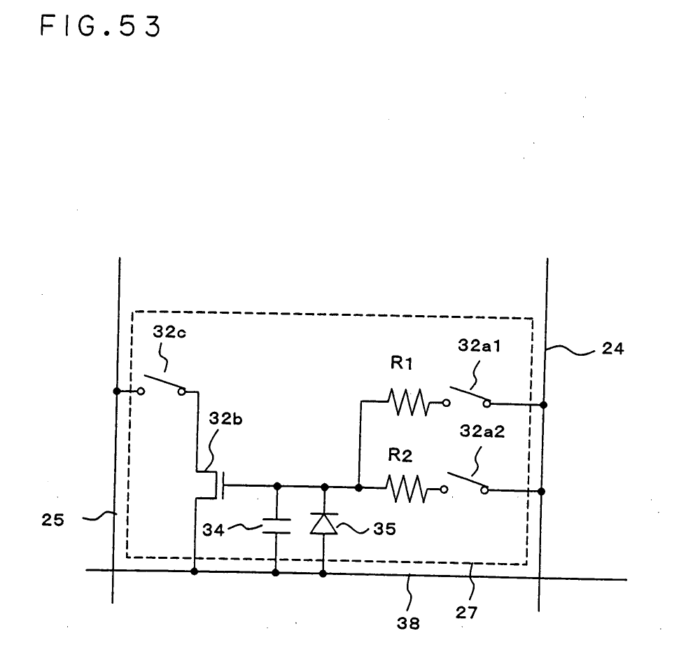

In the ninth embodiment shown in FIG. 53, a plurality of the transistors 32a that apply the precharge signal Vp are formed.

The transistors 32a are formed with a resistor R in series. The resistors R are formed of diffused resisters. The transistor 32a1 is formed with the resistor R1 in series, and the transistor 32a2 is formed with the resistor R2 in series. Even when timing to turn the transistor 32a1 and the transistor 32a2 ON, the precharge signal Vp that is written in the photosensor 35 is decreased with increase in impedances of the resistors R (R1, R2). Therefore, by differentiating the values of resistance of R1, R2, a precharge signal Vp when the transistor 32a1 is turned ON and a precharge signal Vp when the transistor 32a2 is turned ON can be differentiated. Therefore, the required exposure time Tc can be varied by the precharge signal Vp. Therefore, the range of sensitivity against outside light can be enlarged according to the configuration shown in FIG. 53.

(1) First Modification

By differentiating an ON-voltage to be applied to a gate terminal of the transistor 32a1 and an ON-voltage to be applied to a gate terminal of the transistor 32a2, the values of resistance of R1 and R2 can be differentiated equivalently.

For example, when the transistor 32a is the N-channel, the impedance between the channels is lowered with increase in the ON-voltage to be applied (the resistor R is lowered). When the ON-voltage to be applied is closer to the Vt voltage, the impedance between the channels of the transistor 32a is increased (the resistor R is increased). This case is realized easily by forming the gate signal lines 22c for driving the transistor 32a1 separately from the one for driving the transistor 32a2.

(2) Second Modification

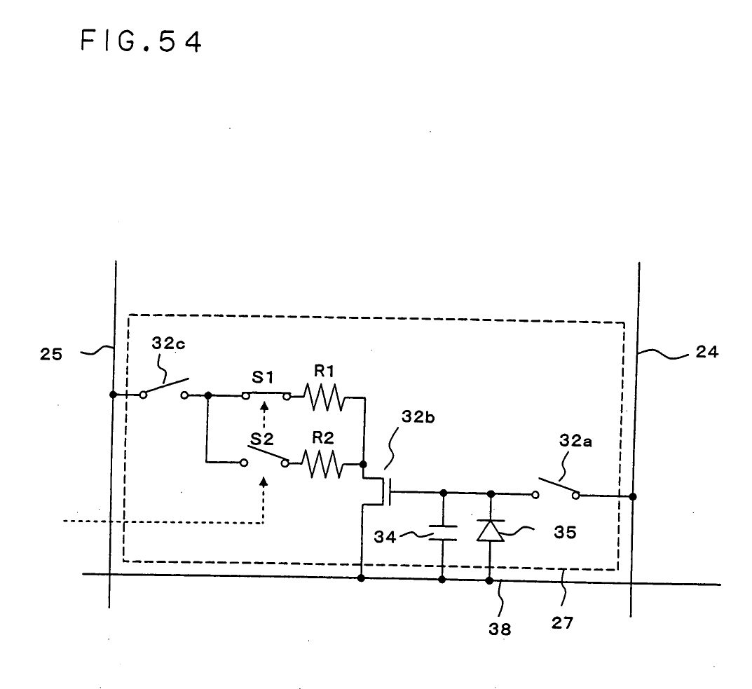

The embodiment shown in FIG. 53 has a configuration in which the plurality of transistors 32a are formed to make the precharge signal Vp variable. However, it is also possible to form a switch separately from the transistor 32a. For example, in FIG. 54, switches S1, S2 are formed.

(3) Third Modification

FIG. 54 shows an embodiment in which the switches S1, S2 are formed in addition to the transistor 32c, and the resistors R1, R2 are formed.

The resistor R1 is connected in series with the transistor 32c by the selection with the switch S1. The resistor R2 is connected in series with the transistor 32c by the selection with the switch S2. Even though the timing to turn the transistor 32c ON is the same, an electric charge outputted to the photosensor output signal line 25 is decreased with increase in impedances of the resistors R (R1, R2). Therefore, by differentiating the values of the resistance of R1 and R2, the outputs when the transistor 32c is turned ON can be differentiated. Therefore, the range of sensitivity against outside light can be enlarged in the configuration shown in FIG. 53. Other configurations are the same as the one in FIG. 53, description will be omitted.

The first, second and third modifications are applied to embodiments in the present invention. It can also be combined with other embodiments as a matter of course.

### [A-12] Eleventh Embodiment

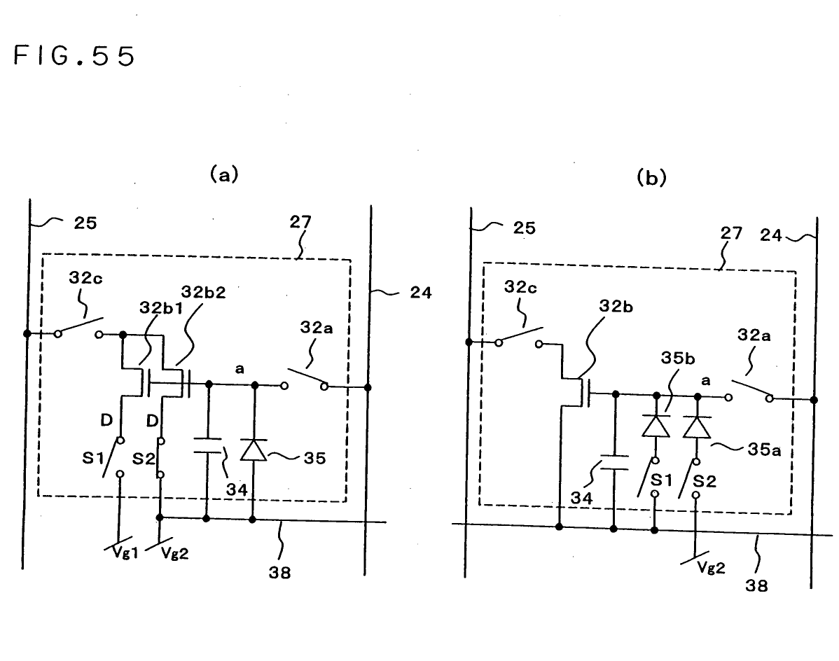

As shown in FIG. 55(a), by forming a plurality of the transistors 32b and differentiating a WL ratio (ratio between a channel width W and a channel length L) of the transistor 32b, the Vt voltage of the transistor 32b can be differentiated. Intensity of outside light can be known relatively when the Vt voltage is different and the transistor 32b being operated can be detected.

For example, it is assumed that the Vt voltage of the transistor 32b1 is 1.5 V and the Vt voltage of the transistor 32b2 is 2.0 V. The exposure time Tc is assumed to be constant. When the terminal voltage at the point a of the photosensor 35 is lowered, and the voltage is lowered below 1.5 V, both of the transistor 32b1 and the transistor 32b2 are in the OFF-state. Therefore, the fact that the terminal voltage at a point a of the photosensor 35 is below 1.5 V can be detected, and hence it is known that the outside light is strong and the amount of leak of the photosensor 35 is significant. When the terminal voltage at the point a of the photosensor 35 is lowered, and the voltage is higher than 1.5 V and lower than 2.0 V, the transistor 32b1 is in the ON-state, and the transistor 32b2 is in the OFF-state.

Therefore, the fact that the terminal voltage at the point a of the photosensor 35 is higher than 1.5 V and lower than 2.0 V can be detected, and hence it is known that the outside light is relatively strong. When the terminal voltage at the point a of the photosensor 35 is lowered and the voltage is higher than 2.0 V, both of the transistor 32b1 and the transistor 32b2 are in the ON-state. Therefore, the fact that the terminal voltage at the point a of the photosensor 35 is higher than 2.0 V can be detected, and hence it is known that the outside light is weak and hence non or little leak occurs in the photosensor 35.

As shown in FIG. 55(a), even when the plurality of transistors 32b are formed and the characteristics of the plurality of transistors 32b are the same, by differentiating the voltage of the drain terminal D of the transistor 32b, the sensitivity against the terminal voltage of the photosensor 35 can be differentiated.

In FIG. 55(a), the voltage of the drain terminal D of the transistor 32b1 is represented by Vg1, and the voltage of the drain terminal D of the transistor 32b2 is represented by Vg2. Therefore, when which transistor 32b is operated can be detected, intensity of outside light can be relatively known. Selection of the transistors 32b is performed by the switches S (S1, S2).

For example, it is assumed that the voltage of the drain terminal D of the transistor 32b1 is 0V and the drain terminal D of the transistor 32b2 is −2.0 V. The exposure time Tc is assumed to be constant. When the terminal voltage at the point a of the photosensor 35 is lowered, the transistor 32b1 is turned OFF in advance of the transistor 32b2. When the outside light is strong and the voltage of the terminal a of the photosensor 35 is further lowered, both of the transistor 32b1 and the transistor 32b2 are turned OFF. When there is no outside light or the outside light is extremely low, both of the transistor 32b1 and the transistor 32b2 are maintained in the ON-state. Which transistor 32b is to be turned into the ON-state can be selected by switching the switch S (S1, S2).

(1) First Modification

In the above-described embodiment, the voltages of the drain terminals D of the transistors 32b are differentiated. Alternatively, as shown in FIG. 55(b), it can be realized by forming a plurality of the photosensors 35 and differentiating the terminal voltages thereof. The photosensors 35 are formed by diode-connecting the transistor.

Even when the plurality of photosensors 35 are formed and the characteristics of the plurality of photosensors 35 are the same, as shown in FIG. 55(b), the voltage at one terminal of the photosensor 35 is differentiated from the Vg2 voltage as the potential of the common signal line 38. By the selection with the switches S (S1, S2), a predetermined voltage is applied to one terminal of the photosensor 35. When the terminal voltages of the photosensors 35 are different, the amounts of retained electric charge are different, and hence the sensitivity with respect to the outside light can be differentiated. Therefore, if which photosensor is operated can be detected, intensity of the outside light can be relatively known. Selection of the photosensor 35 is performed by the switches S (S1, S2).

For example, it is assumed that the terminal voltage to be applied to the photosensor 35b is 0V and the teminal voltage to be applied to the photosensor 35a is −2.0 V. The exposure time Tc is assumed to be constant. The terminal voltage of the point a of the photosensors 35 (35a, 35b) is lowered by the outside light. The extent of lowering of the photosensor 35a is different from the one of the photosensor 35b. Selection may be achieved by the switches S1 and S2. Both of the photosensors, 35a, 35b can be selected as a matter of course.

(2) Second Modification

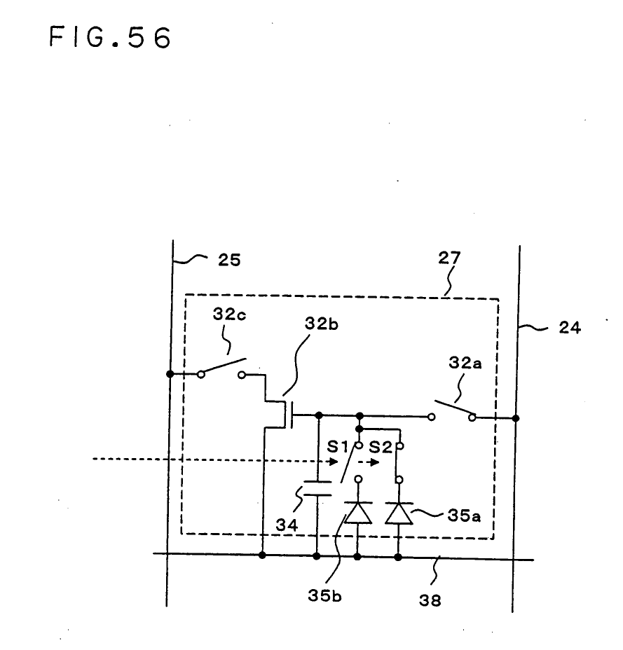

As shown in FIG. 56, the voltage at the one terminal of each of the photosensors 35a, 35b is set to the potential of the common signal line 38, and any one of the photosensors 35a, and the photosensor 35b can be selected by the switches S1, S2 as a matter of course. Leak characteristics of the photosensor 35a and the photosensor 35b are differentiated. In order to differentiate the leak characteristics, the WL (W: channel width, L: channel length) of the transistor that forms the photosensor 35 can be differentiated.

(3) Third Modification

As in the case of FIG. 53 and FIG. 54, the photosensor 35 may be formed with the resistors R in series. The resisters R are formed of diffused resisters. The resister 32a1 is formed with the resister R1 in series.

For example, the photosensor 35a is formed with the resistor R1, and the photosensor 35b is formed with the resistor R2 in series. Even though outside light irradiated on the photosensor 35a and the photosensor 35b is the same, and the characteristics of the photosensors 35a, 35b are substantially the same and the leak characteristics are the same, the amount of the electric charge discharged from the photosensor 35 per unit time varies more with increase in impedances of the resistors R (R1, R2). Therefore, by differentiating the values of resistance of R1 and R2, the terminal voltages of the photosensors 35a, 35b can be differentiated. Therefore, by the selection with the switches S1 and S2, the exposure time Tc can be varied. Therefore, the range of sensitivity against the outside light can be enlarged.

The photosensor 35 is composed of the diode-connected transistor. Therefore, by taking the gate terminal of this transistor out separately and adjusting the voltage to be applied to the gate terminal, the photosensor of different diode characteristics can be configured. The gate voltage is supplied by the volume circuit. Adjustment and setting can be achieved by the intensity of the outside light.

(4) Fourth Modification

The present invention may be combined with other embodiments. It is the same for embodiments in the present invention.

(5) Fifth Modification

The voltage to be applied to the common signal line 38 is not limited to the DC voltage, but may be the alternate voltage, or a rectangular voltage.

(6) Sixth Modification

By varying a level of the rectangular voltage or the like, the exposure time Tc of the photosensor 35 or the like can be adjusted. It can also be applied to other embodiments in the present invention. as a matter of course.

(7) Seventh Modification

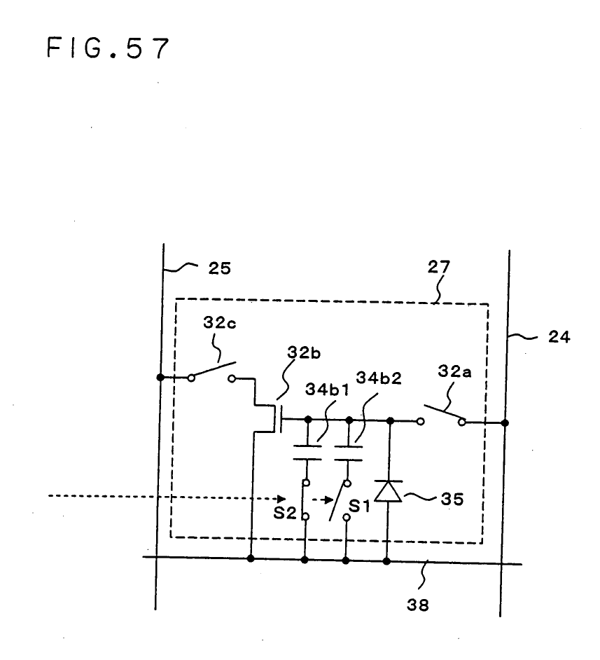

As shown in FIG. 57, it is also possible to form a plurality of the capacitors 34, set the voltage at one terminal of each of the capacitors 34 to the potential of the common signal line 38, and select any one of the capacitors 34 by the switches S1, S2. The potential variation at a point a is different depending on the capacity of the capacitor 34.

It is also possible to select both (a plurality) of the capacitors 34. Therefore, by the selection with the switches S1 and S2, the exposure time Tc can be varied. Therefore, the range of sensitivity against outside light can be widened.

(8) Eighth Modification

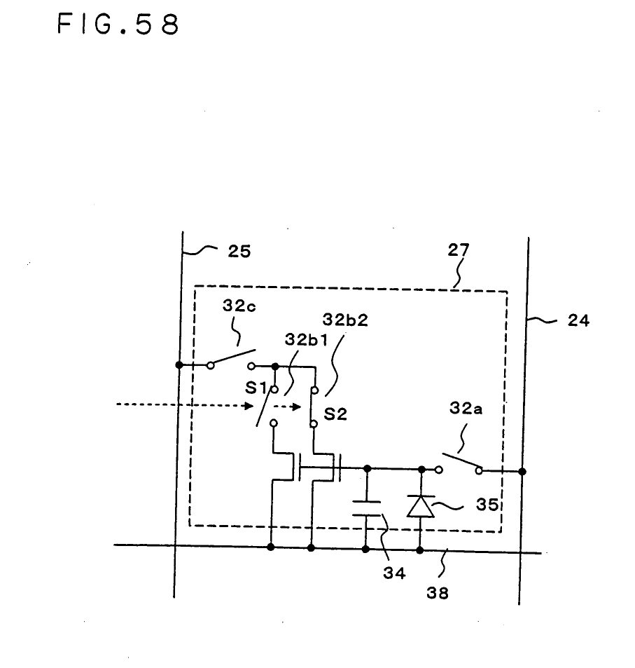

As shown in FIG. 58, it is also possible to form the plurality of transistors 32b (32b1, 32b2), and set the voltage at the one terminal of each of them to the potential of the common signal line 38, and select any one of the transistors 32b by the switches S1, S2.

The WL (W: channel width, L: channel length) of the transistor for forming the transistors 32b (32b1, 32b2) are varied. By the selection with the switches S1 and S2, the exposure time Tc can be varied. Therefore, the range of sensitivity against outside light can be enlarged.

The first to eighth modifications described above are applied to embodiments in the present invention. It can also be combined with other embodiments as a matter of course.

### [A-13] Twelfth Embodiment

FIG. 59 shows another embodiment of the present invention. FIG. 55, FIG. 56, FIG. 57, FIG. 58, FIG. 58 show configurations in which the precharge signal Vp is applied to the photosensor 35 or the like. The embodiment shown in FIG. 59 has a configuration in which a writing current is outputted from the source driver circuit 14 and the potential of the photosensor 35 is set with this current. In other words, it is an embodiment in which the potential of the photosensor pixel 27 is set by a current instead of the precharge signal Vp.

In FIG. 59, the switches SW1, SW2 are switches composed of transistors. The switch SW1 selects the source signal line 24 (a contact a) or a predetermined potential such as the ground potential (a contact b). The switch SW2 selects the photosensor output signal line 25 (the contact b) or a predetermined potential such as an anode voltage Vdd (the contact a). The capacitor 34 for retaining the electric charge and the photosensor 35 are connected to the gate terminal of the transistor 32b. One terminal of the capacitor 34 and the one terminal of the photosensor 35 are connected to the anode terminal Vdd. The transistor 32d is a switching transistor and short-circuits the gate terminal and the drain terminal of the transistor 32b.

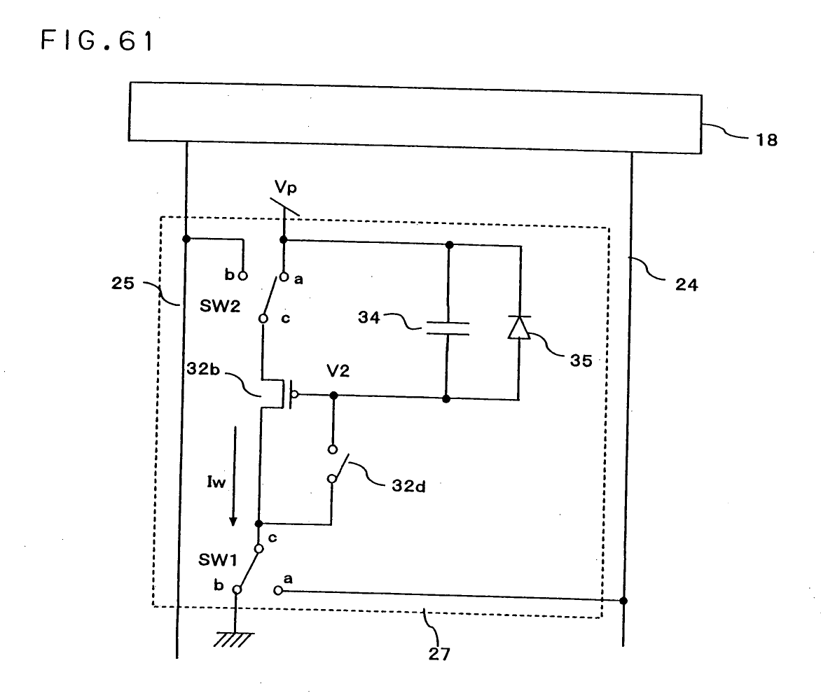

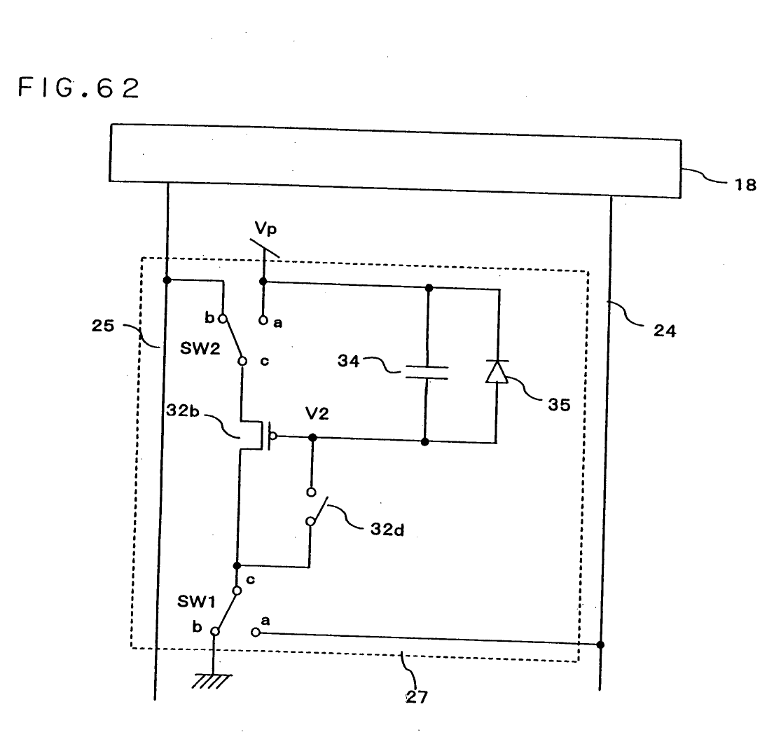

FIG. 60, FIG. 61 and FIG. 62 are explanatory drawings showing the operation of the mode shown in FIG. 59. FIG. 60 is the explanatory drawing showing the operation of setting the voltage V1 to the photosensor pixel 27 by the photosensor processing circuit 18.

The photosensor processing circuit 18 outputs a predetermined constant current. The magnitude of a constant current Iw can be varied. The current to be outputted is a sink current. That is, a current is flowed from the photosensor pixel 27 toward the photosensor processing circuit 18. However, it is applied only in the case in which the transistor 32b is the P-channel transistor. When the transistor 32b is the N-channel transistor, a direction of flow of the current is opposite.

The magnitude of the constant current is preferably higher than 0.1 μA and lower than 10 μA. When it is below 0.1 μA, it takes for a long time for a stationary current to flow to the transistor 32b due to a parasitic capacitance of the precharge signal line 24, and hence setting of the gate potential of the transistor 32b cannot be achieved within a predetermined time. On the other hand, when it is higher than 10 μA, the size of the transistor 32b becomes excessive, and hence a numerical aperture of the pixel 16 cannot be secured.

As shown in FIG. 60, when the switch SW1 selects the terminal b and the switch SW2 selects the terminal a, the constant current Iw flows from the transistor 32b to the photosensor processing circuit 18.

The transistor 32b varies the gate terminal potential to allow the constant current Iw to flow. It is assumed that the gate terminal potential of the transistor 32b is V1 in a state in which the constant current Iw flows in the transistor 32b.

In the pixel configuration described in conjunction with FIG. 14, a drive method to apply the constant precharge signal Vp irrespective of the characteristics of the transistor 32b is employed. Therefore, since the predetermined precharge signal Vp is applied irrespective of the characteristics of the transistor 32b, output to the photosensor output signal line 25 is fluctuated due to the characteristics of the transistor 32b.

In the configuration shown in FIG. 60, the values of the gate terminal potential V1 of the respective transistors 32b in which the constant current Iw flows are different depending on the characteristics of the transistor 32b. The value V1 reflects the characteristics of the transistor 32b. Therefore, even thought the characteristics of the transistor 32b of the respective photosensor pixels 27 are fluctuated, the output of the photosensor output signal line 25 becomes constant by setting the constant exposure time Tc.

When the constant current Iw is flowed in the photosensor pixel 27 shown in FIG. 60, and the gate terminal potential becomes V1 in the stationary state, the switch SW1 is switched to the terminal b as shown in FIG. 61. The transistor 32d is turned OFF (opened). In this operation, the voltage V1 applied to the transistor 32b is retained. Therefore, Vp voltage—V1 voltage is applied to the photosensor 35. The V1 voltage is a voltage at which the transistor 32b is turned ON. As described above, according to the present invention, the transistor 32b is turned into the ON-state by applying the constant current Iw.

When a light beam is irradiated on the photosensor 35, leak occurs in the photosensor 35. The gate terminal potential of the transistor 32b varies due to the leak of the photosensor 35. The larger the leak is, the closer to the Vp voltage the gate terminal potential of the transistor 32b becomes. When it becomes closer to the Vp voltage, the transistor 32b is turned OFF at a predetermined potential due to the characteristics of the transistor 32b.

Assuming that the gate terminal potential reaches V2 due to the leak, whether the transistor 32b is in the ON-state or in the OFF-state in the state in which the gate terminal voltage V2 is applied can be detected (determined) by switching the switch SW2 to the terminal b.

As shown in FIG. 62, the switch SW2 is switched to the terminal b. If the transistor 32b is in the ON-state, a current flows to the ground (at the predetermined potential) via the transistor 32b from the photosensor output signal line 25. Therefore, the input potential of the comparator circuit 155 varies, the varied potential and the Vref voltage are compared, and the output of the comparator circuit 155 is varied.

If the transistor 32b is in the OFF-state, even when the switch Sw2 selects the terminal b, no current is flowed from the photosensor output signal line 25 to the transistor 32b. Therefore, the input potential of the comparator circuit 155 does not vary, and the output from the comparator circuit 155 does not vary.

In the present invention, the setting of the potential of the photosensor 35 as described above may be achieved not only by the precharge signal Vp but also by the constant current Iw.

It can be applied to embodiments in the present invention, as a matter of course. It can also be combined with other embodiments as a matter of course.

### B. Operative Example of Plane Display Device

FIG. 65 is an explanatory drawing of the plane display device in which a display panel 658 in the present invention is employed. The display panel 658 includes the array substrate 11 described above. The drive method, the drive system, the configuration, and the control system of the present invention is applied to the array substrate 11 and the display panel 658.

The display panel 658 is formed by interposing the liquid crystal layer 653 between the array substrate 11 and the opposed substrate 654. The array substrate 11 is arranged on a side that receives incoming outside light for allowing the outside light to enter directly into the photosensor 35 formed on the array substrate 11.

When the pixels arranged or formed in a matrix manner are red (R), green (G), blue (B) and white (W), it is recommended to form the photosensor 35 on the white (W). It is because the amount of incident light to the photosensor 35 can be increased since the white pixel 16 is not formed with a color filter.

In this case, it is also possible to arrange the array substrate 14 at a position of the opposed substrate 654 in FIG. 65 and the opposed substrate 654 at a position of the array substrate 14 in FIG. 65. The white (W) pixel, being not formed with the color filter including a pigment or colorant, does not attenuate incident light. Therefore, even when outside light enters from the side of the opposed substrate 654 formed with the color filter, the outside light favorably reaches the photosensor 35.

The display panel 658 in the present invention is not limited to the display panel having the liquid crystal layer 653, and may be a display panel having an EL (organic EL, inorganic EL) layer. In other words, it may be an EL display panel formed with the EL layer on the pixel 16.

The liquid crystal layer may be any of TN (Twisted Nematic), IPS (In-Plane Switching), FLC (Ferroelectric Liquid Crystal), OCB (Optically Compensatory Bend), STN (Supper Twisted Nematic), VA (Vertically Aligned), ECB (Electrically Controlled Birefringence), Polymer Dispersion (PD) liquid crystal, HAN (Hybrid Aligned Nematic) modes. In particular, the OCB liquid crystal is preferably. The pixel of the display panel 658 may be any of micro reflective, reflective or semi-transmissive types.

Referring now to FIG. 65, the display panel 658 and the plane display device will be described.

(1) Configuration of Array Substrate 11

The array substrate 11 formed of glass or organic material is formed with the pixel electrodes 31 and so on. The glass substrate includes, for example, soda glass or quartz glass. The substrate formed of the organic material may be any of a plate shape or a film shape, and includes, for example, epoxy resin, polyimide resin, acrylic resin and polycarbonate resin. These substrates are formed by integral molding by application of pressure. The thickness of the substrate is between 0.2 mm to 0.8 mm inclusive. The array substrate 11 must simply have a light transmissive property. The opposed substrate 654 does not have to have the light transmissive property, and may be of metal substrate such as silicon or aluminum, and of colored plastic substrate.

The array substrate 11 and the opposed substrate 654 may be formed of sapphire glass for securing a heat discharging property. It is also formed of a substrate on which a diamond thin film is formed, a ceramic substrate such as alumina, or a metallic substrate of copper.

A surface of the array substrate 11 that comes into contact with air is formed with an antireflection coating (AIR coat). When a deflecting plate or the like is not adhered on the array substrate 11, the AIR coat is formed directly on the array substrate 11, and when other material such as the deflecting plate (deflecting film) or the like is adhered, the AIR coat is formed thereon. The AIR coat may be, for example, formed of a dielectric single layer film or multi-layer film. It is also possible to apply resin having a refractive coefficient as low as 1.35 to 1.45.

The AIR coat includes a three-layer configuration and a two-layer configuration. In order to prevent static charge on the liquid crystal display panel, it is preferable to apply hydrophilic resin on the surface of the display panel 21. An emboss processing may also be applicable in order to prevent surface reflection, or to make dirt such as fingerprints invisible.

(2) Color Filter, Deflection Plate, Phase film

A color filter is formed or provided on the display pixel 26. The color filter is formed on the opposed substrate 654.

The color filter includes a color filter formed of resin obtained by coloring gelatin or acryl, a color filter formed of optical dielectric multi-layer film, and a color filter formed of hologram. It is also possible directly tocolor the liquid crystal layer as a substitution.

One or a plurality of phase films (phase plate, phase rotational means, wave plate, or phase difference film) are arranged between the array substrate 11 and a deflecting plate 655. The phase film is preferably formed of polycarbonate. The phase film (not shown) contributes to generate a phase difference between incident light and outgoing light for achieving efficient light modulation.

The phase film may be formed of organic resin plate or organic resin film such as polyester resin, PVA resin, polysulphone resin, polyvinyl chloride resin, ZEONEX resin, acryl resin, polystyrene resin. Alternatively, crystal such as quartz crystal may be used. The phase difference of one phase plate 26 is preferably between 50 nm and 350 nm in an axial direction. More preferably, it is between 80 nm and 220 nm.

(3) Other Configurations

The array substrate 11 is formed with the pixels 16 (the display pixels 26 and the photosensor pixels 27) arranged in a matrix manner. The array substrate 11 and the opposed substrate 654 interpose sealing walls 652. The opposed substrate 654 is formed with opposed electrodes 657. The array substrate 11 is provided with the deflecting plate (deflecting film) 655a arranged thereon, and the opposed substrate 654 is formed with the deflecting plate 655b arranged thereon. As a light source of back light 656, a fluorescent tube, white LED, and LED of red (R), green (G) and blue (B) are used. A light beam 661 radiated (emitted) from the back light 656 enters from the side of the opposed substrate 654, modulated by the liquid crystal layer 653, and goes out from the side of the array substrate 11.

(4) Reading Operation

As shown in FIG. 66, when a finger or a substance 651 such as a image scanning object (image sheet) is arranged on the side of the array substrate 11, the light beam 661a emitted from part where the substance 651 does not exist passes therethrough. When there is the substance 651, it (the light beam 661b) is reflected from the substance 651. The reflected light beam 661b enters into the photosensor pixel 27 at a position B. The photosensor pixel 27 to which the light beam 661b enters leaks an electric charge corresponding to intensity of the light beam 661b and the exposure time Tc. The gate terminal voltage of the transistor 32b varies with the amount of leak of the electric charge, and the ON and OFF states of the transistor 32b is determined. The light beam reflected by the substance 651 includes strong parts and weak parts distributed therein, and hence the respective photosensor pixels 27 react depending on the strength, whereby an image distribution corresponding to the substance 651 can be formed.

This is an embodiment in which the light beam 661 from the back light (light generating means arranged on the display device 658) 656 is irradiated on the substance 651 to form the image distribution by the photosensor 35.

(5) Light Shielding Operation

FIG. 67 shows an operation in which the outside light 661a is shielded by the substance 651 and a shadow and an irradiated portion are formed by the photosensor 35 to form an image distribution of the shadow of the substance 651. The outside light 661 includes room light such as fluorescent lamp or sunlight.

As shown in FIG. 67, the outside light 661a at the portion where the substance 651 does not exist enters into the photosensor pixel 27. The photosensor 35 of the photosensor pixel 27 to which the outside light 661a enters leaks the electric charge corresponding to the intensity of the outside light 661a. In most cases, the photosensor pixel 27 to which the outside light 661a enters leaks the electric charge and the transistor 32b is brought into the OFF-state.

On the other hand, as shown in FIG. 67, the outside light 661a does not enter to a position where the substance 651 exists (shielded by the substance 651). Therefore, the outside light does not enter into the position B. Therefore, the photosensor 35 of the photosensor pixel 27 at the position B does not leak the electric charge in most cases. In most cases, the photosensor pixel 27 retains the electric charge and hence the transistor 32b is in the ON-state (it is applied only in the case in which the transistor 32b is the N-channel transistor, and it is opposite when the transistor 32b is the P-channel transistor). Therefore, the outside light 661a is shielded by the substrate 651, and the shadow and the irradiated portion can be formed by the photosensor 35, so that the image distribution of the shadow of the substrate 651 can be formed.

(6) Operation by Light Pen

FIG. 68 shows an operation in which the light beam 661b from the light generating means of a pen (light pen) 681 that emits a light beam is irradiated on the photosensor pixel 27, and the coordinate of a position where the light beam is irradiated is detected by the photosensor 35. As described above, the present invention may be a mode in which the light beam is irradiated by the light generating means 681 to cause the photosensor 35 to behave. Other configurations and operations are the same as the embodiments described above, and hence description will be omitted.

(7) Modification

In the present invention, the array substrate 11 is arranged on the side where the outside light (the outside light 661a in FIG. 67) enters. However, the invention is not limited thereto, and the opposed substrate 654 side may be arranged on the side where the outside light enters.

In the description of the present invention, calibration is performed according to the intensity of the outside light, and setting of the precharge signal Vp and setting of the exposure time Tc (FIG. 67). However, the present invention is not limited thereto, and the setting of the precharge signal Vp and the setting of the exposure time Tc may be performed according to the intensity of the light beam from the back light 656 as shown in FIG. 66. It is also possible to perform the setting of the precharge signal Vp and the setting of the exposure time Tc according to the intensity of the light beam from the light generating source 681 as shown in FIG. 68.

### C. Drive Method of Plane Display Device

Referring now to the drawings, a drive method of the plane display device will be described. In the embodiment shown below, the pixel 16 may have any configurations described above as a matter of course.

### [C-1] First Embodiment

(1) ON Output Area and Shadow

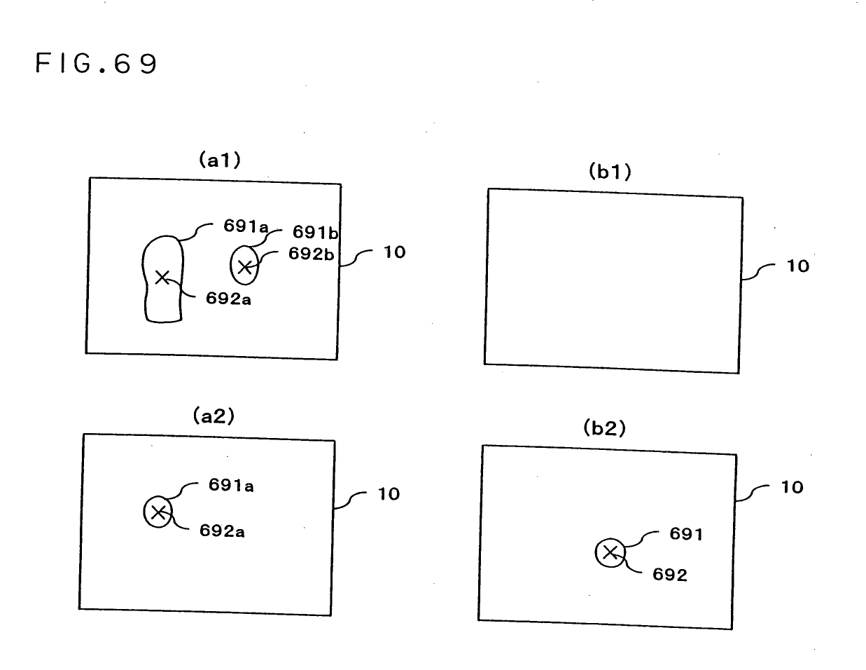

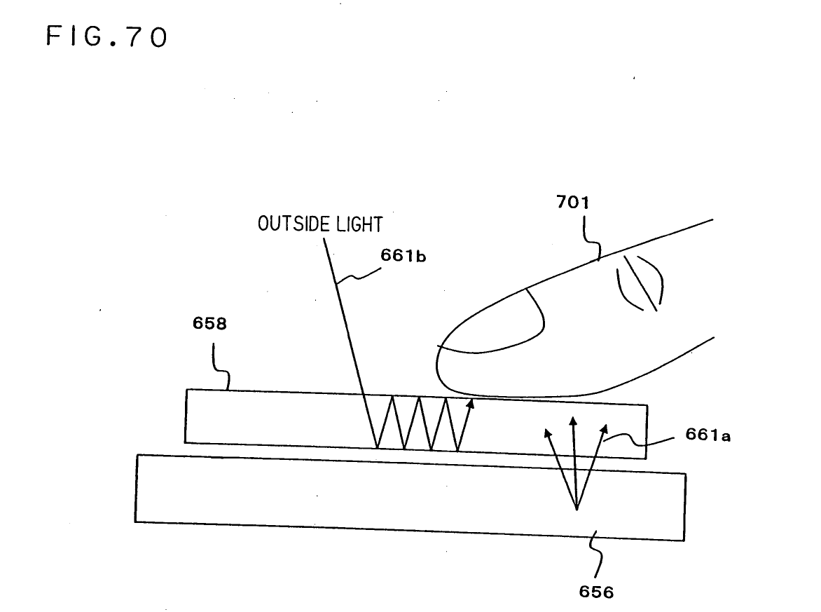

FIG. 69 shows a state in which the display area 10 (the area in which the photosensor pixels 27 are formed) is touched by a finger 701 as an object as shown in FIG. 70. FIG. 67 shows a state in which the outside light 661 is shielded by the finger 701 and a shadow of the finger is detected. In FIG. 69(a1), ON output areas 691a, 691b are generated. On the other hand, in FIG. 69(b1), the ON output area 691 is not generated at all.

The ON output area 691a in FIG. 69(a1) is the shadow of the objective finger 701. With the existence of the finger 701, an area on which the outside light 661 is irradiated and the area shielded by the finger 701 are generated in the display area 10 in which the photosensor pixels 27 are formed or arranged in a matrix manner. The transistor 32b of the photosensor pixel 27 in the shielded area is in the ON-state. This area corresponds to the ON output area 691.

In FIG. 69(a1), the finger 701 has a distribution of strong parts and weak parts of the outside light 661 and the ON output area 691b is generated. Since the ON output areas 691a, 691b have substantially circular shape, the ON output area 691a has a center coordinate 692a, and the ON output area 691b has a center coordinate 692b. The center coordinates 692 are obtained by approximating a contour of the ON output area 691 to a circle and finding a plurality of segments of diameter.

In the description of the present invention, the photosensor pixel 27 is kept in the ON-state by the shadow of the object 701, and the ON output area 691 is generated as an aggregation, and the center coordinates of the ON output areas 691 are obtained. However, the present invention is not limited thereto. When the transistor 32b of the photosensor pixel 27 is the P-channel transistor, the portion of the shadow of the object 701 is an aggregation of the photosensor pixels 27 in the OFF-state. Therefore, the processing is performed as the OFF output area 691. In the embodiments shown in FIG. 66 and FIG. 68, the operation is inverted. Even when the transistor 32b of the photosensor pixel 27 is the N-channel transistor, the peripheral portion of the ON output area 691 is the OFF output area. Therefore, by processing the OFF output area in the periphery thereof, the center coordinate of the object 701 and so on can be detected.

(1-1) ON Output Area and OFF Output Area in FIG. 66.

In FIG. 66, the light beam 661b emitted from the backlight 656 is reflected by the object 651, and the reflected light beam 661b is irradiated on the photosensor pixel 27. The precharge signal Vp is applied to the photosensor pixel 27 at constant cycles, and the transistor 32b is in the ON-state. The precharge signal Vp applied to the photosensor pixel 27 leaks the electric charge quickly every time when the reflected light beam from the object 651 is irradiated, and the transistor 32b is brought into the OFF-state. The area where there is no object 32b is maintained in the ON-state.

In the embodiment shown in FIG. 66, the OFF output area is apt to be generated below the object 651, and the ON output area is apt to generate in other areas. In FIG. 66, the color filter or the light shielding film is formed on the photosensor pixel 27 to shield the light beam emitted from the backlight 656 and entering directly into the photosensor pixel 27. Adequate generation of the ON output area and the OFF output area is adjusted by the precharge signal Vp and the exposure time Tc.

In the configuration shown in FIG. 66, it is also possible to arrange the array substrate 11 on the backlight 656 side, and arrange the opposed substrate 654 on the light outgoing side.

(1-2) ON Output Area and OFF Output Area in FIG. 67

In FIG. 67, the outside light 661a is shielded by the object 651 such as the finger. In other words, a shadow of the object 651 is generated under the object 651. The outside light 661a enters directly to the portion where the object 651 does not exist (display area 10).

The precharge signal Vp is applied to the photosensor pixel 27 at constant cycles, and the transistor 32b thereof is turned into the ON-state. The precharge signal Vp applied to the photosensor pixel 27 located in an area where the shadow of the object 651 is generated is preserved at a level higher than a certain threshold within a predetermined exposure time Tc. In the photosensor pixel 27 located in the area in which no object 661 exists and hence the outside light 661a is irradiated, the electric discharge is leaked quickly, so that the transistors 32b is turned into the OFF-state.

In the embodiment shown in FIG. 67, the ON output area is apt to be generated below the object 651, and the ON output area is hardly be generated in other areas. The area in which the outside light 661a directly enters into the photosensor pixel 27 becomes the OFF output area. In FIG. 67, the color filter or the light shielding film is formed on the side of the opposed substrate 654, and a light beam emitted from the back light 656 and entered directly into the photosensor pixel 27 is shielded. Adequate generation of the ON output area and the OFF output area is adjusted by the precharge signal Vp and the exposure time Tc.

(1-3) ON Output Area and OFF Output Area in FIG. 68

In FIG. 68, the light beam 661b is irradiated on the photosensor pixel 27 by the light pen 681. In the area where the light beam 661b is irradiated, the precharge signal Vp is quickly discharged and is brought into the OFF-state. It is little influenced by other outside lights.

The precharge signal Vp is applied to the photosensor pixel 27 at constant cycles and the transistor 32b is turned into the ON-state. The precharge signal Vp applied to the photosensor pixel 27 is preserved at a value higher than the certain threshold in the area on which the light beam from the light pen 681 is not irradiated within the predetermined exposure time Tc. The photosensor pixel 27 in the area on which the light beam 661b is irradiated leaks the electric charge quickly and turns the transistor 32b into the OFF-state.

In the embodiment shown in FIG. 68, the area on which the light beam from the light pen 681 is irradiated is turned into the OFF output area, and the OFF output area can hardly be generated in other areas. The area on which the light beam 661b is not irradiated is the ON output area. In FIG. 67, the color filter or the light shielding film is formed on the side of the opposed substrate 654, and shields the light beam entering into the photosensor pixel 27 directly from the backlight 656. Adequate generation of the ON output area and the OFF output area is adjusted by the precharge signal Vp and the exposure time Tc.

(1-4) ON Output and OFF Output Areas

As described above, this embodiment is described assuming that the ON output area 691 is generated by the shadow of the object 701 in order to facilitate the description. In the case of the reverse operation, the ON output area 691 is replaced by the OFF output area 691.

In the present invention, the position of the object 701 and the position of irradiation by the light pen 681 are detected by changing the ON and OFF states or maintaining the ON/OFF-state of the photosensor pixel 27 by shielding the outside light by the object 701 and by the reflection of alight beam from the object 701 or by the irradiation of the light beam on the photosensor pixel 27 by the light pen 681. As shown in FIG. 68, in the present invention, the position where the light beam is irradiated by the light pen 681 and the photosensor pixel 27 is turned into the OFF-state is detected.

(1-5) Rate of Number of ON Pixels

A rate of the number of the ON pixels (%) represents a rate of the number of photosensor pixels in the ON-state within a predetermined range. In contrast, a rate of the number of OFF pixels (%) represents a rate of the number of photosensor pixels in the OFF-state within the predetermined range. Although the rate of the number of the ON pixels (%) will be described in this specification, it may be replaced by the rate of the number of the OFF pixels (%) as a matter of course.

(2) Calibration

In the present invention, calibration is performed for defining one ON output area 691. In FIG. 69(a1), the precharge signal Vp is lowered. In the description below, it is assumed that the precharge signal Vp is varied. However, the present invention is not limited thereto. For example, in the embodiment shown in FIG. 59, the constant current Iw is varied and set.

The exposure time Tc is maintained at a constant value (predetermined value). The precharge signal Vp varies by the electronic volume 261a. The varied precharge signal Vp is outputted from the photosensor processing circuit 18. The precharge signal Vp is varied by a constant amount such as 0.1 V. The rate of variation is determined from the surface area of the ON output area 691.

The meaning of the surface area is equivalent to, similar to or corresonds to the number of the ON pixels, or the rate of the number of the ON pixels (%) (the number of the OFF pixels, or the rate of the number of the OFF pixels (%)).

The number of steps of variation of the precharge signal Vp is at least 64 steps. The maximum value of the precharge signal Vp is 5(V), and the variable range is at least 1V. When the ON output area 691 is large, the width of variation of the precharge signal Vp to be changed at once is increased. When the ON output area 691 is small, the width of variation of the precharge signal Vp to be changed at once is decreased.

The surface area of the ON output area 691 is the number of the transistors 32b of the photosensor pixels 27 in the display area 10 in the ON-state. In other words, the surface area of the ON output area 691 can be obtained by counting the number of the transistors 32b of the photosensor pixels 27 in the display area 10 in the ON-state. It is easy to count the number of the transistors 32b, because it can be achieved by counting the outputs of the comparator circuits 155 of the respective photosensor output signal lines 25.

(3) Data Formation by Comparator Circuit 155

The present invention is characterized in that the output of the data signal applied to the photosensor output signal line 25 is binarized by the comparator circuit 155, the counting of the number can be achieved easily. It is possible to arrange an OP amplifier instead of the comparator circuit 155, process the analogue data directly, and form or generate the ON output area 691. It is also possible to convert the analogue data into multi-level digital data by the AD converting circuit 171 to generate the ON output area 691 as described in conjunction with FIG. 17.

In the present invention, for example, FIG. 69 shows as if the ON output area 691 is displayed in the display area 10. It is for facilitating description. The display area 10 shown in FIG. 69 means a data array in which the outputs of the photosensor pixels 27 are arranged in a matrix manner and processed. By describing the data array as the display area 10, the state of the shadow or the state of occurrence can easily be understood.

(4) Operation and Processing by Precharge Signal Vp

The precharge signal Vp is lowered (varied), and the ON output area 691 is measured (detected). The surface area of the ON output area 691 is reduced by lowering of the precharge signal Vp. The lowering of the precharge signal Vp is performed until the ON output area 691b is disappeared. Preferably, the lowering of the precharge signal Vp is performed until the ON output area 691b is disappeared and the ON output area 691a is changed substantially into a single isolated circular shape as shown in FIG. 69(a2).

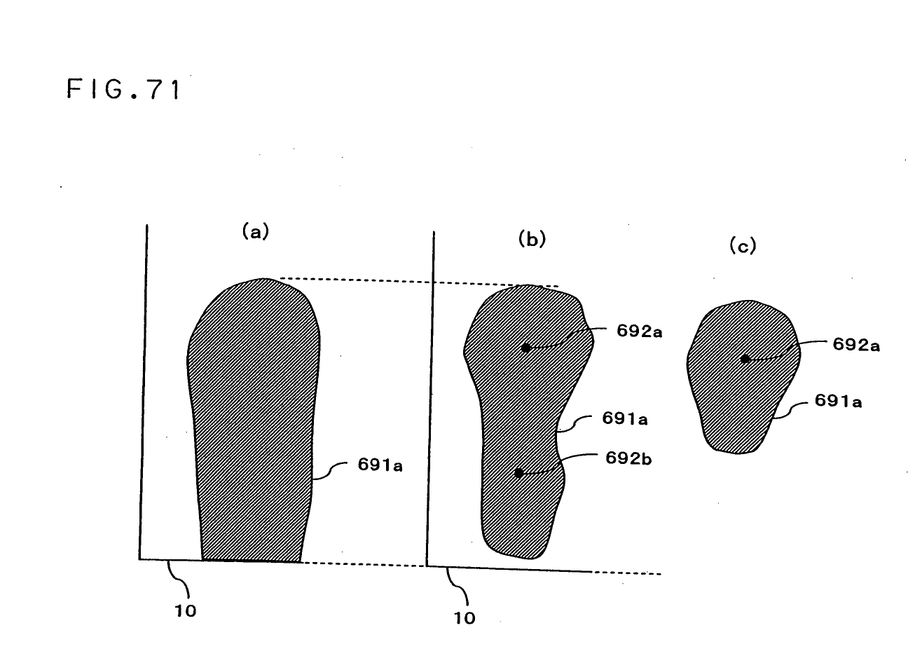

For example, as shown in FIG. 71, the ON output area 691a varies with the magnitude of the precharge signal Vp. When the precharge signal Vp is high, as shown in FIG. 71(a), the ON output area 691a having a large surface area due to the shadow of the finger 701 is formed. The ON output area 691a is in contact with one side of the display area 10.

When the precharge signal Vp is lowered, the surface area of the ON output area 691a is downsized correspondingly. When the ON output area 691a is downsized, the ON output area 691a is separated from the one side of the display area 10 and becomes an isolated area as shown in FIG. 71(b). In the ON output area 691a in FIG. 71(b), two coordinate centers of 692a and 692b are generated.

When the precharge signal Vp is further lowered, the surface area of the ON output area 691a is further downsized. When the ON output area 691a is further downsized, the ON output area 691a is approximated to a circular shape, and hence the coordinate center exists only at the 692a, as shown in FIG. 71(c).

When the precharge signal Vp is lowered to the state near the state shown in FIG. 71(c), the calibration is completed. The above described embodiment is an embodiment of calibration performed by varying the precharge signal Vp.

(4-1) Preservation of Precharge Signal Vp

The precharge signal Vp is varied corresponding to the intensity of the outside light 661 as described in conjunction with FIG. 21 and FIG. 22. In particular, an initial value is set on the basis of the intensity of the outside light. The values obtained by the calibration performed previously (the precharge signal Vp, the exposure time Tc, and so on) are stored and used as initial values.

(4-2) Setting and Optimization of Precharge Signal Vp

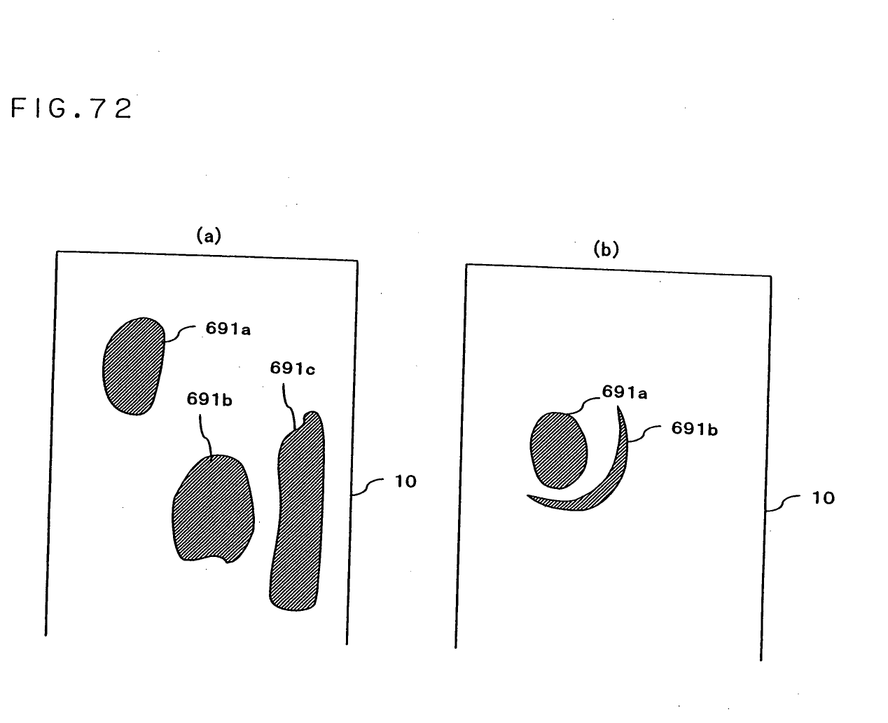

The ON output area 691 is generated in various manners. For example, as shown in FIG. 72(a), the ON output areas 691a, 691c in addition to the intended ON output area 691b are generated. As shown in FIG. 72(b), there is also a case in which the ON output area 691b is generated in an arcuate shape around the intended ON output area 691a. FIG. 72(b) shows a distribution of the ON output area 691 that is generated often when the light pen 681 is used. In the cases described above, the intended ON output area 691 is achieved without generating other additional ON output areas by setting or adjusting the precharge signal Vp adequately.

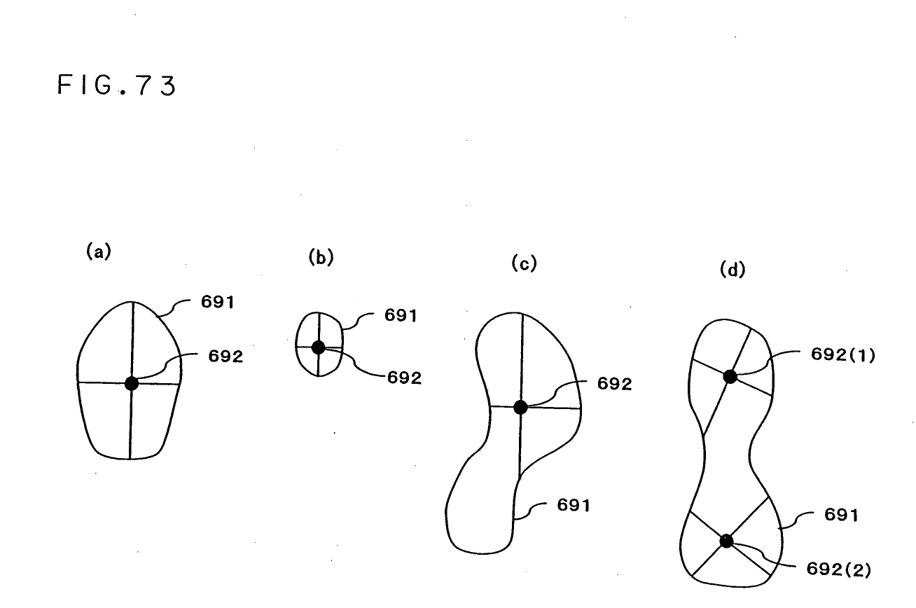

Even when there is only one ON output area 691, the shape of the ON output area 691 may vary depending on the setting of the precharge signal Vp. For example, the shapes as shown in FIG. 73 may be generated.

FIG. 73(a) shows a case in which the ON output area 691 is relatively large, and there is only one center coordinate 692. In this case, the position of the center coordinate 692 is apt to be oscillated when finding the center coordinate from the ON output area 691. Therefore, whether the center coordinate 692 indicates the center position of the finger 701 is not sure. Therefore, the precharge signal Vp is lowered or the exposure time Tc is elongated so as to achieve the state shown in FIG. 73(b).

FIG. 73(b) is a case in which the ON output area 691 is narrow and there exists only one center coordinate 692. In this state, the precharge signal Vp or the exposure time Tc is adequately set and the most preferable state is achieved. In this state, when obtaining the center coordinate from the ON output area 691, the position of the center coordinate 692 is fixed. Therefore, the center coordinate 692 indicates the center position of the finger 701.

FIG. 73(c) shows a case in which the ON output area 691 is relatively large and there is only one center coordinate 692 although the shape is distorted. In this case, the position of the center coordinate 692 is apt to oscillate when finding the center coordinate from the ON output area 691. Therefore, whether the center coordinate 692 indicates the center position of the finger 701 is not sure. In the case of FIG. 73(c), it is necessary to lower the precharge signal Vp or elongate the exposure time Tc in comparison with the case of FIG. 73(a).

FIG. 73(d) is a case in which the ON output area 691 is relatively large, the shape is distorted, and there are two center coordinates 692. In a case in which there is only one ON output area 691 and there are a plurality of the center coordinates 692 as shown in FIG. 73(d), it is necessary to reset (readjust) the calibration. In the case shown in FIG. 73(d), it is necessary to further lower the precharge signal Vp or elongate the exposure time Tc in comparison with the case shown in FIG. 73(c).

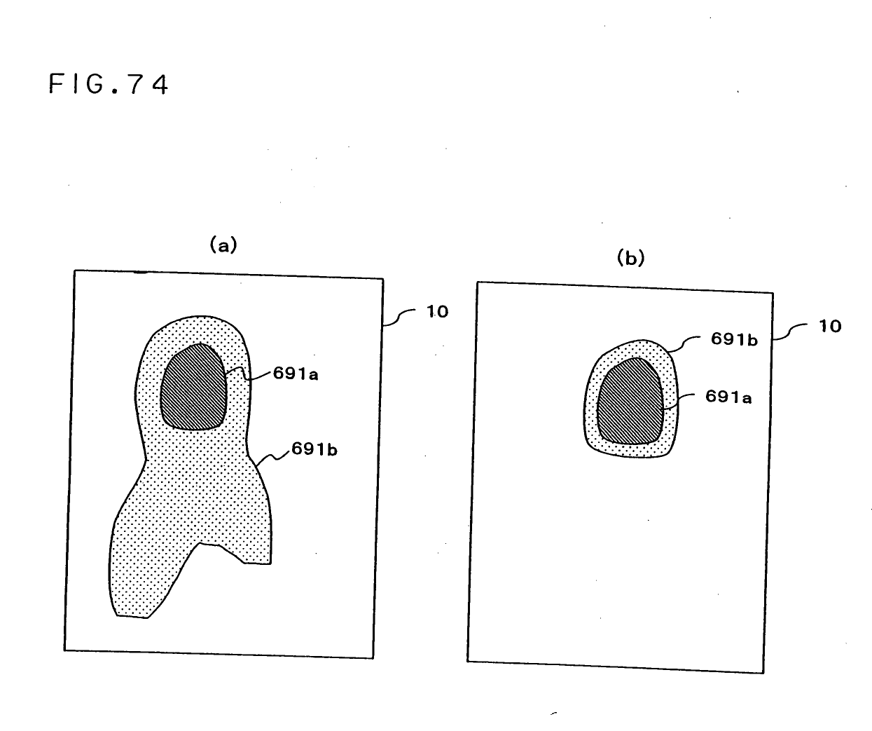

In the ON output area 691, all the transistors 32b of the photosensor pixels 27 in the ON output area 691 are not in the ON-state. As shown in FIG. 74, a mixed ON output area 691b in which the transistors 32b in the ON-state and those in the OFF-state are mixed is generated on the outside of the area 691a in which all the photosensor pixels 27 are maintained completely in the ON-state.

In FIG. 74(a), the mixed ON output area 691b surrounds the completely ON output area 691a over a large surface area. In FIG. 74(b), a mixed ON output area 691b surrounds the completely ON output area 691a in a small surface area. In such a case, the number of the photosensor pixels 27 in the ON-state per unit surface area is counted, and the range (unit surface area) having more than a preset number of ON-state photosensor pixels 27 is processed as the ON output area 691.

(5) Photosensor Processing Circuit

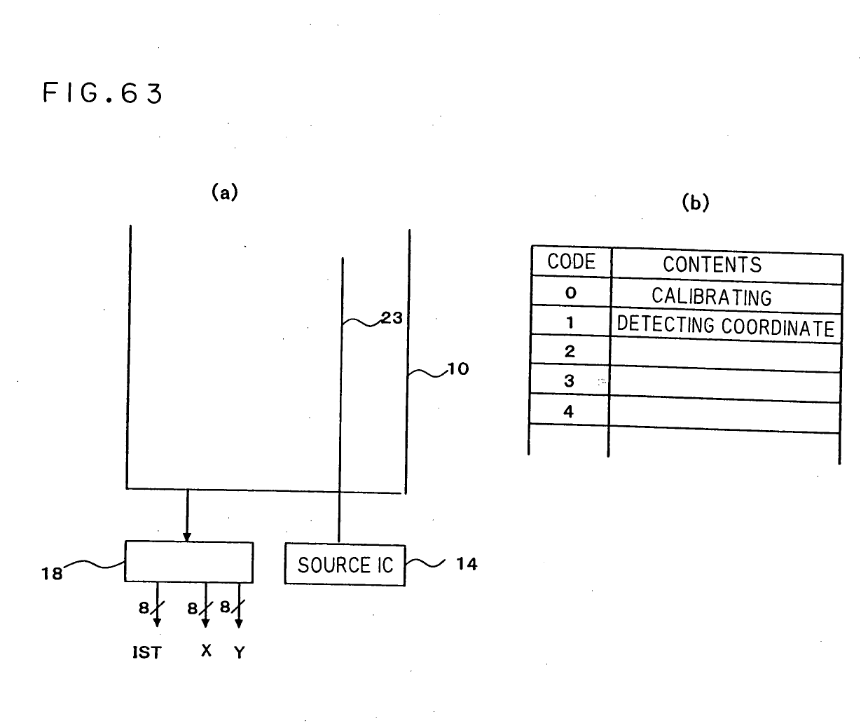

The photosensor processing circuit 18 acquires photosensor output information from the display area 10 via the comparator circuit 155, and detects the surface area and the center coordinate value 692 of the ON output area 691. The photosensor processing circuit 18 also performs the calibration. As shown in FIG. 63(a), the photosensor processing circuit 18 sends the center coordinate values (X-coordinate value, Y-coordinate value: X, Y are 8-bits respectively) to the microcomputer (not shown). Then, the state signal IST of 8-bits is sent to the microcomputer. IST information includes, for example, “calibrating Code 1”, “detecting coordinate of Code 2”, and so on as shown in FIG. 63(b).

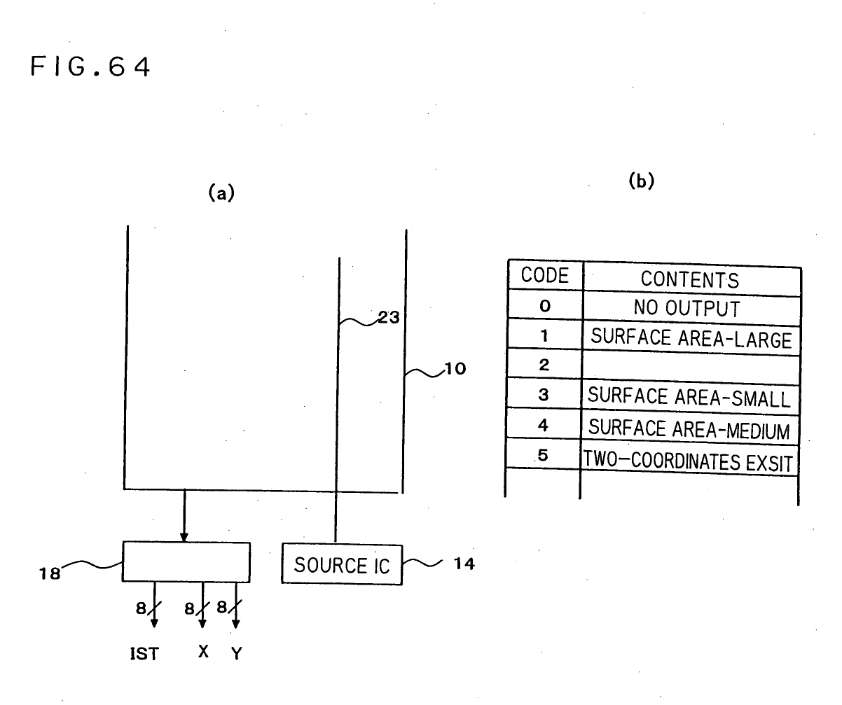

As shown in FIG. 64(b), information on the ON output area 691 is sent to the microcomputer. For example, Code 0 represents that there is no ON output area 691. Code 1 represents that the surface area of the ON output area 691 is larger than a predetermined value. Code 2 represents that the surface area of the ON output area 691 is within the predetermined value. Code 3 represents information such that the surface area of the ON output area 691 is smaller than the predetermined value and hence the calibration should be performed. Code 4 represents information that there are the plurality of center coordinates.

(6) Exposure Time Tc

In the embodiment described above, the precharge signal Vp is varied for calibration. However, the present invention is not limited thereto. For example, as shown in FIG. 36, variations as shown in FIG. 71 can be achieved even by adjusting the exposure time Tc.

For example, when the exposure time Tc is short, as shown in FIG. 71(a), the ON output area 691a having a large surface area is formed by the shadow of the finger 701. The ON output area 691a is in contact with one side of the display area 10.

When the exposure time Tc is elongated, the surface area of the ON output area 691a is downsized correspondingly. When the ON output area 691a is downsized, the ON output area 691a is separated from the one side of the display area 10, as shown in FIG. 71(b), and becomes an isolated area. In the ON output area 691a in FIG. 71(b), the two coordinate centers of 692a and 692b are generated.

When the exposure time Tc is further elongated, the surface area of the ON output area 691a is further downsized. When the ON output area 691a is further downsized, the ON output area 691a is approximated to a circular shape as shown in FIG. 71(c), and hence the coordinate center 692 exists only at the 692a.

The exposure time Tc is also changed corresponding to the intensity of the outside light 661 as described in conjunction with FIG. 36. In particular, the initial value is set on the basis of the intensity of the outside light. The values obtained by the calibration performed previously (the precharge signal Vp, the exposure time Tc, and so on) are stored and used as initial values.

Variation or modification of the ON output area 691 can be achieved not only by independently varying the exposure time Tc or the precharge signal Vp, but also by combining the exposure time Tc and the precharge signal Vp. In addition, variations or adjustment of the ON output area 691 can be achieved by varying the comparative voltage (comparator) Vref as a matter of course.

(7) Calibration and Exposure Time Tc

In the above described embodiment, the precharge signal Vp is varied to vary the surface area or the size of the ON output area 691. However, the calibration of the present invention may be performed by varying the exposure time Tc. For example, in the state shown in FIG. 69(a1), it is assumed that the exposure time Tc is 100H (100 times of the horizontal scanning period (1H)). The adjustment or variation of the exposure time Tc is preferably performed by the unit of 1H. The exposure time Tc is also controlled by the photosensor processing circuit 18.

The exposure time Tc is elongated by the photosensor processing circuit 18 and the ON output area 691 is measured (detected). The precharge signal Vp is preserved at a constant voltage. The surface area of the ON output area 691 is downsized by increase in the exposure time Tc. Increase in the exposure time Tc is performed until the ON output area 691b is disappeared. When the exposure time Tc is increased, the amount of electric charge leaked from the photosensor 35 increases, the gate terminal voltage of the transistor 32b is lowered, and the transistor 32b is turned into the OFF-state. Therefore, the ON output area 691 is downsized. Preferably, the exposure time Tc is increased until the ON output area 691b is disappeared and the ON output area 691a is changed substantially into a single isolated circular shape as shown in FIG. 69(a2).

Variation or modification of the ON output area 691 can be achieved not only by independently varying the exposure time Tc or the precharge signal Vp, but also by combining the exposure time Tc and the precharge signal Vp. In addition, variations or adjustment of the ON output area 691 can be achieved by varying the comparative voltage (comparator) Vref as a matter of course.

It is because the output voltage of the transistor 32b outputted to the photosensor output signal line 25 varies with the gate terminal voltage of the transistor 32b. The gate terminal voltage varies with the amount of leak from the photosensor 35. Therefore, the voltage of the transistor 32b that outputs the photosensor output signal line 25 is different depending on the terminal voltage of the photosensor 35. The ON output area 691 can be varied by varying the comparative voltage (comparator voltage) Vref of the comparator circuit 155.

(8) Other Adjustments

The ON output area 691 can be modified, varied or adjusted also by output acquisition timing of the transistor 32b, the magnitude/output timing of the picture signal from the source driver circuit (IC) 14, the image display state of the display pixel 26, and selection of the photosensors 35 having different sensitivities (described in conjunction with FIG. 17). The range and the size of the ON output area 691 or presence and absence of generation of the ON output area 691 can be adjusted or varied by selecting one or more of the length of the exposure time Tc, the magnitude of the precharge signal Vp, the magnitude of the comparative voltage Vref, the output acquisition timing of the transistor 32b, the magnitude/output timing of the picture signal from the source driver circuit (IC) 14, the image display state of the display pixel 26, and selection of the photosensors 35 having different sensitivities, or by combining the plurality of them, as a matter of course.

In the case in which the transistor 32b of the photosensor pixel 27 is the P-channel transistor, control of the exposure time Tc, the magnitude of the precharge signal Vp and the magnitude of the comparative voltage (comparator voltage) Vref may be performed in the reverse procedure from the above described embodiment, as a matter of course.

### [C-2] Second Embodiment

As shown in FIG. 69(a1), when the intensity distribution of the outside light 661 originally exists in the finger 701 and hence the ON output area 691b is generated, the calibration is performed to form one isolated area in the display area 10 and to make the isolated area substantially a circular shape as shown in FIG. 69(a2). The center coordinate 692a of the ON output area 691a is outputted to the microcomputer (not shown) as the detected coordinate of the finger.

In FIG. 69(b1) as well, a shadow of the finger 701 is generated in the display area 10 as in the case of FIG. 69(a1). However, there is no ON output area 691 in the display area 10. The considerable cause is that the exposure time Tc is too long and the precharge signal Vp is too low.

(1) Calibration and Precharge Signal Vp

In the case of FIG. 69(b1), the calibration is performed to generate the ON output area 691. In FIG. 69(b1), the precharge signal Vp is increased. The exposure time Tc is maintained at a constant value. The precharge signal Vp is controlled by the electronic volume 261a by the photosensor processing circuit 18. The precharge signal Vp is varied by a constant amount such as 0.1 V. When the precharge signal Vp is increased, the ON output area 691 appears as in FIG. 69(b2).

The width of steps of variation of the precharge signal Vp is such that when increase in surface area of the ON output area 691 with respect to the one step of variation of precharge signal Vp is large, the width of the steps of variation of the precharge signal Vp is decreased. When increase in the surface area of the ON output area 691 with respect to the one step of variation of precharge signal Vp is small, the width of the precharge signal Vp to be varied at once is increased.

By increasing the precharge signal Vp (to a high level), the number of the transistors 32b in the photosensor pixels 27 in the ON-state in the display area 10 increases. The surface area of the ON output area 691 is the number of the transistors 32b of the photosensor pixels 27 in the ON-state in the display area 10. The rate of increase or decrease of the number of the transistors 32b in the ON-state (variation velocity, variation ratio) can be obtained by counting the number of the transistors 32b of the photosensor pixels 27 in the display area 10 in the ON-state synchronously with the change of the precharge signal Vp.

It is easy to count the number of the transistors 32b, because it can be achieved by counting the outputs of the comparator circuits 155 of the respective photosensor output signal lines 25. It is also applied to the embodiment shown in FIG. 69(a).

Since the output of the data signal applied to the photosensor output signal line 25 is binarized by the comparator circuit 155, the counting of the number can be achieved easily in detection of the rate of the number of the transistors 32b in the ON-state (variation velocity, variation ratio).

It is also possible to arrange the OP amplifier instead of the comparator circuit 155, process the analogue data directly, and form or generate the ON output area 691. It is also possible to convert the analogue data into the multi-level digital data by the AD converting circuit 171 to generate the ON output area 691 as described in conjunction with FIG. 17.

The precharge signal Vp is increased (varied), and the ON output area 691 is measured (detected). The surface area of the ON output area 691 is enlarged by increase of the precharge signal Vp. Increase of the precharge signal Vp is continued immediately before a plurality of the ON output area 691 are generated or the surface area of the ON output area 691 reaches the size of a stipulated value. If the plurality of ON output areas 691 are generated, it can be detected easily by the photosensor processing circuit 18. When the plurality of ON output areas 691 are generated, the precharge signal Vp is lowered and reset to a value at which only one ON output area 691 is formed.

(2) Surface Area of on Output Area

The maximum surface area of the ON output area 691 is predetermined in advance. The surface area of the ON output area 691 is the number of the transistors 32b of the photosensor pixel 27 in the ON-state in the surface area 10. By counting the number of the transistors 32b in the ON-state and comparing the counted value and the predetermined count value, whether the surface area exceeds the predetermined surface area of the ON output area 691 or not can be determined.

When the ON output area 691 exceeds the maximum surface area, the precharge signal Vp is lowered to reduce the surface area of the ON output area 691 to a level below the predetermined surface area.

(3) Center Coordinate

With the operation described above, the precharge signal Vp is lowered until the ON output area 691 is changed substantially into a single isolated circular shape as shown in FIG. 69(b2). The center coordinate 692a of the ON output area 691 is sent to the microcomputer (not shown) as the detected coordinate of the finger.

(4) Modification

In the embodiment described above, the precharge signal Vp is varied and the surface area and the size of the ON output area 691 are varied. However, the calibration in the present invention may be performed by varying the exposure time Tc as described in conjunction with FIG. 69(a). For example, in a state shown in FIG. 69(b1), it is assumed that the exposure time Tc is 100H (100 times of the horizontal scanning period (1H)).

The exposure time Tc is reduced (shortened) by the photosensor processing circuit 18 and the ON output area 691 is measured (detected). By shortening the exposure time Tc, the surface area of the ON output area 691 is generated or increased. Shortening of the exposure time Tc is continued until the ON output area 691b is disappeared. Preferably, as shown in FIG. 69(b2), the exposure time Tc is shortened until the ON output area 691 is generated and changed into a single isolated circular shape having a constant surface area.

Variation or modification of the ON output area 691 may be achieved not only by independently varying the exposure time Tc or the precharge signal Vp, but also by combining the exposure time Tc and the precharge signal Vp. In addition, variations or adjustment of the ON output area 691 can be achieved by varying the comparative voltage (comparator) Vref as a matter of course.

The appearance of ON output area 691 or the surface area thereof can be modified, varied or adjusted also by the output acquisition timing of the transistor 32b, the magnitude/output timing of the picture signal from the source driver circuit (IC) 14, the image display state of the display pixel 26, and the selection of the photosensors 35 having different sensitivities (described in conjunction with FIG. 17).

The range and the size of the ON output area 691 or presence and absence of generation of the ON output area 691 can be adjusted or varied by selecting one or more of the length of the exposure time Tc, the magnitude of the precharge signal Vp, the magnitude of the comparative voltage Vref, the output acquisition timing of the transistor 32b, the magnitude/output timing of the image signal from the source driver circuit (IC) 14, the image display state of the display pixel 26, and selection of the photosensors 35 having different sensitivities, or by combining the plurality of them, as a matter of course.

In the case in which the transistor 32b of the photosensor pixel 27 is the P-channel transistor, the control of the exposure time Tc, the magnitude of the precharge signal Vp and the magnitude of the comparative voltage (comparator voltage) Vref may be performed in the reverse procedure from the above described embodiment, as a matter of course.

As shown in FIG. 69(b2), the control is made so that the ON output area 691 is formed only one in the display area 10, and the ON output area 691 in the isolated area is formed substantially into a circular shape. The center coordinate 692 of the ON output area 691 is supplied to the microcomputer (not shown) as the detected coordinate of the finger.

As described above, the present invention is characterized in that the calibration is intended to operate (adjust or vary) the ON output area 691. The calibration is characteristically intended to form only one ON output area 691 is formed in the display area 10 (or the area where the photosensor pixels 27 are formed. This area is described to be identical, or substantially coincided with the display area 10 in the present invention). More preferably, it is characteristically intended to form the ON output area 691 into the single isolated area (the states shown in FIG. 69(a2), (b2)). More preferably, it is characteristically intended to form the independent and isolated area of the ON output area 691 into a substantially circular shape and specify a single center coordinate (692 in FIG. 69(a2), (b2)).

In the display area 10, in order to avoid being affected by variations in characteristics of the photosensors 35 and the transistors 32b, the display area 10 is sectionalized in a matrix manner, and an average value or the number of ON-outputs in the matrix section is counted to determine the ON/OFF-state of the matrix section according to a certain level of the counted value, whereby the processing is performed.

The determination data constitutes the ON output area 691. The sectionalizing the matrix means to divide the photosensor pixels 27 or the pixels 16 into a section of 10×10 pixels in columns and rows to perform processing.

### [C-3] Third Embodiment

In the description of the above-described embodiment, the positional coordinate of the object to be inputted is detected. However, the present invention is not limited thereto. For example, it is also an object of the present invention to detect that the display area 10 is touched by a finger. It is also a characteristic of the present invention.

(1) Detection of Position Touched by Finger or the Like

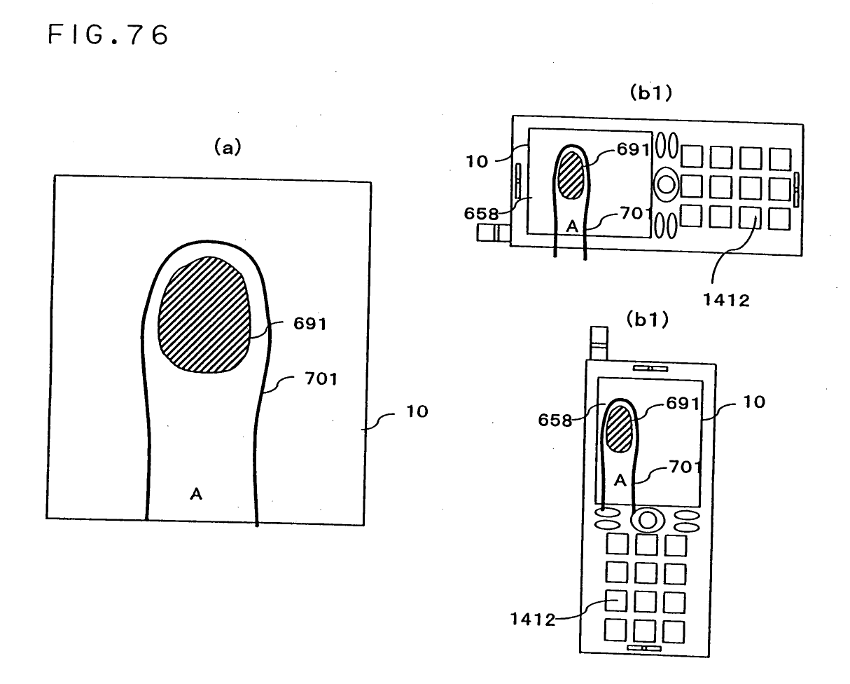

In a case in which a position in the display area 10 touched by the finger 701 is determined, it is important to detect a coordinate of the tip of the finger 701. When the finger 701 touches the display screen 10, the light is shielded by the finger 701 as shown in FIG. 76(a). Since the light is shielded most at the tip potion of the finger 701 the ON output area 691 is generated at the tip portion of the finger 701.

Since the substance 701 such as the finger is a light shielding substance, the shadow of the finger 701 is generated in the display area 10, and the ON output area 691 is generated at the position other than the tip portion of the finger. In particular, when the precharge signal Vp is set to a high level at the time of calibration, the ON output area 691 is generated over the entire substance 701 such as the finger.

In this case, it is important to adjust the precharge signal Vp or the like to make the ON output area 691 into a circular shape or to reduce the surface area of the ON output area 691.

As shown in FIGS. 76(b1), (b2), in order to detect the input coordinate of the finger 701, information on the direction of setting (arrangement) of the screen 10 is also important. FIG. 76(b) shows a configuration in which the display panel 658 in the present invention is arranged in a mobile display device. FIG. 76(b1) shows a case in which the display panel 658 in the present invention is arranged to be elongated in the lateral direction and input is performed with the finger 701. FIG. 76(b2) shows a case in which the display panel 658 in the present invention is arranged to be elongated in the vertical direction and input is performed with the finger 701.

(2) Direction of Arrangement of Display Panel

As shown in FIG. 76(a), a portion A at a root of the finger 701 is apt to be in the shadow. Therefore, it is apt to become the ON output area 691. If information about the orientation of the display panel 658 is known, the portion A of the root of the finger 701 can be extracted, whereby the ON output area 691 at the tip portion of the finger 701 can be determined by excluding the ON output area 691 at the portion A. As described above, the present invention is also characterized in that the information on the orientation of the display panel (FIGS. 76(b1), (b2)) is utilized.

If the position of the finger 701 input can be specified in the display area 10, the coordinate position of the finger input or the fact that the finger input is performed can easily be detected.

In the case shown in FIG. 76(b1), even when the shadow is generated at a portion A, and hence it becomes the ON output area 691, if there is the information indicating that the display panel 658 is laterally arranged is obtained, the fact that the portion A corresponds to the end of the display area 10 of the display panel 658 is known. Therefore, the ON output area at the portion A can be excluded, and hence the real ON output area 691 which corresponds to the tip of the finger 701 can be detected as the input coordinate position.

In the case shown in FIG. 76 (b2), even when the shadow is generated at a portion A and hence it becomes the ON output area 691, as long as the information indicating that the display panel 658 is arranged in the vertical direction is obtained, the fact that the portion A corresponds to the end of the display area 10 of the display panel 658 is known. Therefore, the ON output area at the portion A can be excluded and the real ON output area 691 which corresponds to the tip of the finger 701 can be detected as the input coordinate position.

(3) Method Using Pressure

In the description of the present invention, the ON output area 691 which corresponds to the shadow of the object 701 is detected to find the input coordinate position. However, the present invention is not limited thereto. For example, when the surface of the display panel 658 is pressed with the finger 701, the thickness of the liquid crystal layer 653 varies. By the variation in thickness of the liquid crystal layer 653, a capacity component of the respective photosensor pixels 27 is varied. Therefore, the value of the precharge signal Vp which sets whether the photosensor pixels 27 at the pressed position into the ON output or the OFF output is different.

In the case in which the identical precharge signal Vp is applied to the display area 10, or in the case in which the above-described portion is the ON output area or the OFF output area 691 in the state in which no pressure is applied, the portion received the pressure is varied to the OFF output area or the ON output area. The coordinate can be detected by detecting the changed position.

In other words, detection of the coordinate position and the detection of contact can be performed by the pressure applied by the object 701 irrespective of the intensity or variations in the outside light. In the plane display device in the present invention, precharge signal Vp applying means, the capacitance 34 formed or naturally formed in the pixel 27, the transistor 32b such as the source follower, the transistors 32a, 32c are to be functioned and operated. The drive method is as described above.

It can also be applied to other embodiments in the present invention. It is also possible to combine with other embodiments.

### D. Method of Detecting Input Coordinate

### [D-1] First Embodiment

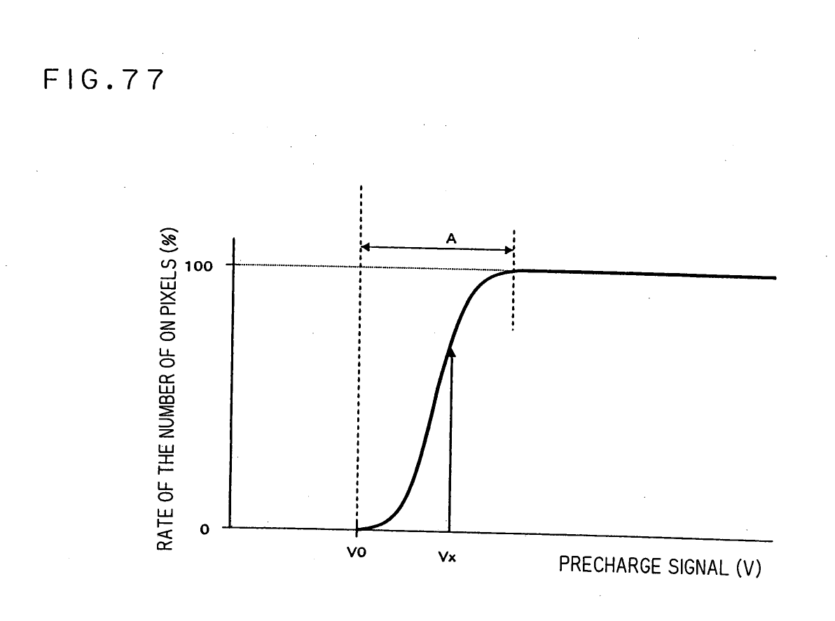

As shown in FIG. 77, assuming that the exposure time Tc is constant and the precharge signal Vp is a valuable value, the rate of the number of the ON pixels (%) varies. When the transistor 32b of the photosensor pixel 27 is the N-channel, the rate of the number of the ON pixels (%) increases with increase in the precharge signal Vp. The precharge signal Vp at which increase in the rate of the number of the ON-pixels (%) starts is referred to as V0.

As an example, it is assumed that the rate of the number of the ON pixels (%) reaches 100% when the voltage is increased from V0 to a voltage A. The range of the voltage A is approximately from 0.4 to 0.6 V.

The rate of the number of the ON pixels (%) will take any value of the rate of the number of the ON pixels (%) between 0% to 100% due to the precharge signal Vp between the voltage V0 to V0+A. In other words, when the precharge signal Vp=V0+Vx is applied on the basis of V0, a predetermined rate of the number of the ON pixels (%) can be obtained.

(1) Reference Voltage Position

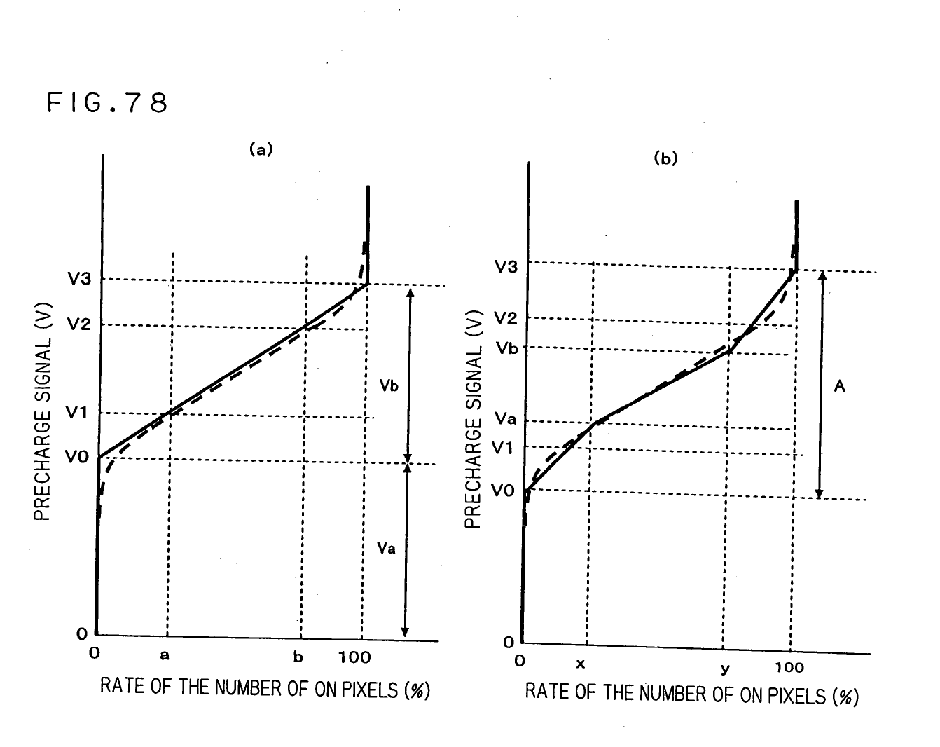

In the present invention, it is important to find the V0 voltage or a reference voltage position, because it is a reference for obtaining the predetermined rate of the number of the ON pixels (%). In order to find the V0, the characteristics in FIG. 77 are approximated with a straight line as shown in FIG. 78(a). The characteristics of the photosensor pixels 27 in the display area 10 shown in FIG. 77 assume substantially normal distribution. To be precise, the graph shown in FIG. 77 shows a value after the normal distribution is added thereto. Therefore, part of the line near V0 and near V0+A is non-linear. However, in this plane display device, the amount of variation of the rate of the number of the ON pixels (%) is an issue. Therefore, the non-linear portion near V0 does not affect the amount of variation of the ON output area 691. In particular, a part in which the rate of the number of the ON pixels (%) is around 50% (between 20% and 80%), the amount of variation of the ON output area 691 has a linear property and hence it does not come into question.

FIG. 78(a) is the graph shown in FIG. 77, but turned by 90° in order to facilitate description. The dotted line in FIG. 78(a) shows the characteristics in FIG. 77. This is approximated as shown by a solid line in FIG. 78(a).

The position of V0 in FIG. 77 is shifted from the position of V0 in FIG. 78(a). The position of V0+A in FIG. 77 is also shifted from the position of V3 in FIG. 78(a). Description will be made after approximation as in FIG. 78(a). In other words, the rate of the number of the ON pixels (%) starts to change from the precharge signal Vp=V0. The rate of the number of the ON pixels (%) reaches 100% when the precharge signal Vp=V3. It is assumed that the rate of the number of the ON pixels (%)=a when the precharge signal Vp=V1 is applied, and the rate of the number of the ON pixels (%)=b when the precharge signal Vp=V2. A range from 0 to V0 is assumed to be Va, and a range from V3 to V0 is assumed to be Vb.

(2) Rate of Number of ON Pixels

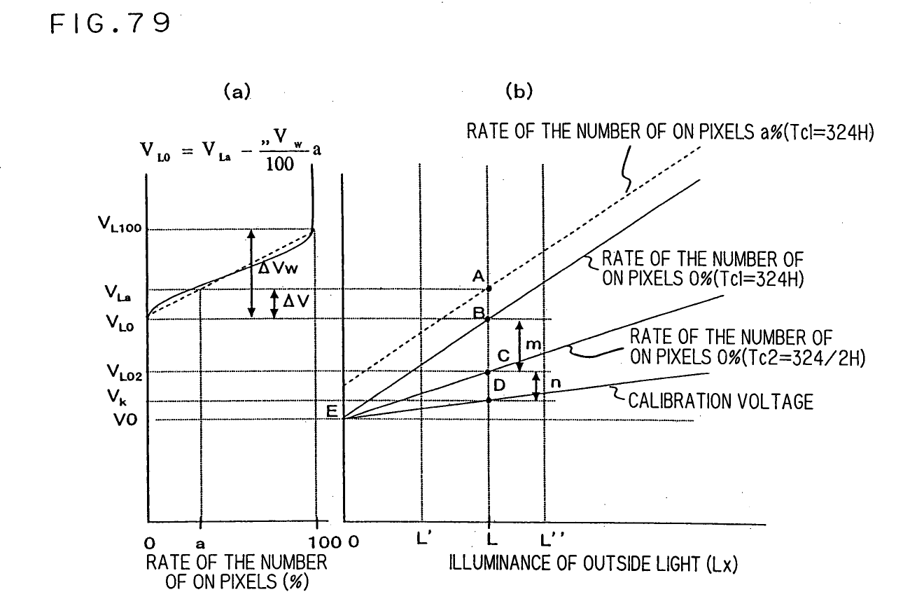

FIG. 79 shows a relation between the illuminance of outside light and the rate of the number of the ON pixels (%). FIG. 79(a) is a graph in FIG. 78(a). FIG. 79(b) shows a relation between the illuminance of outside light and the precharge signal Vp.

In FIG. 79, a case in which the rate of the number of the ON pixels (%) is 0% (or a position or a point where slight amount of the rate of the number of the ON pixels (%) is generated) will be described as an example for facilitating the desription.

However, the present invention is not limited to the processing performed with the rate of the number of the ON pixels (%) set to 0%. For example, the rate of the number of the ON pixels (%) may be assumed to be a (%) as shown by a dotted line. In this case, the precharge signal Vp at the point A is achieved when an illuminance of outside light is L. The precharge signal Vp at the point A is VLa. Conversion of the VLa voltage to the precharge signal Vp=VL0 at which the rate of the number of the ON pixels (%) becomes 0% can be achieved easily from FIG. 79(a). A relation between the rate of the number of the ON pixels (%) and the precharge signal Vp is similar to a linear shape of a portion from VL0 to VL100 as shown by a dotted line (FIG. 78).

Since the rate of the number of the ON pixels (%) is proportional to the precharge signal Vp from VL0 to VL100, the position of VL0 can be obtained easily by calculation. Therefore, a point B in FIG. 79(b) can also be obtained. In order to express in a general way, description will be made assuming that a straight line (solid line) when the rate of the number of the ON pixels (%) is 0% is the rate of the number of the ON pixels b (%).

Preferably, the precharge signal Vp is adjusted with respect to a desired illuminance L of the outside light and the intended rate of the number of the ON pixels b (%) is set to a range between 0% and 20%. More preferably, it is set to a range between 0% and 10%.

A distance ΔVw between VL0 and VL100 varies with the temperature, the precharge signal Vp and so on, since the amount of variation of ΔV at a position where the rate of the number of the ON pixels (%) starts to vary (precharge signal Vp=VL0) is small. It can be obtained from an expression VL0=VLa−ΔVw·a/100. The rate of the number of the ON pixels (%) can be set to a value between 70% and 100% as a matter of course. A portion near 100% can be processed easily as a reference point.

(4) Correction Coefficient

A value of ΔVw is preferably corrected by the temperature of the photosensor 35, or the intensity of the incident light (illuminance of outside light). In particular, there is a case in which dependency of the value ΔVw to the illuminance of outside light in a low illumination area below 1000 lux (Lx) is significant. In this case, the collection coefficient Cv for a voltage difference between VL0 and VL02 is set in advance and ΔVw×(VL0−VL02)×Cv is used. The value of Cv is preferably corrected further by the value such as m and n.

The correction may be performed by the correction coefficient Cv on the basis of the magnitude of m, the voltage difference between the precharge signal Vp and V0 at a first exposure time Tc1, the magnitude of the precharge signal Vp at the first exposure time Tc1 and the magnitude of the precharge signal Vp at a second exposure time Tc2, as a matter of course. The calculation of correction is achieved by multiplying the above-described values by the correction coefficient Cv.

(4) Relation with Exposure Time Tc

The characteristics of the present invention are in that the precharge signal Vp is adjusted or set so that a desired rate of the number of the ON pixels (%) (for example, 0%, 5% or 10%) is achieved at a certain illuminance of outside light (or in a state in which a light beam of a desired intensity is irradiated on the photosensor pixels 27), and in that the precharge signal Vp is adjusted or set so that the desired rate of the number of the ON pixels (%) is achieved at a plurality of the exposure times Tc.

In FIG. 79(b), the plurality of exposure time Tc includes 324H (324 horizontal scanning period) and a half of it, 162H (162H horizontal scanning period). In the present invention, the exposure time Tc is not limited to 324H or the like as a matter of course. In the present invention, the plurality of exposure times Tc must simply be more than two. When selecting two exposure times Tc, one of the exposure times Tc is a value close to one frame. For example, when one frame is 340H (horizontal scanning period), a value closer to 340H is preferable. Assuming that one frame is composed of a horizontal scanning period D (one frame=DH), the first exposure time Tc is preferably in a range between D×0.6 and D. A range between D×0.8 and D is more preferable. In order to facilitate description (in order to make it more detail), it is assumed that one frame is 340H, and in FIG. 79(b), the first exposure time Tc is 324H.

The second exposure time Tc is preferably a value close to ½ of the first exposure time Tc. Assuming that one frame is composed of the horizontal scanning period D (one frame=DH) as an example, the second exposure time Tc is preferably between D×0.6×0.5 and D×0.8. A range between D×0.8×0.5 and D×0.6 is more preferable. In order to facilitate description or in order to make it more detail, it is assumed that one frame is 340H, and in FIG. 79(b), the second exposure time Tc is 324/2=162H.

Preferably, the second exposure time Tc is substantially ½ of the first exposure time Tc. In a bit processing, the second exposure time Tc is obtained by shifting the data of the first exposure time Tc rightward by one bit. In other words, the plurality of exposure times Tc are preferably obtained or calculated by rightward or leftward shifting of the data.

(5) Values of m and n

The rate of the number of the ON pixels is operated with a target of a %. When obtaining the distribution by counting the number of the OFF pixels, a % is preferable within a range between 50 and 100. Preferably, the rate of the number of the ON pixels 0% is obtained by obtaining the point of a % and calculating the expression VL0=VLa−ΔVw·a/100 or the like.

When obtaining the precharge signal Vp at which the rate of the number of the ON pixels becomes a % in the first exposure time Tc, and then obtaining the precharge signal Vp at which the rate of the number of the ON pixels becomes 2% in the second exposure time Tc, the next precharge signal Vp can be set at a high speed by employing the voltage value of Vla−VLax (second exposure time Tc/first exposure time Tc).

The rate of the number of the ON pixels a % may be different between the first exposure time Tc and the second exposure time Tc, because it can be converted into the predetermined rate of the number of the ON pixels easily by the calculation of VL0=VLa−ΔVw·a/100.

The straight line b indicating the rate of the number of the ON pixels is obtained by applying the precharge signal Vp so that the rate of the number of the ON pixels (%) becomes b (%) (b=0 in the embodiment shown in FIG. 79) when the illuminance of outside light (Lx) is L.

According to the straight line showing a case in which the rate of the number of the ON pixels is 0 (%) when the first exposure time Tc=324H, the precharge signal Vp at the point B is VL0 when the illuminance of outside light is L. According to the straight line showing a case in which the rate of the number of the ON pixels is 0 (%) when the second exposure time Tc=324/2H, the precharge signal Vp at a point C is VL02 when the illuminance of outside light is L. At a point D, the precharge signal Vp to be set at a time of k calibration is Vk.

The voltages VL0 and VL02 of the precharge signal Vp are voltages to be measured by varying or adjusting the precharge signal Vp. The precharge signal Vp=Vk can be obtained by calculation using VL0 and VL02 of the precharge signal Vp.

The distance between the point B and the point C is VL0−VL02. Therefore, it can be obtained by varying the precharge signal Vp so as to obtain the rate of the number of the ON pixels b(%) (exposure time Tc=DH) and the rate of the number of the ON pixels b(%) (exposure time Tc=D/2H).

Assuming that the distance between the point B and the point C is m and the distance between the point C and the point D is n. A ratio m:n is the same even when the illuminance of outside light varies as L, L′ and L″. It is hardly varied even with the temperature or the wavelength of outside light. The ratio m:n or the values of m and n are obtained at the time of shipping or inspecting the panel or at the time of adjustment.

When the value of m (or the relative magnitude) is obtained, the value of n (or the relative magnitude) can be obtained. The value of m can be obtained by measuring the values of VL0, VL02 of the precharge signal Vp.

The rate of the number of the ON pixels a % may be different between the first exposure time Tc and the second exposure time Tc, because it can be converted into the predetermined rate of the number of the ON pixels easily by the calculation of VL0=VLa−ΔVw·a/100.

(6) Temperature Correction

The value of ΔVw varies with the illuminance of outside light. In general, it increases with increase in illuminance of outside light. Therefore, it is preferable to multiply the correction coefficient in proportional to the value or the magnitude of m and the value or the magnitude of precharge signal Vp. The value of ΔVw varies also with the temperature of the photosensor 35, the photosensor pixel 27 or the panel 658. Therefore, it is preferably to perform correction by detecting (measuring) the temperature with a temperature sensor or the like. The temperature sensor may be, for example, a thermistor.

(7) Method of Processing Precharge Signal Vp

The straight line b indicating the rate of the number of the ON pixels is obtained by applying the precharge signal Vp so that the rate of the number of the ON pixels (%) becomes b (%) (b=0 in the embodiment shown in FIG. 79) when the illuminance of outside light is (Lx). According to the straight line showing the case in which the rate of the number of the ON pixels 0 (%) when the first exposure time Tc=324H, the precharge signal Vp at a point B is VL0 when the illuminance of outside light is L. According to the straight line showing the case in which the rate of the number of the ON pixels 0 (%) when the second exposure time Tc=324/2H, the precharge signal Vp at the point C is VL02 when the illuminance of outside light is L. The point D represents the precharge signal Vp=Vk to be set at the time of calibration.

The voltages VL0 and VL02 of the precharge signal Vp are voltages to be measured by varying or adjusting the precharge signal Vp. The precharge signal Vp=Vk can be obtained by calculation using VL0 and VL02 of the precharge signal Vp.

The distance between the point B and the point C is VL0−VL02. Therefore, it can be obtained by varying the precharge signal Vp so as to obtain the rate of the number of the ON pixels b (%) (exposure time Tc=DH) and the rate of the number of the ON pixels b (%) (exposure time Tc=D/2H).

Assuming that the distance between the point B and the point C is m and the distance between the point C and the point D is n. The ratio m:n is the same even when the illuminance of outside light varies as L, L′ and L″. It is hardly varied even with the temperature or the wavelength of the outside light. When the value of m (or the relative magnitude) is obtained by obtaining the ratio m:n or the values of m and n at the time of shipping or inspecting the panel or at the time of adjustment, the value of n (or the relative magnitude) can be obtained. The value of m can be obtained by measuring the values of VL0, VL02 of the precharge signal Vp.

When the exposure time Tc is varied, if the intended rate of the number of the ON pixels (%) is the same, the ratio of m:n is maintained at a constant value with respect to a desired illuminance of outside light. The straight lines indicating the plurality of the rates of the number of the ON pixels b (%) pass an original point E by varying the exposure time Tc. The present invention utilizes this property. The straight line indicating the rate of the number of the ON pixels a (%) (indicated by the dotted line) does not pass through the original point E. However, as described previously, it can be obtained by VL0=VLa−ΔVw·a/100. ΔVw is obtained in advance at the time of shipping or inspection of the panel or at the time of adjustment. Therefore, Vk can be obtained from the ratio of A-C:C-D.

Assuming that m:n=2:1, the first precharge signal Vp=VL0=2.0 V, and the second precharge signal Vp=VL02=1.2 V, m=0.8, and n=0.4 are resulted. Therefore, Vk=0.8 V is resulted. The precharge signal Vp=Vk=0.8 V is applied to the photosensor pixel 27.

In the embodiment shown above, the plurality of exposure times Tc are set at a desired illuminance of outside light (the amount of luminous flux incoming into the photosensor 35) and the first precharge signal Vp=VL0 and the second precharge signal Vp=VL02 are obtained.

The exposure time Tc may be set to three or more values. By setting three or more exposure times Tc and performing averaging process or rate processing for the desired illuminance of outside light L, the value of Vk can be obtained with high level of accuracy. Also, since the precharge signal Vp=VL0 can be obtained by one exposure time Tc and, from the absolute value thereof, the value Vk can be obtained directly from the known value of m:n. Alternatively, the value of Vk can be obtained from the absolute value or the proximal value of the precharge signal Vp=VL0, VL02 or the values of m and n or the like.

The value V0 varies with temperature dependency of the photosensor pixel 27, or light-wavelength dependency of the photosensor 35. In the method described in conjunction with FIG. 79, the precharge voltage is varied, adjusted or set so as to obtain the predetermined rate of the number of the ON pixels b (%) using the identical photosensor pixel 27 for the desired illuminance of outside light L.

The value of the illuminance of outside light L is not necessary to obtain the value V0. In other words, two different precharge signals must simply be applied to obtain the identical rate of the number of the ON pixels b (%) with respect to the different exposure times Tc for any illuminance of outside light.

Although adjustment or the like is performed for obtaining the identical rate of the number of the ON pixels b (%) for the different exposure times Tc in the description, it does not mean to obtain the identical rate of the number of the ON pixels b (%). Even when the rate of the number of the ON pixels (%) for the first exposure time Tc is b1(%) and the rate of the number of the ON pixels (%) for the second exposure time Tc is b2(%), by applying the expression VL0=VLa−ΔVw·a/100, b1=b2 is obtained. In other words, even when the straight line indicating the rate of the number of the ON pixels (%) does not pass through the original point E, it can be shifted by calculation to make it pass through the original point E.

(8) Configuration of Photosensor

Description in conjunction with FIG. 79 shows the embodiment in which photosensor pixel 27 of one type is formed in the display area 10. However, the present invention is not limited thereto. It is also possible to form a plurality of types of the photosensor pixels 27 in the display area 10. By extracting one photosensor pixel 27 from the plurality of photosensor pixels 27, the system shown in FIG. 79 may be applied. By processing the plurality of photosensor pixels 27 as a single unit, the embodiment shown in FIG. 79 may be applied.

### [D-2] Second Embodiment

In the embodiment shown in FIG. 79, the identical rate of the number of the ON pixels (%) is employed for the plurality of exposure times Tc. However, the present invention is not limited thereto. It is also possible to obtain V0 voltage from two or more rate of the number of the ON pixels (%). The accuracy is improved by obtaining the value Vk from a number of exposure times Tc, the precharge signal Vp and the rate of the number of the ON pixels (%) and averaging the obtained Vk values or deriving the center value thereof.

### [D-3] Third Embodiment

Calibration is performed using the obtained Vk voltage. However, the Vk is not limited to be varied on a real time basis. The value of the Vk is logically a fixed value according to the change of the illuminance of outside light L. However, in fact, the Vk voltage is oscillated by the calculation accuracy. Therefore, the Vk voltage to be used for calibration is preferably varied slowly. It is preferable to provide a hysteresis property thereto. Therefore, a certain number of the obtained Vk voltages are stored in the memory, and are applied with moving average process. The process of excluding the maximum value and the minimum value is also performed. The amount of variation in a certain period is adapted to fall within the predetermined range.

### [D-4] Fourth Embodiment

In the description of this specification, Vk voltage is obtained for facilitating the description. However, the invention is not limited thereto. It is intended to obtain a value close to Vk or the value similar thereto, or to obtain a value corresponding to the Vk indirectly. Although there is a case in which the calibration uses the V0 directly, it adds or subtracts a predetermined value to/from the voltage Vk. Alternatively, it uses by multiplying the same by a predetermined constant.

It is possible to vary both of the exposure time Tc and the precharge signal Vp simultaneously so that the multiplied value between the precharge signal Vp and the exposure time Tc becomes constant or in a predetermined relation as a matter of course. It is also possible to vary the comparative voltage (comparator voltage) Vref.

### [D-5] Fifth Embodiment

FIG. 78(a) is approximated to a characteristic curve that is curved at V0 and V3. However, the present invention is not limited thereto. For example, as shown in FIG. 78(b), it may be approximate to a characteristic curve which is curved or changed in angle at x, y in the rate of the number of the ON pixels (%), or Va, Vb in the precharge signals Vp corresponding to x and y. In other words, it may be approximate to not only the curve bent at two positions as shown in FIG. 78(a) but also the curve bent at four positions in FIG. 847(b). In other words, it may be approximate to a curve bent at a plurality of points or a gentle curve. By such an approximation, the position of the V0 can be obtained accurately.

### E. Method of Acquisition of Illuminance of Outside Light

### [E-1] First Embodiment

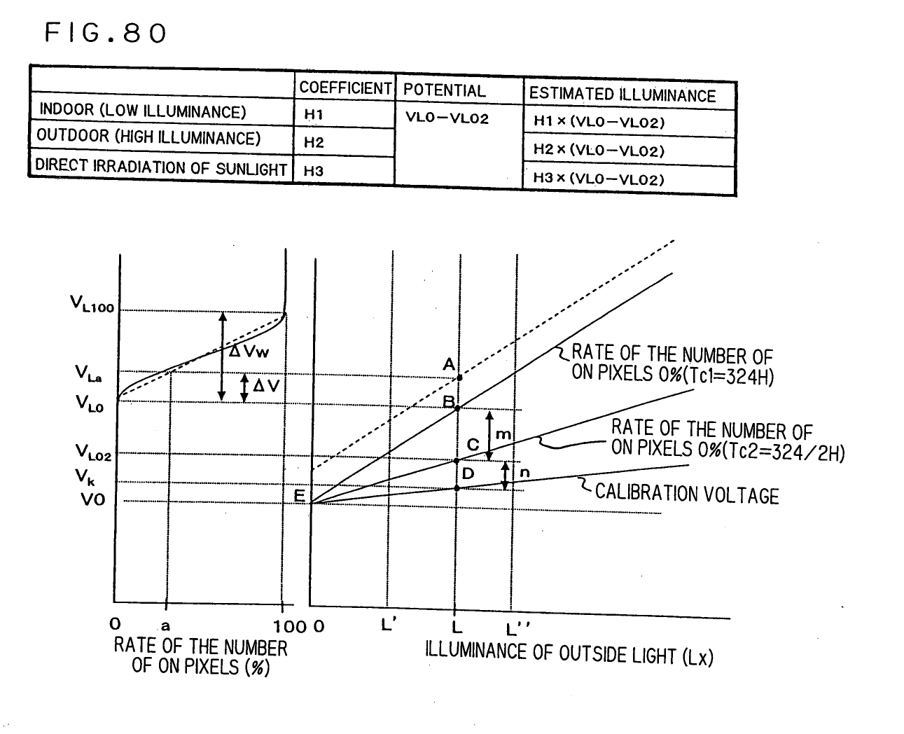

As described in FIG. 79, the calibration voltage Vk can be calculated by obtaining the differential voltage between the exposure time Tc1 and exposure time Tc2 using the values of m and n, the n/m ratio, and so on. As shown in FIG. 80, the illuminance of outside light can also be obtained.

As shown in FIG. 80, by employing the exposure time Tc1 and varying the precharge signal Vp so as to obtain the rate of the number of the ON pixels a, the calibration voltage VL0 is obtained. On the other hand, by employing the exposure time Tc2 and varying the precharge signal Vp so as to obtain the rate of the number of the ON pixels a, which is identical to the rate of the number of the ON pixels described above, the calibration voltage VL02 is obtained.

(1) Adjustment of Illuminance Correction Coefficient H

The value obtained from the expression VL0-VL02 is the magnitude of m. ΔVp=VL0−VL02 or m (or n, n+m) is proportional to the illuminance of outside light L. In other words, by multiplying the value of VL0−VL02 by a constant H, the illuminance of outside light can be estimated. The value of H is written into an EEPROM 1401 mounted to a panel module as a characteristic value of the panel. The written value of H is read by the controller IC mounted to the array substrate 11 of the panel by COG, and the illuminance of outside light and so on is calculated. The calculated illuminance of outside light is transmitted to a microcomputer 814 arranged or mounted to the outside of the panel module.

The value of H is measured in the process of inspection or adjustment at the time of shipping of the panel module. Adjustment is performed by irradiating a light beam having the illuminance L to be set to the panel, and adjusting the precharge signal Vp at the exposure time Tc1 so that the predetermined rate of the number of the ON pixels a % can be obtained. The precharge signal Vp is adjusted at the exposure time Tc2 so that the predetermined rate of the number of the ON pixels a % can be obtained. A value of ΔVp, which is the difference between these two precharge signals Vp, is obtained. The illuminance of outside light L is measured, the H=L/ΔVp is obtained, and the obtained value H is stored in the EEPROM. The value of H corresponds to a ratio of the illuminance of outside light per 1V of ΔVp.

Therefore, the illuminance of outside light can be obtained by obtaining the value of H×ΔVp. The value of a is preferably between 30 and 90%. As described above, the present invention provides a method of obtaining the conversion coefficient H from the precharge signal Vp corresponding to the plurality of exposure times Tc and the illuminance of outside light L at the time of measurement. It is also a method of obtaining an estimated illuminance of outside light using the conversion coefficient H at the time of operating the panel.

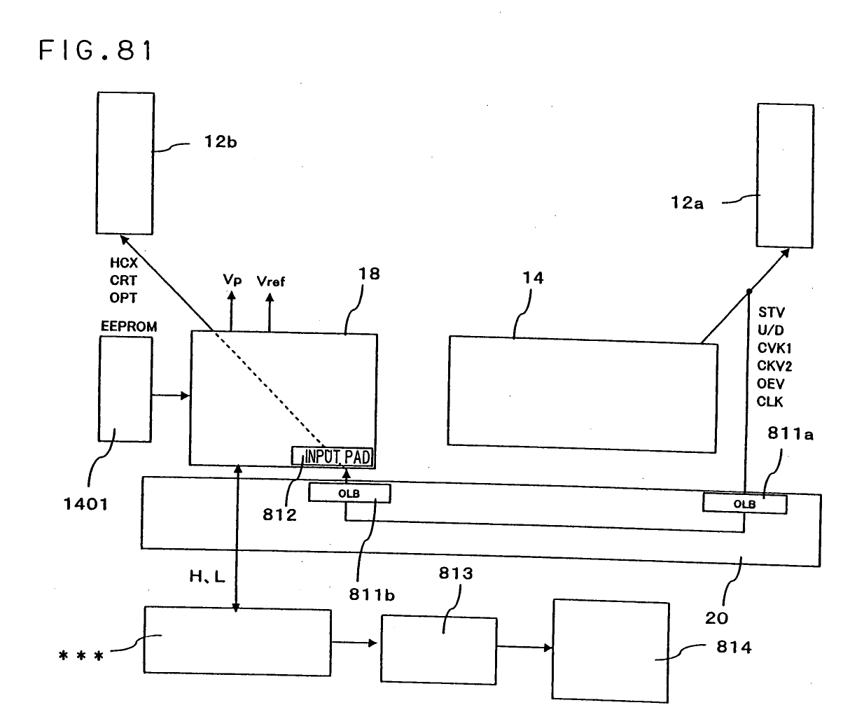

From the description above, the illuminance of outside light can be estimated from the value of H measured while taking the characteristics of the respective panels and the ΔVp (or the value m) measured at the time of calibration operation. The illuminance of outside light L is obtained by the controller IC on the panel and the obtained values (H, L, and so on) are transmitted at the microcomputer 814 (see FIG. 81). The microcomputer 814 can acquire the illuminance of outside light using the display device in the present invention as the photosensor.

(2) Control of Brightness of Backlight

The microcomputer 814 controls an LED driver 813 or the like of the backlight of the display device in the present invention, and adjusts the backlight 656 for achieving an adequate display brightness according to the intensity of the outside light (illuminance of outside light). For example, when the illuminance of outside light is low, the brightness of the backlight 656 is lowered, to achieve saving of power consumption. On the other hand, when the illuminance of outside light is high, the brightness of the backlight 656 is increased to improve visibility.

As described above, the intensity of the illuminance of outside light can be obtained using the photosensor pixels 27 formed on the display panel in the present invention. The brightness of the backlight can be controlled by using the detected illuminance of outside light, so that the optimal display brightness is achieved.

(3) Adjustment of Precharge Signal (Calibration Voltage)

In the case in which the obtained illuminance of outside light or a value or data relative to the illuminance is lower than the predetermined value, a drive system that varies the processing of the ON output area 691 is also exemplified. For example, it is a case in which the illuminance of outside light is as dark as 50 Lx or below. In such a case, it is preferable to detect the light beam 661 emitted from the backlight 656 and reflected by the object 701 by the photosensor 35 rather than detecting the shadow of the object 701. Therefore, by adjusting the precharge signal Vp to an optimal value, the photosensor pixels 27 corresponding to the position of the object 701 become the OFF output area 691. Other area becomes the ON output area since outside light is low. Therefore it assumes an opposite state from FIG. 69.

In this case, by performing inverse processing to output logic of the photosensor pixels 27 in the ON output state and those in the OFF output state, the method of processing described above can be applied to the process from then on.

According to the present invention, the illuminance of outside light (or the relative value of the illuminance of outside light) can be detected. Modification is achieved by detecting or figuring out the illuminance of outside light, then detecting the low illuminance and then detecting reflecting light from the object 701 by changing the logic.

### [E-2] Second Embodiment

When obtaining the value of H, it is preferable to execute calculation by adjusting the illuminance of outside light into a plurality of values and calculating the value of H not only at one point, but also at a plurality of points through the averaging process or the like. An error occurs in the value of H according to the illuminance of outside light. Therefore, the illuminance of outside light is divided into a plurality of areas like an indoor area (low illuminance), an outdoor area (high illuminance), and an extra-high illuminance area (direct irradiation of sunlight) and the Hs (H1, H2 and H3) are respectively obtained, or obtained in advance.

In the present invention, the calibration voltage Vt or the illuminance of outside light are calculated or obtained according to the value or the magnitude of m. However, the value of H can be obtained also by the magnitude of the precharge signal Vp at the first exposure time Tc and the magnitude of the precharge signal Vp at the second exposure time Tc, and the magnitude, the relative value or the absolute value of the calibration voltage Vt. As described thus far, in the present invention, calculation or calibration of the respective values is performed by the precharge signal Vp or the like corresponding to one or more exposure times Tc.

The value like ΔVw is preferably corrected by the panel temperature (the temperature of the photosensor pixel 27). It is also preferable to correct by a main wavelength of outside light or the like. The temperature sensor or the photosensor is arranged on the panel and correction is made with the output therefrom.

### [E-3] Third Embodiment

The display device according to the present invention is of a system to detect the shadow of the object 701 such as a finger. Therefore, when outside light is weak, there is no difference generated between the ON pixel area 691 and the OFF pixel area. Therefore, the shadow of the object 701 cannot be detected, and hence the coordinate detection cannot be achieved. In other words, input by the object (finger) cannot be achieved. When it is non-enterable with the finger, it is necessary to inform the fact that it is non-enterable to an operator.

According to the display device in the present invention, the illuminance of outside light L can be obtained by the value of H stored in the EEPROM 1401 and the measured value such as ΔVp. By sending the obtained value of the illuminance of outside light to the microcomputer 814, the microcomputer 814 can determine whether it is the non-enterable low illuminance area or not.

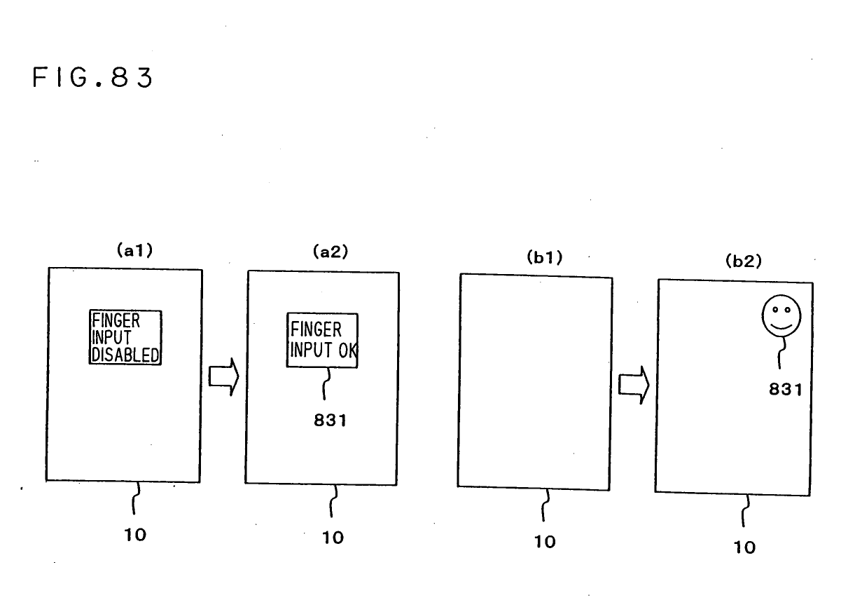

For example, when it is non-enterable in the low illuminance area where the illuminance of outside light is 50 Lx, as shown in FIG. 83 (a1), an icon 831 indicating “non-enterable with finger” is displayed. When it is enterable with a relatively high illuminance, the icon 831 indicating “enterable with finger” is displayed as shown in FIG. 83(a2).

As shown in FIG. 83(b2), when input with finger is possible, it is also possible to display the icon 831 of a character. When it is non-enterable, no icon is displayed as shown in FIG. 83(b1). It is also possible to allow the operator to determine whether it is enterable or non-enterable by voice guidance. As a sign to allow the operator to determine whether it is enterable or non-enterable, the color of the character can be changed. It is also applicable to let the operator know by vibrations of a vibrator. Alternatively, the magnitude of the illuminance of outside light may be displayed on the display screen 10. The brightness of the backlight 656 may be varied according to the magnitude of the illuminance of outside light. The color of the display screen 10 may be changed. The backlight may be flickered. A buzzer sound may be generated.

As described above, the present invention demonstrates a characteristic effect such that the illuminance of outside light can be detected accurately with the photosensor pixels 27 without providing the photosensor that detects the illuminance of outside light.

### [E-4] Fourth Embodiment

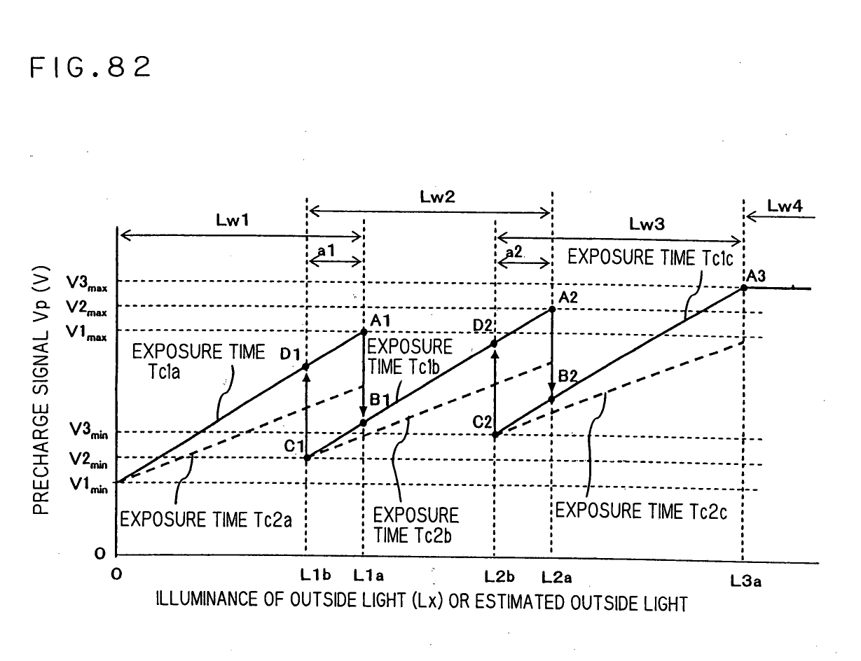

As shown in FIG. 82, in the indoor (low illuminance) area, the illuminance of outside light or estimated outside light covers a range between 0 and L1a (Lx) (Lw1) The range of the precharge signal Vp at that time is assumed to be between V1min and V1max. The value of L1a (Lx) can be adjusted or set by the exposure time Tc and the precharge signal Vp.

In the outdoor (high illuminance) area, the illuminance of outside light or the estimated outside light covers a range from L1b and L2a (Lw2). The range of the precharge signal Vp at that time is assumed to be between V2min and V2max. The range between L1b and L2a can be adjusted or set by the exposure time Tc and the precharge signal Vp.

In the area where the sunlight is irradiated directly (extra-high illuminance), the illuminance of outside light and the estimated outside light covers a range between L2b and L3a (Lw3). The range of the precharge signal Vp at that time is a range between V3min and V3max. The range between L2b and L3a can be adjusted or set by the exposure time Tc and the precharge signal Vp. In a range larger than L3a, the maximum value V3max of the precharge signal Vp is preserved. In this case, the exposure time Tc can be reduced.

The present invention is characterized in that the illuminance ranges that are covered (Lw1, Lw2, Lw3) are overlapped with each other as shown in FIG. 82. In other words, the range of Lw1 and the range of Lw2 are overlapped with each other in area a1. The range of Lw2 and the range of Lw3 are overlapped with each other in the area a2. The values of a1 and a2 are at least 0 or larger. The values of a1 and a2 can be adjusted by setting the range of variations in the precharge signal Vp in each area (Vn min, Vn max, where n is any one of 1, 2 and 3 in the embodiment shown in FIG. 82), and setting of the exposure time Tc. By providing the ranges of a1 and a2, the following effects are demonstrated.

(1) Calibration

An adjustment operation for calibration will be described first. In the plane display device in the present invention, a case in which the precharge signal Vp is varied for performing the calibration is considered. The illuminance of outside light is between L2a and L3a, and the calibration is started from the precharge signal Vp=V1min in the range of Lw1. The precharge signal Vp varies in the higher direction.

When the precharge signal reaches a point A1, at which the precharge signal is Vp=V1max, that is, the highest value in the range of Lw1, it is moved to the range of Lw2, and the precharge signal Vp is varied to a point B1. At this time, the exposure time Tc also varies. Since the illuminance of outside light (or estimated outside light) is still higher, the calibration setting is not achieved also in the range of Lw2, and the precharge signal Vp increases in the range of Lw2.

When the precharge signal reaches a point A2, at which the highest precharge signal is Vp=V2max, that is, the highest value in the range of Lw2, it is moved to the range of Lw3, and the precharge signal Vp is varied to a point B2. The exposure time Tc is also varied to a value set in the range of Lw3. The precharge signal Vp varies in the range of Lw3, and an adequate precharge signal Vp for a target illuminance of outside light (estimated outside light) is defined.

(2) Hysteresis Operation

Outside light varies constantly. The amount of light entering into the display area 10 varies due to the effect of the shadow of the object 701 or the like. The present invention changes the range from Lw1, Lw2 . . . according to the illuminance of outside light. However, in the respective ranges (Lw1, Lw2, Lw3 . . . ), the exposure time Tc varies. The precharge signal Vp also varies significantly and accuracy also varies. Therefore, it is preferable that movement does not occur among the respective ranges (Lw1, Lw2, Lw3 . . . ) very often.

In the present invention, the hysteresis characteristic is provided by the provision of the ranges of a1 and a2. For example, when the precharge signal Vp is adjusted in the range of Lw1, when the precharge signal Vp reaches the point A1, it moves to the point B1 in the range of Lw2. It returns to the range of Lw1 only when the precharge signal Vp is lowered to a point C1 in the range of Lw2.

When it reaches the point C1, it varies to a point D1 in the range of Lw1, and the exposure time Tc or the like varies. Likewise, when adjusting the precharge signal Vp in the range of Lw2, when the precharge signal Vp reaches the point A2, it moves to the point B2 in the range of Lw3. It returns to the range of Lw2 again only when the precharge signal Vp is lowered to a point C2 within the range of Lw3. When it reaches the point C2, it varies to a point D2 in the range of Lw2, and the exposure time Tc or the like varies.

As described above, since the overlapped ranges (a1, a2) are provided among the respective ranges (Lw1, Lw2, Lw3), the number of time of movement in the respective ranges is reduced. Therefore, the calibration can be performed in the stable state. The stability can easily achieved by adjusting the size of the a1 and a2. In other words, by providing the overlapped ranges, a hysteresis operation in which the movement between ranges does not occur within a certain range of variation of outside light is achieved.

The overlapped periods (ranges) of the respective ranges (Lw1, Lw2, Lw3) (a1, a2) may be differentiated. However, if they are the same, calibration processing is facilitated. For the highest range of Lw3 or higher, the maximum precharge signal Vp is preferably set to V3max and the exposure time Tc is reduced to achieve calibration processing. It is because the margin range of the calibration voltage is high in the extra-high illuminance of outside light. It is also because even when the precharge signal Vp is set to a constant value, operation is achieved without problem, and the calibration processing is facilitated.

(3) Setting of Exposure Time Tc

The exposure times Tc1, Tc2 for the respective ranges (Lw1, Lw2, Lw3) may be the same, and may be different. The relation between the exposure time Tc1a of the smallest illuminance range of Lw1 and the exposure time Tc1b of the next illuminance range of Lw2 (Tc1a/Tc1b) is set to be satisfy a range between 2 and 8. The relation between the exposure time Tc1c of the largest illuminance range of Lw3 and the exposure time Tc1b of the previous illuminance range of Lw2 (Tc1b/Tc1c) is set to be satisfy a range between 4 and 12. In other words, in the range of low illuminance, variation in the exposure time Tc is reduced, and in the range of high illuminance, variation in exposure time Tc is increased.

### F. Characteristic Compensation of Photosensor

When there is no variation in characteristic or characteristic inclination of the photosensor 35 or the like in the input screen (display area) 10, the voltage Vk or the voltage V0 in FIG. 79 is basically obtained in the entire display area 10. In other words, one value of Vk is obtained (or calculated) with the entire variations in characteristics of the photosensor pixels 27 in the display area 10.

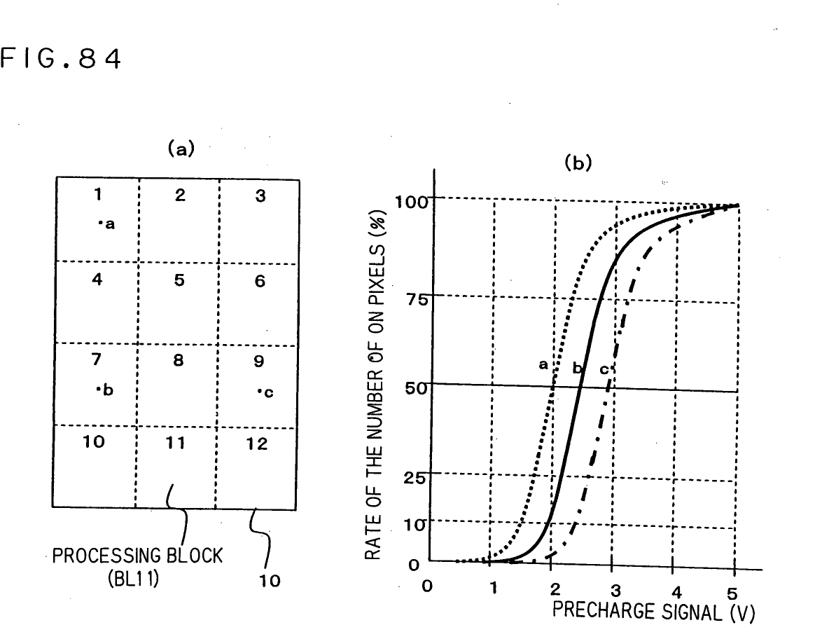

It is also possible to obtain the calibration voltage Vk in respective areas 861 as a matter of course. As shown in FIG. 84, the display area 10 is divided into a plurality of the processing blocks (BL) 861 and the voltages Vk is obtained for the respective processing blocks (BL) 861.

The processing blocks may be obtained by dividing the entire display area 10 into a plurality of blocks or by dividing a part or a predetermined range of the display area 10 into a plurality of blocks. The processing block (BL) is also divided into a plurality of sections. Although the section has the plurality of photosensor pixels 27, a smallest configuration includes “one photosensor pixel 27=one section”. There may be a case in which “one processing block (BL)=one section”. Therefore, the smallest configuration of the processing block may be “one processing block (BL)=one photosensor pixel 27”.

(1) Characteristic Distribution

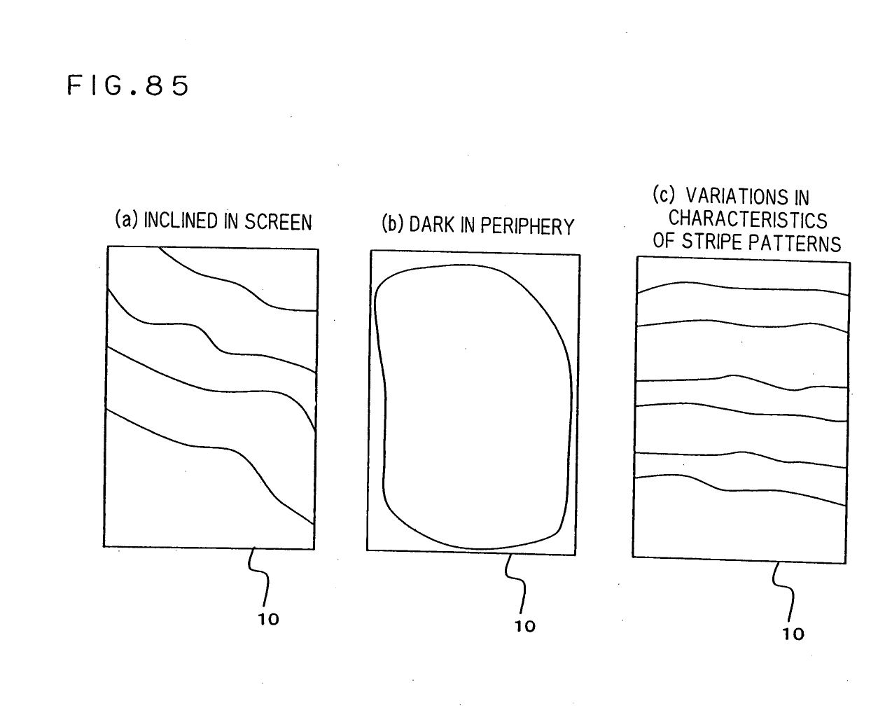

The display area 10 has the characteristic inclination in a constant direction. For example, as shown in FIG. 85(a), there is the characteristic inclination of the photosensor 35, the transistor 32b, and so on in the input screen 10. As shown in FIG. 85(b), the characteristics of the photosensor 35 and the transistor 32b may be different between the center portion and the peripheral portion of the input screen 10. As shown in FIG. 85(c), there may be a case in which a band-shaped characteristic distribution of the photosensor 35, the transistor 32b or the like may be generated in the input screen 10.

Because of the variations in characteristics of the photosensors 35 and the transistors 32b described in conjunction with FIG. 85, in the respective processing blocks (BL) 861 shown in FIG. 84(a), the characteristic of the rate of the number of the ON pixels (%) with respect to the precharge signal Vp varies in a certain range as shown in FIG. 84(b). As an example, a solid line represents an average value in the input screen 10, a dotted line represents a smallest value, and a chain line represents a largest value in FIG. 84(b). For example, the characteristic of a point a in the processing block (BL) 861 may assume the characteristic curve shown by the dotted line, the characteristic of a point b in the processing block (BL) 861 may assume the characteristic curve shown by the solid line, and the characteristic of a point c in the processing block (BL) 861 may assume the characteristic curve shown by the chain line.

(2) Processing Block (BL)

When the value of Vk is obtained from the entire display area 10, it corresponds to the initial voltage of the solid line in FIG. 84(b). As an example, the precharge signal Vp is 1V. As shown in FIG. 78(a), since it is approximated to a straight line, the value of V0 will be on the order of 1.5 V. The processing block is to be added with a reference sign BL or a reference numeral 861.

In the respective processing blocks in the display area 10, as shown in FIG. 84, the value of Vk or V0 is different in the respective processing blocks (BL) 861. Therefore, when the value of Vk or V0 is obtained from the entire input screen (display area) 10, the calibration is deviated from the adequate value.

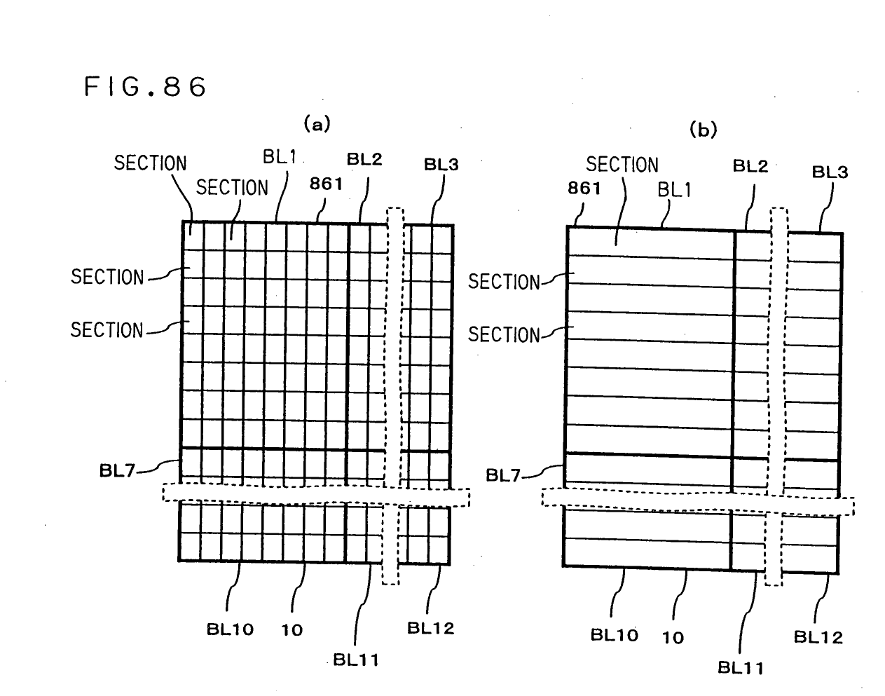

In the present invention, this problem is solved as follows. In the present invention, as shown in FIG. 86, the processing block (BL) 861 (in the example, it is divided into BL1 to BL12 as shown in FIG. 84(a)) is further divided into a plurality of sections (FIG. 86). Each section includes the plurality of photosensor pixels 27.

(3) Processing Block (BL) and Section

FIG. 86(a) is a drawing showing an example in which the processing block (BL) 861 is divided into the sections in a matrix manner. FIG. 86(b) is an example in which the processing block (BL) 861 is divided into sections in stripes. Each section in FIG. 86(a) includes the plurality of photosensor pixels 27. Sections in strips shown in FIG. 86(b) is made per pixel row. In other words, it is divided per pixel row or per photosensor pixel 27. The division is not limited thereto, and may be divided per several photosensor pixel 27 rows.

(4) Application of Precharge Signal Vp

The embodiment shown in FIG. 86(b) will be exemplified for description in order to facilitate description. It is because implementation of the example shown in FIG. 86(a) can be achieved by changing the division shown in FIG. 86(b) into the direction of pixel row.

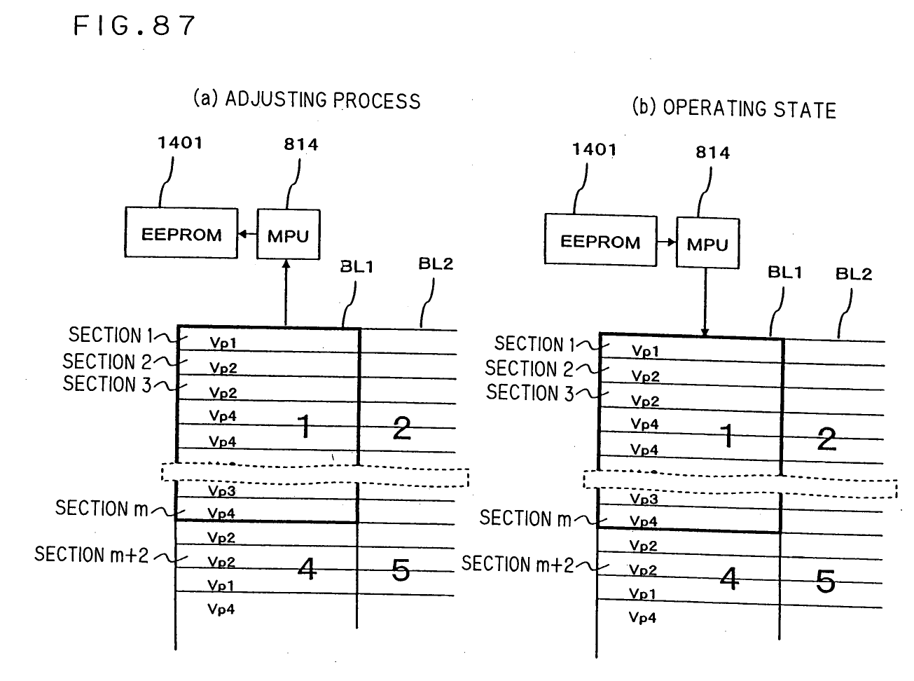

FIG. 87 is an explanatory drawing showing a drive method or a control system for compensating the variations in characteristics of the photosensors 35 and the transistors 32b. FIG. 87(a) is an explanatory drawing explaining the adjustment process of the plane display device in the present invention. FIG. 87(b) is an explanatory drawing of the operating state (state of usage) of the plane display device in the present invention.

In FIG. 87(a), the plurality of precharge signals Vp are applied to the processing block (BL) 861 in FIG. 87(a). The same precharge signal Vp is applied to the respective sections. Therefore, the plurality of precharge signals Vp are applied to the processing block (BL) 861 so that the precharge signal applied in the direction of the pixel row as a section becomes the same.

In FIG. 87(a), description is made such that the precharge signal Vp is applied to the photosensor pixel 27 or the photosensor 35. The precharge signal Vp in this description is a signal for adjusting the display device in the present invention. The characteristics of the photosensor pixel 27 or the photosensor 35 are detected by applying the precharge signal Vp and adjusting the precharge signal Vp. Therefore, it may be adequate to be referred to as characteristic detection signal rather than as the precharge signal Vp. However, since the characteristic detection signal and the precharge signal Vp have the same function, the description will be made as the precharge signal Vp in this specification.

In FIG. 87, the difference in magnitude of the precharge signal Vp is indicated by the numerals 1 to 4, that is, 1 (precharge signal Vp1), 2 (precharge signal Vp2), 3 (precharge signal Vp3) and 4 (precharge signal Vp4). The “1” is the lowest precharge signal Vp and the “4” is the highest precharge signal Vp. A plurality of types of the precharge signals Vp are generated by the photosensor processing circuit 18.

(4-1) Magnitude of Precharge Signal Vp

The number of the magnitudes of the precharge signal Vp is preferably four or more. However, even two or more types may accommodate a relatively large range of outside light.

For example, the precharge signal Vp may be classified into two steps of 2.50 V and 2.52 V. The precharge signal Vp may be classified into four steps of 2.50 V, 2.51 V, 2.52 V and 2.53 V. The precharge signal Vp when divided into eight steps will be 2.50 V, 2.51 V, 2.52 V, 2.53 V, 2.54 V, 2.55 V, 2.56 V and 2.57 V.

(4-2) Difference Between Precharge Signals Vp

The difference between the precharge signals Vp is preferably between 0.05 and 0.2 V. It is preferable to divide the voltage from V0 to V3 in FIG. 78(a) by an integer. It is also preferable to be able to vary for each processing block (BL) 861. For example, in the block 1 of the processing block (BL) 861, the precharge signals Vp are set to be 2.50 V, 2.51 V, 2.52 V and 2.53 V, and in the block 2 of the processing block (BL) 861, the precharge signals Vp are set to 2.53 V, 2.54 V, 2.55 V and 2.56 V. The type of the precharge signal Vp is preferably multiples of 2. In other words, the types of the precharge signals Vp are set to 2, 4, 6, 8, . . . .

(4-3) Position of Application of Precharge Signal Vp

In FIG. 87, the precharge signals Vp 1 to 4 are most preferably varied from pixel row to pixel row. However, when it is varied from pixel row (photosensor pixel row) to pixel row, processing becomes complex, and much capacity of the memory 1401 is necessary for storing the result. Therefore, as shown in FIG. 87, it is preferable to change from one pixel row to one pixel row. It is also possible to vary the same every two pixel rows or every plural pixel rows as a matter of course.

(5) Drive Method of Liquid Crystal Panel

In the drive method of the liquid crystal panel, in the case of a line inversion drive, positive and negative picture signals are applied for each pixel row. The source signal line 23 and the photosensor pixel 27 are coupled by the parasitic capacitance. Therefore, the potential level of the photosensor pixels 27 varies depending on the polarity of the picture signal. In particular, the effect of the polarity is significant when the signal line for applying the precharge signal Vp and the source signal line for applying the picture signal are shared as shown in FIG. 43.

When the value of the precharge signal Vp is varied every two pixel rows, since the picture signals of the positive polarity and the negative polarity are applied to the every two pixel rows in pairs, the potential level is not affected by the polarity of the picture signal, the effect may be alleviated. Therefore, it is effective to cause the voltage of the precharge signal Vp to be varied every two pixel rows.

In other words, the precharge signal Vp1 is applied to the first and second pixel rows, the precharge signal Vp2 is applied to the third and fourth pixel rows, the precharge signal Vp3 is applied to the fifth and sixth pixel rows, and so forth. Alternatively, the precharge signal Vp1 is applied to the first, second, third and forth pixel rows, the precharge signal Vp2 is applied to the fifth, sixth, seventh and eighth pixel rows, the precharge signal Vp3 is applied to the ninth, tenth, eleventh and twelfth pixel rows, and so forth.

In this manner, when the line inversion drive varies the polarity of the picture signal for each pixel row, the precharge signal Vp is varied every two pixel rows. In other words, the precharge signal Vp is varied with the cycle of the negative polarity of the picture signal as one unit. Therefore, the cycle of the negative polarity of the picture signal is taken into consideration for division into sections.

The embodiment described above is description of division in the direction of the pixel row. When the drive method of the liquid crystal panel is a method of varying the polarity of the picture signal in the column direction such as a column inversion, division is made corresponding to the pixel columns.

Varying the precharge signal Vp by every pixel row or every plural pixel rows, may be achieved by a single source of the precharge signal Vp. It is because the precharge signal Vp to be applied must simply be varied every horizontal scanning period or ever plural horizontal scanning periods.

(6) Variation of Precharge Signal Vp

The precharge signals Vp of the respective processing blocks (BL) 861 are determined according to the magnitude of the illuminance of outside light and the illuminance of the backlight 656. Which precharge signal Vp is to be selected is determined by being detected (measured) in the inspection process before shipping of the panel 656. In this case, the backlight 656 to be used actually or the light source similar thereto is mounted. In particular in the periphery of the display area 10, there is a case in which the precharge signal Vp to be selected may vary under the influence of the backlight 656 or the like.

(7) Basic Precharge Signal Vp

It is also possible to set by a difference from a value of a basic precharge signal Vp, not by the absolute value of the precharge signal Vp. The basic precharge signal Vp is assumed to be V0, and the difference values are set to 0.1 V, 0.25 V, 0.32 V, 0.11 V and so on. Therefore, the precharge signals Vp to be applied to the respective photosensor pixels 27 are V0+0.10, V0+010, V0+0.25, V0+0.30, V0+0.32, . . . . In other words, the precharge signal Vp having a center value (basic precharge signal Vp) is determined and the magnitudes of the plurality of precharge signals Vp are determined on the basis of this precharge signal Vp.

(8) Method of Adjustment

FIG. 87(a) is an explanatory drawing showing a method of adjusting the plane display device according to the present invention. In FIG. 87(a), the precharge c signal Vp is applied to each section. The precharge signal Vp to be applied is applied corresponding to the characteristic of the photosensor pixel 27. The rates of the number of the ON pixels (%) in each section are set. For example, the rates of the number of the ON pixels (%) which can be measured or figured out easily, such as 0%, 5%, 50%, and 100% are determined for the section. In order to facilitate description, the rate of the number of the ON pixels (%) is set to 50%.

In the description given below, the precharge signal Vp is determined by one rate of the number of the ON pixels (%), however, the invention is not limited thereto. For example, it is also possible to adjust the precharge signal Vp so that the rates of the number of the ON pixels (%) become 5% and 20% respectively, and consider or calculate the plurality of precharge signals Vp to obtain the predetermined one precharge signal Vp. In the description below, the rate of the number of the ON pixels (%) is set to a predetermined value. However, the invention is not limited thereto. For example, the precharge signal Vp may be adjusted and determined so that the respective sections have the same numbers of the ON pixels.

In FIG. 87(a), the precharge signal Vp is applied to the section 1, and the rate of the number of the ON pixels (%) is measured. When the rate of the number of the ON pixels (%) is smaller than 50%, a precharge signal Vp which is higher than the precharge signal Vp previously applied is applied. When the rate of the number of the ON pixels (%) is larger than 50%, a precharge signal Vp which is lower than the precharge signal Vp previously applied is applied. In this manner, the precharge signal Vp to be applied is varied to adjust the rate of the number of the ON pixels (%) to be 50% or a value close thereto. The value close thereto is +10% or below. More preferably, the precharge signal Vp is adjusted or set so as to be ±5% or below.

As described above, the precharge signal Vp is adjusted, the precharge signal Vp1 at which the rate of the number of the ON pixels (%) becomes 50% (it is assumed that when the precharge signal Vp1 is applied, the rate of the number of the ON pixels (%) becomes 50%) is obtained, and the value or data that represents the precharge signal Vp1 is stored in the EEPROM 1401 as the precharge signal Vp in the section 1. This operation is achieved by controlling the photosensor processing circuit 18 by the MPU 814.

In the same manner, the precharge signal Vp is applied to the section 2 and the rate of the number of the ON pixels (%) is measured. When the rate of the number of the ON pixels (%) is smaller than 50%, a precharge signal Vp which is higher than the precharge signal Vp previously applied is applied. When the rate of the number of the ON pixels (%) is higher than 50%, a precharge signal Vp which is lower than the precharge signal Vp previously applied is applied. In this manner, the precharge signal Vp to be applied is varied to adjust the rate of the number of the ON pixels (%) to be 50% or a value close thereto. The value close thereto is +10% or below. More preferably, the precharge signal Vp is adjusted or set so as to be ±5% or below.

In this manner, in the section 2 as well, the precharge signal Vp is adjusted, a precharge signal Vp2 at which the rate of the number of the ON pixels (%) becomes 50% (it is assumed that when the precharge signal Vp2 is applied, the rate of the number of the ON pixels (%) becomes 50%) is obtained, and the value or data that represents the precharge signal Vp2 is stored in the EEPROM 1401 as the precharge signal Vp in the section 2.

The same processing is performed for each section and an optimal precharge signal Vp suitable for the characteristic of the photosensor pixel 27 in each section (the precharge signal Vp at which the rate of the number of the ON pixels (%) becomes 50%) is measured or set, and the measured or set precharge signal Vp is stored in the storage means such as the EEPROM 1401.

In this manner, the precharge signals Vp for the respective sections are defined. In FIG. 87(a), the precharge signal Vp1, the precharge signal Vp2, the precharge signal Vp2 and the precharge signal Vp4, . . . are set to the section 1, the section 2, the section 3 and the section 4 . . . , and the set values are stored in the EEPROM 1401.

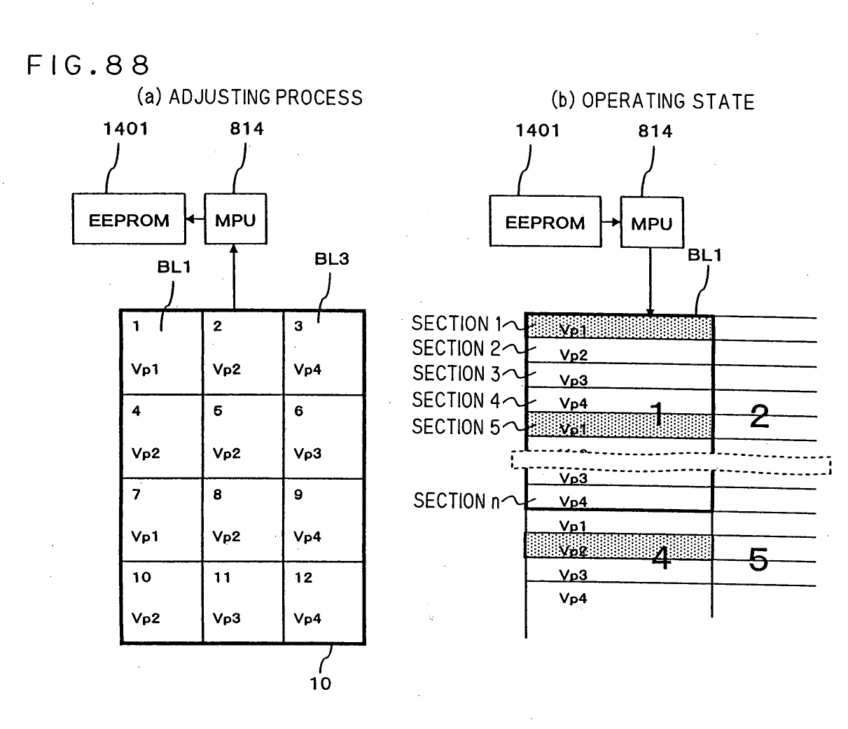

When performing the operation to apply the precharge signal Vp shown in FIG. 87(a), it is performed so that a light beam is not irradiated on the photosensor pixels 27. Alternatively, a light beam of known predetermined intensity is irradiated uniformly on the display area 10 or the photosensor pixels 27 formed therein, or irradiated uniformly on the photosensor pixels 27 to be adjusted. It is the same for FIG. 88. The exposure time Tc and the panel temperature are also fixed to predetermined values.

In this processing, in FIG. 79, when a is set to 50, the original position is determined, when a is set to 0 (the rate of the number of the ON pixels (%)=0), the point E is obtained. In the same manner, when the same processing is performed with the exposure time Tc/2, the point E or the point V0 is determined (see description in conjunction with FIG. 79 and FIG. 80). Therefore, the characteristic compensation of the photosensor pixel 27 can be achieved. The data of the precharge signal Vp stored in the EEPROM 1401 corresponds to the characteristic of the photosensor pixel 27 of the each section.

When the precharge signals Vp for applying the respective sections are generated by the precharge signal Vpx of the EEPROM 1401 and applied to the respective sections, the characteristic compensation of the photosensor pixels 27 is achieved. It is because that the data stored in the EEPROM 1401 reflects the characteristics of the photosensor pixels 27 in the respective sections.

(8-1) Operating State

Description of the operating state of the present invention is shown in FIG. 87(b). In the operating state, the precharge signal Vp or the data corresponding to the precharge signal Vp is read from the EEPROM 1401, and the precharge signals Vp corresponding to (compensating) the characteristics of the photosensor pixels 27 in the respective sections are obtained and applied to the photosensor pixels 27.

In FIG. 87(b), in order to facilitate understanding, 0 the precharge signal Vp in FIG. 87(a) and the precharge signal Vp in FIG. 87(b) are the same in the respective sections. However, as described in conjunction with FIG. 79, the precharge signal Vp to be applied is processed corresponding to V0 and Vk, and the precharge signal Vp after having processed is applied to the photosensor pixel 27 as a matter of course.

By driving or controlling as described above, the calibration processing or the rate of the number of the ON pixels (%) processing can be adequately performed. Also, as shown in FIG. 87, even when the variations in characteristics or distributions of the photosensor pixels 27 exist as sown in FIG. 85, it can be compensated. Therefore, erroneous input does not occur in the entire input area 10, and hence favorable coordinate input is achieved.

(8-2) Modification of Adjustment Method

The embodiment shown in FIG. 87 is a system in which the optimal precharge signal Vp is determined for each section, and the data corresponding to the determined precharge signal Vp or the data corresponding to the precharge signal Vp is stored in the EEPROM 1401.

FIG. 88 is an explanatory drawing of the method of measuring the precharge signal Vp which meets the characteristics of the photosensor pixels 27 in the processing block (BL) 861, and storing the precharge signal Vp of the processing block (BL) 861 or the data showing the precharge signal Vp in the EEPROM 1401 in the adjusting process.

When in operation, different precharge signals Vp are applied to the sections in the respective processing blocks (BL) 861 to extract sections corresponding to the precharge signals Vp stored in the EEPROM 1401 described above, and the rates of the number of the ON pixels (%) of the extracted sections are obtained for performing the calibration process or the like.

FIG. 88(a) is an explanatory drawing showing the adjusting process. The precharge signal Vp is applied to the respective processing blocks (BL) 861 or the entire display area 10. In order to facilitate the description, it is assumed in the description such that the precharge signals Vp are applied to the respective processing blocks (BL) 861, and the optimal precharge signal Vp is measured or adjusted.

In FIG. 88(a), the precharge signal Vp is applied to the processing block (BL1) 861 and the rate of the number of the ON pixels (%) is measured. When the rate of the number of the ON pixels (%) is smaller than 50%, a precharge signal which is higher than the precharge signal Vp previously applied is applied. When the rate of the number of the ON pixels (%) is higher than 50%, a precharge signal Vp which is lower than the precharge signal Vp previously applied is applied. In this manner, the precharge signal Vp to be applied is varied to adjust the rate of the number of the ON pixels (%) to be 50% or a value close thereto.

As described above, the precharge signal Vp is adjusted, a precharge signal Vp1 at which the rate of the number of the ON pixels (%) becomes 50% (it is assumed that when the precharge signal Vp1 is applied, the rate of the number of the ON pixels (%) becomes 50%) is obtained, and the value or data that represents the precharge signal Vp1 is stored in the EEPROM 1401 as the precharge signal Vp in the section 1.

In the same manner, the precharge signal Vp is applied to the processing block (BL2) 861 and the rate of the number of the ON pixels (%) is measured. When the rate of the number of the ON pixels (%) is smaller than 50%, a precharge signal which is higher than the precharge signal Vp previously applied is applied. When the rate of the number of the ON pixels (%) is higher than 50%, a precharge signal Vp which is lower than the precharge signal Vp previously applied is applied. In this manner, the precharge signal Vp to be applied is varied to adjust the rate of the number of the ON pixels (%) to be 50% or a value close thereto.

As describe above, in the processing block (BL2) 861 as well, the precharge signal Vp is adjusted, the precharge signal Vp2 at which the rate of the number of the ON pixels (%) becomes 50% (it is assumed that when the precharge signal Vp2 is applied, the rate of the number of the ON pixels (%), becomes 50%) is obtained, and the value or data representing the precharge signal Vp2 is stored in the EEPROM 1401 as the precharge signal Vp of the processing block (BL) 861.

The same processing is performed for each section and an optimal precharge signal Vp suitable for the characteristic of the photosensor pixel 27 in each section (the precharge signal Vp at which the rate of the number of the ON pixels (%) becomes 50%) is measured or set, and the measured or set precharge signal Vp is stored in the storage means such as the EEPROM 1401.

In this manner, the precharge signals Vp for the respective processing blocks (BL) 861 are defined. In FIG. 87(a), the precharge signal Vp1, the precharge signal Vp2, the precharge signal Vp4, the precharge signal Vp2, . . . are set to the processing block (BL1) 861, the processing blocks (BL2) 861 and the processing blocks (BL3) 861 . . . , and the set values are stored in the EEPROM 1401.

When performing the operation to apply the precharge signal Vp shown in FIG. 88(a), it is performed so that a light beam is not irradiated on the photosensor pixels 27 as shown in FIG. 87. Alternatively, it is performed in a state in which a light beam of known predetermined intensity is irradiated on the photosensor pixel 27. The light beam of the known predetermined intensity is irradiated uniformly on a area in which the photosensor pixels 27 are formed. The exposure time Tc and the panel temperature are also fixed to predetermined values. The temperature setting is set to the temperature in the operating state or the value close thereto. Since other configurations are the same as FIG. 87(a), description will be omitted.

In the description in FIG. 88(a), the precharge signal Vp is applied to the processing block (BL) 691. However, the precharge signal Vp is a signal for adjusting the display device in the invention. The characteristics of the processing blocks 691 are measured or detected by applying the precharge signal Vp and adjusting the precharge signal Vp. Therefore, it may be adequate to be referred to as characteristic detection signal rather than as the precharge signal Vp.

The operating state in FIG. 88(b) is different from the operating state in FIG. 87(b). In FIG. 87(b), the precharge signals Vp read from the EEPROM 1401 or the precharge signals Vp generated from the data corresponding to the precharge signal Vp are applied to the respective sections.

In the case of FIG. 88(b), the precharge signals Vp are applied at predetermined steps in reference to the predetermined precharge signal Vp to the respective sections. The predetermined precharge signal Vp is a precharge signal Vp stored in the EEPROM 1401 in FIG. 88(a) or a precharge signal Vp generated from this precharge signal Vp. A plurality of the precharge signals Vp are generated before and after this precharge signal Vp at predetermined steps and are applied to the respective sections in sequence.

In FIG. 88(b), in order to facilitate understanding, the types of the precharge signals Vp are 5 types of Vp1 to Vp5. The five types of the precharge signals Vp, not an average value of the precharge signals Vp in the respective blocks (BL) 861, are applied to the respective sections in sequence.

In FIG. 88(b), the five types of precharge signals Vp are applied in sequence in the processing block (BL1) 861 such that the precharge signal Vp1 is applied to the section 1, the precharge signal Vp2 is applied to the section 2, the precharge signal Vp3 is applied to the section 3, the precharge signal Vp4 is applied to the section 4, the precharge signal Vp5 is applied to the section 5, the precharge signal Vp1 is applied to the section 6, the precharge signal Vp2 is applied to the section 7, the precharge signal Vp3 is applied to the section 8 . . . .

The center values of the precharge signals Vp to be applied to the respective processing blocks (BL) 861 may be different from each other. For example, the precharge signals are set to values in 0.2 (V) steps, such as the precharge signal Vp1=2.0 (V), the precharge signal Vp2=2.2 (V), the precharge signal Vp3=2.4 (V), the precharge signal Vp4=2.6 (V) and the precharge signal Vp5=2.8 (V). Since the precharge signal Vp1 is 2.0 (V) in the processing block (BL1) 861, the precharge signals Vp in two steps are generated before and after the precharge signal Vp1, and applied to the processing block (BL1) 861. Therefore, the precharge signals Vp to be applied to the respective sections are five types of voltages; 1.6, 1.8, 2.0, 2.2 and 2.4.

Since the precharge signal Vp2=2.2 (V) in the processing block (BL2) 861, the two steps of precharge signals Vp are generated before and after the precharge signal Vp2, and applied to the processing block (BL1) 861. Therefore, the precharge signals Vp to be applied to the respective sections are five types of voltages; 1.8, 2.0. 2.2, 2.4 and 2.6.

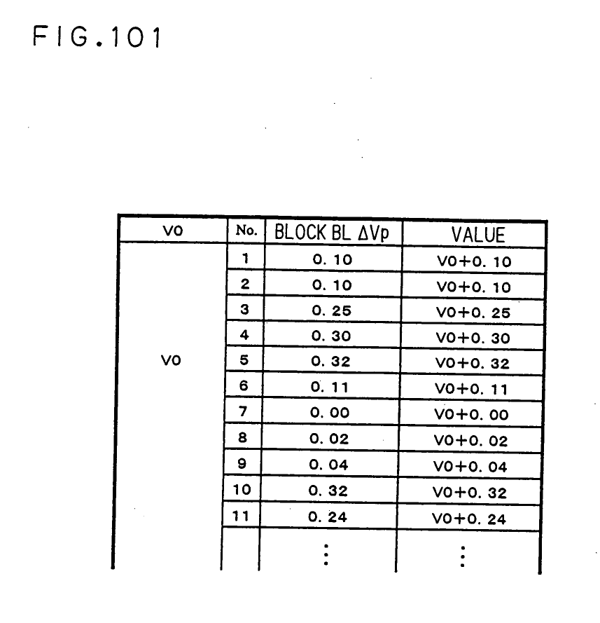

As shown in FIG. 101, the difference ΔVp for each processing block (BL) 691 may be set and specified by a selected number. For example, when No.=2 is specified, ΔVp=0.1 V, and hence the precharge signal Vp=V0+0.10. The difference ΔVp data is stored in the EEPROM.

The ΔVp in FIG. 101 is the difference among the respective processing blocks (BL) 691. However, the invention is not limited thereto. ΔVp may be the difference among the sections (see FIG. 87, FIG. 88, and so on). ΔVp may be, not only in the positive direction (for example No. 3 is +3.0 V), or may be in the negative direction (for example, No. 2 is −0.10V, No. 3 is −0.25V).

In the embodiment shown in FIG. 101, V0 may be the precharge signal Vp obtained by averaging the characteristics of the photosensor pixels 27 in the input area, and ΔVp may be the characteristic differences between the precharge signal Vp=V0 and the photosensor pixels 27 of the respective sections. For example, in the case of the reference precharge signal Vp=V0=2.5 V, it is assumed that ΔVp of the section 1 (No. 1) is 0.10 V, ΔVp of the section 2 (No. 2) is 0.10 V, ΔVp of the section 3 (No. 3) is 0.25 V, ΔVp of the section 4 (No. 4) is 0.30 V, ΔVp=0.32 V of the section 5 (No. 5) . . . . In the present invention, the precharge signal Vp=(2.5+0.10) V is applied to the section 1 (No. 1), the precharge signal Vp=(2.5+0.10) V is applied to the section 2 (No. 2), the precharge signal Vp=(2.5+0.25) V is applied to the section 3 (No. 3), the precharge signal Vp=(2.5+0.30) V is applied to the section 4 (No. 4), and the precharge signal Vp=(2.5+0.32) V is applied to the section 5 (No. 5).

There are optimal values of the reference precharge signal Vp=V0 voltage depending on the illuminance of outside light and the panel temperature, it is varied by the calibration. In other words, the reference precharge signal Vp=V0 constantly varies according to the illuminance of outside light or the like. ΔVp shows a relative characteristic difference among the photosensor pixels 27 in the section or the processing block (BL) 691. The rate of the number of the ON pixels (%) of the photosensor pixels 27 in the input area is adjusted to the predetermined value or the predetermined range by calibration, and the precharge signal Vp applied at that time is set to the reference precharge signal Vp=V0. The ΔVp indicating the characteristic difference among the photosensor pixels 27 in the respective sections or the processing blocks (BL) 691 is added to the reference precharge signal Vp=V0 (when ΔVp is in the negative direction, it is reduced). Although ΔVp indicates the characteristic difference among the photosensors or the like in the description, the invention is not limited thereto, and it may be the one in which the effect of a light beam emitted from backlight is taken into consideration. In particular, the peripheral portion of the panel is different in optimal value of precharge signal Vp from the center portion of the panel since the light beam from the backlight wraps around the panel. The difference is measured as ΔVp and stored in the EEPROM.

In each section or the processing block (BL) 691, the characteristic difference ΔVp of photosensor pixels 27 or the photosensors 35 is measured or acquired in the process or adjusting the panel, or the effect of the backlight is taken into consideration. The characteristic difference ΔVp is stored in the EEPROM. When the panel is operated, the characteristic difference ΔVp among the respective sections of the respective processing blocks (BL) 691 stored in the EEPROM is added to or subtracted from the precharge signal Vp=V0 which is a reference obtained by the calibration, and the precharge signals Vp (V0+ΔVp) applied to the respective sections or the respective processing block (BL) 691 are obtained. The obtained precharge signals Vp(V0+ΔVp) are applied to the respective processing blocks (BL) 691 or the respective sections.

In this arrangement or execution, the effect of the characteristic distribution of the photosensor pixels 27 or the like can be cancelled, and hence the favorable coordinate input and the contact determination of the object are achieved. In the embodiment described above, the ΔVp of the sections or the processing blocks (BL) 691 is acquired. However, the invention is not limited thereto, and it is also possible to acquire the ΔVp data in the respective photosensor pixels 27, store the same in the memory or the like, or generate the precharge signal Vp using the ΔVp data. In the embodiment described above, ΔVp data is stored in the EEPROM or the like. However, the invention is not limited thereto, and the acquired data such as ΔVp may be held temporarily using a sample hold circuit.

It can also be applied to other embodiments of the invention as a matter of course. The embodiments of the invention such as those shown in FIG. 87, FIG. 88, FIG. 101, and so on can be combined with each other as a matter of course. In other words, the embodiments of the invention can be implemented independently and in combination.

A section employed for the rate of the number of the ON pixels (%) coincides with the precharge signal Vp of the processing block (BL) 861 in FIG. 88(a). For example, since the precharge signal Vp of the processing block (BL1) 861 is Vp1, it corresponds to a position where the precharge signals Vp=Vp1 as in the section 1 and section 6 in the processing block (BL1) 861 in FIG. 88(b) are applied. Other positions are not used for calculation or processing of the rate of the number of the ON pixels (%).

Likewise, since the precharge signal Vp in the processing block (BL2) 861 is Vp2, the section of the processing block (BL2) 861 in FIG. 88(b) employed is a position where the precharge signal Vp=Vp2 is applied. In the same manner, since the precharge signal Vp of the processing block (BL3) 861 is Vp4, a position (section) where the precharge signal Vp=Vp4 is applied is employed from the sections of the processing block (BL3) 861 in FIG. 88(b).

In the employed section, the characteristics of the photosensors 35 or the like in the respective processing blocks (BL) 861 are measured to obtain the precharge signal Vp or the data corresponding to the precharge signal Vp having a quintessential or average characteristics in the adjustment processing in FIG. 88(a). Therefore, the sections selected in FIG. 88(b) are sections to which the precharge signals Vp which are coincided with the characteristics of the processing block (BL) 861 are applied.

Therefore, by selecting the sections where the precharge signal Vp which is coincided with the characteristics of the respective processing blocks (BL) 861 is applied and not selecting others, erroneous input or erroneous detection can be avoided. Processing such as the rate of the number of the ON pixels (%), approach, contact, separation is performed using the ON/OFF-state of the photosensor pixels 27 in the selected sections.

The type of the precharge signal Vp to be applied to one processing block (BL) 861 is preferably multiples of 2, and more preferably, between 4 and 8. The number of types is preferably between 2 and 16. When the number of types of the precharge signals Vp is small, variations in the display area 10 cannot be compensated. When it is too much, the number of photosensor pixels per type is reduced, and the accuracy of detecting the coordinate is lowered.

(9) Types of Precharge Signals Vp to be Applied to Processing Block

The types of the precharge signals Vp to be applied to one processing block (BL) 861 may be determined corresponding to the intensity of outside light or the backlight 656 (brightness or illuminance). When the illuminance is low, the number of types of the precharge signals Vp to be applied to one processing block (BL) 861 is increased. In the range of high illuminance, the number of types of the precharge signals Vp to be applied to one processing block (BL) 861 is reduced. It is because the margin of the calibration is narrow in the range of the low illuminance.

(10) Variations in Precharge Signals Vp

It is recommended to determine the width of variation in the plurality of precharge signals Vp to be applied to one processing block (BL) 861 corresponding to the intensity of outside light or the backlight 656 (brightness or illuminance). When the illuminance is low, the width of the precharge signal Vp is increased. In the range of high illuminance, the width of variation in the precharge signal Vp is reduced. It is because the margin of the calibration is reduced in the range of low illuminance.

Matters described above (types and width of variations in the precharge signal Vp) may be combined when used for the illuminance of outside light.

In the embodiments shown in FIG. 87 and FIG. 88, the characteristics of the photosensor pixels 27 of the processing blocks (BL) 861 and the sections are measured, and the precharge signals Vp which match the characteristics are applied or set to predetermined potentials for performing the rate of the number of the ON pixels (%) processing. In other words, it employs a system in which the precharge signals Vp are applied so as to match the characteristics of the photosensor pixels 27. By bringing the precharge signals Vp to match the characteristics, the variations in characteristics of the photosensor pixels 27 can be compensated, and hence erroneous input is avoided.

G. Setting of Non-Enterable Area

When the precharge signal Vp which does not match at all the characteristics of the photosensor pixel 27 is applied, the photosensor pixel 27 in question does not operate any more. For example, when the precharge signal Vp of 5.0 (V) is applied to the photosensor pixel 27 whose optimal precharge signal Vp is 1.5 (V), it is kept in the constantly ON-state. Alternatively, the ON-state or the OFF-state is maintained because of entry of outside light, and there arises a difference between the position where the normal precharge signal Vp is applied and the operation thereof. Therefore, by identifying the difference, the operation can be varied.

When the precharge signal Vp of 0.5 (V) is applied to the photosensor pixel 27 whose optimal precharge signal Vp is 2.5 (V), it is kept in the constantly OFF-state. Alternatively, the ON-state or the OFF-state is maintained because of entry of outside light, and there arises a difference between the position where the normal precharge signal Vp is applied and the operation thereof. Therefore, by identifying the difference, the operation of the plane display device in the present invention can be varied.

In order to facilitate the description, the present invention will be described under the following assumed conditions. Input to the plane display device in the present invention is achieved by shielding outside light by the light-shielding substance 701 such as the finger. Therefore, the precharge signal Vp that makes the transistor 32b in the ON-state is applied to the photosensor pixel 27, the photosensor pixels 27 shielded from a light beam by the finger 701 are kept in the ON-sate, and the photosensor pixels 27 on which outside light is irradiated are brought into the OFF-state.

To the processing blocks (BL) 861 which are not intended to be reacted, the precharge signal Vp which brings the photosensor pixels 27 into the OFF-state is applied from the beginning or the precharge signal Vp is not applied. An embodiment in which a very high precharge signal Vp is applied to the photosensor pixels 27 which are not intended to be reacted so that the ON-sate is maintained even when outside light is irradiated is also exemplified.

The precharge signal Vp optimal for the processing block (BL) 861 is different depending on the variations in characteristics of the photosensor pixels 27 (FIG. 85). However in order to facilitate the description, the precharge signal Vp optimal for the respective processing blocks (BL) 861 is assumed to be 2.5 (V). It is assumed that the photosensor pixels 27 is turned into the OFF-state and finally does not react any longer as the precharge signal to be applied is decreased. In other words, it starts to be hard to react as the precharge signal Vp is reduced from 2.5 (V), and does not react at all when the precharge signal is lower than 1.5 (V).

(1) Setting of Precharge Signal Vp

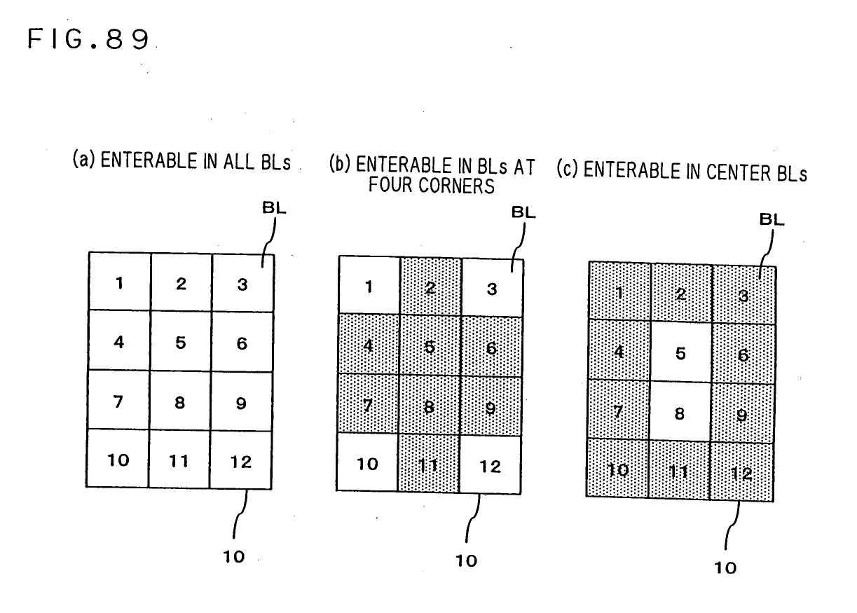

FIG. 89(a) shows an embodiment in which the precharge signal Vp=2.5 (V) is applied to all the processing blocks (BL) 861. The ON/OFF output areas of all the processing blocks (BL) 861 are varied by the object 701 such as the finger, and hence presence or absence of input or the input coordinate can be detected.

In FIG. 89(b), the precharge signal Vp=2.5 (V) is applied to BL1, BL3, BL10 and BL12 of the processing block (BL) 861, and the precharge signal Vp=1.5 (V) is applied to other processing blocks (BL) 861. In this manner, by applying the precharge signal Vp, the input determination or the coordinate detection can be performed only in BL1, BL3, BL10 and BL12 out of the processing blocks (BL) 861.

In FIG. 89(c), the precharge signal Vp=2.5 (V) is applied to BL5, BL8 of the processing block (BL) 861, and the precharge signal Vp=1.5 (V) is applied to other processing blocks (BL) 861.

By applying the precharge signal Vp in this manner, the input determination and the coordinate detection can be performed only in the BL5 and BL82 of the processing block (BL) 861. In other words, it is possible to configure in such a manner that the coordinate input can be performed only at the center portion of the display area 10, and other potions are input-prohibited areas or areas which do not react even an attempt is made to input.

As described above, by applying the precharge signals Vp to the respective processing blocks (BL) 861 and varying or adjusting the precharge signals Vp to be applied, the coordinate input, or “presence or absence” of input, and “effective or ineffective” can be adjusted or set.

In the embodiment shown in FIG. 89, the precharge signals Vp or the like are set for the respective processing blocks (BL) 861, and the coordinate input, or “presence or absence” and “input-enabled or -disabled” are adjusted or set. However, the present invention is not limited thereto. For example, the precharge signal Vp or the like can be set or adjusted for each section described in conjunction with FIG. 86 as a matter of course.

(2) Input Operation

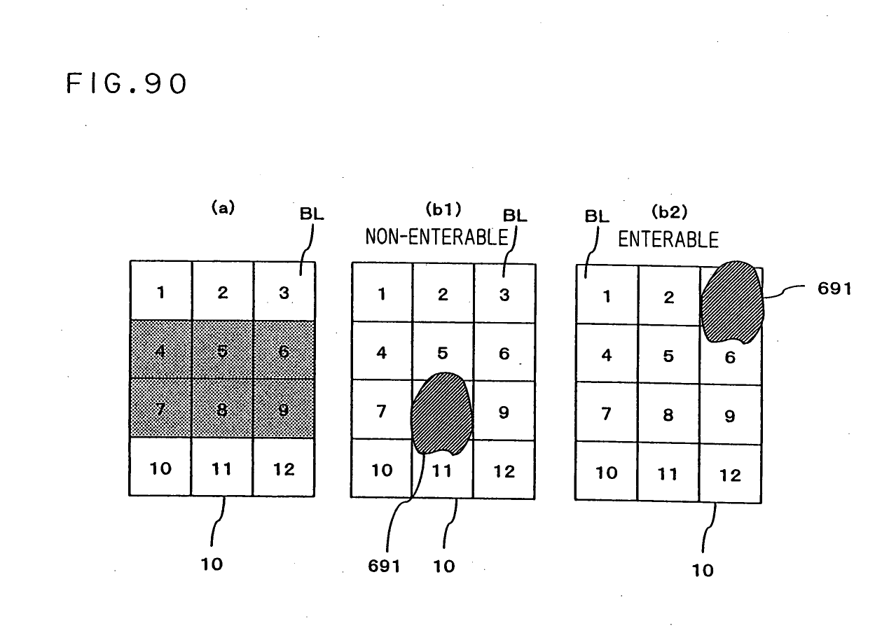

FIG. 90 is an explanatory drawing showing the operation. In FIG. 90(a), the precharge signal Vp=2.5 (V) is applied to the BL1, BL2, BL2, BL10, BL11 and BL12 of the processing block (BL) 861, and the precharge signal Vp=1.5 (V) is applied to other processing blocks (BL) 861. In this manner, by applying the precharge signal Vp, the input determination and the coordinate detection can be performed only in BL1, BL2, BL3, BL10, BL11 and BL12 of the processing blocks (BL) 861. In other words, the coordinate input is disabled at the center portion of the display area 10.

Therefore, as shown in FIG. 90(b), even when there is the shadow of the object 701 to be input in BL8 of the processing block (BL) 861, input is disabled. However, when there is the shadow of the object 701 to be input in BL3 of the processing block (BL) 861 as shown in FIG. 90(c), the ON output area 691 is generated and hence input is enabled.

(3) Interlock with Image Display

FIG. 91 shows a detailed embodiment of the operation of the processing block (BL) 861. FIG. 91 is an embodiment in which a plurality of selection screens are displayed, and the precharge signals Vp to be applied to the respective blocks (BL) 861 are varied in synchronous with the screen display. An embodiment in which film images displayed on the screen 10 are selected is shown below.

In FIG. 91 (a1), a film image 911 is displayed on the display screen 10. The film image 911a corresponds to BL1 of the processing block (BL) 861, and the film image 911b corresponds to BL4 of the processing block (BL) 861. The film image 911c corresponds to BL7 of the processing block (BL) 861, and the film image 911d corresponds to the BL10 of the processing block (BL) 861.

The film image 911e corresponds to BL3 of the processing block (BL) 861, and the film image 911f corresponds to BL6 of the processing block (BL) 861. The film image 911g corresponds to BL9 of the processing block (BL) 861 and the film image 911h corresponds to BL12 of the processing block (BL) 861.

In this state, the precharge signal Vp=2.5 (V) is applied to the BL1, BL4, BL7, BL10, BL3, BL6, BL9, BL12 of the processing block (BL) 861 to achieve the enterable state. On the other hand, the precharge signal Vp=1.5 (V) is applied to the BL2, BL5, BL8, BL11 of the processing block (BL) 861 to disable (so as not to be able to select).

Therefore, the center portion of the display area is non-enterable, and the left and right portion is set to the enterable state. The film image that the operator wants to select finally is shown with a circle on the film 911a in FIG. 91(a1).

In this state, the operator selects 911a where the film image that he/she wants to select is located with the object 701. Then, the state is changed into the display state shown in FIG. 91(b1). In FIG. 91(b1), only the film image 911a is displayed in the display area 10. On the other hand, the precharge signal Vp=2.5 (V) is applied to the BL4, BL5, BL6 of the processing block (BL) 861 to make them enterable. The precharge signal Vp=1.5 (V) is applied to other processing blocks (BL) 861 so that they do not react.

The reason why the precharge signal Vp is set so as to be non-enterable as described above is to prevent erroneous input or erroneous operation caused by selecting unnecessary positions.

FIG. 91(b1), the film images 911aa, 911ab, 911ac are shown at positions of BL4, BL5 and BL6 of the processing block (BL) 861. The film image 911aa corresponds to BL4 of the processing block (BL) 861, and the film image 911ab corresponds to BL5 of the processing block (BL) 861. The film image 911ac corresponds to BL6 of the processing block (BL) 861. When the BL5 of the processing block (BL) 861 is touched by the object 701, the film image 911ab is selected.

Subsequently, the display screen is displayed as shown in FIG. 91(c1). The precharge signal Vp=2.5 (V) is applied to BL2, BL5 and BL8 of the processing block (BL) 861 (FIG. 91(c2)). The precharge signal Vp=1.5 (V) is applied to other processing blocks (BL) 861 (FIG. 91(c2)). Therefore, only BL2, BL5, BL8 of the processing block (BL) 861 are enterable, and other processing blocks (BL) 861 are non-enterable.

When the BL2 of the processing block (BL) 861 is touched by the object 701 in this state, the film 911aba is selected. As described above, in the present invention, the enterable area and the non-enterable area are formed by applying the precharge signal Vp to the processing blocks (BL) 861 or the sections and varying the magnitude of the precharge signal Vp. The selected image is displayed corresponding to the position of the processing block (BL) 861. By causing application of the precharge signal Vp and image display state to be interlocked, favorable control and coordinate input are achieved.

(4-1) First Modification

In the above-described embodiment, the precharge signals Vp are applied to the respective processing blocks (BL) 861 to set one of two values of “enterable” and “non-enterable”. However, the present invention is not limited thereto.

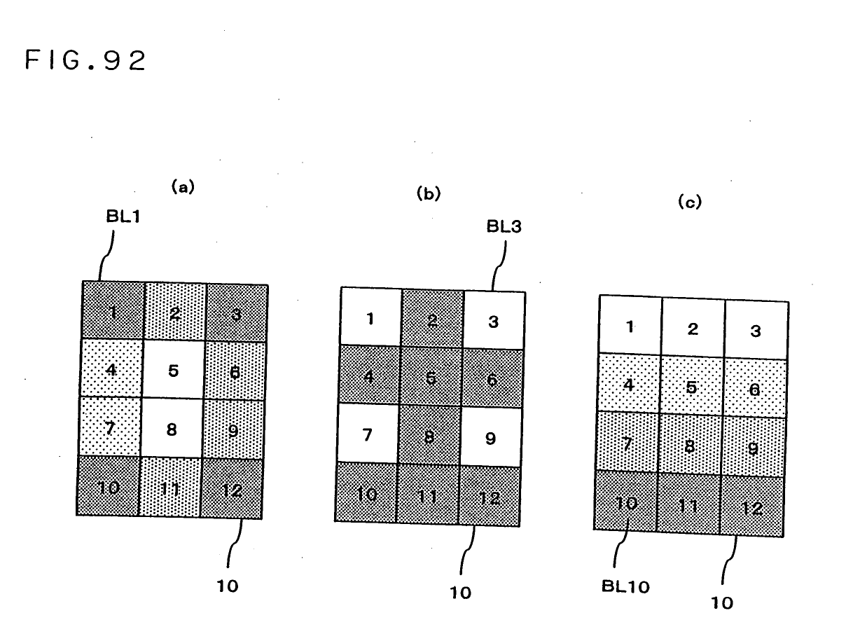

FIG. 92(a) shows an embodiment in which three types of the precharge signals Vp are applied. Areas of BL5 and BL8 of the processing block (BL) 861 are applied with the precharge signal Vp=2.5 (V). Areas of BL2, BL4, BL6, BL7, BL9 and BL 11 of the processing block (BL) 861 are applied with the precharge signal Vp=2.0 (V). Areas of BL1, BL3, BL10 and BL12 of the processing block (BL) 861 are applied with the precharge signal Vp=1.5 (V).

The areas where adequate input can be performed are BL5 and BL8 of the processing block (BL) 861, and the areas BL2, BL4, BL6, BL7, BL9 and BL11 of the processing block (BL) 861 are range in which input is rather hard. However, input can be enabled depending on the intensity of outside light. For example, when the intensity of outside light is suddenly changed and lowered, the setting of the precharge signals Vp in the areas BL2, BL4, BL6, BL7, BL9 and BL11 of the processing block (BL) 861 becomes optimal, and hence input is enabled.

In contrast, the precharge signals Vp in the areas BL5, BL8 of the processing block (BL) 861 are too high, and the ON-state is maintained. Therefore, input is disabled. The areas BL1, BL3, BL10 and BL12 of the processing block (BL) 861 are non-enterable ranges.

(4-2) Second Modification

FIG. 92(b) shows an embodiment in which two types of the precharge signals Vp are applied. The areas BL1, BL3, BL7 and BL9 of the processing block (BL) 861 are areas in which the precharge signal Vp=2.5 (V) is applied. Other processing blocks (BL) 861 are areas to which the precharge signal Vp=1.5 (V) ise applied. The areas where adequate input is can be performed are BL1, BL3, BL7 and BL9 of the processing block (BL) 861, and other processing blocks (BL) 861 are non-enterable areas.

(4-3) Third Modification

FIG. 92(c) shows an embodiment in which four types of precharge signal Vp is applied. The areas BL1, BL2 and BL3 of the processing block (BL) 861 are areas to which the precharge signals Vp=2.5 (V) are applied.

The areas BL4, BL5 and BL6 of the processing block (BL) 861 are areas to which the precharge signal Vp=2.25 (V) is applied. The areas BL7, BL8 and BL9 of the processing block (BL) 861 are areas to which the precharge signal Vp=2.0 (V) is applied. The areas BL10, BL11 and BL12 of the processing block (BL) 861 are areas to which the precharge signals Vp=1.75 (V) are applied.

In the embodiment shown in FIG. 92(c), the precharge signals Vp 2.5 V (V), 2.25 (V), 2.00 (V), and 1.75 (V) are applied to a group of the processing blocks (BL) 861 in the vertical direction (for example BL1, BL4, BL7 and BL10).

In the present invention, the calibration is applied for the intensity of outside light to set adequate precharge signal Vp and the exposure time Tc. However, the intensity of outside light is apt to vary suddenly, the precharge signal Vp and the exposure time Tc may be deviated from the adequate values. Although the variations in the intensity of outside light can be followed by applying calibration frequently, for example, the coordinate input processing cannot be achieved in time.

As shown in FIG. 92(c), by varying the value of the precharge signal Vp (or the exposure time Tc) in the processing blocks (BL) 861, the coordinate input is enabled in any of the processing blocks (BL) 861. Therefore, the calibration setting may be rough.

(4-4) Fourth Modification

In the description of the above-described embodiment, the precharge signals Vp or the like are varied in the processing blocks (BL) 861. However, the present invention is not limited thereto, and it may be varied on section to section basis. The setting of the precharge signal Vp is not limited to be performed fixedly, but may be varied on the time basis.

For example, the precharge signal Vp=2.5 (V) is applied to all the processing blocks (BL) 861 in a first period, and then the precharge signal Vp=2.25 (V) is applied to all the processing blocks (BL) 861 in a second period next to the first period. The precharge signal Vp=2.00 (V) is applied to all the processing blocks (BL) 861 in a third period next to the second period, and the precharge signal Vp=1.75 (V) is applied to all the processing blocks (BL) 861 in a fourth period next to the third period. The same processing is repeated from then on.

Therefore, the precharge signal Vp is applied to the processing block (BL) 861 in the sequence of 2.50 (V), 2.25 (V), 2.00 (V), 1.75 (V), 2.50 (V), 2.25 (V) . . . . It is also possible to apply the different precharge signals Vp to the plurality of processing blocks (BL) 861 in the display area 10, and the applied precharge signals Vp may be varied on the time basis. It is also possible to vary the exposure time Tc instead of the precharge signal Vp. It is also possible to vary both of the precharge signal Vp and the exposure time Tc. The precharge signal Vp or the exposure time Tc may be varied not in the unit of the processing block (BL) 861, but in the unit of the section. As a matter of course, the precharge signal Vp and the exposure time Tc may be set, adjusted, and applied according to the characteristics of the photosensor pixels 27 in the processing blocks (BL) 861 or the like (FIG. 87, FIG. 88).

(4-5) Fifth Modification

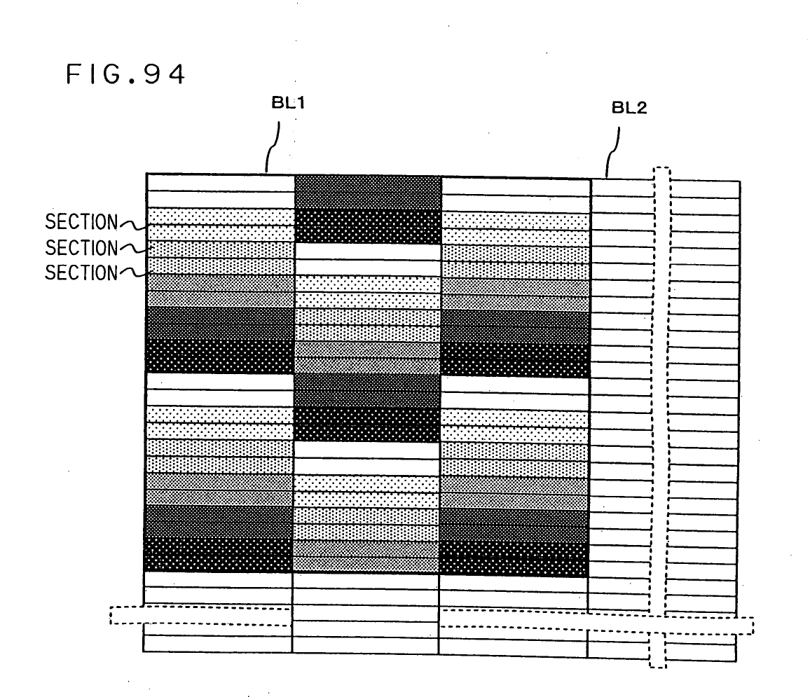

The above-described embodiment is the embodiment in which the precharge signal Vp is varied in the unit of the processing block (BL) 861. However, the present invention is not limited thereto. For example, as shown in FIG. 94, the plurality of precharge signals Vp can be applied to the sections arranged in BL1 of the processing block (BL) 861, respectively.

In the embodiment shown in FIG. 94, the magnitude of the precharge signal Vp is shown in the colors strength. The set value of the precharge signal Vp is divided into six steps for every second pixel rows. For example, the precharge signal Vp is classified into 6 steps of 3.00 (V), 2.75 (V), 2.50 (V), 2.25 (V), 2.00 (V) and 1.75 (V). The different precharge signals Vp are set to the adjacent sections.

As described above, by varying the precharge signal Vp for the sections in the processing block (BL) 861 demonstrates the useful effects when input determination is performed in the unit of processing block (BL) 861. Since the plurality of precharge signals Vp are applied in the processing block (BL) 861, the section to which any one of the precharge signal Vp is applied performs an adequate operation with respect to the intensity of outside light. By extracting the section that performs the adequate operation to perform the input determination and the coordinate detection, processing with high degree of accuracy is achieved.

The value of the precharge signal Vp to be applied in the unit of the processing block (BL) 861 may be varied also in FIG. 94. For example, the precharge signal Vp is classified into the six steps of 3.00 (V), 2.75 (V), 2.50 (V), 2.25 (V), 2.00 (V) and 1.75 (V) for BL1 of the processing block (BL) 861, and the precharge signal Vp is classified into the six steps of 2.50 (V), 2.25 (V), 2.00 (V), 1.75 (V), 1.50 (V) and 1.25 (V) for BL2 of the processing block (BL) 861.

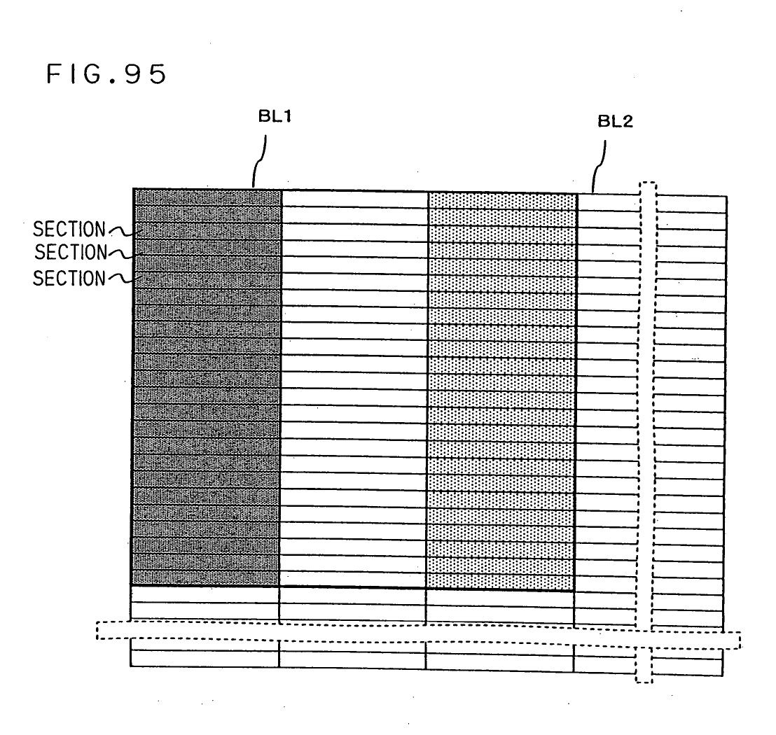

FIG. 94 shows the embodiment in which the sections in the processing block (BL) 861 are divided into small areas and the plurality of precharge signals Vp are applied. FIG. 95 shows an embodiment in which three types of the precharge signals Vp are applied in the stripe manner.

(4-6) Sixth Modification

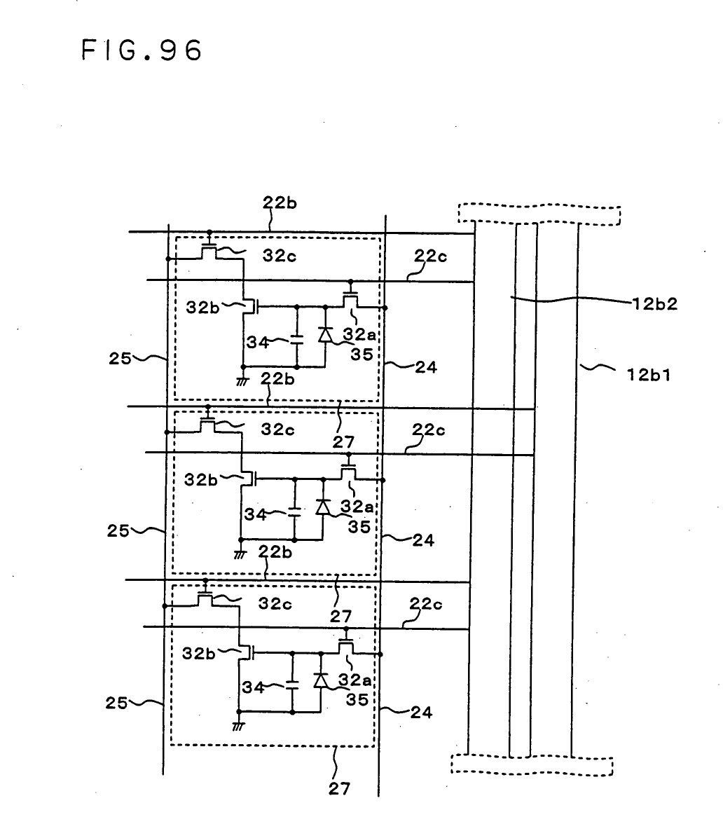

In the present invention, the factor that is varied among the processing blocks (BL) 861 or the sections is not only the precharge signal Vp, but may be the exposure time Tc. When varying the exposure time Tc, a configuration shown in FIG. 96 is employed. In the embodiment shown in FIG. 96, the two gate driver circuits 12b (12b1, 12b2) are formed. The gate driver circuit 12b1 controls the photosensor pixels 27 in the rows of odd numbers. The gate driver circuit 12b2 controls the photosensor pixels 27 in the rows of even numbers. In this arrangement, the exposure time Tc of the photosensor pixels 27 of the rows of even numbers and the exposure time Tc of the photosensor pixels 27 in the rows of odd numbers can be varied or controlled independently.

(4-7) Seventh Modification

In the drive system in the present invention, the exposure time Tc may be varied on the time basis. For example, the exposure time Tc in a first period is set to 5 msec, and the exposure time Tc in a second period next to the first period is set to 4 msec. The exposure time Tc is set to 3 msec in a third period next to the second period, and the exposure time Tc for a fourth period next to the third period is set to 2 msec. The same processing is repeated from then on. Therefore, the exposure time Tc is varied from 5 msec, 4 msec, 3 msec, 2 msec, 5 msec, 4 msec . . . . It is also possible to set the exposure time Tc for the plurality of processing blocks (BL) 861 in the display area 10 respectively.

(4-8) Eighth Modification

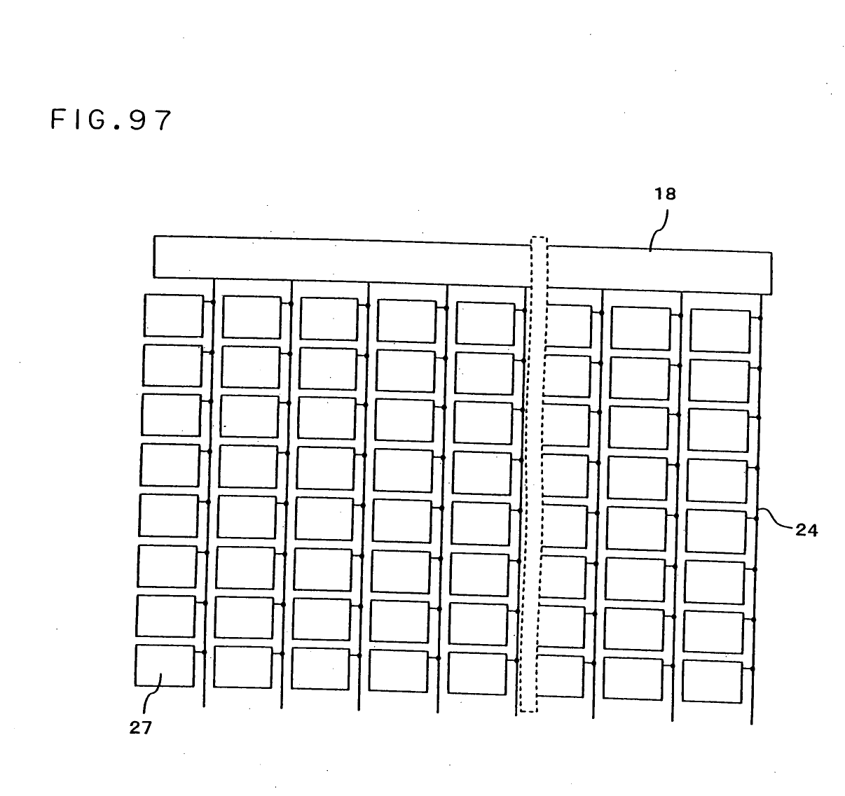

In the description of the present invention, the precharge signal Vp is varied or controlled in the unit of the processing block (BL) or in the unit of the section. However, the invention is not limited thereto. It can be performed in the unit of photosensor pixel 27. As shown in FIG. 97, the photosensor pixels 27 is connected to the precharge signal line 24. Therefore, it is easy to vary the precharge signal Vp to be applied to the precharge signal line 24 by the pixel column or by the pixel row.

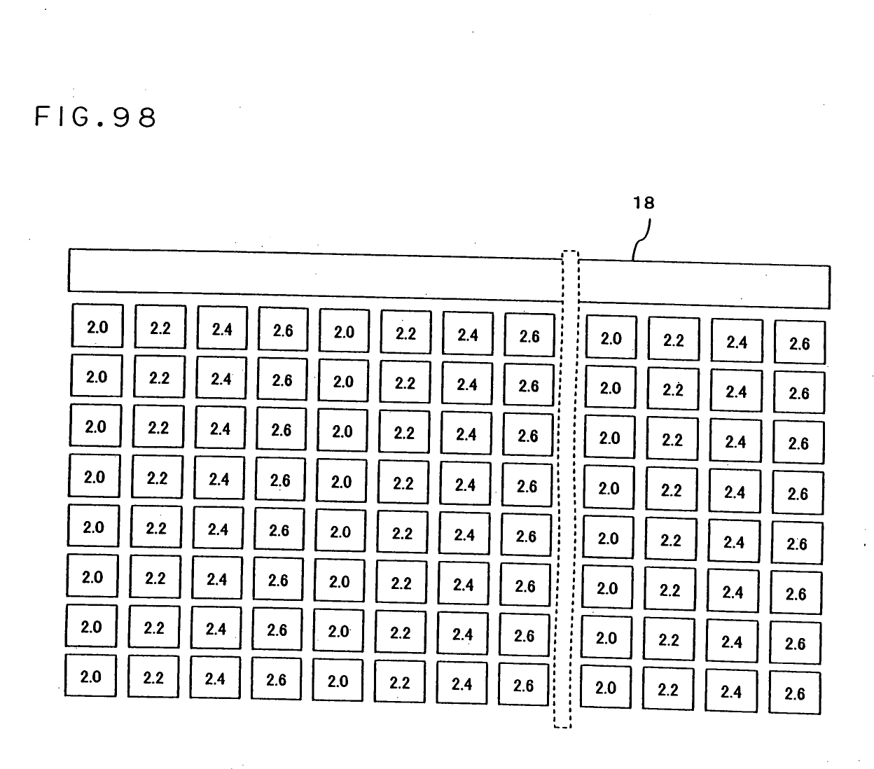

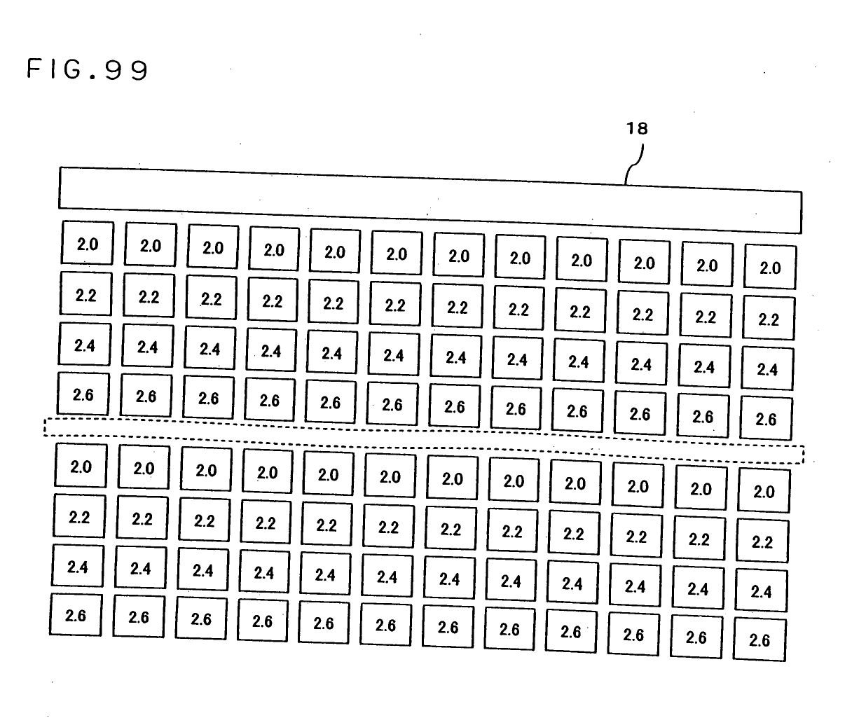

FIG. 98 shows an embodiment in which the precharge signal Vp is classified into 2.0 (V), 2.2 (V), 2.4 (V) and 2.6 (V) and varied by the pixel column. FIG. 99 shows an embodiment in which the precharge voltage Vp is classified into 2.0 (V), 2.2 (V), 2.4 (V) and 2.6 (V) and varied by the pixel rows.

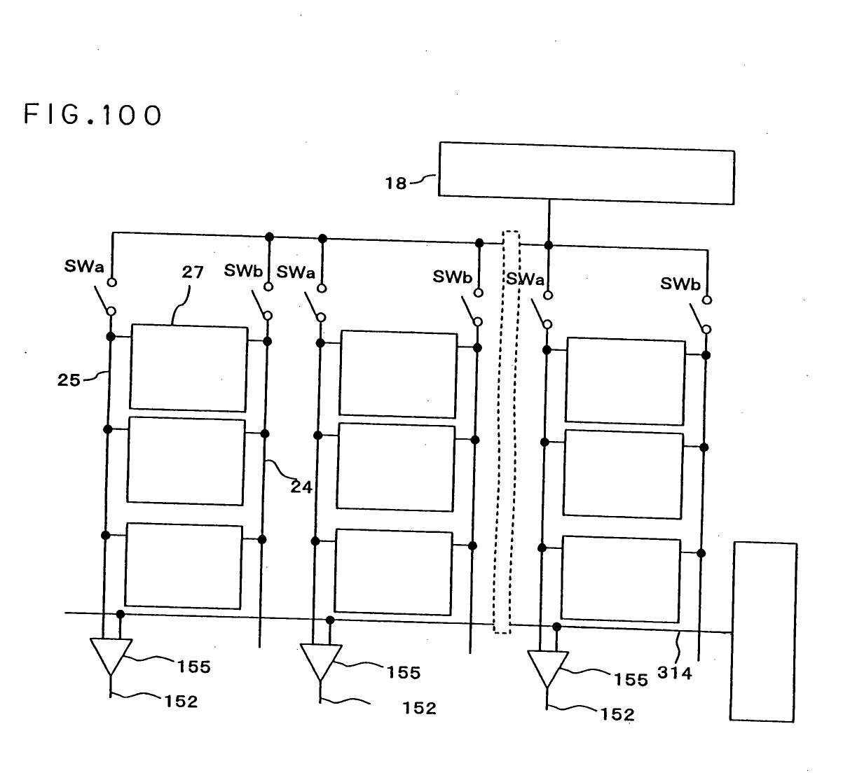

As shown in FIG. 100, when applying the precharge signal Vp, it is preferably applied also to the photosensor output signal line 25 simultaneously with the precharge signal line 24. The switches SWa, SWb are controlled between ON and OFF synchronously with the output of the precharge signal Vp.

Selection of the optimal precharge signal Vp in the respective processing blocks (BL) 861 is determined according to the magnitude of the illuminance of outside light and the illuminance of the backlight 656. Which precharge signal Vp is to be selected is determined by being inspected (measured) in the inspection process before shipping of the panel. In this case, determination is performed by mounting the backlight 656 to be used actually or the light source similar thereto, because there is a case in which the precharge signal Vp to be selected is different by the effect of the back light 656 or the like in particular in the periphery of the display area 10.

(4-9) Ninth Modification

The processing of calibration, approach, contact, and separation can be performed by applying and varying the plurality of precharge signals Vp to one pixel as a matter of course. For example, the precharge signal Vp is varied in the frame basis. Variation may be applied on the basis of the plurality of frames. For example, the precharge signal Vp can be varied every 2 frames.

It is also possible to vary the exposure time Tc simultaneously or asynchronously with variations in the precharge signal Vp. It is also possible to vary the precharge signal Vp and the exposure time Tc simultaneously. For example, the precharge signal Vp is set to 3.5 V and the exposure time Tc is set to 324H, variations in the number of the ON pixels in the processing block (BL) 861 are detected (whether the number of the ON pixels is one or more, and so on), and the calibration is performed by multiplying the precharge signal Vp 4.0 V by a constant value b (for example, when b=0.5, the precharge signal Vp will be 4.0×0.5=2V). In other words, at the time of calibration, the precharge signal Vp is set to 2.0 V and the exposure time Tc is set to 324H. The step of variation of the exposure time Tc is preferably 2H or more.

The operation to detect the variations in the number of ON pixels in the processing block (BL) 861 is performed by varying from, or on the basis of, the precharge signal Vp=4.0 V, and the exposure time Tc=324H. At the time of calibration, calibration is made from, or on the basis of, the precharge signal Vp=2.0 V and the exposure time Tc=324H. The operation to detect the number of the ON pixels and the calibration operation are performed alternately.

(5) Approach, Contact and Separation

The term “approach” means to detect or determine the fact that the finger or the like approaches the panel surface. It also means the processing operation. The term “approach” also means the operation to process the fact that the finger or the like moves toward the panel surface.

The term “contact” means to detect or determine the fact that the finger or the like is in contact with the panel surface, or the operation to process. The term “contact” means the operation to process the fact that the finger or the like is in contact with the panel surface.

The term “separation” means to detect or determine the fact that the finger or the like separates (comes apart) from the panel surface, or the operation to process the fact of separation.

Which precharge signal Vp or the exposure time Tc is employed out of the precharge signals Vp or the exposure times Tc applied to the pixel rows in the respective processing blocks (BL) 861 is preferably determined for each processing block (BL) 861 and stored in the EEPROM as data in advance at the time of shipping of the panel.

(6) Variations in Precharge Signal Vp and Exposure Time Tc

The precharge signal Vp can be applied to the consecutive pixel rows. The precharge signal Vp can also be applied randomly to the pixel rows. Alternatively, the strength of the precharge signal Vp can be varied at a constant cycle (two-dimensionally, in the direction of time axis). The precharge signal Vp to be applied to each pixel row may be varied in the frame basis.

The same thing is applied also to the exposure time Tc. The exposure time Tc may be applied to the consecutive pixel rows. The exposure time Tc may be applied randomly to the pixel rows. The length of the exposure time Tc can be varied a the constant cycle (two-dimensionally, in the direction of time axis). The exposure time Tc to be applied to each pixel row may be varied in the frame basis.

The precharge signal Vp and the exposure time Tc may be varied simultaneously. The exposure time Tc and the precharge signal Vp may be varied alternately in the frame basis or the pixel row basis.

By configuring or forming a plurality of types of sensitivities of the photosensor pixels 27 and applying the plurality of precharge signals Vp to the photosensor pixels 27, and by setting the plurality of exposure times Tc, the wider range of intensity of outside light can be accommodated as a matter of course. It is also possible to generate and apply a plurality of comparator voltages of the comparator circuit 155 as a matter of course.

These matters can be implemented independently or in combination in the embodiments in the present invention as a matter of course. Other matters are also the same.

(7) Effect of Disturbance

The light beam 661a from the backlight 656 is fogged by halation in the panel 658. It also illuminates the object 701. Execution of the calibration including the effect of the light beam 661a varies the original position V0 (point E in FIG. 79) when there is no illuminance of outside light.

It is assumed that the calibration voltage at the illuminance 0 (light-shielded state) is V0. The V0 voltage is a precharge signal Vp which can detect or figure out a value at which the rate of the number of the ON pixels (%) is 0% or generation of the rate of the number of the ON pixels (%) in the state of illuminance 0. Since the leak occurs in the photosensors 35 as the illuminance of outside light or the like increases, it is necessary to increase the precharge signal Vp at which the rate of the number of the ON pixels (%) is genetared according to the illuminance of outside light. Therefore, as shown in the straight line of the calibration voltage shown in FIG. 79, it is increased from V0 (point E) corresponding to the illuminance of outside light (including a light beam from the backlight 656).

By applying the precharge signal Vp to the photosensor pixel 27 so as to match the straight line of the calibration voltage, an adequate calibration is achieved.

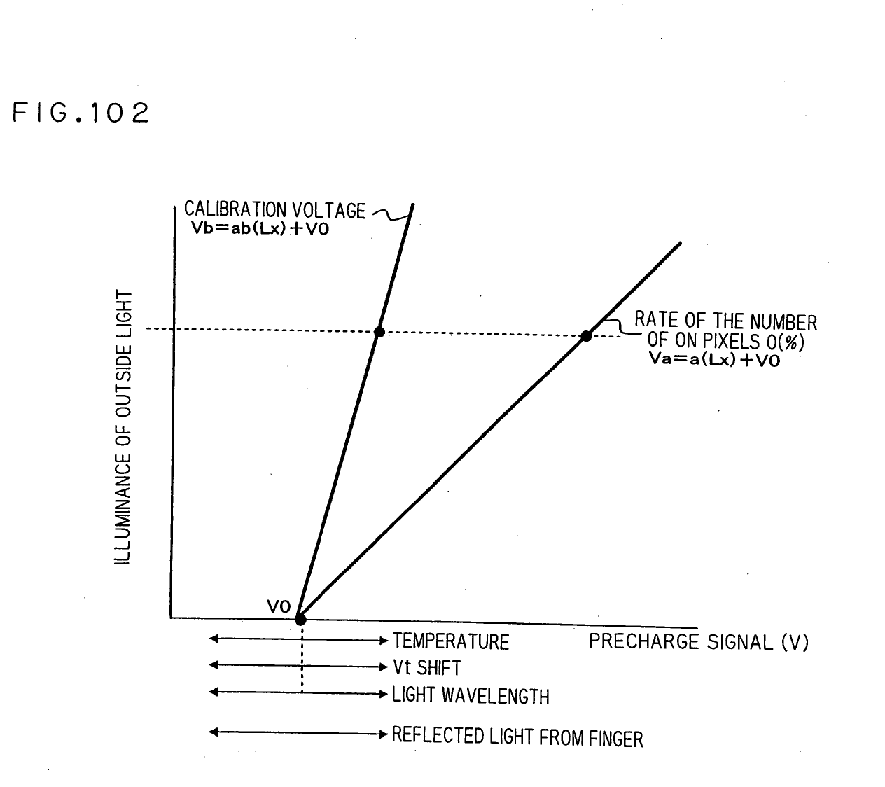

The voltage V0 as the original point is shifted due to the temperature change, Vt shift of the transistor, the wavelength of outside light or the like (defined by the main wavelength), the reflected light beam 661 from the object 701 (like a finger) as shown in FIG. 102.

As described in FIG. 79, the rate of the number of the ON pixels (%) (Tc=324H or the like) can be expresses as Va=a(La)+V0 where a and b represent constants and Lx represents the illuminance of outside light. The straight line of the calibration voltage can be expressed as Vb=ab(Lx)+V0. In other words, by multiplying the straight line of the rate of the number of the ON pixels (%) by the constant b which is obtained in advance, the calibration voltage Vb can be obtained.

Both of the straight line of the calibration voltage and the straight line of the rate of the number of the ON pixels (%) pass through V0. The constants a and b are not affected by the temperature, Vt or the main wavelength. Therefore, even when the illuminance of outside light takes any value, the optimal calibration voltage can be obtained by obtaining the straight line of the predetermined rate of the number of the ON pixels (%).

### H. Acquisition of Voltage V0

In FIG. 70, for example, by shielding the photosensor pixel 27 from a light beam by the object 701, the photosensor pixel 27 in the OFF-state due to the outside light 661 is turned into the ON-state. The precharge signal Vp to be applied to the photosensor pixel 27 applies a voltage to turn the photosensor pixel 27 into the ON-state in the light-shielded state (basically 0 Lx). When outside light is applied on the photosensor pixel 27, the precharge signal Vp is adapted to be the OFF-state.

As shown in FIG. 70, if the illuminance of the portion (shadow) below the object 701 such as a finger or the state of the photosensor pixel 27 is known, V0 or the calibration voltage can be known. In other words, the calibration voltage corresponding to V0 or the intensity of outside light shown in FIG. 79 is a voltage at which the photosensor pixel 27 in the light-shielded state is held in the ON-state or a voltage relative thereto.

Therefore, the light-shielded state is provided or formed in the display area 10 constantly or at the time of calibration. However, it is necessary that the light-shielded portion is illuminated on the back surface (the contact surface with the panel) of the object 701 by part of light entered from other display area 10 or light of a constant rate (151a, 151b in FIG. 70).

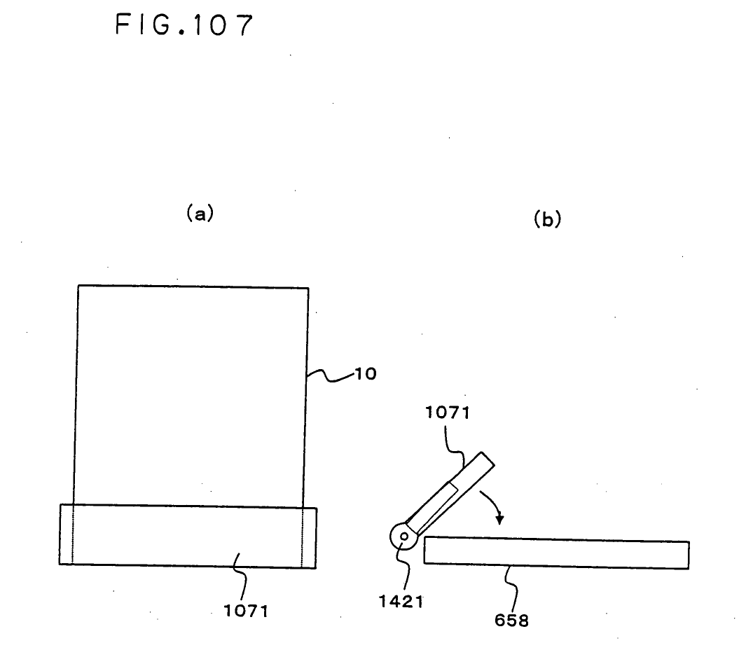

In order to generate the state described above, in the present invention, a light-shielding panel or a film 1071 is arranged at the time of calibration as shown in FIG. 107. The light-shielding panel 1071 is adapted to rotate about a fulcrum point 801 and to be dismounted from the display area 10 at the time other than the time of calibration. The light-shielding panel 1071 is mounted or arranged on the surface of the display panel at the time of calibration.

The light-shielding panel 1071 does not mean a complete light-shielding substance. The substance whose transmission factor is less than 20% may be used satisfactorily. It may be any member which blocks light beams that is sensed by the photosensor 35. When the photosensor 35 is formed of polysilicon, light beams with main wavelengths of 500 nm or less are shielded. The light-shielding panel 1071 may be arranged constantly on the surface on the display panel at which the photosensor pixels 27 are formed. The only disadvantage is that this portion cannot be used as the coordinate input position.

It can be applied to embodiments in the present invention as a matter of course. It also can be combined with other embodiments as a matter of course.

(1) First Modification

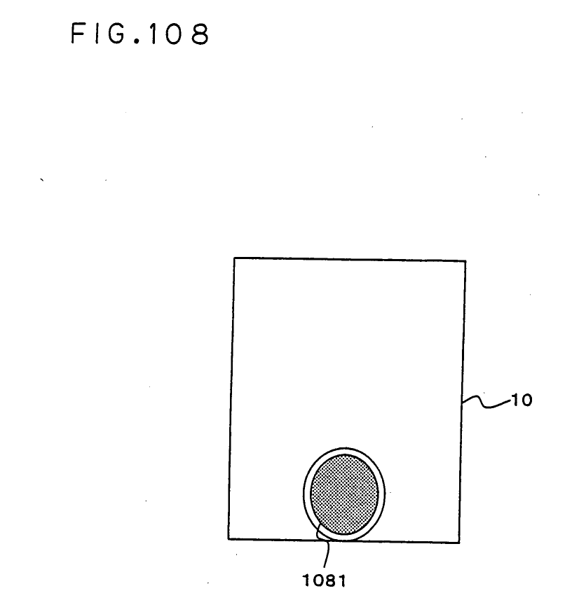

An embodiment shown in FIG. 108 has a configuration in which a light-shielding seal 1081 is adhered on the display area 10 instead of the light-shielding panel 1071. As shown in FIG. 108, if the illuminance of the portion (shadow) below the light-shielding seal 1081 or the state of the photosensor pixels 27 is known, V0 or the calibration voltage can be known. In other words, the calibration voltage corresponding to V0 or the intensity of outside light shown in FIG. 79 is a voltage at which the photosensor pixel 27 in the light-shielded state is held in the ON-state or a voltage relative thereto.

(2) Second Modification

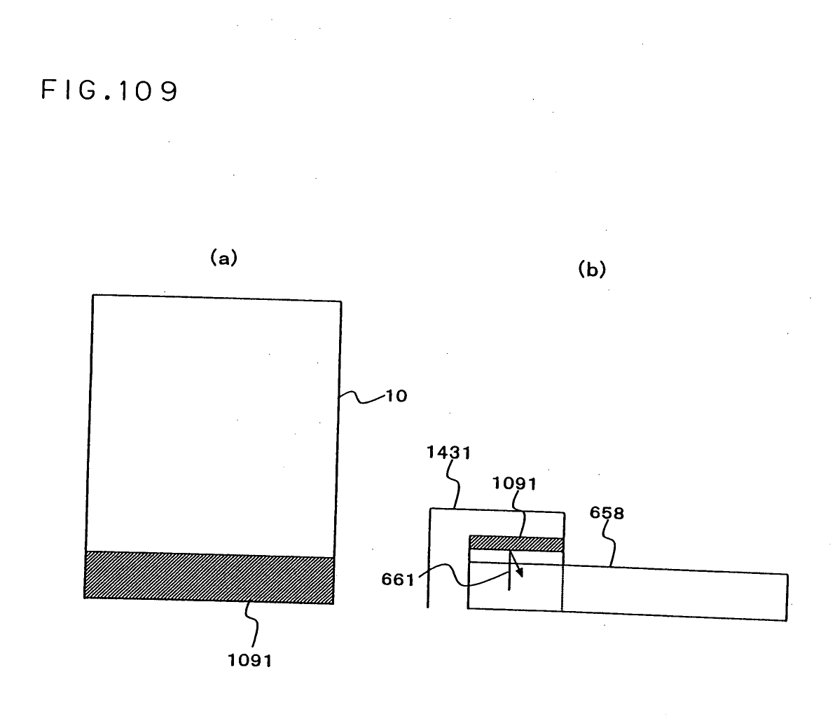

FIG. 109 shows an embodiment in which a light-shielding portion 1091 is formed or provided on a part of the display area 10. The light-shielding portion 1091 reflects part of the light beam 661 from the backlight 656 and illuminates the photosensor pixels 27. As shown in FIG. 109, if the illuminance of the portion (shadow) below the light-shielding portion 1091 or the state of the photosensor pixels 27 is known, V0 or the calibration voltage can be known. Other configurations are the same as this embodiment, description will be omitted.

(3) Third Modification

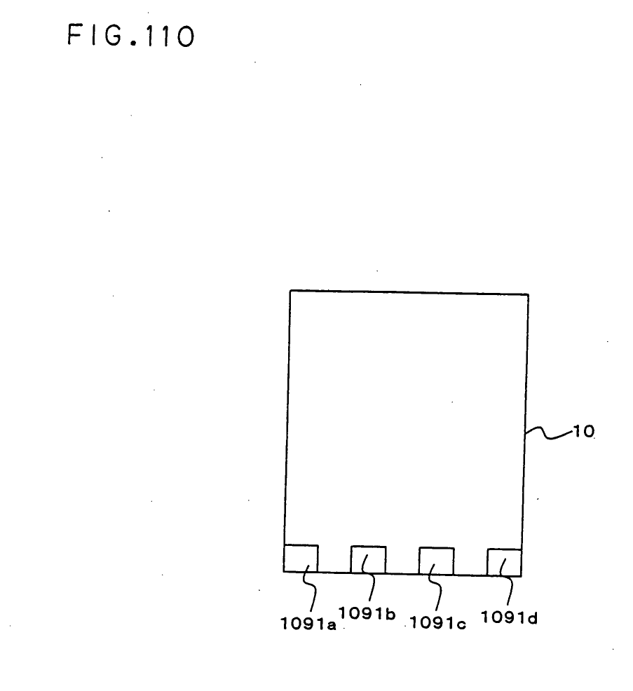

FIG. 110 shows a configuration in which the light-shielding portion 1091 is formed or arranged in a dispersed manner. Other configurations are the same as those in other embodiments such as those shown in FIGS. 108 and 109, and hence the description will be omitted.

### I. Contact Detection

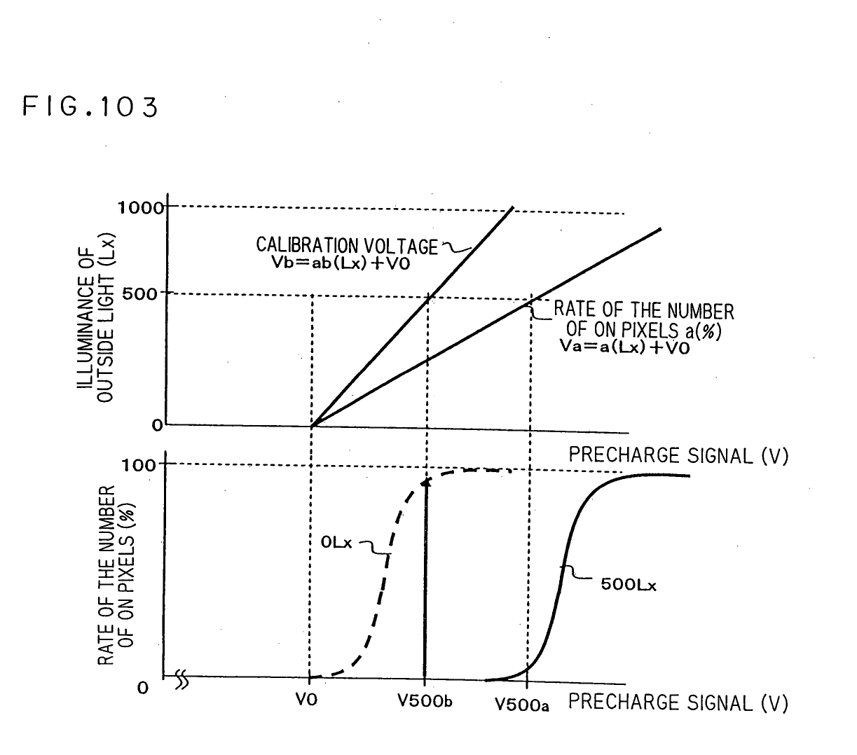

When outside light is strong, the precharge signal Vp applied to the photosensor pixel 27 can maintain the OFF-state sufficiently. The precharge signal Vp for maintaining the OFF-state is relatively high. For example, as shown in FIG. 103, a relation between the precharge signal Vp and the rate of the number of the ON pixels (%) at the outside light 500 Lx is shown by a solid line. In this solid line, the precharge signal Vp at the rate of the number of the ON pixels is 0 (%) is V500a.

The calibration voltage obtained from V500a is V500b. The relation between the precharge signal Vp and the rate of the number of the ON pixels (%) at the light-shielded time (0 Lx) is indicated by a dotted line.

From the configuration described above, the rate of the number of the ON pixels (%) of the photosensor pixels 27 to which the precharge signal Vp=V500b is applied varies as indicated by an arrow by being shielded from a light beam by the object 701. In FIG. 103, the rate of the number of the ON pixels (%) varies from 0% to 90% or more. Therefore, in the high illuminance area, variations in the rate of the number of the ON pixels (%) are large, and hence the object 701 can be detected easily.

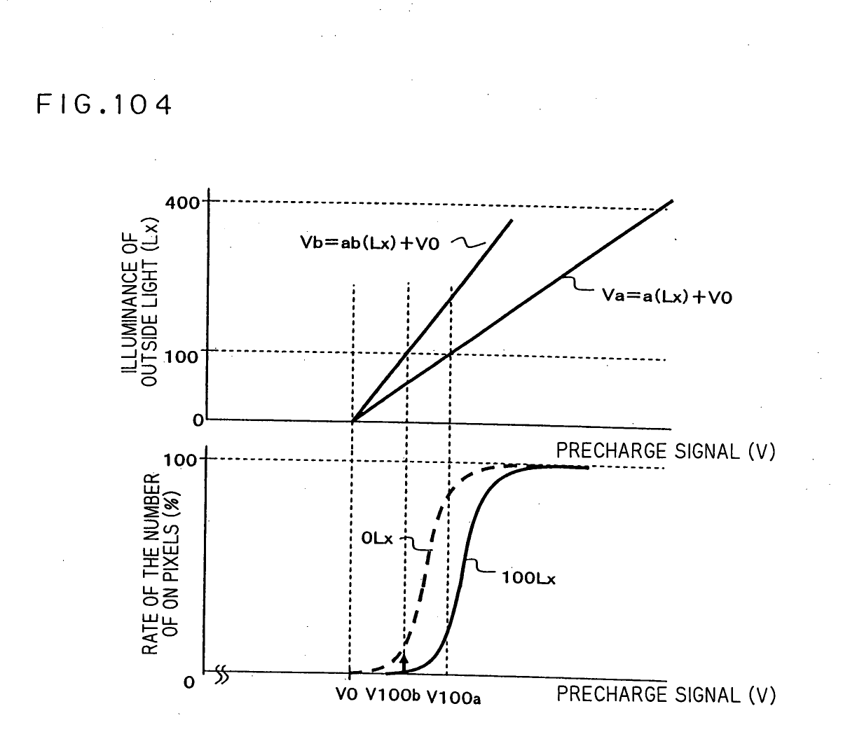

When outside light is weak, the precharge signal Vp to be applied to the photosensor pixel 27 is low. In FIG. 104, the relation between the precharge signal Vp and the rate of the number of the ON pixels (%) at 100 Lx of outside light is shown by a solid line. In the solid line, the precharge signal Vp of the rate of the number of the ON pixels 0 (%) is V100a.

The calibration voltage obtained from V100a is V100b. The potential difference between V100b and V0 is small. The relation between the precharge signal Vp and the rate of the number of the ON pixels (%) when the light is shielded (0 Lx) is shown by dotted lines. In the photosensor pixel 27 to which the precharge signal Vp=V100b is applied, the rate of the number of the ON pixels (%) is varied as shown by an arrow by being shielded from a light beam by the object 701.

Referring to FIG. 104, the rate of the number of the ON pixels (%) does not change from 0% to 5%. Therefore, in the low illuminance area, variations in the rate of the number of the ON pixels (%) are small, and hence detection of the object 701 is difficult.

What is important is that the rate of the number of the ON pixels (%) varies corresponding to the illuminance of outside light. When the illuminance is high, the rate of the number of the ON pixels (%) as a result of being shielded from the light beam by the object 701 is large. When the illuminance is low, the rate of the number of the ON pixels (%) as a result of being shielded from the light beam by the object 701 is small. In the present invention, in order to cope with this problem, determination of contact, approach, separation and the like are performed considering the maximum value of the estimated rate of the number of the ON pixels (%) from the absolute value of the calibration voltage.

Determination of the amount of variation in the rate of the number of the ON pixels (%) may be made by the magnitudes or rate of m and n shown or described in FIG. 79 as a matter of course. When the values of m and n are decreased, it means that the illuminance of outside light L is weak. It is also possible to judge, determine or calculate by the values of VLa, VL0 and VL100 or the potential difference between these values and V0. In other words, the rate of the number of the ON pixels (%) K when the light beam is shielded by the object 701 can be set or figured out from the magnitudes of the m and n, the rate, the values of VLa, VL0, VL100, or the potential difference between these values and V0.

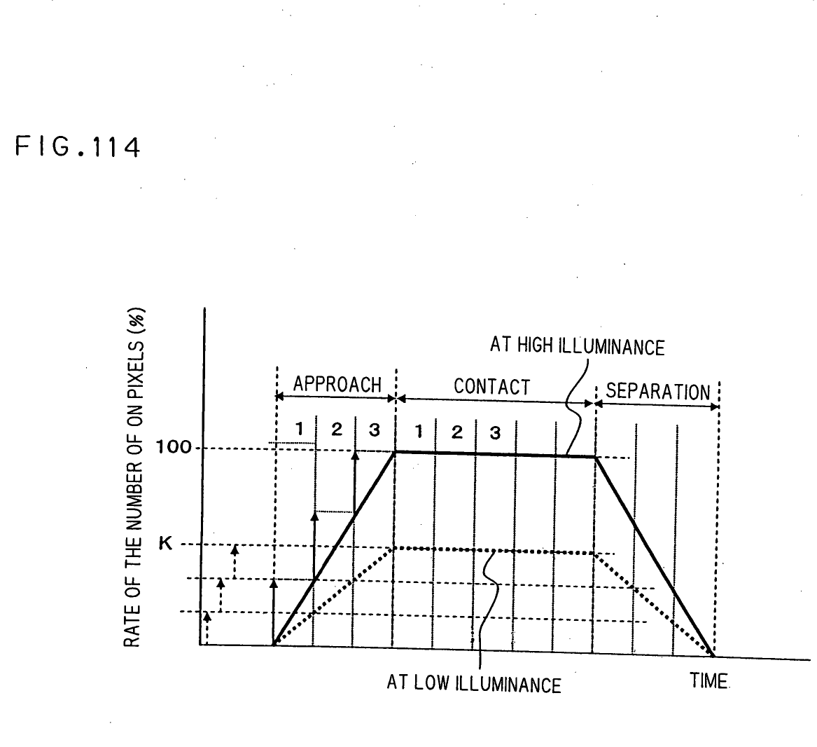

FIG. 114 shows the rate of the number of the ON pixels (%) relating to approach, contact and separation. A lateral axis represents time. When the object 701 “approaches”, the rate of the number of the ON pixels (%) is increased. When the object 701 “comes into contact”, the rate of the number of the ON pixels (%) is stabilized at one constant value. When the object 701 “separates”, the rate of the number of the ON pixels (%) is lowered.

At a high illuminance, the rate of the number of the ON pixels (%) becomes near 100%. However, at a low illuminance, the rate of the number of the ON pixels (%) becomes K % less than 100%. Therefore, the rate of the number of the ON pixels (%) per unit time at the time of approach or separation is 100/elapsed time at a high illuminance, and K/elapsed time at a low illuminance. K is an actual count between 0 and 100.

The elapsed time (for example, time from a moment when the finger as the object 701 starts approaching until a moment when it comes into contact with the panel, and from a moment when it starts separating from the panel until a moment when it is completely separated) is substantially constant.

In the present invention, the rate of variations in the rate of the number of the ON pixels (%) is obtained corresponding to the illuminance of outside light and taking the K (K is between 0 to 100%) of the rate of the number of the ON pixels (%). When the illuminance of outside light is low, variations in the rate of the number of the ON pixels (%) per unit time are small. Therefore, even when variations in the rate of the number of the ON pixels (%) are small, determination of approach or separation is performed. When there is more than a certain rate of the number of the ON pixels (%), the determination of approach or separation is not performed taking it as an abnormal state. When the illuminance of outside light is high, variation in the rate of the number of the ON pixels (%) per unit time is large. Therefore, when variation in the rate of the number of the ON pixels (%) is less than a predetermined value, determination of approach or separation is not performed. When there is variation more than a predetermined level, determination of approach or separation is performed.

As shown in FIG. 114, the rate of the number of the ON pixels K (%) when a light beam is shielded by the object 701 is set from the magnitudes of m and n, the rate, the values of VLa, VL0, VL100, or the magnitude of the potential difference between these values and V0.

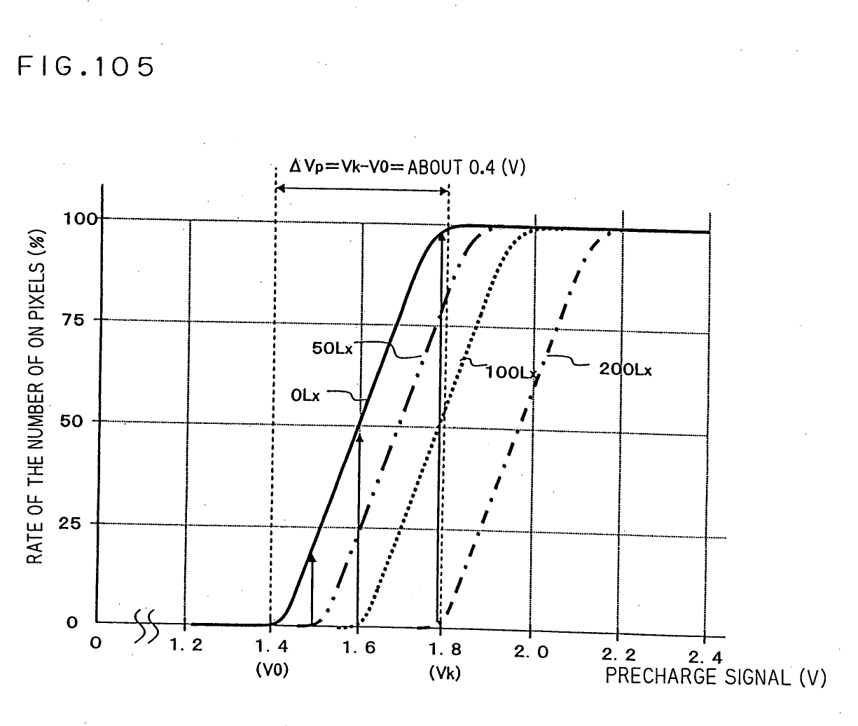

The magnitudes of m and n, the rate, the values of VLa, VL0, VL100, or the magnitude of the potential difference between these values and V0 relatively indicates the illuminance of outside light L. FIG. 105 shows variation in the precharge signal Vp and the rate of the number of the ON pixels (%) with respect to the respective values of the illuminance of outside light. In the range of relatively low illuminance, the curve of the precharge signal Vp and the rate of the number of the ON pixels (%) is shifted according to the illuminance while maintaining the inclination. The difference (amount of change) between the curve of 0 Lx and the rate of the number of the ON pixels (%) is increased with increase in the illuminance of outside light.

From the description shown above, in the present invention, the rate of the number of the ON pixels (%) is set in proportion to or relatively with respect to the magnitudes of m, n and so on. For example, when the value of m is higher than 1.0 V, the rate of the number of the ON pixels (%) is set to 100%, and when it is below 1.0, a value obtained by multiplying the value of m by a constant 0.9 is employed as the rate of the number of the ON pixels (%).

(1) Size of Processing Block (BL)

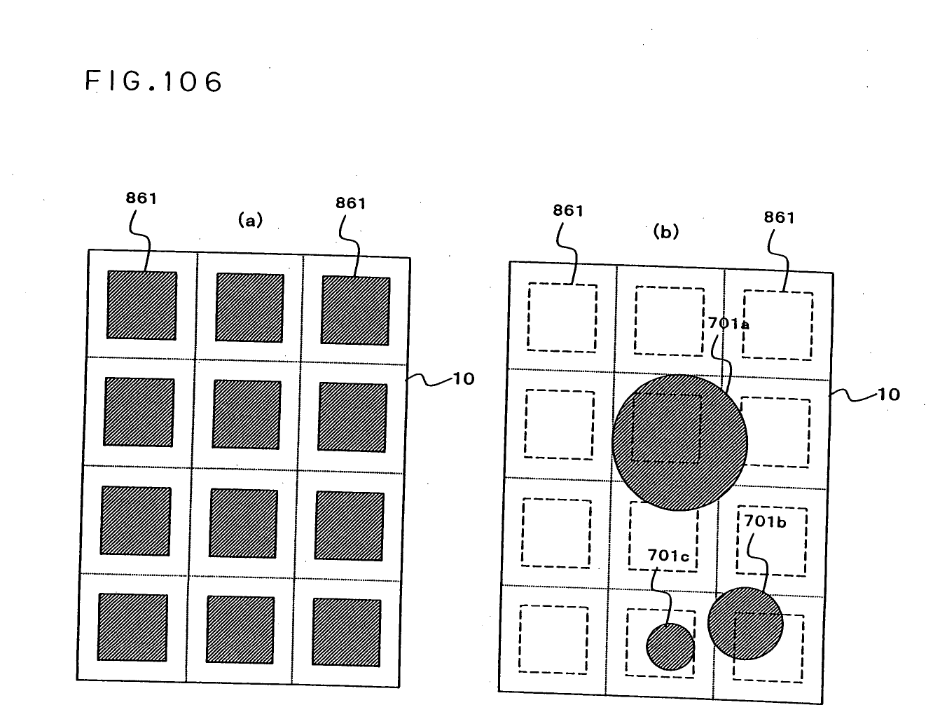

When the processing block (BL) 861 is configured in a state of being shielded completely from a light beam by the light-shielding substance 701, detection of approach, contact and separation of the object 701 is ensured. Therefore, as shown by shaded portions in FIG. 106(a), the surface area of the processing block (BL) 861 is configured (set) to divide the display area 10 and occupy part of the divided area.

By configuring (setting) as shown in FIG. 106, the processing block (BL) 861 is adequately shielded from a light beam by the light-shielding substance 701a. When the light shielding substances 701b, 701c are smaller than the processing block 701, determination of approach, contact, and so on will be uncertain. Therefore, assuming the size of the object (light-shielding substance) 701a such as the finger, the surface area of the processing block (BL) 861 is defined. In other words, the sizes of the object 701 and the processing block 861 are set to have a proportional relation or a relative relation.

In the display device in the present invention, the shadow of the object 701 is detected by the photosensor pixel 27. The coordinate position of the object 701 is detected by obtaining the center position of the shadow. The coordinate input device in the related art has a touch panel or the like and detects the coordinate position at a location pressed.

(2) Detection of Shadow Position

Since the present invention is a system for detecting the shadow as an example, the coordinate position can be detected even when the object 701 does not come in contact with the display panel. In other words, when the shadow of the object 701 is generated within the display area, the center position of the shadow can be obtained. Therefore, even when the object 701 is in the air, the position of the object 701 can be obtained. The method of obtaining the center position 692 is described in conjunction with FIG. 69 and so on.

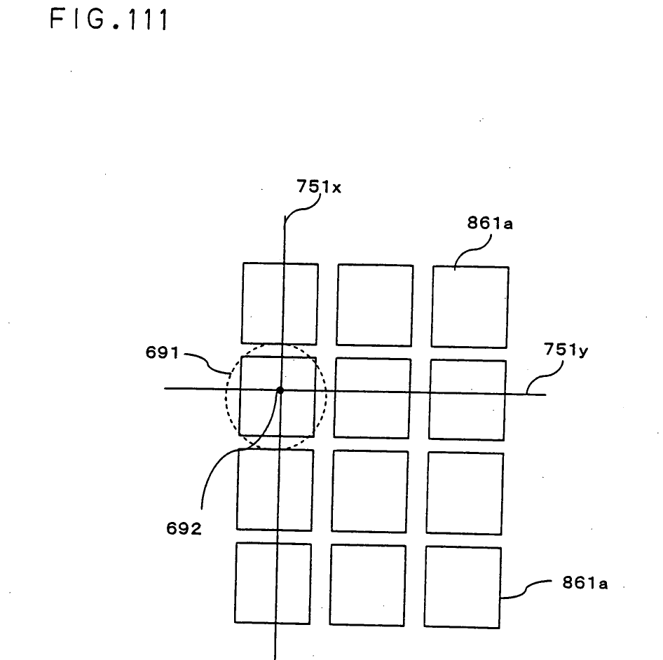

As indicated in FIG. 111, when the shadow of the object 701 is generated in the display area, the ON output area 691, which is the area of the shadow, is generated. Therefore, the center position 692 of the ON output area 691 can be obtained. Therefore, even when the object 701 is in the air, the position of the object 701 can be obtained. When the center position 692 is detected, a cursor 751 is displayed in the display area.

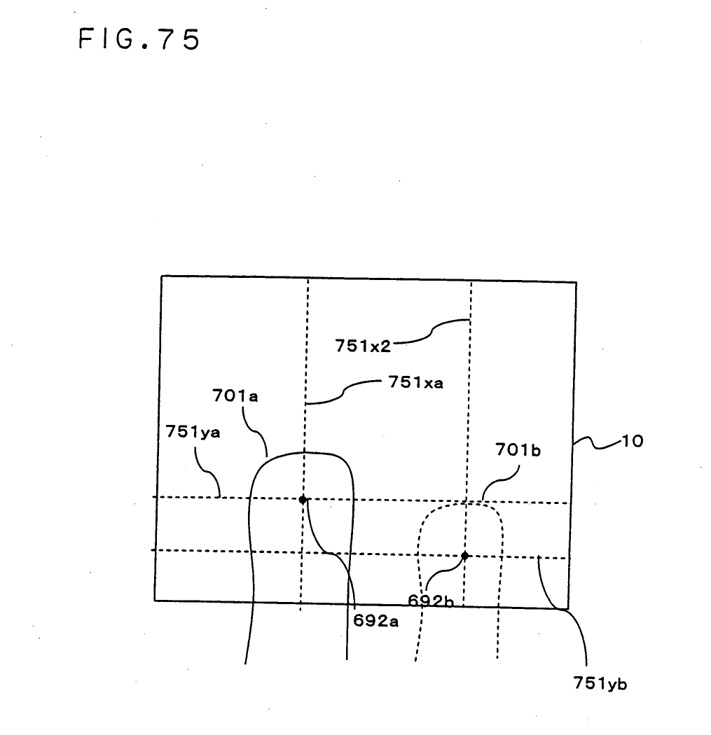

As shown in FIG. 75, when the object 701a exists over the display panel 658, the shadow of the object 701a is generated. The photosensor pixels 27 at the position of the shadow correspond to the ON output area 691. The center position 692a of the ON output area 691 is obtained or calculated.

(3) Cursor Display

As shown in FIG. 75, when the center position 692a is detected or can be detected, the cross cursor (751xa, 751ya) is displayed in the display area 10. In other words, when they are at positions where the presence of the object 701 can be detected, the center position 692a is displayed. Therefore, the coordinate position to be entered can be notified to the operator before he/she inputs with the object 701. This is an effect that the touch panel in the related art does not have.

As shown in FIG. 75, when the object 701a is located over the display panel 658, the shadow of the object 701a is generated. The photosensor pixels 27 at the position of the shadow correspond to the ON output area 691. The center position 692a of the ON output area 691 is obtained, or calculated.

Subsequently, the object 701 moves and comes to the position 701b. When the center position 692b of the object 701b is detected or can be detected, the cross cursor (751xb, 751yb) is displayed in the display area 10. In other words, when they are at positions where the presence of the object 701b can be detected, the center position 692b is displayed.

In the description of the above-described embodiment, the cross cursor is displayed. However, this invention is not limited thereto. For example, a cursor of dot or circular shape may be displayed. In other words, the present invention is characterized in that the cursor is displayed in the display panel so as to notify the position of the object 701 from the shadow or the like of the object 701 even in a state in which the object 701 does not come in contact with the input surface 10 of the display panel. In contrast, when the cursor is displayed, it means that the displayed position or the portion in the periphery thereof is in the enterable state.

As shown in FIG. 75, when the object 701b exists over the display panel 658, a shadow of the object 701b is generated. The photosensor pixels 27 at the position of the shadow are in the ON output area 691. The center position 692b of the ON output area 691 is obtained, or calculated. As described above, the cross cursor (751x, 751y) is moved in association with the movement of the object 701. On the other hand, when the object 701 comes apart from the display area 10 by a certain distance, the shadow becomes weak, and the ON output area 691 of the photosensor pixels 27 is reduced. Therefore, the center position 692 cannot be obtained any longer. Therefore, the display of the cross cursor is disappeared.

As described above, the operator can determine whether it is in a state in which he/she can enter the coordinate from the presence or absence of the cursor display 751. The enterable position can also be determined.

(3-1) Second Modification

Even when it is in the state in which the center position 692 can be obtained, there is an operation in which the cross cursor 751 is not displayed. For example, it is a case in which the center coordinate 692 is generated at the non-enterable area. Whether or not the cross cursor 751 is displayed is controlled by a control signal from the microcomputer. From the display device of the present invention, a determination signal indicated whether or not the center coordinate value is asked for and a position of the x-y coordinate thereof are outputted to the microcomputer. The microcomputer displays the cross cursor in the display area 10 depending on the determination signal and the position of the x-y coordinate.

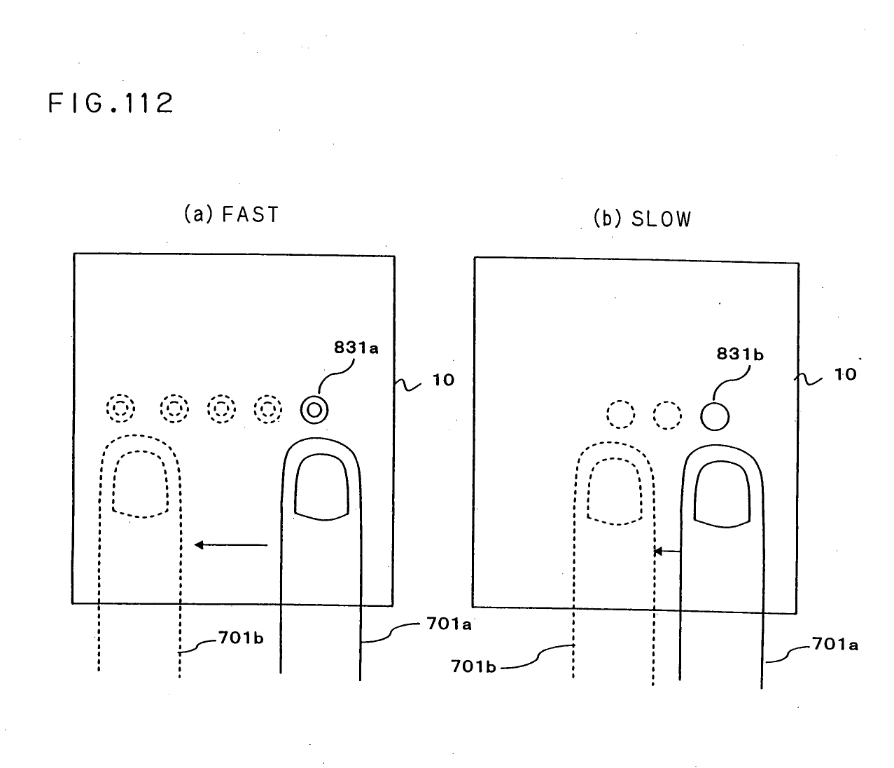

In the description in conjunction with FIG. 75, the cross cursor 751 is displayed. However, the invention is not limited thereto. For example, as shown in FIG. 112, a position of the tip of the object 701 is calculated from the coordinate position of the object 701, and the icon 831 is displayed at a position where the operator can visually identify such as the position of the distal end thereof.

The icon 831 is moved in association with the movement of the object 701. FIG. 112(a) shows a state in which the speed of movement of the object 701 is low, and FIG. 112(b) shows a state in which the speed of movement of the object 701 is high. The speed of movement of the object 701 is determined by the speed of change of the coordinate position 692 to be detected. Preferably, the display image of the icon 831 is varied corresponding to the speed of the movement of the object 701.

(3-2) Third Modification

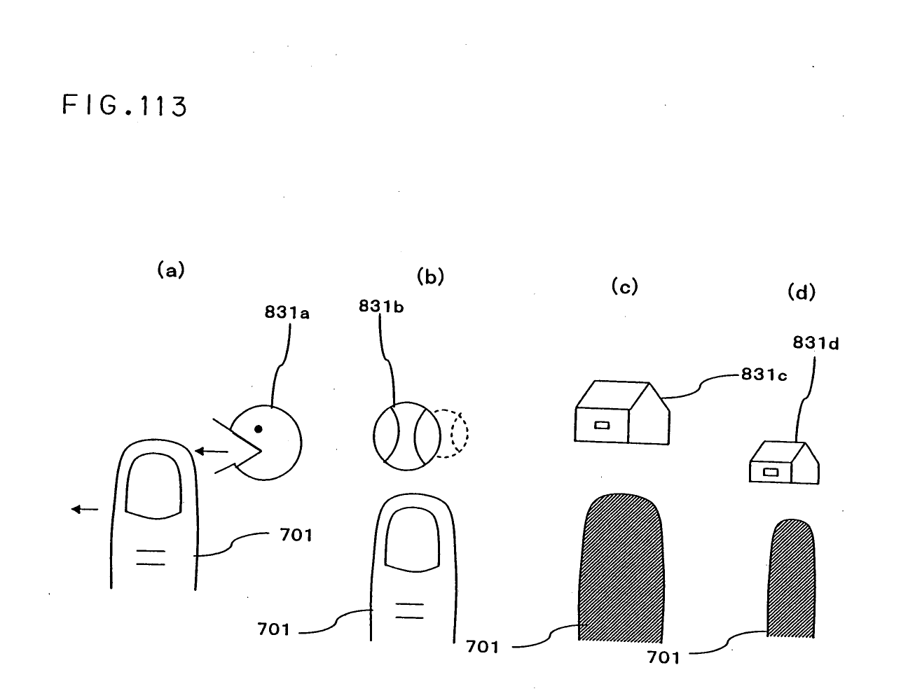

FIG. 113 shows an embodiment in which the display of the icon 831 is changed. FIG. 113(a) shows a display of a character. The icon 891a is displayed so as to follow the direction of movement of the object 701. FIG. 113(b) shows a display of a ball. The character to be displayed is varied according to the speed of movement of the object 701.

FIG. 113(c) and FIG. 113(d) show an embodiment in which the size of the icon 891 to be displayed is varied in accordance with the size of the shadow of the object 701 or the size of the object 701 to be detected.

(4) ON Output Area and Input Detection Photosensor

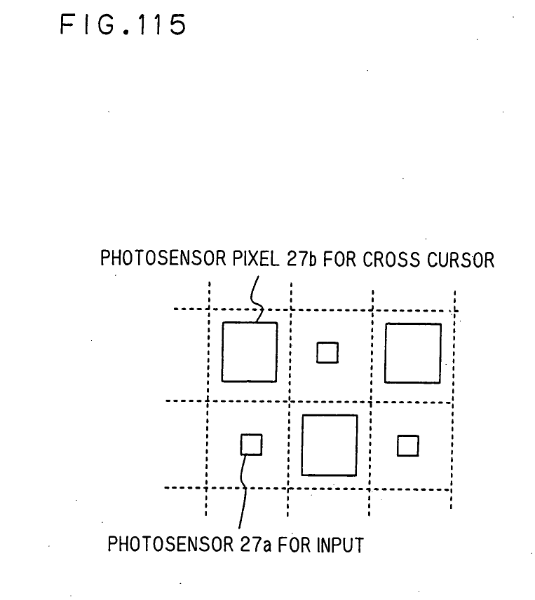

Preferably, as shown in FIG. 115, the photosensor pixels 27b for detecting the ON output area 691 generated by the object 701, and the input photosensor pixels 27a for detecting input by the operation such as approach and contact (see FIG. 114 and so on) are formed or configured separately.

(5) Specification of Coordinate Position

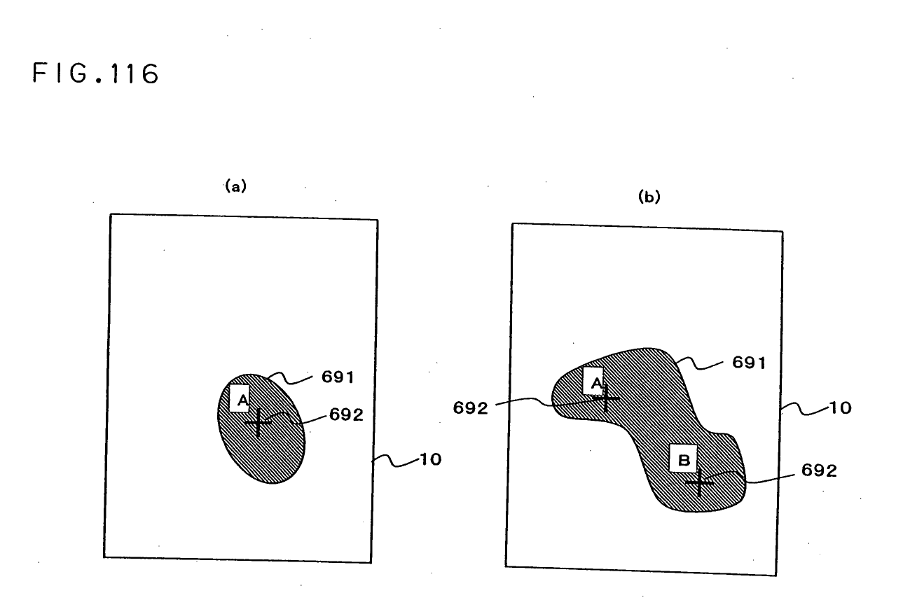

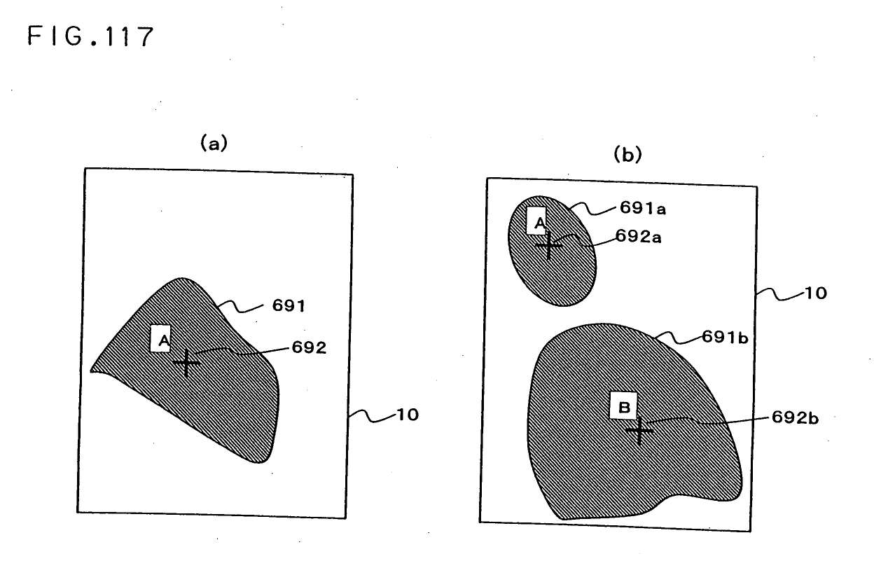

As shown in FIG. 116(a), when there is only one ON output area 691 and the ON output area 691 is approximated to a circular shape, one coordinate position 692 can be detected. As in the case shown in FIG. 116(a), even when the ON output area 691 is apart from the circle to some extent, as long as it is an independently isolated state, one coordinate position 692 can be detected. However, as shown in FIG. 116 (b), when the ON output area 691 is deformed and the ON output area 691 is apart from the circle, there may be a case in which a plurality of the coordinate positions 692 are detected. When the plurality of ON output areas 691 are generated as shown in FIG. 117(b), the plurality of coordinate positions 692 are generated.

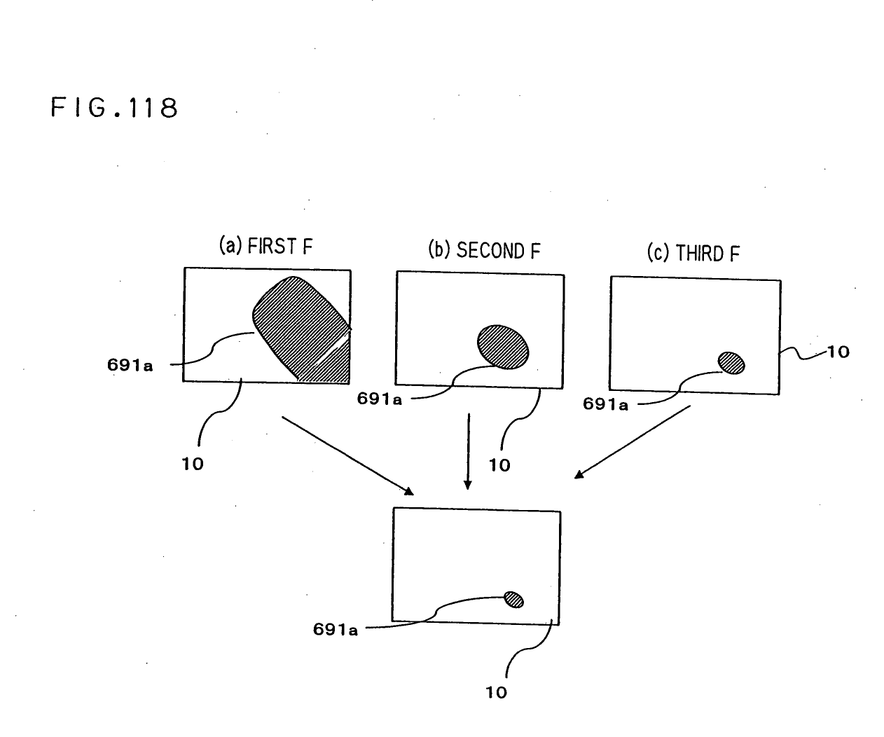

In order to make the area of the shadow adequate, the precharge signals Vp for the calibration are varied for the respective frames as shown in FIG. 118. When the precharge signals Vp are varied, the size of the ON output area 691 is also varied. The center coordinate is detected from the ON output area 691 that is common in the plurality of frames.

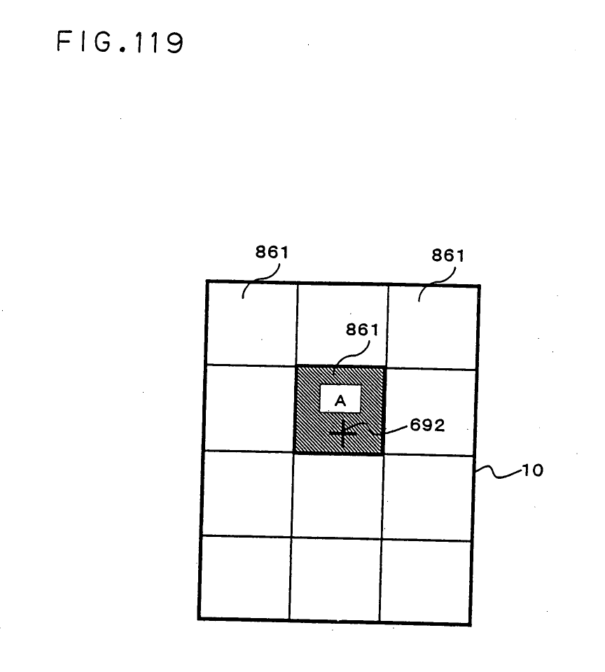

In order to solve the problem described above, in the present invention, the coordinate position is detected by logically multiplying conformity with the original input determination according to approach, contact and separation. For example, referring to FIG. 119, it is assumed that the contact determination is generated in the shadowed processing block (BL) 861 in the display area 10. The center coordinate 692 of the ON output area is assumed to be generated within the identical processing block (BL) 861. In this case, the processing block at the position A is a position for input.

(5-1) Processing of a Plurality of Coordinate Positions

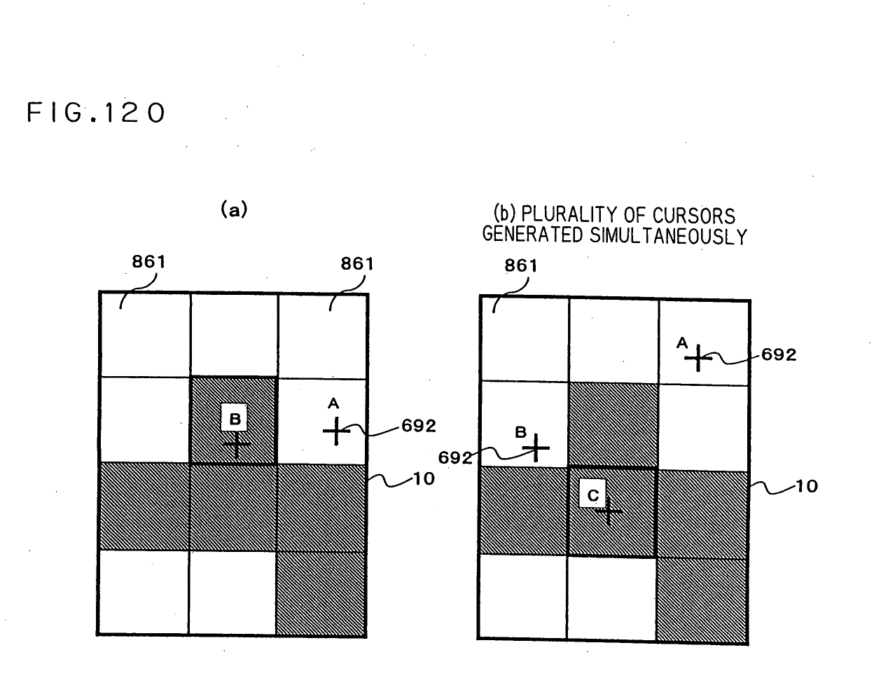

The input determination (contact determination) according to approach, contact and separation, or approach and contact may be generated in the plurality of processing blocks (BL) 861. For example, it is assumed that the input determination is generated in the shadowed processing block (BL) 861 in FIG. 120. In FIG. 120, determination is performed in five processing blocks (BL) 861. A and B are outputted as the center positions 692 of the ON output area 691. The processing block (BL) 861 in which the contact determination matches the center position is B. Therefore, the point B is determined to be the input position.

In FIG. 120(b), five processing blocks (BL) 861 are determined to be in contact as FIG. 120 (a). The points A, B and C are outputted as the center positions 692 of the ON output area 691. The processing block (BL) 861 in which the contact determination matches the center position is the point C. Therefore the point C is determined to be the input position.

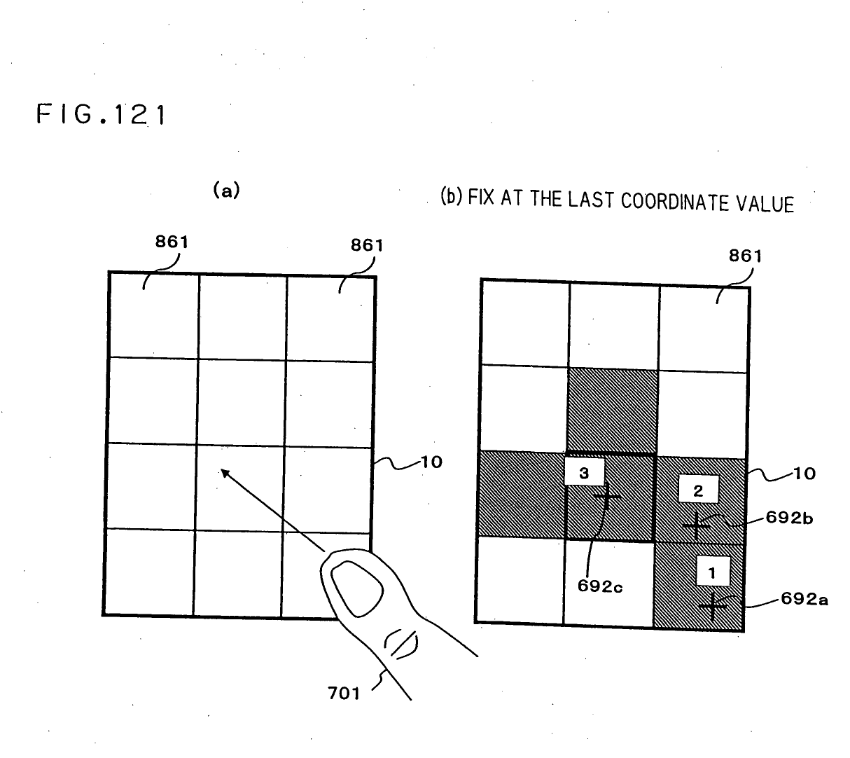

In FIG. 121, five processing blocks (BL) 861 are determined to be in contact as in FIG. 120. Numerals 1, 2 and 3 are outputted as the center positions 692 of the ON output area 691. The processing blocks (BL) 861 in which the contact determination matches the center position is 1, 2 and 3. Therefore, the input position cannot be determined.

In this case, as shown in FIG. 121 (a), the direction of movement of the object 701 is taken into consideration. When the object 701 is moved in the direction of the arrow, the position where the shadow of the object 701 is generated is moved. Simultaneously, the position of the ON output area 691 is also moved. The position of the center coordinate of the ON output area 691 is also moved and the center position is moved in the sequence of 1→2→3 as shown in FIG. 121(b). Since the last position is most likely the input position, the center coordinate 692c is determined to be the input position.

(5-2) Input Direction of the Object

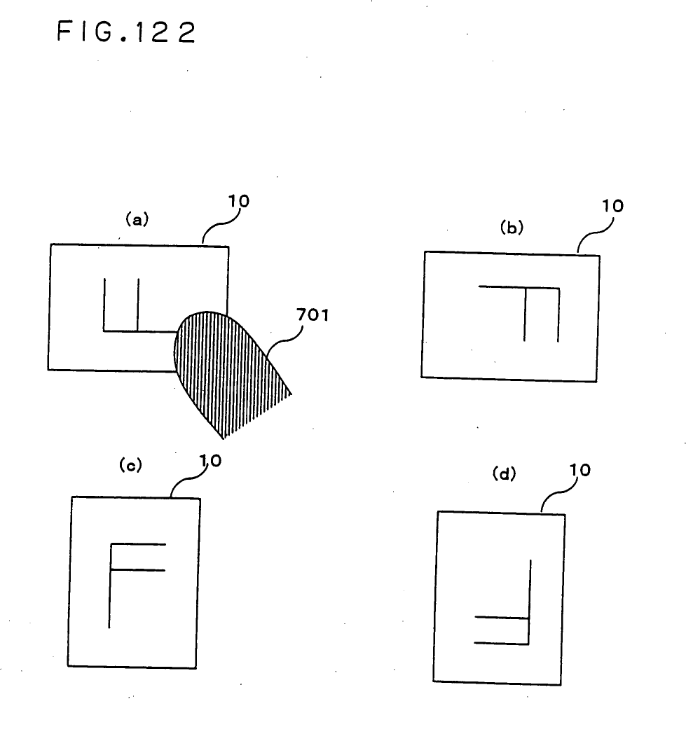

In the detection of the coordinate position, there is a case in which a positional relation between the object 701 and the display device is important. For example, as shown in FIG. 122, the relation between the object 701 and the display position of the display panel 658 is important. In FIG. 122, FIG. 122(a) shows a lateral arrangement, and FIG. 122(b) shows a laterally inversed arrangement of FIG. 122(a). FIG. 122(c) shows a vertical arrangement, and FIG. 122(d) shows a vertically inverted arrangement of FIG. 122(c).

In the plane display device and the drive method thereof in the present invention, information on the direction of arrangement in the screen 10 and input information of at least one of the input directions of the object 701 are input or expressly provided to execute operation.

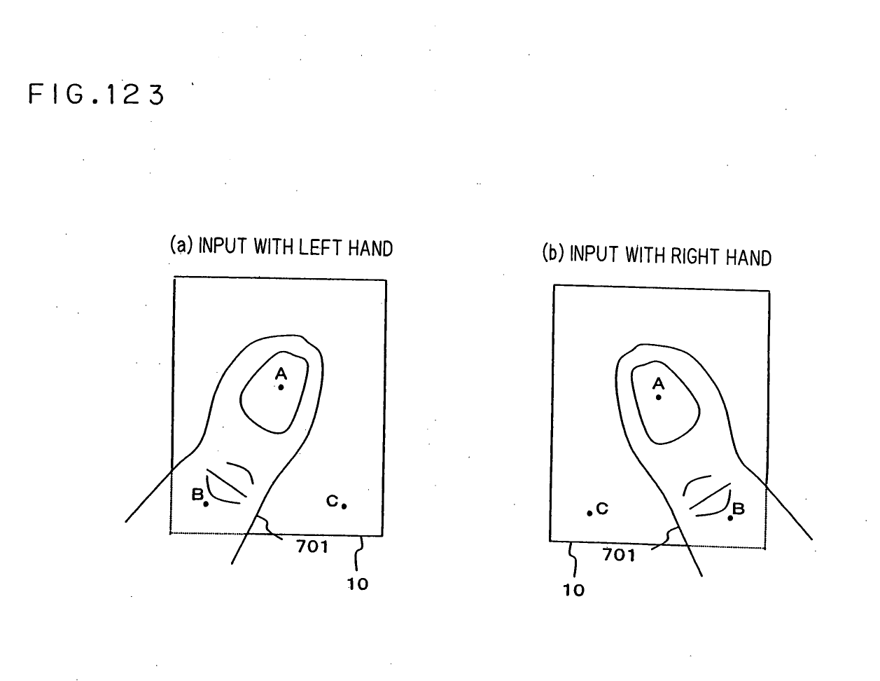

FIG. 123(a) shows a case in which input is made with a left hand as the object 701 on the display screen 10 of the display device in the present invention. FIG. 123(b) is a case in which input is made with a right hand as the object 701 in the display screen 10 of the display device in the present invention.

In both of FIGS. 123(a) and (b), a case in which input is made at the point A at the center of the screen 10. However, when input is made by a left hand as in FIG. 123(a), the shadow of the object 701 (left hand) is also generated at the point B. However, at the point C, there is no shadow generated. In the case of FIG. 123(a), when the precharge signal Vp is relatively far from the optimal value, the point B may be determined as the coordinate input position as well as the point A. In this case, by setting whether input is made by the left hand or the right hand as the object 701 in advance, the point B may be excluded from the objects of coordinate detection.

FIG. 123(b) shows a case in which input is made by the right hand. It shows a case in which input is made at the point A at the center of the screen 10. However, when input is made with the right hand in FIG. 123(b), a shadow is also generated at the point C by the object 701 (right) However, no shadow is generated at the point B. In the case of FIG. 123(b), when the precharge signal Vp is relatively far from the optimal value, there may be a case in which the point C is also determined as the coordinate input position as well as the point A. In this case, by setting that input is made by the right hand as the object 701, the point C can be excluded from the objects of the coordinate detection.

(5-3) Direction of Arrangement of Display Screen

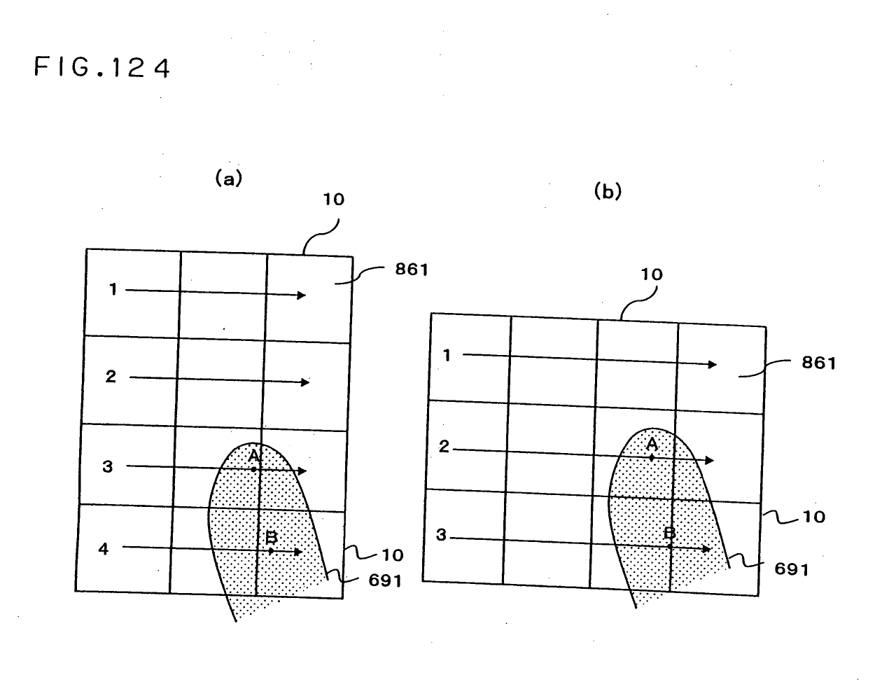

Information of setting or the direction of arrangement of display screen 10 is also important information for specifying the input coordinate position. For example, as shown in FIGS. 124 (a), (b), cases in which the screen is arranged in a laterally elongated position and a vertically elongated position are assumed. Input is made by the right hand as the object 701 and in the same direction both in FIGS. 124(a) and (b).

As in FIG. 124(a), the case in which the display screen 10 of the display device 658 in the present invention is arranged in the vertically elongated direction is assumed. The process of detecting the coordinate position is performed in the direction indicated by arrows in the sequence of 1, 2, 3 and 4 as shown in FIG. 124(a). Then, the ON output area 691 generated by the object 701 is detected at the point A, and then the ON output area 691 generated by the object 701 at the point B is detected. The direction of input by the object 701 (for example, the right hand or the left hand), and the direction of arrangement of the screen 10 (vertically elongated, laterally elongated, top, bottom, left, right) is known, it is automatically known that the point A is the input coordinate position. Therefore, the point B can be excluded.

The direction of arrangement of the screen 10 (vertically elongated, laterally elongated, top, bottom, left, right) is known as the system since the image is displayed by DSP or the microcomputer. Therefore, the coordinate position of the object 701 can be specified using the information.

As shown in FIG. 124(b), the case in which the display screen 10 of the display device 658 in the invention is arranged in the laterally elongated direction is assumed. The process of detection of the coordinate position is performed in sequence of arrows 1, 2, 3 and 4 as shown in FIG. 124(b). Then, the ON output area 691 generated by the object 701 is detected at the point A, and then the ON output area 691 generated by the object 701 is detected at the point B. As in the case shown in FIG. 124(a), the direction of input by the object 701 (for example, the right hand or the left hand), and the direction of arrangement of the screen 10 (vertically elongated, laterally elongated, top, bottom, left, right) are known, it is automatically known that the point A is the input coordinate position. Therefore, the point B can be excluded.

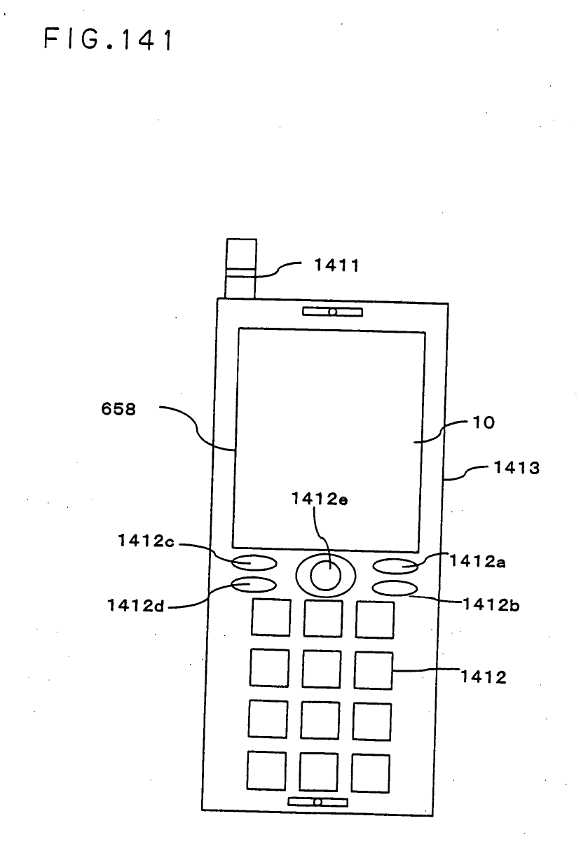

The direction of input by the object 701 is not limited to the explicit setting such as key entry. For example, in a cellular phone device shown in FIG. 141, the switch is formed at a position that causes a difference between a point of an enclosure 1413 touched by the right hand and a point of the enclosure 1413 touched by the left hand depending on the hand which holds the enclosure 1413. In other words, the switch is adapted so as to be pressed when the enclosure 1413 is held by the right hand, and not to be pressed when the enclosure 1413 is held by the left hand. Input by the finger 701 is assumed to be made by the hand which is not holding the enclosure 1413. In this arrangement, determination (judgment) can be made without setting whether the object 701 is the right hand or the left hand explicitly.

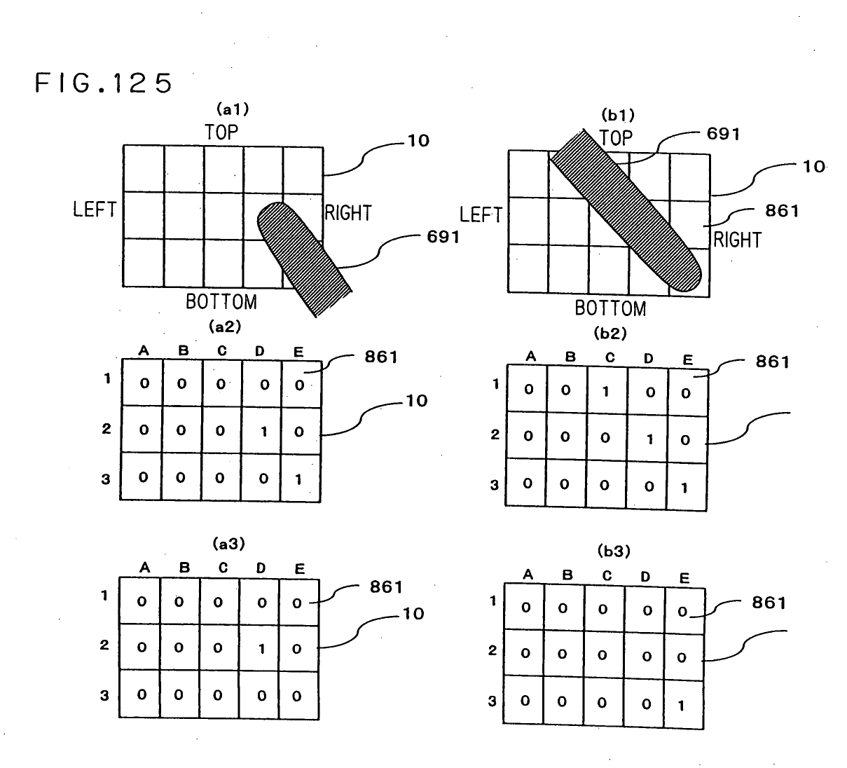

When the direction of input by the object 701 is known, even when a number of ON output areas 691 are generated in the display area 10, and the positions of the coordinate detection are generated in a number of processing blocks (BL) 861, the input position can be determined easily. For example, FIG. 125(a) (FIGS. 125(a1), (a2)) shows a case in which input is made by the object (finger) 701 from the right bottom in the display screen 10. FIG. 125(b) (FIGS. 125(b1), (b2)) shows a case in which input is made by the object (finger) 701 from the left top in the display screen 10.

FIG. 125(a1) shows the fact that the ON output area 691 is generated by the object 701, and the coordinates are detected in two processing blocks (BL) 861. In FIG. 125, reference numeral 1 designates the processing block (BL) 861 at which the coordinate is detected. Reference numeral 0 designates the processing block (BL) 861 at which the coordinate is not detected.

FIG. 125(a2) shows a case in which input is made by the object (finger) 701 from the right bottom in the display screen 10. Therefore, the coordinate positions are generated at D2 and E3 of the processing block (BL) 861. However, since the direction of input by the object 701 is known in the present invention, as shown in FIG. 125(a3), the point D2 is detected (determined) to be the input position.

FIG. 125(b1) shows the fact that the ON output area 691 is generated by the object 701, and the coordinates are detected in three processing blocks (BL) 861 (shows a possibility to be detected). In FIG. 125(b), input is made by the object (finger) 701 from the left top in the display screen 10. Therefore, the coordinate positions are generated at the points C1, D2 and E3 of the processing block (BL) 861. However, in the present invention, since the direction of input by the object 701 is known, as shown in FIG. 125(b3), the point E3 is detected (determined) to be the input position.

In FIG. 125(a2) and FIG. 125(b2), points that may be detected as the coordinate positions are commonly D2 and E3. However, as shown in FIGS. 125(a1), (b1), since the direction of input of the object 701 is known, the position of the input coordinate by the object 701 can be specified using the input information described above.

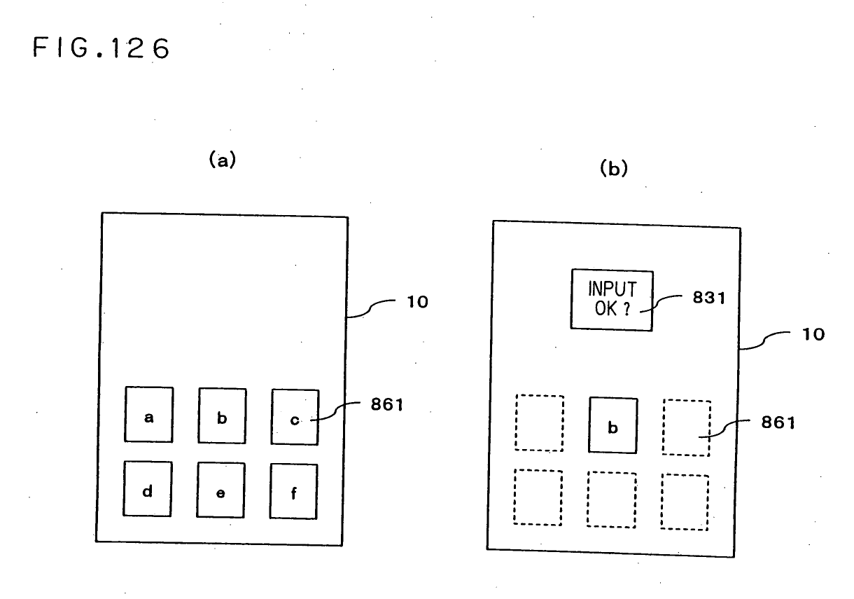

The detected input coordinates which do not cause any problem in operation may be used as the fixed coordinates even when they are erroneous input. However, for example, an erroneous input that causes a problem like police call is indicated by the confirmation icon 831 as shown in FIG. 126(b).

(5-4) Input Confirmation

FIG. 126(a) shows a normal input screen. Input positions a, b, c, d, e and f are displayed. When the processing block (BL) 861 at the input position b is entered, the processing block (BL) 861 at the input position b is kept displayed as is as shown in FIG. 126(b), and the confirmation icon 831 “input OK?” is displayed. When input is OK, the processing block (BL) 861 at the input position b or the confirmation icon 831 is pressed to fix the input.

(5-5) Start of Calibration

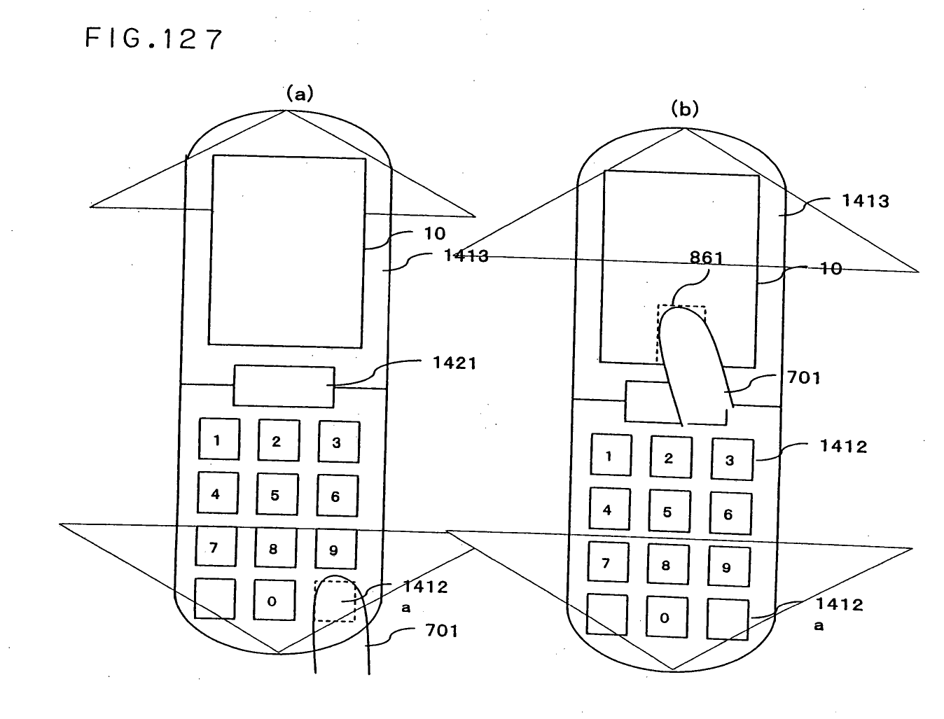

In order to start finger input, as shown in FIG. 127(a), instruction is given by touching a specific key 1412a. As shown in FIG. 127(b), calibration is performed by bringing the object 701 into contact with the specific processing block (BL) 861 in the display area 10.

As shown in FIG. 127(b), a display portion is displayed in the processing block (BL) 861 in the display area 10. In this display portion, an instruction to prompt the user to press this area with the finger 701 and a contour of the finger 701 for indicating the position to press are displayed. Display in the display portion is achieved by the source driver circuit 14.

When the processing block (BL) 861 is touched by the finger 701, calibration is performed. Alternatively, the calibration is started by pressing the key 1412. It may also be started by detection of the fact that the display portion is touched by the finger 701. When the key 1412 is pressed, the finger 701 touches the display portion 10, the calibration is started. The precharge signal Vp is varied and the ON output area 691 is detected.

When the precharge signal Vp is varied, the state of the On output area 691 varies with the precharge signal Vp. The precharge signal Vp is varied slowly from a low voltage to a high voltage, and the precharge signal Vp is varied slowly from a high voltage to a low voltage. In other words, the precharge signal Vp is repeatedly varied between the high voltage and the low voltage within a predetermined voltage range.

The operator views the state of display in the display area 10 and separates the finger 701 apart from the display portion 10 at a moment when the ON output image becomes “closest to black” display, or in a range in which white and black can be recognized most clearly in the display portion 10. When the finger 701 is separated, the precharge signal Vp stops variation, and the precharge signal Vp when it stops is stored. Alternatively, the key 1412 is pressed to finish. When the key 1412 is pressed, the precharge signal Vp stops variation, and the precharge signal Vp when it stops is stored. When required, a value obtained by adding or subtracting a constant value to/from the precharge signal Vp is stored as a real precharge signal Vp.

As described in FIG. 106 and FIG. 120, there are many factors of variation in the states of approach, contact, and separation. Therefore, it is necessary to adjust or set the variation speed of the ON output area to an optimal state. (6) Variation in Rate of the Number of ON Pixels (%) at Time of Approach, Contact and Separation.

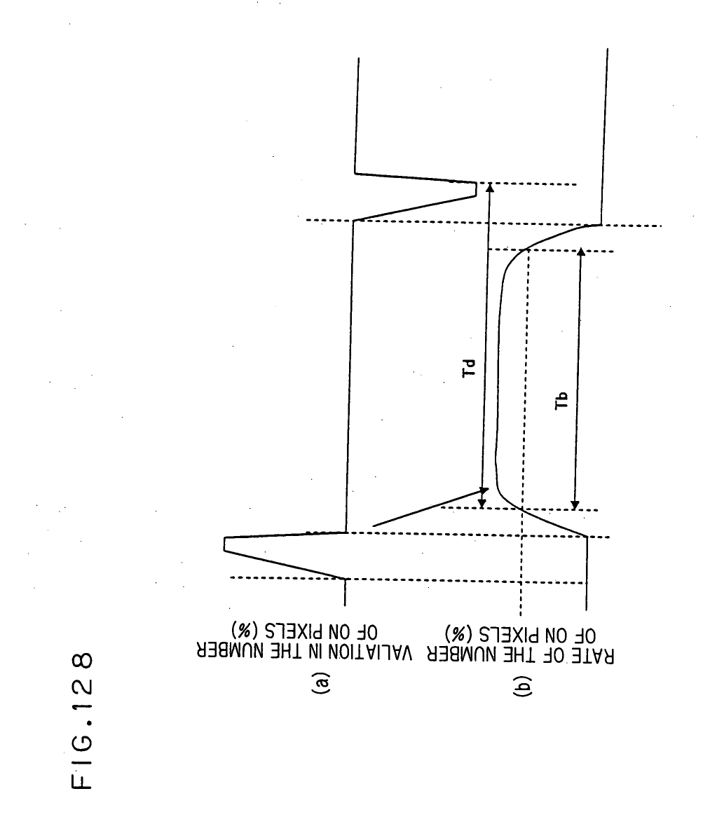

FIG. 128 shows the variation in the rate of the number of the ON pixels (%) at the time of approach, contact and separation. FIG. 128(a) shows a variation in the rate of the number of the ON pixels of approach and separation. When the object 701 approaches, variation in the number of the ON pixels occurs. The variation occurs in the direction in which the rate of the number of the ON pixels (%) increases, and hence it is the positive direction. Even when the object 701 is separated, the variation in the number of the ON pixels occurs naturally. Since the variation occurs in the direction in which the rate of the number of the ON pixels (%) decreases, it is the negative direction. A period from approach to separation is represented by Td as shown in FIG. 128(a). When this period is a short period, the processing cannot be completed in time, and hence the object 701 cannot be detected. When it is too long, erroneous input occurs.

As shown in FIG. 128(b), in the contact state, the rate of the number of the ON pixels (%) increases. What is detected is not the velocity of variation, but the stable rate of the number of the ON pixels (%). The stable state is, when the final value of the rate of the number of the ON pixels (%) is assumed to be 100%, represented by a period of Tb from a moment when the rate of the number of the ON pixels (%) reaches 70% to a moment when it underruns 70%. When this period is a short period, the processing cannot be completed in time, and hence the object 701 cannot be detected. When it is too long, erroneous input occurs.

(7) Input Determination System

The description described above is the system of detecting the coordinate with the three operations of approach, contact and separation. In the present invention, there is also a system of detecting the coordinate with the two operations of approach and contact. The three operation system and the two operation system can be switched by giving a command. They can be switched automatically.

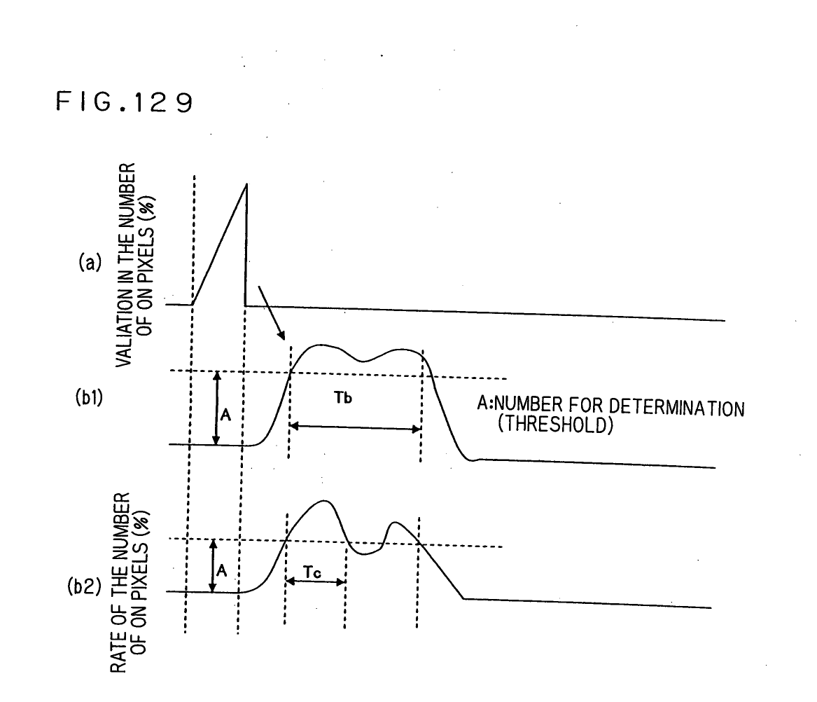

FIG. 129 shows a system for performing the coordinate detection by the two operations of approach and contact. After having detected approach in FIG. 129(a), a contact signal in FIG. 129(b1) is detected. A threshold A for detecting the contact signal may be varied. The A in the normal state is, when the final value of the rate of the number of the ON pixels (%) is assumed to be 100%, the point of 70%. As described in FIG. 114, when the illuminance is low, the threshold A is reduced. The illuminance to be reduced is determined from the estimated illuminance L obtained from H or the like as described in conjunction with FIG. 80. The value of A can be varied according to the value of the estimated illuminance L.

As shown in FIG. 129(b2), the period of Tb may not be continued. As shown in the drawing, the rate of the number of the ON pixels (%) is reduced in the midway to a level below the threshold A. Therefore, the period becomes Tc. In this case, the length of the period of Tb and the period of Tc is determined and whether the coordinate detection is determined or not is determined.

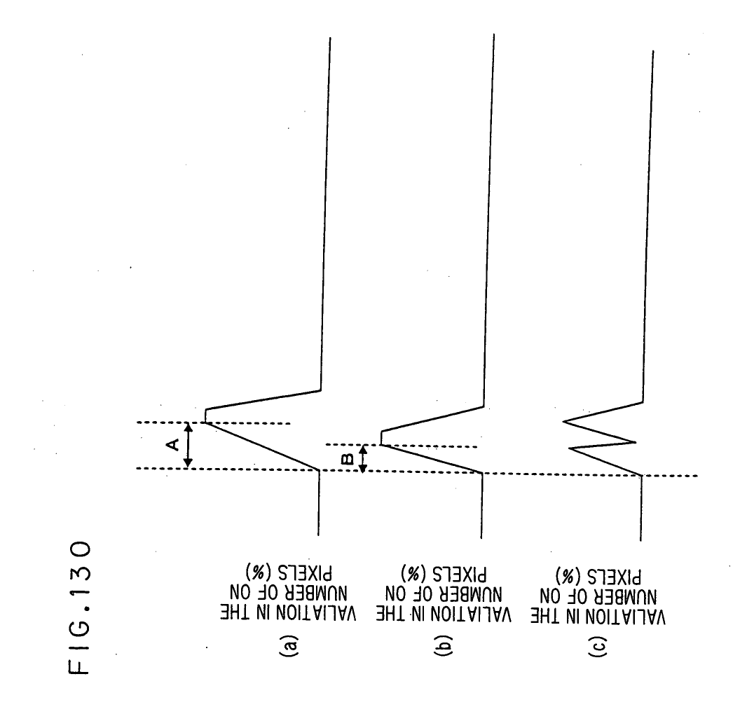

As shown in FIG. 130(a), there may be a case in which the variation in the number of the ON pixels of the approach signal is the period A, which is relatively slow. As shown in FIG. 130(b), there is a case in which the variation in the number of the ON pixels of the approach signal is the period B, which is relatively fast. The limit of the range that is determined as the approach signal is determined by providing a threshold. As shown in FIG. 130(c), there is a case in which the approach signal is attenuated (reduced) in the midway. In this case, there is a possibility that it is an erroneous input. Therefore, the approach signal is cancelled.

(8) Processing of Approach and Separation Signal

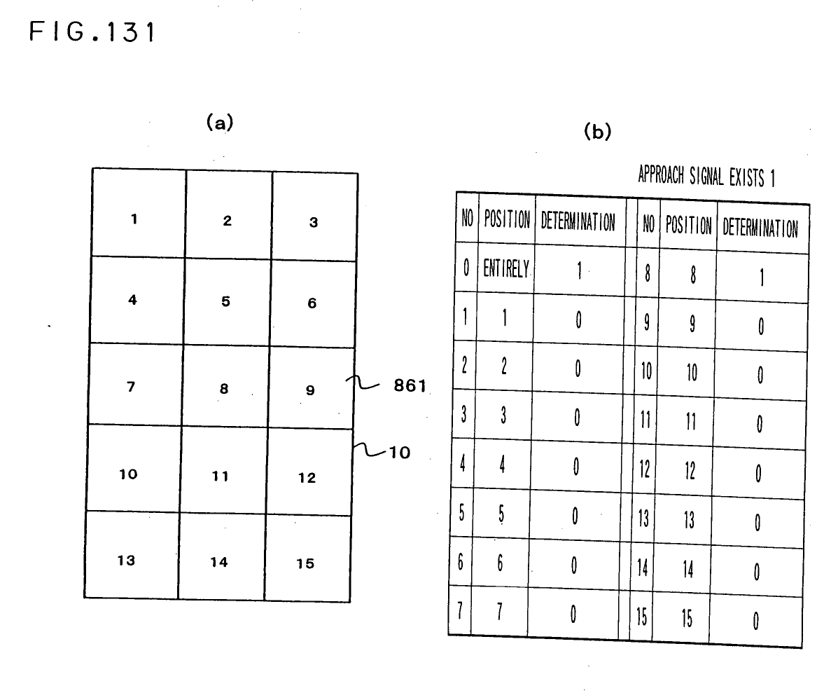

The presence or absence of approach and separation signals is preferably determined by both of the entire area where the photosensor pixels 27 are formed and the respective processing blocks (BL) 861. FIG. 131 is an explanatory drawing of this determination.

As shown in FIG. 131(a), the display area 10 includes fifteen processing blocks (BL) 861 (designated by numerals from 1 to 15) arranged or preset. The determination or the processing of contact and separation described in conjunction with FIG. 129 and FIG. 130 is achieved by determining how the rate of the number of the ON pixels (%) varies in the entire display area 10. This determination is shown by No. 0 in FIG. 131(b). Whether or not approach or separation is occurred by the object is determined generally and substantially. The variation in the rate of the number of the ON pixels (%) of the photosensor pixels in the respective processing blocks (BL) 861 is detected, and the processing block (BL) 861 in which approach or separation is occurred is determined. In FIG. 131(b), the fact that it is occurred in the processing block No. 8 is represented by “1”.

In FIG. 131(b), since it is determined that approach or separation is occurred as a whole and approach or separation is occurred in the processing block No. 8, it is determined that input is made in the processing block No. 8. When it is determined that approach or separation is occurred as a whole, and approach and separation is not made in all the processing blocks, it is not determined that the input is made. When occurrence of approach or separation is not determined as a whole, and approach and separation is occurred in at least one processing block Nos., re-entry is prompted, or the processing block which is most likely the input is specified by the processing of the microcomputer.

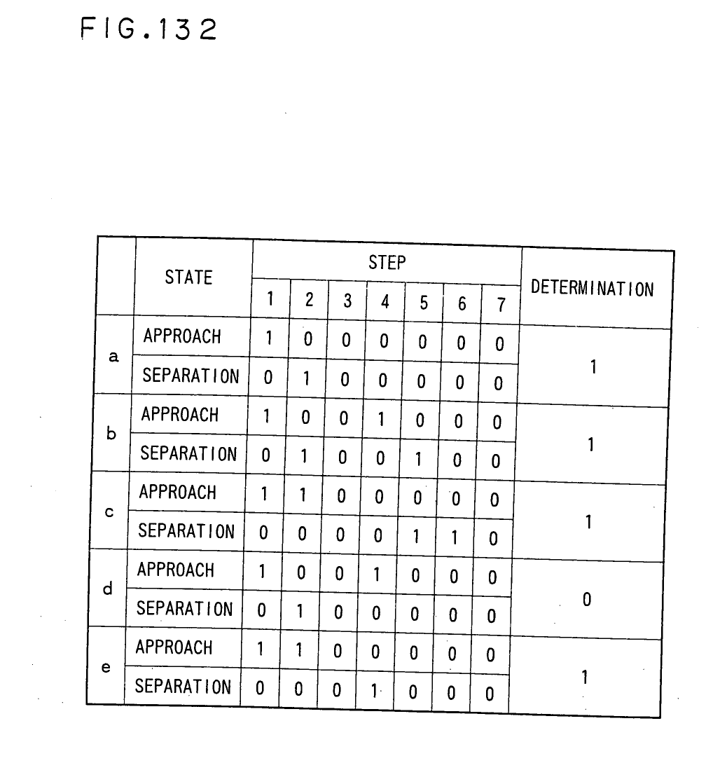

The determination or the processing in FIG. 131 is performed for each approach or separation. When input determination is made by the three operations of approach, contact and separation, it is determined to be input when the approach determination matches the separation determination as shown in FIG. 132. The sequence such that the determination of separation is occurred after having determined approach is monitored.

In FIG. 132, the values in columns of step represent time and determination output timings to be performed at predetermined intervals. However, in order to facilitate understanding, the determination of contact is omitted.

In a case a, the determination of approach is outputted in Step 1 which indicates the time, and the determination of separation is outputted in Step 2 of the timing. Therefore, determination is “input is present”.

In a case b, the determination of approach is outputted in Step 1 which indicates the time, and the determination of separation is performed in Step 2 of the timing. Then, the determination of approach is outputted in Step 4, and the determination of separation is outputted in Step 5. In this case, since approach and separation constitute a pair, the determination is “input is present”. There is also a case of double-click input.

In a case c, the determination of approach is outputted continuously in Steps 1 and 2 which indicate time, and then the determination of separation is performed continuously in Steps 5 and 6 of the timing. Therefore, the determination is “input is present”.

In a case d, the determination of approach is outputted in Step 1 which indicates time, and then the determination of separation is made in Step 2 of the timing. However, a signal indicating approach is outputted again in Step 4, and then no separation signal is outputted. In this case, it is determined to be an erroneous input, and hence the determination is “no input” or “cancelled”.

In a case e, the determination of approach is outputted continuously in Steps 1 and 2 which indicate time, and then the determination of separation is made in Step 4 of the timing. This is a case in which the operator takes time to select input, and it is determined to be inputted, and to be “input is present”. However, it is necessary to use other reasons for determination.

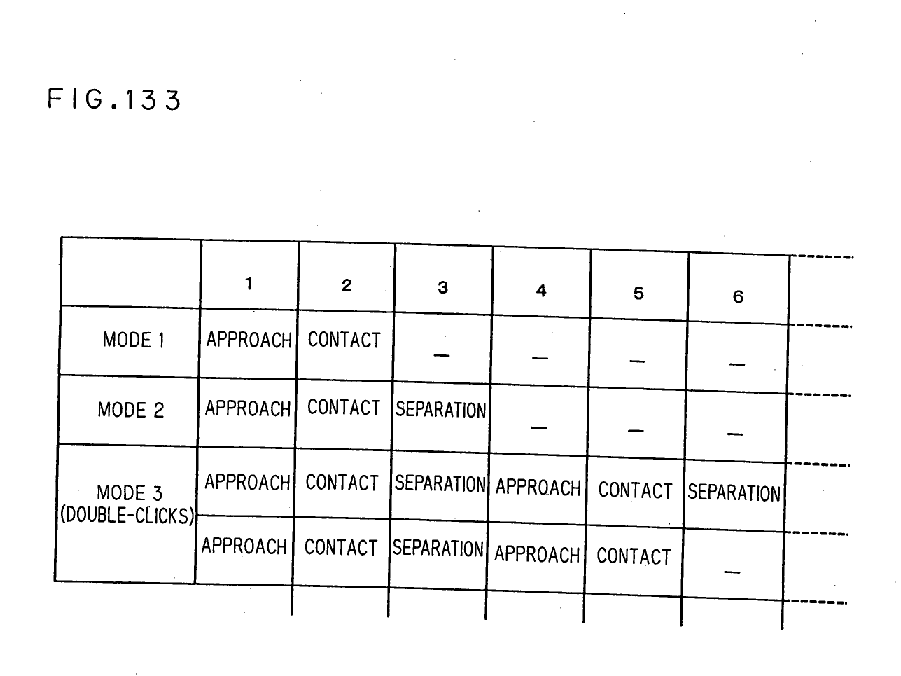

The input determination (judgment) of the display device in the present invention can select the operations shown in FIG. 133. These operations can be switched as needed by command setting or the operator. It can also be switched corresponding to the illuminance of outside light. For example, when the illuminance is low, the erroneous input is apt to occur, and hence the determination is made by approach+contact+separation in Mode 2. When the illuminance is high, the input determination is made by approach+contact in mode 1. This switching operation is achieved by the output from the photosensor which detects outside light, or, as described in conjunction with FIG. 80 and so on, by the magnitude of the estimated illuminance.

Mode 3 in FIG. 133 is an input by double-clicks. It is determined by approach+contact+separation+approach+contact. It is also possible to determine by approach+contact+separation+approach+contact+separation. It is also possible to determine by approach+separation+approach+separation. Since the input by double-clicks is a specific pattern, erroneous operation can hardly occur.

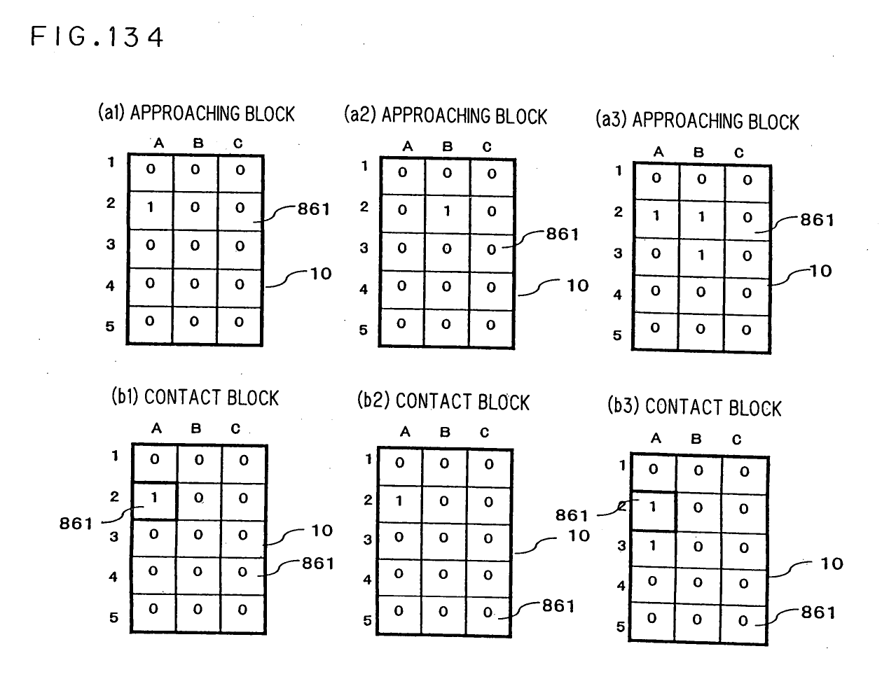

The determination of approach and contact is performed in the entire display area 10, and also performed for each processing block (BL) 861 for input determination. FIG. 134 shows an example of determination performed by processing block (BL) 861. The embodiment shown in FIG. 134 is an example of the two operations mode of approach+contact. It is the same for the three operations mode of approach+contact+separation.

In a set of embodiments shown in FIGS. 134(a1) and (b1), the processing block (BL) 861 which is determined (processed) as approach is A2 as shown in FIG. 134(a1). As shown in FIG. 134(b1), the processing block (BL) 861 which is determined (processed) as contact is A2. Therefore, the processing block (BL) 861 determined as approach and the processing block (BL) 861 determined as contact are completely identical. Therefore, the input position is A2 of the processing block. As described in conjunction with FIG. 131, it is preferable that determination of approach and contact is made in the entire display area 10.

In a set of embodiments shown in FIGS. 134 (a2) and (b2), the processing block (BL) 861 determined (processed) as approach is B2 as sown in FIG. 134(a2). As shown in FIG. 134(b2), the processing block (BL) 861 determined (processed) as contact is A2. Therefore, the processing block (BL) 861 determined as contact and the processing block (BL) 861 determined as contact are not the same. Therefore, since the approach and the contact states of the FIG. 134(a2), (b2) are likely to be the erroneous input, the input process is not made. Alternatively, as described in conjunction with FIG. 126(b), the input confirmation process is performed.

In a set of embodiments shown in FIG. 134(a3) and (b3), the processing blocks (BL) 861 determined (processed) as approach as shown in FIG. 134 (a3) are A2 and B2. As shown in FIG. 134(b2) the processing block (BL) 861 determined (processed) as contact is A2. Therefore, the processing block (BL) 861 determined as approach and the processing block (BL) 861 determined as contact are both A2. Therefore, the input position is determined to be A2 of the processing block. As described in FIG. 131, it is preferable that the determination of approach and contact is made in the entire display area 10. Since the contact state is likely to be an erroneous input, it is preferable to perform the input confirmation process as shown in FIG. 126(b).

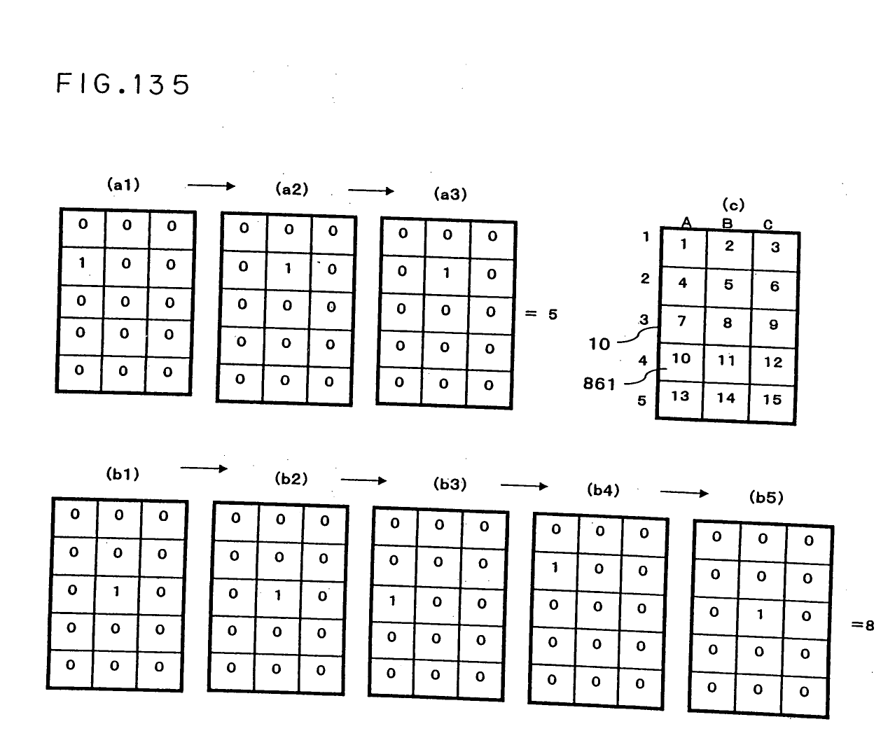

In the low illuminance area below 100 Lx, the sensitiveness of the photosensor 35 with respect to outside light or the like is reduced. Therefore, it is preferable to detect whether the contact determination is continued by a plurality of times (a plurality of STEPS, see FIG. 132, and so on). FIG. 135 shows an embodiment of the case described above.

In FIG. 135(c), sections in the processing block (BL) 861 are shown as in FIG. 131(a). FIG. 135(a) (a1, a2, a3) shows an example in which the contact determination is performed three times. In FIG. 135(a1), the position where contact is determined is A2. In FIG. 135(a2), the position where contact is determined is B2. In FIG. 135(a3), the position where contact is determined is B2. Therefore, the processing blocks (BL) 861 which is determined to be in contact through the determination of three times (3 STEPS) are A2 for one time and B2 for two times. Therefore, it is determined that contact is occurred in the processing block (BL) 861 No. 5 (see FIG. 135(c), which corresponds to B2. The same thing can be applied to contact and separation.

FIG. 135(b) (b1, b2, b3, b4 and b5) shows an example in which contact determination is performed five times. In FIG. 135(b1), the position where contact is determined is B3. In FIG. 135(b2), the position where contact is determined is B3. In FIG. 135 (b3), the position where contact is determined is A3. In FIG. 135(b4), the position where contact is determined is A2. In FIG. 135(b5), the position where contact is determined is B3. Therefore, the processing blocks (BL) 861 which is determined to be in contact through the determination of three times (3 STEPS) are B3 for three times, A3 for one time, and A2 for one time. Therefore, it is determined that contact is occurred at the processing block (BL) 861 No. 8 (see FIG. 135(c)) which is B3. The same things can be applied to approach and separation

(8-1) First Modification

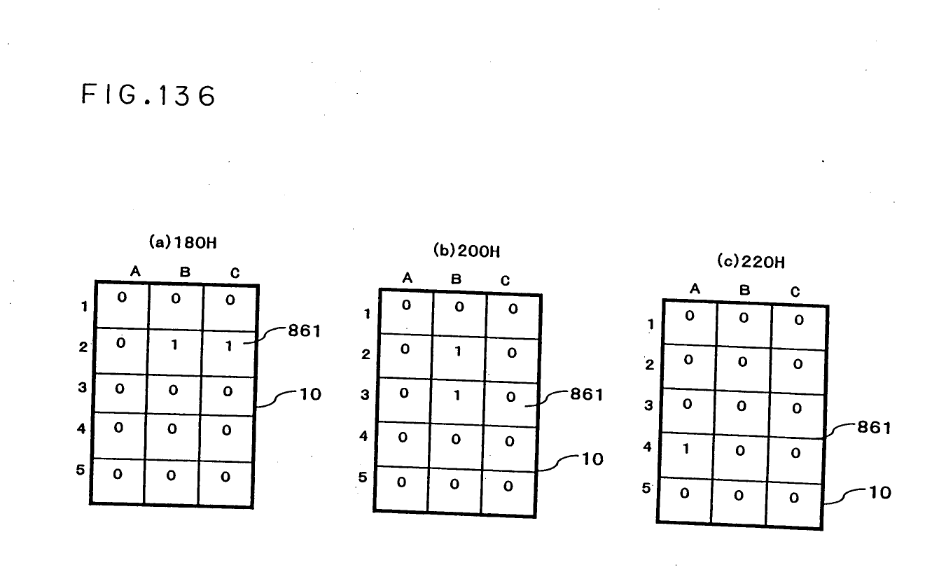

The embodiment described above is the embodiment in which approach, contact and/or separation are determined with the same exposure time Tc. However, the present invention is not limited thereto. For example, as shown in FIG. 136, determination or detection process may be performed with the exposure time Tc varied.

FIG. 136(a) is an embodiment in which the exposure time Tc is set to 180H. The precharge signal Vp is set to be an adequate value. FIG. 136(b) shows an embodiment in which the exposure time Tc is set to 200H. FIG. 136(c) shows an embodiment in which the exposure time Tc is set to 220H. It is varied to values near the exposure time Tc of 200H to be used originally. As described above, the processing block (BL) 861 in which contact or separation is detected is determined.

In FIG. 136(a), the detected processing blocks (BL) 861 are B2 and C2. In FIG. 136(b), the detected processing blocks are B2 and B3. In FIG. 136(c), the detected processing block (BL) 861 is A4. In this state, the detected state is unstable. However, the processing block B2 is detected twice in three times, and other detected positions are also close thereto. Therefore, it is determined that contact or separation is detected about in B2.

(8-2) Second Modification

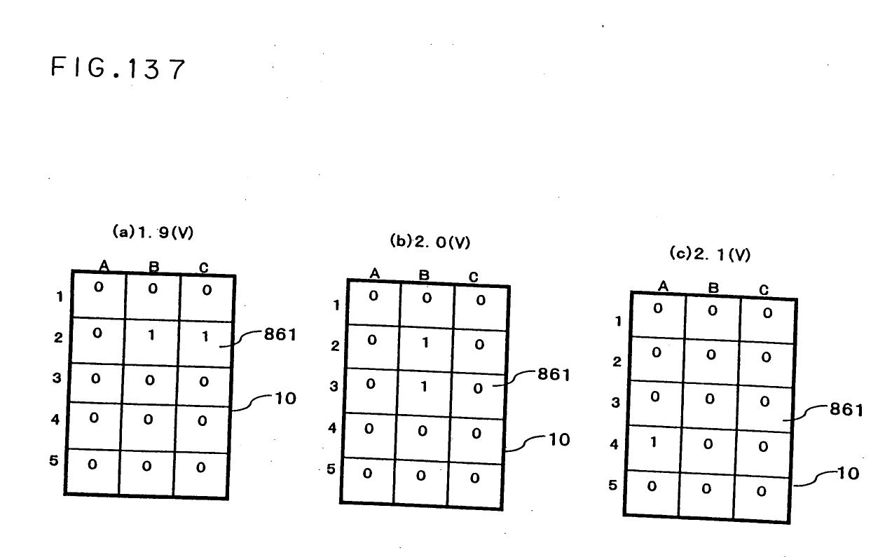

Likewise, the precharge signal Vp may be varied. FIG. 137(a) shows an embodiment in which the precharge signal Vp is set to 1.9 V. The exposure time Tc is set to an adequate value. FIG. 137(b) is an embodiment in which the precharge signal Vp is set to 2.0 V. FIG. 137(c) is an embodiment in which the precharge signal Vp is set to 2.1 V. It is varied to values near the precharge signal Vp of 2.0 V to be used originally. In this manner, processing blocks (BL) 861 in which contact or separation is detected is determined.

In FIG. 137(a), the detected processing blocks (BL) 861 are B2 and C2. In FIG. 136(b), the detected processing blocks (BL) 861 are B2 and B3. In FIG. 136(c), it is detected in A4. In this state, the detected state is instable. However, the processing block B2 is detected twice in three times, and other detected positions are also close thereto. Therefore, it is determined that contact or separation is detected about in B2. Determination is made by majority. The borderline of determination by majority is set to be variable.

(8-3) Third Modification

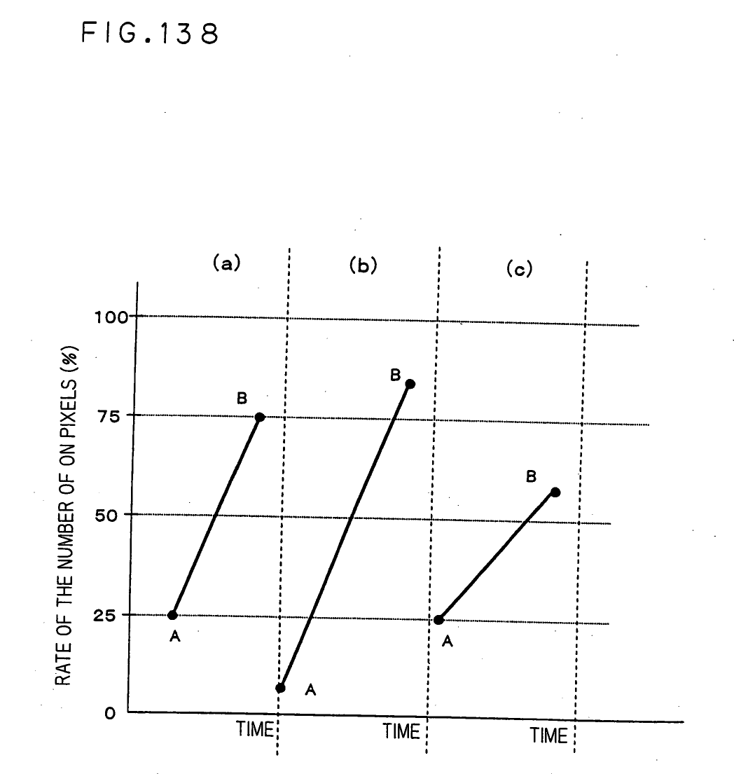

In particular, in the low illuminance area, it is also necessary to pay attention to the velocity of a variation in the number of ON pixels at the time of approach (separation). FIG. 138 shows the rate of the number of the ON pixels (%) of approach. The rate of variation is the smallest in the case shown in FIG. 138(c), and the largest in the case (b). FIG. 138(a) is intermediate state between (c) and (b). The rate of variation is apt to be smaller with decrease in illuminance. Therefore, the amount of change to be determined by the rate of the number of the ON pixels (%) is preferably set according to the illuminance of outside light.

(8-4) Fourth Modification

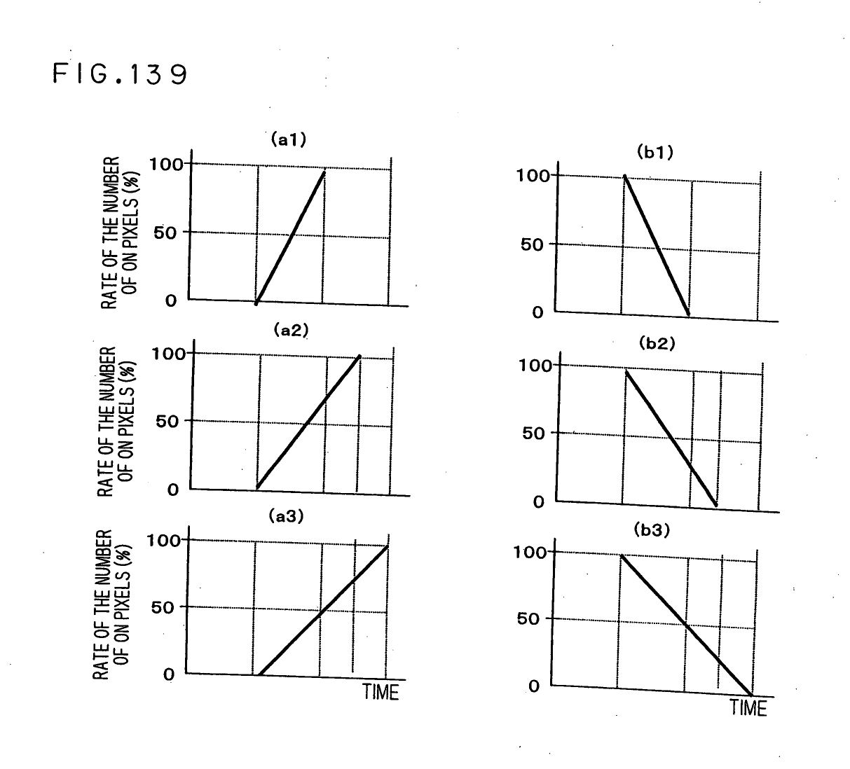

FIG. 139(a) is an example showing the rate of the number of the ON pixels (%) of approach. FIG. 139(b) is an example showing the rate of the number of the ON pixels (%) of separation. Preferably, the amount of variation at which the rate of the number of the ON pixels (%) is determined is set according to the illuminance of outside light. As shown in FIG. 139, a configuration in which the plurality of patterns are set and the desired pattern is selected according to the estimated illumination (FIG. 80) may be employed.

### J. Circuit Configuration and Operation

### (1) First Embodiment

In FIG. 81, the source driver circuit (IC) 14 transmits signals to the gate driver circuit (IC) 12a or the like. The signal includes a start signal of the gate driver circuit (STV), a vertically inverted circuit (U/D), a shift clock in the positive direction (CKV1), or CKV2 of the opposite phase from CKV1, an enable signal (OEV), and a main clock (CLK).

These signals are entered into an input pad 812 of the photosensor circuit (IC) 18 via connecting terminals (OLB) 811a, 811b between the glass substrate and the flexible printed circuit 20 of the panel.

The photosensor processing circuit 18 in the display device of the present invention generates a timing signal of the precharge signal Vp and the timing signal of the comparator voltage Vref depending on the entered signal. A shift clock of the gate driver circuit (HCX), a position control signal (CRT) of the precharge signal Vp, an output acquisition timing signal (OPT) which are required for controlling the gate driver circuit 12b are generated.

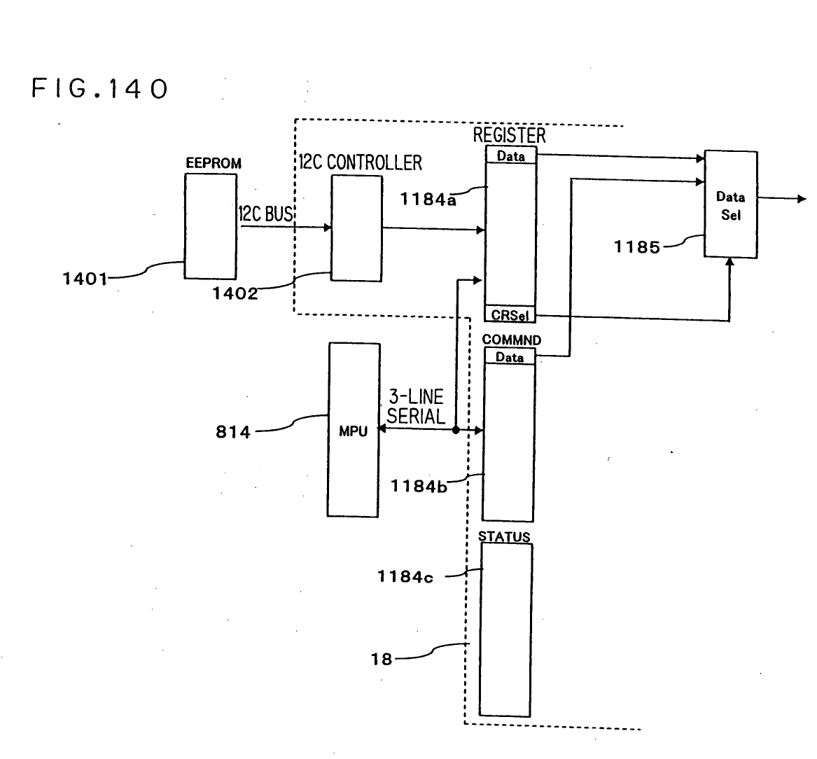

In the display device according to the present invention, as shown in FIG. 140, the panel characteristic data or the setting data (Tc1, Tc2, H, m, n and so on described in FIG. 80) are supplied to the EEPROM 1401. The photosensor circuit 18 in the present invention is composed of a I2C controller 1402, registers 1404, 1405 of the respective data, and a logic circuit (not shown) for the calibration or the like.

The I2C controller 1402 reads the data from the EEPROM 1401, and transmits the same to the register 1404a. The register includes the EEPROM register 1404a, the command (COMMND) register 1404b, the status (STSTUS) register 1404c. The microcomputer (MPU) 1183 can perform reading and writing of the contents of the respective registers. The actual operation is such that one of the command register 1404b or the register 1404a is selected by a CRsel (selection code of command and ROM) and stored in the DATA selector (DataSel) 1405.

### (2) Second Embodiment

In the display device in the present invention and the drive method thereof, the size of the photosensor pixel 27 was described to be one type. However, the present invention is not limited thereto. The photosensor pixel 27 or the photosensor 35 having a plurality of sensitivities may be provided as a matter of course.

For example, in the embodiments shown in FIG. 79 and FIG. 80, the configuration, variation or operation, or adjustment of one photosensor pixel 27 or the photosensor 35 are described. When a plurality of types of the photosensor pixels 27 or the photosensors 35 are formed, the present invention is implemented for one type of photosensor pixel 27 or the photosensor 35. Alternatively, the present invention is implemented for the plurality of photosensor pixels 27 or photosensors 35 and the result is averaged or put together for performing the processing in the present invention.

### K. Application Example

An application example in the present invention will be described. The following application example implements the device or the method described above.

(1) Cellular Phone

FIG. 141 shows a plan view of a cellular phone as an example of an information terminal device. An antenna 1411, a ten key 1412 are mounted to the enclosure 1413. Reference numeral 1412 designates a display color switching key, power ON/OFF, and a frame rate switching key.

The operation of the keys 1412 in the display device 658 according to the present invention is to touch the display screen by a finger. In other words, the keys or push switches are displayed on the display screen 10, and the same operation can be achieved by pressing the keys or switch images.

(2) Video Camera

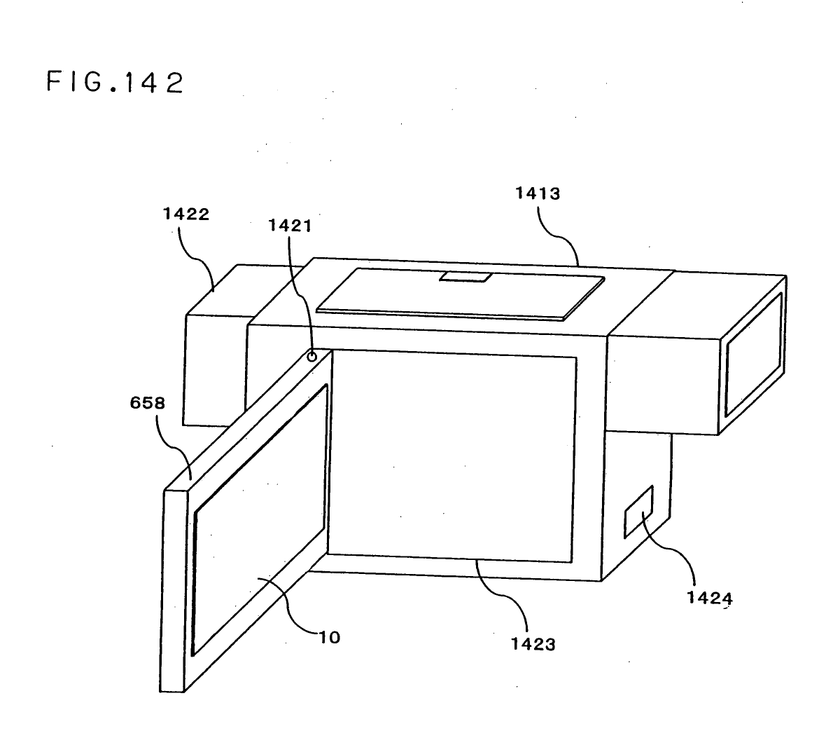

FIG. 142 is a perspective view of a video camera. The video camera includes a imaging (image pickup) lens portion 1422 and a video camera body 1413, and the imaging lens portion 1422 and the view finder portion 1413 are in a back to back relation. The display panel 658 of the present invention is also used as a display monitor. The display portion 10 can be adjusted freely in angle at a fulcrum point 1421. When the display portion 10 is not used, it is stored in a storage section 1423.

A switch 1424 is a change-over or control switch for implementing the functions described below. By operating the switch 1424, the display is switched to a display mode in which the operation is achieved by touching the display screen 10 with the finger.

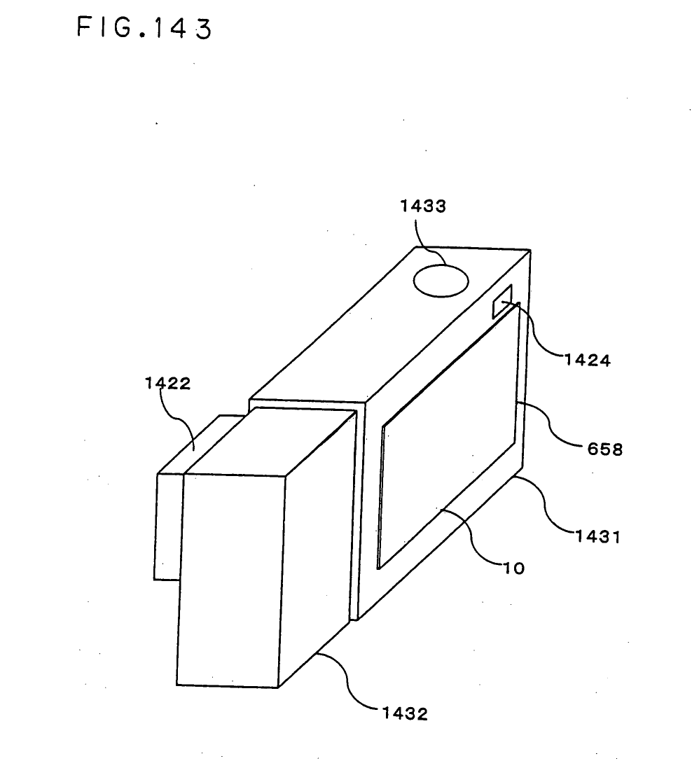

The display device in the present invention can be applied not only to the video camera, but also to an electronic camera or a still camera as shown in FIG. 143. The display device 658 is used as a monitor attached to the camera body 1431. It can also be used as a finger input device. The camera body 1431 is provided not only a shutter 1433, but also the switch 1424.

### INDUSTRIAL APPLICABILITY

The present invention can be applied not only to the liquid crystal panel, but also to other display panels. For example, it may be applied to other types of display such as EL (organic, inorganic) display panels, field emission displays (FED), SEDs (trademark), PDPs (plasma display panel), liquid crystal devices, displays using a carbon nano tube (also abbreviated as CNT), or Cathode Ray Tube (CRT) as a matter of course. It is also possible to employ the technical idea of the present invention to a simple matrix display panel.

The present invention may be applied to video cameras, projectors, three-dimensional TVs, and projection TVs.

The invention may also be applied to view finders, main monitors and sub monitors of cellular phones, watch displays, PHSs, Personal Digital Assistances and the monitors thereof, digital cameras, satellite televisions, satellite mobile televisions and monitors thereof.

The invention may also be applied to scanners, image sensors, electrophotographic systems, head mount displays, direct-view monitor display, laptop personal computers, video cameras, digital still cameras, and electronic still cameras.

The present invention may also be applied to monitors for ATMs, public telephones, TV-telephones, Personal computers, watches and display devices thereof. The present invention is also applicable to information generators such as barcode. These technical ideas may be combined partly or totally.

The present invention may be applied to or developed for display monitors for appliances such as rice cooking machines, displays for car audio sets, speed meters for vehicles, displays for shaving machines, mobile game playing machines and monitors thereof, number displays for telephone sets, display monitors such as indicators of instruments for industrial use, display monitors on trains for indicating destinations, displacements in neon indicating devices, backlights for display panels, illuminating devices for family use or industrial use, and illumination devices such as ceiling lights, window glasses, vehicle headlights, as a matter of course.

The present invention may also be applied to display devices such as advertisements or posters, RGB traffic lights, and alarm lamps. These technical ideas may be combined partly or totally.

What is claimed is:

1. A plane display device having display pixels formed on an array substrate in a matrix manner and a plurality of photosensor pixels formed on the array substrate, comprising:
a display area in the plane display device divided into a plurality of processing blocks, the blocks each having the plurality of photosensor pixels;
a precharge signal supply unit for supplying a precharge signal for providing energy required for an operation of the photosensor pixels to the respective photosensor pixels;
a reading unit for acquiring reading signals outputted from the respective photosensor pixels according to intensities of light beams irradiated on the respective photosensor pixels in a state in which the precharge signals are supplied to the respective photosensor pixels;
a storage unit for storing data relating to the precharge signals for one or a plurality of the photosensor pixels in the corresponding processing blocks;
wherein the precharge signal supply unit supplies the precharge signals to the respective photosensor pixels on the basis of the data.

2. The plane display device according to claim 1, wherein the data stored in the storage unit are data relating to a precharge signal that brings the one or the plurality of photosensor pixels to a light-detectable state.

3. The plane display device according to claim 1, wherein the processing block includes a plurality of sections,
wherein the data stored in the storage unit are stored for the respective sections, and the data for the respective sections are data relating to the precharge signals that bring a predetermined ratio of the photosensor pixels out of the plurality of photosensor pixels belonging to the sections to a light-detectable state, and
wherein the precharge signal supply unit supplies the precharge signals to the photosensor pixels belonging to the respective sections on the basis of the data for the respective sections.

4. The plane display device according to claim 1, wherein the data stored in the storage unit are stored for the respective processing blocks, and the data for the respective processing blocks are data relating to the precharge signals that bring a predetermined ratio of the photosensor pixels out of the plurality of photosensor pixels belonging to the processing blocks to a light-detectable state,
wherein the precharge signal supply unit supplies the precharge signals to the photosensor pixels belonging to the respective processing blocks on the basis of the data for the corresponding processing blocks, and
wherein the reading unit acquires reading signals from the photosensor pixels having only a predetermined characteristic out of the reading signals from the photosensor pixels belonging to the corresponding processing blocks.

5. The plane display device according to claim 1, wherein the storage unit outputs characteristic detection signals to the respective photosensor pixels, acquires reading signals outputted from the respective photosensor pixels in a state in which the characteristic detection signals are supplied to the respective photosensor pixels, determines whether or not the respective photosensor pixels are light-detectable from the acquired reading signals, and stores the characteristic detection signals of the photosensor pixels which are determined to be light-detectable as the precharge signals corresponding to the respective photosensor pixels.

6. The plane display device according to claim 1, wherein the precharge signals to be supplied to the respective photosensor pixels are supplied synchronously with rewrite timing of the respective display pixels.

7. The plane display device according to claim 1, wherein the precharge signal supply unit supplies precharge signals that bring the photosensor pixels to a light-undetectable state to the photosensor pixels belonging to part of the processing blocks out of the plurality of the processing blocks.

8. The plane display device according to claim 1, wherein the storage unit stores the data in an encoded state.

9. The plane display device according to claim 1, wherein picture signals to be applied to the respective display pixels and the precharge signals are supplied via an identical signal line.

10. The plane display device according to claim 1, wherein the precharge signal supply unit supplies the precharge signal to one terminal of the photosensor in the photosensor pixel, and
wherein the reading unit acquires a potential of the one terminal of the photosensor after a predetermined period has elapsed from timing when the precharge signal is supplied as the reading signal.

11. The plane display device according to claim 1, comprising: a plurality of processing ranges,
wherein the processing ranges are different in at least one of the precharge signal and an exposure time, and
wherein one of the plurality of processing ranges is selected depending on an illuminance of outside light.

12. The plane display device according to claim 1, wherein the reading unit acquires the reading signals at predetermined cycles, and the acquired reading signals are compared with a reference value and converted into binary signals.

13. A plane display device having display pixels formed on an array substrate in a matrix manner and photosensor pixels formed on the array substrate,
wherein the photosensor pixel comprises:
a precharge signal line for supplying a precharge signal that provides energy required for an operation of the photosensor pixel;
a first capacitor which the precharge signal is applied thereto and hence electric charge is accumulated therein;
a photosensor that discharges the electric charge accumulated in the capacitor by being irradiated by a light beam;
a detection transistor that is changed between ON and OFF states corresponding to the precharge signal discharged from the capacitor; and
an offset circuit for performing an offset cancelling for the detection transistor.

14. The plane display device according to claim 13, comprising: a detection unit for detecting characteristic values of at least one of the photosensors of the respective photosensor pixels and the detection transistor;
a storage unit for storing the detected characteristic data; and
a precharge signal adjusting unit for determining a magnitude of the precharge signal on the basis of the stored characteristic data.

15. The plane display device according to claim 13, wherein a position of an input object is displayed on a display screen in a state in which the input object is arranged in a non-contact state with respect to the display screen of the plane display device.

16. The plane display device according to claim 13, wherein information indicating operating states of the photosensor pixels is displayed on the display screen of the plane display device.

17. A plane display device having display pixels formed on an array substrate in a matrix manner and photosensor pixels formed on the array substrate, comprising:
a first operating unit for setting a first exposure time and obtaining a first precharge signal at which a predetermined number of photosensor pixels out of a plurality of the photosensor pixels are operated within a predetermined range during the first exposure time;
a second operating unit for setting a second exposure time which is different from the first exposure time and obtaining a second precharge signal at which the predetermined number of photosensor pixels out of the plurality of photosensor pixels are operated within the predetermined range during the second exposure time; and
a calculating unit for multiplying a difference between the first precharge signal and the second precharge signal by a constant value for obtaining a value relative to an illuminance.
